(19) United States
(12) Patent Application Publication
(10) Pub. No.: US 2016/0086391 A1
(43) Pub. Date: Mar. 24, 2016

(54) FLEETWIDE VEHICLE TELEMATICS SYSTEMS AND METHODS

(71) Applicant: AutoConnect Holdings LLC, Wellesley, MA (US)

(72) Inventor: Christopher P. Ricci, Saratoga, CA (US)

(21) Appl. No.: 14/863,361

(22) Filed: Sep. 23, 2015

Related U.S. Application Data
(60) Provisional application No. 62/054,166, filed on Sep. 23, 2014.

(51) Int. Cl. G07C 5/00; G07C 5/08

(52) U.S. Cl. CPC G07C 5/008; G07C 5/08

(57) ABSTRACT

Fleetwide vehicle telematics systems and methods that includes receiving and managing fleetwide vehicle state data. The fleetwide vehicle state data may be fused or compared with customer enterprise data to monitor conformance with customer requirements and thresholds. The fleetwide vehicle state data may also be analyzed to identify trends and correlations of interest to the customer enterprise.

### CROSS REFERENCE TO RELATED APPLICATIONS

The present application claims the benefits of and priority, under 35 U.S.C. §119(e), to U.S. Provisional Application Ser. No. 62/054,166, filed on Sep. 23, 2014, entitled “Network Connected Vehicle and Associated Controls,” the entire disclosure of which is hereby incorporated herein by reference, in its entirety, for all that it teaches and for all purposes.

This application is also related to 62/046,517, filed Sep. 5, 2014, entitled “Network Connected Vehicle and Associated Controls”; 61/811,981, filed on Apr. 15, 2013, entitled “Functional Specification for a Next Generation Automobile”; 61/865,954, filed on Aug. 14, 2013, entitled “Gesture Control of Vehicle Features”; 61/870,698, filed on Aug. 27, 2013, entitled “Gesture Control and User Profiles Associated with Vehicle Features”; 61/891,217, filed on Oct. 15, 2013, entitled “Gesture Control and User Profiles Associated with Vehicle Features”; 61/904,205, filed on Nov. 14, 2013, entitled “Gesture Control and User Profiles Associated with Vehicle Features”; 61/924,572, filed on Jan. 7, 2014, entitled “Gesture Control and User Profiles Associated with Vehicle Features”; and 61/926,749, filed on Jan. 13, 2014, entitled “Method and System for Providing Infotainment in a Vehicle.” The entire disclosures of the applications listed above are hereby incorporated by reference, in their entirety, for all that they teach and for all purposes.

This application is also related to U.S. patent application Ser. No. 14/847,849 filed on Sep. 8, 2015, entitled, “Network Connected Vehicle and Associated Controls”; Ser. No. 13/420,236, filed on Mar. 14, 2012, entitled, “Configurable Vehicle Console”; Ser. No. 13/420,240, filed on Mar. 14, 2012, entitled “Removable, Configurable Vehicle Console”; Ser. No. 13/462,593, filed on May 2, 2012, entitled “Configurable Dash Display”; Ser. No. 13/462,596, filed on May 2, 2012, entitled “Configurable Heads-Up Dash Display”; Ser. No. 13/679,459, filed on Nov. 16, 2012, entitled “Vehicle Comprising Multi-Operating System” (Attorney Docket No. 6583-228); Ser. No. 13/679,234, filed on Nov. 16, 2012, entitled “Gesture Recognition for On-Board Display” (Attorney Docket No. 6583-229); Ser. No. 13/679,412, filed on Nov. 16, 2012, entitled “Vehicle Application Store for Console” (Attorney Docket No. 6583-230); Ser. No. 13/679,857, filed on Nov. 16, 2012, entitled “Sharing Applications/Media Between Car and Phone (Hydroid)” (Attorney Docket No. 6583-231); Ser. No. 13/679,878, filed on Nov. 16, 2012, entitled “In-Cloud Connection for Car Multimedia” (Attorney Docket No. 6583-232); Ser. No. 13/679,875, filed on Nov. 16, 2012, entitled “Music Streaming” (Attorney Docket No. 6583-233); Ser. No. 13/679,676, filed on Nov. 16, 2012, entitled “Control of Device Features Based on Vehicle State” (Attorney Docket No. 6583-234); Ser. No. 13/678,673, filed on Nov. 16, 2012, entitled “Insurance Tracking” (Attorney Docket No. 6583-235); Ser. No. 13/678,691, filed on Nov. 16, 2012, entitled “Law Breaking/Behavior Sensor” (Attorney Docket No. 6583-236); Ser. No. 13/678,699, filed on Nov. 16, 2012, entitled “Etiquette Suggestion” (Attorney Docket No. 6583-237); Ser. No. 13/678,710, filed on Nov. 16, 2012, entitled “Parking Space Finder Based on Parking Meter Data” (Attorney Docket No. 6583-238); Ser. No. 13/678,722, filed on Nov. 16, 2012, entitled “Parking Meter Expired Alert” (Attorney Docket No. 6583-239); Ser. No. 13/678,726, filed on Nov. 16, 2012, entitled “Object Sensing (Pedestrian Avoidance/Accident Avoidance)” (Attorney Docket No. 6583-240); Ser. No. 13/678,735, filed on Nov. 16, 2012, entitled “Proximity Warning Relative to Other Cars” (Attorney Docket No. 6583-241); Ser. No. 13/678,745, filed on Nov. 16, 2012, entitled “Street Side Sensors” (Attorney Docket No. 6583-242); Ser. No. 13/678,753, filed on Nov. 16, 2012, entitled “Car Location” (Attorney Docket No. 6583-243); Ser. No. 13/679,441, filed on Nov. 16, 2012, entitled “Universal Bus in the Car” (Attorney Docket No. 6583-244); Ser. No. 13/679,864, filed on Nov. 16, 2012, entitled “Mobile Hot Spot/Router/Application Share Site or Network” (Attorney Docket No. 6583-245); Ser. No. 13/679,815, filed on Nov. 16, 2012, entitled “Universal Console Chassis for the Car” (Attorney Docket No. 6583-246); Ser. No. 13/679,476, filed on Nov. 16, 2012, entitled “Vehicle Middleware” (Attorney Docket No. 6583-247); Ser. No. 13/679,306, filed on Nov. 16, 2012, entitled “Method and System for Vehicle Data Collection Regarding Traffic” (Attorney Docket No. 6583-248); Ser. No. 13/679,369, filed on Nov. 16, 2012, entitled “Method and System for Vehicle Data Collection” (Attorney Docket No. 6583-249); Ser. No. 13/679,680, filed on Nov. 16, 2012, entitled “Communications Based on Vehicle Diagnostics and Indications” (Attorney Docket No. 6583-250); Ser. No. 13/679,443, filed on Nov. 16, 2012, entitled “Method and System for Maintaining and Reporting Vehicle Occupant Information” (Attorney Docket No. 6583-251); Ser. No. 13/678,762, filed on Nov. 16, 2012, entitled “Behavioral Tracking and Vehicle Applications” (Attorney Docket No. 6583-252); Ser. No. 13/679,292, filed Nov. 16, 2012, entitled “Branding of Electrically Propelled Vehicles Via the Generation of Specific Operating Output” (Attorney Docket No. 6583-258); Ser. No. 13/679,400, filed Nov. 16, 2012, entitled “Vehicle Climate Control” (Attorney Docket No. 6583-313); Ser. No. 13/840,240, filed on Mar. 15, 2013, entitled “Improvements to Controller Area Network Bus” (Attorney Docket No. 6583-314); Ser. No. 13/678,773, filed on Nov. 16, 2012, entitled “Location Information Exchange Between Vehicle and Device” (Attorney Docket No. 6583-315); Ser. No. 13/679,887, filed on Nov. 16, 2012, entitled “In Car Communication Between Devices” (Attorney Docket No. 6583-316); Ser. No. 13/679,842, filed on Nov. 16, 2012, entitled “Configurable Hardware Unit for Car Systems” (Attorney Docket No. 6583-317); Ser. No. 13/679,204, filed on Nov. 16, 2012, entitled “Feature Recognition for Configuring a Vehicle Console and Associated Devices” (Attorney Docket No. 6583-318); Ser. No. 13/679,350, filed on Nov. 16, 2012, entitled “Configurable Vehicle Console” (Attorney Docket No. 6583-412); Ser. No. 13/679,358, filed on Nov. 16, 2012, entitled “Configurable Dash Display” (Attorney Docket No. 6583-413); Ser. No. 13/679,363, filed on Nov. 16, 2012, entitled “Configurable Heads-Up Dash Display” (Attorney Docket No. 6583-414); and Ser. No. 13/679,368, filed on Nov. 16, 2012, entitled “Removable, Configurable Vehicle Console” (Attorney Docket No. 6583-415). The entire disclosures of the applications listed above are hereby incorporated by reference, in their entirety, for all that they teach and for all purposes.

This application is also related to PCT Patent Application Nos. PCT/US14/34092, filed on Apr. 15, 2014, entitled, “Building Profiles Associated with Vehicle Users” (Attorney Docket No. 6583-543-PCT); PCT/US14/34099, filed on Apr. 15, 2014, entitled “Access and Portability of User Profiles Stored as Templates” (Attorney Docket No. 6583-544-PCT); PCT/US14/34087, filed on Apr. 15, 2014, entitled “User Interface and Virtual Personality Presentation Based on User Profile” (Attorney Docket No. 6583-547-PCT); PCT/US14/34088, filed on Apr. 15, 2014, entitled “Creating Targeted Advertising Profiles Based on User Behavior” (Attorney Docket No. 6583-549-PCT); PCT/US14/34232, filed on Apr. 15, 2014, entitled “Behavior Modification via Altered Map Routes Based on User Profile Information” (Attorney Docket No. 6583-550-PCT); PCT/US14/34098, filed on Apr. 15, 2014, entitled “Vehicle Location-Based Home Automation Triggers” (Attorney Docket No. 6583-556-PCT); PCT/US14/34108, filed on Apr. 15, 2014, entitled “Vehicle Initiated Communications with Third Parties via Virtual Personalities” (Attorney Docket No. 6583-559-PCT); PCT/US14/34101, filed on Apr. 15, 2014, entitled “Vehicle Intruder Alert Detection and Indication” (Attorney Docket No. 6583-562-PCT); PCT/US14/34103, filed on Apr. 15, 2014, entitled “Driver Facts Behavior Information Storage System” (Attorney Docket No. 6583-565-PCT); PCT/US14/34114, filed on Apr. 15, 2014, entitled “Synchronization Between Vehicle and User Device Calendar” (Attorney Docket No. 6583-567-PCT); PCT/US14/34125, filed on Apr. 15, 2014, entitled “User Gesture Control of Vehicle Features” (Attorney Docket No. 6583-569-PCT); PCT/US14/34254, filed on Apr. 15, 2014, entitled “Central Network for the Automated Control of Vehicular Traffic” (Attorney Docket No. 6583-574-PCT); and PCT/US14/34194, filed on Apr. 15, 2014, entitled “Vehicle-Based Multimode Discovery” (Attorney Docket No. 6583-585-PCT). The entire disclosures of the applications listed above are hereby incorporated by reference, in their entirety, for all that they teach and for all purposes.

### BACKGROUND

Whether using private, commercial, or public transport, the movement of people and/or cargo has become a major industry. In today's interconnected world, daily travel is essential to engaging in commerce. Vehicles more commonly contain systems which allow monitoring of vehicle systems, if not both monitoring and broadcasting of the state and/or health of vehicle systems. If such systems are monitored and broadcast across a fleet of vehicles, such as a fleet of rental vehicles, trend information may be harvested. Such trend information is useful in many ways, e.g. to identify systemic maintenance problems of a fleet of vehicles. Currently, no such fleetwide telematics systems exist.

### SUMMARY

There is a need for fleetwide vehicle telematics systems and methods that includes receiving and managing fleetwide vehicle state data. The fleetwide vehicle state data may be fused or compared with customer enterprise data to monitor conformance with customer requirements and thresholds. The fleetwide vehicle state data may also be analyzed to identify trends and correlations of interest to the customer enterprise. These and other needs are addressed by the various aspects, embodiments, and/or configurations of the present disclosure. Also, while the disclosure is presented in terms of exemplary and optional embodiments, it should be appreciated that individual aspects of the disclosure can be separately claimed.

In one embodiment, a method is disclosed, the method comprising: receiving vehicle state data from a plurality of vehicles, the vehicle state data comprising a plurality of parameters; receiving geolocation data associated with the vehicle state data of the plurality of vehicles; receiving customer enterprise data from a customer, the customer enterprise data associated with the plurality of vehicles; aggregating the vehicle state data, the geolocation data, and the customer enterprise data associated with the plurality of vehicles to produce aggregate data; analyzing the aggregate data to provide a customer telematics analysis service to the customer; determining a trend between two or more vehicles; and providing an output associated with the trend to the customer.

In another embodiment, a system is disclosed, the system comprising: a communication device, comprising: a microprocessor; and a memory comprising microprocessor executable instructions that, when executed by the microprocessor, receives vehicle state data from a plurality of vehicles, the vehicle state data comprising a plurality of parameters; receives geolocation data associated with the vehicle state data of the plurality of vehicles; receives customer enterprise data from a customer, the customer enterprise data associated with the plurality of vehicles; aggregates the vehicle state data, the geolocation data, and the customer enterprise data associated with the plurality of vehicles to produce aggregate data; analyzes the aggregate data to provide a customer telematics analysis service to the customer; determines a trend between two or more vehicles; and provides an output associated with the trend to the customer.

In yet another embodiment, a tangible and non-transient computer readable medium comprising microprocessor executable instructions that, when executed, perform a method is disclosed, the method comprising: receiving vehicle state data from a plurality of vehicles, the vehicle state data comprising a plurality of parameters; receiving geolocation data associated with the vehicle state data of the plurality of vehicles; receiving customer enterprise data from a customer, the customer enterprise data associated with the plurality of vehicles; aggregating the vehicle state data, the geolocation data, and the customer enterprise data associated with the plurality of vehicles to produce aggregate data; analyzing the aggregate data to provide a customer telematics analysis service to the customer; determining a trend between two or more vehicles; and providing an output associated with the trend to the customer.

In one configuration, a method of device pairing includes: intercepting a first signal associated with a first device located in a zone of a vehicle using a communications unit; providing the first signal associated with the first device to a vehicle control system; pairing the first device with the vehicle by isolating an identifier associated with the first device using a vehicle control system; and registering the first device with the vehicle control system. In one configuration of a method of device pairing, isolating the identifier associated with the first device is based on at least one of a cell tower registration signal, a sent message, or a sent packet using the vehicle control system. In one configuration of a method of device pairing, isolating the identifier associated with the first device is based on at least one of a cell tower registration signal, a sent message, or a sent packet and is performed instead of utilizing an active pair handshake. In one configuration of a method of device pairing, the communications unit that intercepts the first signal is one or more of a sensor, antenna, transceiver, or transmitter. In one configuration of a method of device pairing, the vehicle control system includes a processor, a memory coupled to the processor, and an input-output module coupled to the memory.

In one configuration, a non-transitory computer readable medium includes microprocessor executable instructions that, when executed, perform the following operations: intercepting a first signal associated with a first device located in a zone of a vehicle using a communications unit; providing the first signal associated with the first device to a vehicle control system; pairing the first device with the vehicle by isolating an identifier associated with the first device using a vehicle control system; and registering the first device with the vehicle control system. In one configuration of the medium, isolating the identifier associated with the first device is based on at least one of a cell tower registration signal, a sent message, or a sent packet using the vehicle control system. In one configuration of the medium, isolating the identifier associated with the first device is based on at least one of a cell tower registration signal, a sent message, or a sent packet and is performed instead of utilizing an active pair handshake.

Embodiments include a vehicle control system, comprising: a vehicle; a vehicle control system coupled to the vehicle; and a communications unit coupled to the vehicle control system, wherein the vehicle control system synchronizes a calendar with the vehicle control system and generates a notice for a first user based on an event in the calendar and a supplemental factor. In one configuration of the vehicle system, the first user is associated with the vehicle. In one configuration of the vehicle system, the supplemental factor is based on an amount of traffic from a departure point to an arrival point. In one configuration of the vehicle system, the supplemental factor is based on an amount of time required for the first user to arrive at the vehicle from a departure site. In one configuration of the vehicle system, the notice is provided to a second user. In one configuration of the vehicle system, the notice is provided to a second user based on at least one of a set of conditions. In one configuration of the vehicle system, at least one of the set of conditions is based on the second user being one of more of a colleague of the first user, another meeting attendee, and a meeting invitee. In one configuration of the vehicle system, the communications unit is one or more of a sensor, transceiver, or transmitter.

Embodiments include a method, comprising: receiving authorization from a first device to synchronize a calendar associated with the first device with a vehicle control system coupled to a vehicle; synchronizing the calendar with the vehicle control system; and generating a smart alarm for a first user based on an event in the calendar and a supplemental factor. In one configuration of a method, the first device is associated with the vehicle. In one configuration of a method, the supplemental factor is based on an amount of time corresponding to traffic from a departure point to an arrival point. In one configuration of a method, the supplemental factor is based on an amount of time required for the first user to arrive at the vehicle from a departure site. In one configuration of a method, the smart alarm is provided to a second user. In one configuration of a method, the smart alarm is provided to a second user based on at least one of a set of conditions. In one configuration of a method, the condition is based on the second user being a colleague of the first user. In one configuration of a method, the communications unit is one or more of a sensor, transceiver, or transmitter.

In one configuration, a computer readable medium includes microprocessor executable instructions that, when executed, perform the following operations: receiving authorization from a first device to synchronize a calendar on the first device with a vehicle control system coupled to a vehicle; synchronizing the calendar with the vehicle control system; and generating a smart alarm to a first user based on an event in the calendar and a supplemental factor. In one configuration of the computer readable medium, the first device is associated with the vehicle. In one configuration of the computer readable medium, the supplemental factor is based on an amount of time corresponding to traffic from a departure point to an arrival point. In one configuration of the computer readable medium, the supplemental factor is based on an amount of time required for the first user to arrive at the vehicle from a departure site.

In one configuration, a vehicle system includes: a vehicle; and a configuration unit coupled to the vehicle, wherein when the configuration unit receives information from a device accessed by a user, the configuration unit configures the vehicle based on the information. In one configuration of the vehicle system, the information is based on a search performed by the user. In one configuration of the vehicle system, the configuration unit configures the vehicle based on the information. In one configuration of the vehicle system, the information is automatically sent to the configuration unit. In one configuration of the vehicle system, the information is stored in a cloud. In one configuration of the vehicle system, the information is direction-finding information. In one configuration of the vehicle system, the device is detected by the configuration unit upon receiving a registration signal from the device associated with the user. In one configuration of the vehicle system, the configuration unit reviews the information and configures the vehicle based on the information. In one configuration of the vehicle system, the information includes at least one of a text message, an email, a phone recording, a social networking status, or a social networking post. In one configuration of the vehicle system, the information is transferred to the configuration unit via an automation system. In one configuration of the vehicle system, the automation system is a Smarthome. In one configuration of the vehicle system, the device and the configuration unit are synchronized when the vehicle is within a certain distance from a location of the device. In one configuration of the vehicle system, the certain distance includes a garage located within the certain distance. In one configuration of the vehicle system, the vehicle is traveling away from the device. In one configuration of the vehicle system, the configuration unit and the device are synchronized based on a timer or event.

In one configuration, a method includes: receiving, by way of a configuration unit, information from a device accessed by a user associated with the device; and configuring the vehicle based on the information. In one configuration, the method further includes, synchronizing the vehicle with the device. In one configuration, the method further includes, reviewing the information and configuring the vehicle based on the review of the information. In one configuration, the method further includes, transferring the information to the configuration unit via an automation system.

In one configuration, a computer readable medium having stored thereon computer-executable instructions, the computer executable instructions causing a processor of a device to execute a method for providing a user interface, the computer-executable instructions including: instructions to receive information from a device accessed by a user associated with the device; instructions to configure a vehicle based on the information; and, based on the information, configuring the vehicle.

In one configuration a vehicle system includes: a vehicle; a sensing control system coupled to the vehicle; and a sensor unit coupled to the sensing control system, wherein the sensor unit provides a first signal to the sensing control system and, based on the first signal, the sensing control system determines whether an action is necessitated concerning the vehicle, and provides a notification to a predetermined user. In one configuration of the vehicle system, the predetermined user is associated with the vehicle. In one configuration of the vehicle system, the action is at least one of a vehicle health action or a maintenance action. In one configuration of the vehicle system, the maintenance action is at least one of an oil change, a washer fluid change, or a windshield wiper change. In one configuration of the vehicle system, the user of the vehicle is a driver of the vehicle. In one configuration of the vehicle system, the notification includes a shopping list. In one configuration of the vehicle system, the notification is sent to a device associated with the user associated with the vehicle. In one configuration of the vehicle system, the notification is timed to arrive to the user associated with the vehicle during an appropriate time. In one configuration of the vehicle system, the appropriate time is during a red light or a specified length of road. In one configuration of the vehicle system, the user defines whether the action is addressed. In one configuration of the vehicle system, the action is necessitated by the vehicle a seller of goods or services necessitated by the action is contacted. In one configuration of the vehicle system, when the action is necessitated by the vehicle, a seller of goods or services necessitated by the action is contacted, and an appointment is scheduled. In one configuration of the vehicle system, when the action is necessitated by the vehicle, and the action requires the purchase of a good, a provider of the good is contacted and the good is ordered. In one configuration of the vehicle system, when the action is necessitated by the vehicle, a good or service necessitated by the action is ordered and purchased. In one configuration of the vehicle system, the sensor unit is at least one of a sensor, or a transceiver.

In one configuration, a method includes: sensing vehicle information; providing, by way of a sensor unit, a signal to a sensing control system; determining, based on the signal, whether an action is necessitated by the vehicle; and providing a notification of the action to a user. In one configuration, a method includes: sending the notification to a device associated with the user. In one configuration of the method, the notification is a shopping list associated with the action. In one configuration a method includes: defining whether the action is addressed by the user.

In one configuration there is a computer readable medium having stored thereon computer-executable instructions, the computer executable instructions causing a processor of a device to execute a method for providing a user interface, the computer-executable instructions includes: instructions to receive a signal input from a sensor unit; instructions to sense, based on the signal, whether an action is necessitated by the vehicle; and based on the action, generate a notification associated with the action.

In one configuration, a vehicle system includes: a first vehicle; and a bandwidth utilization system coupled to the first vehicle, wherein the bandwidth utilization system receives permission from a wireless communication system having access to bandwidth, based on the permission the bandwidth utilization system utilizes the bandwidth to access a communication network. In one configuration of the vehicle system, the wireless communication system is a vehicle-based communication system. In one configuration of the vehicle system, the wireless communication system is a wireless telephone, tablet, or computer. In one configuration of the vehicle system, the bandwidth may be from a cellular system or WiFi system. In another configuration of the vehicle system, the vehicle-based communication device is coupled to a second vehicle. In one configuration the vehicle system, permission is granted based on characteristics of the first vehicle. In one configuration the vehicle system, the permission is granted automatically based on a relationship between the first vehicle and a second vehicle. In one configuration of the vehicle system, the permission is based on a relationship between the first vehicle and the second vehicle. In one configuration of the vehicle system, the relationship includes the first vehicle and the second vehicle being manufactured by a common manufacturer. In one configuration of the vehicle system, the relationship includes the first vehicle and the second vehicle being in a similar price range.

In one configuration, a vehicle system includes: a vehicle; and a bandwidth utilization system coupled to the vehicle, wherein the bandwidth utilization system detects whether there is a wireless communication system available having access to bandwidth, based on the detection the bandwidth utilization system utilizes the wireless communication system to access the bandwidth. In one configuration of the vehicle system, the wireless communication system is a vehicle-based communication system. In one configuration of the vehicle system, the wireless communication system is a wireless telephone, tablet, or computer. In one configuration of the vehicle system, the bandwidth is from a cellular system or WiFi system. In one configuration of the vehicle system, the wireless communication system is a vehicle-based communication system coupled to a second vehicle.

In one configuration, a method of accessing bandwidth includes: detecting, by way of a bandwidth utilization system coupled to a vehicle, whether there is a wireless communication system available that has access to bandwidth for use by the bandwidth utilization system; receiving, by way of the bandwidth utilization system, permission to use the bandwidth from the wireless communication system; and utilizing the bandwidth based on the permission. In one configuration of the method, the wireless communication system is a vehicle-based communication system. In one configuration of the method, the wireless communication system is a wireless telephone, tablet, or computer. In one configuration of the method, the bandwidth is from a cellular system or WiFi system. In one configuration of the method, the vehicle-based control system is coupled to a second vehicle.

In one configuration a vehicle system includes: a vehicle; a vehicle control system coupled to the vehicle; and a means of intercepting a first signal coupled to the vehicle control system, the signal being associated with a first device, the first device being located in a zone of the vehicle, and a means of pairing the first device with the vehicle by isolating an identifier associated with the first device and registering the first device with the vehicle control system.

In one configuration, a vehicle system includes: a vehicle; a vehicle control system coupled to the vehicle; and a means for synchronizing a calendar with the vehicle control system and generating a notice for a first user based on an event in the calendar and a supplemental factor.

In one configuration, a vehicle system includes: a vehicle; and coupled to the vehicle, a means for receiving information from a device accessed by a user, and configuring the vehicle based on the information.

In one configuration a vehicle system includes: a vehicle; a sensing control system coupled to the vehicle; and a means for providing a first signal to the sensing control system and, based on the first signal, determining whether an action is necessitated concerning the vehicle, and providing a notification to a predetermined user.

In one configuration, a vehicle system includes: a first vehicle; and, coupled to the first vehicle, a means of receiving permission from a wireless communication system having access to bandwidth, based on the permission, utilizing the bandwidth to access a communication network.

The present disclosure can provide a number of advantages depending on the particular aspect, embodiment, and/or configuration.

For example, the system can allow for a vehicle to pair itself with a wireless device without the need for a user of the device to manually pair the device with the vehicle. This allows the user to save time and energy associated with pairing a device to the vehicle. Further, because the pairing may be based on attributes of the device, and thus the user of the device, the vehicle may have access to content associated with the device, reducing the need of the user of the device to manually access or provide access to the content.

These and other advantages will be apparent from the disclosure.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refer to any process or operation done without material human input when the process or operation is performed. However, a process or operation can be automatic, even though performance of the process or operation uses material or immaterial human input, if the input is received before the performance of the process or operation. Human input is deemed to be material if such input influences how the process or operation will be performed. Human input that consents to the performance of the process or operation is not deemed to be “material.”

The term “automotive navigation system” can refer to a satellite navigation system designed for use in vehicles. It typically uses a GPS navigation device to acquire position data to locate the user on a road in the unit's map database. Using the road database, the unit can give directions to other locations along roads also in its database. Dead reckoning using distance data from sensors attached to the drivetrain, a gyroscope and an accelerometer can be used for greater reliability, as GPS signal loss and/or multipath can occur due to urban canyons or tunnels.

The term “bus” and variations thereof, as used herein, can refer to a subsystem that transfers information and/or data between various components. A bus generally refers to the collection communication hardware interface, interconnects, bus architecture, standard, and/or protocol defining the communication scheme for a communication system and/or communication network. A bus may also refer to a part of a communication hardware that interfaces the communication hardware with the interconnects that connect to other components of the corresponding communication network. The bus may be for a wired network, such as a physical bus, or wireless network, such as part of an antenna or hardware that couples the communication hardware with the antenna. A bus architecture supports a defined format in which information and/or data is arranged when sent and received through a communication network. A protocol may define the format and rules of communication of a bus architecture.

The terms “communication device,” “smartphone,” and “mobile device,” and variations thereof, as used herein, can be used interchangeably and may include any type of device capable of communicating with one or more of another device and/or across a communications network, via a communications protocol, and the like. Exemplary communication devices may include but are not limited to smartphones, handheld computers, laptops, netbooks, notebook computers, subnotebooks, tablet computers, scanners, portable gaming devices, phones, pagers, GPS modules, portable music players, and other Internet-enabled and/or network-connected devices.

A “communication modality” can refer to any protocol- or standard defined or specific communication session or interaction, such as Voice-Over-Internet-Protocol (“VoIP), cellular communications (e.g., IS-95, 1G, 2G, 3G, 3.5G, 4G, 4G/IMT-Advanced standards, 3GPP, WIMAX™, GSM, CDMA, CDMA2000, EDGE, 1xEVDO, iDEN, GPRS, HSPDA, TDMA, UMA, UMTS, ITU-R, and 5G), Bluetooth™, text or instant messaging (e.g., AIM, Blauk, eBuddy, Gadu-Gadu, IBM Lotus Sametime, ICQ, iMessage, IMVU, Lync, MXit, Paltalk, Skype, Tencent QQ, Windows Live Messenger™ or MSN Messenger™, Wireclub, Xfire, and Yahoo! Messenger™), email, Twitter (e.g., tweeting), Digital Service Protocol (DSP), and the like.

The term “communication system” or “communication network” and variations thereof, as used herein, can refer to a collection of communication components capable of one or more of transmission, relay, interconnect, control, or otherwise manipulate information or data from at least one transmitter to at least one receiver. As such, the communication may include a range of systems supporting point-to-point or broadcasting of the information or data. A communication system may refer to the collection individual communication hardware as well as the interconnects associated with and connecting the individual communication hardware. Communication hardware may refer to dedicated communication hardware or may refer a processor coupled with a communication means (i.e., an antenna) and running software capable of using the communication means to send and/or receive a signal within the communication system. Interconnect refers some type of wired or wireless communication link that connects various components, such as communication hardware, within a communication system. A communication network may refer to a specific setup of a communication system with the collection of individual communication hardware and interconnects having some definable network topography. A communication network may include wired and/or wireless network having a pre-set to an ad hoc network structure.

The term “computer-readable medium,” as used herein refers to any tangible storage and/or transmission medium that participates in providing instructions to a processor for execution. Such a medium may take many forms, including but not limited to, non-volatile media, volatile media, and transmission media. Non-volatile media includes, for example, non-volatile random access memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a compact disc read only memory (CD-ROM), any other optical medium, punch cards, paper tape, any other physical medium with patterns of holes, a random access memory (RAM), a programmable read only memory (PROM), and erasable programmable read only memory EPROM, a FLASH-EPROM, a solid state medium like a memory card, any other memory chip or cartridge, a carrier wave as described hereinafter, or any other medium from which a computer can read. A digital file attachment to an e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. It should be noted that any computer readable medium that is not a signal transmission may be considered non-transitory.

The terms dash and dashboard and variations thereof, as used herein, may be used interchangeably and can be any panel and/or area of a vehicle disposed adjacent to an operator, user, and/or passenger. Dashboards may include, but are not limited to, one or more control panel(s), instrument housing(s), head unit(s), indicator(s), gauge(s), meter(s), light(s), audio equipment, computer(s), screen(s), display(s), HUD unit(s), and graphical user interface(s).

The term “module” as used herein refers to any known or later developed hardware, software, firmware, artificial intelligence, fuzzy logic, or combination of hardware and software that is capable of performing the functionality associated with that element.

The term “desktop” refers to a metaphor used to portray systems. A desktop is generally considered a “surface” that may include pictures, called icons, widgets, folders, etc. that can activate and/or show applications, windows, cabinets, files, folders, documents, and other graphical items. The icons are generally selectable to initiate a task through user interface interaction to allow a user to execute applications and/or conduct other operations.

The term “display” refers to a portion of a physical screen used to display the output of a computer to a user.

The term “displayed image” refers to an image produced on the display. A typical displayed image is a window or desktop. The displayed image may occupy all or a portion of the display.

The term “display orientation” refers to the way in which a rectangular display is oriented for viewing. The two most common types of display orientations are portrait and landscape. In landscape mode, the display is oriented such that the width of the display is greater than the height of the display (such as a 4:3 ratio, which is 4 units wide and 3 units tall, or a 16:9 ratio, which is 16 units wide and 9 units tall). Stated differently, the longer dimension of the display is oriented substantially horizontal in landscape mode while the shorter dimension of the display is oriented substantially vertical. In the portrait mode, by contrast, the display is oriented such that the width of the display is less than the height of the display. Stated differently, the shorter dimension of the display is oriented substantially horizontal in the portrait mode while the longer dimension of the display is oriented substantially vertical. A multi-screen display can have one composite display that encompasses all the screens. The composite display can have different display characteristics based on the various orientations of the device.

The term “electronic address” can refer to any contactable address, including a telephone number, instant message handle, e-mail address, Uniform Resource Locator (“URL”), Global Universal Identifier (“GUID”), Universal Resource Identifier (“URI”), Address of Record (“AOR”), electronic alias in a database, etc., combinations thereof.

The term “gesture” refers to a user action that expresses an intended idea, action, meaning, result, and/or outcome. The user action can include manipulating a device (e.g., opening or closing a device, changing a device orientation, moving a trackball or wheel, etc.), movement of a body part in relation to the device, movement of an implement or tool in relation to the device, audio inputs, etc. A gesture may be made on a device (such as on the screen) or with the device to interact with the device.

The term “gesture capture” refers to a sense or otherwise a detection of an instance and/or type of user gesture. The gesture capture can be received by sensors in three-dimensional space. Further, the gesture capture can occur in one or more areas of a screen, for example, on a touch-sensitive display or a gesture capture region. A gesture region can be on the display, where it may be referred to as a touch sensitive display, or off the display, where it may be referred to as a gesture capture area.

The terms “infotainment” and “infotainment system” may be used interchangeably and can refer to the hardware/software products, data, content, information, and/or systems, which can be built into or added to vehicles to enhance driver and/or passenger experience. Infotainment may provide media and/or multimedia content. An example is information-based media content or programming that also includes entertainment content.

A “multi-screen application” refers to an application that is capable of producing one or more windows that may simultaneously occupy one or more screens. A multi-screen application commonly can operate in single-screen mode in which one or more windows of the application are displayed only on one screen or in multi-screen mode in which one or more windows are displayed simultaneously on multiple screens.

A “single-screen application” refers to an application that is capable of producing one or more windows that may occupy only a single screen at a time.

The terms “online community,” “e-community,” or “virtual community” can mean a group of people that interact via a computer network, for social, professional, educational, and/or other purposes. The interaction can use a variety of media formats, including wilds, blogs, chat rooms, Internet forums, instant messaging, email, and other forms of electronic media. Many media formats may be used in social software separately and/or in combination, including text-based chat rooms and forums that use voice, video text or avatars.

The term “satellite positioning system receiver” can refer to a wireless receiver or transceiver to receive and/or send location signals from and/or to a satellite positioning system (SPS), such as the Global Positioning System (“GPS”) (US), GLONASS (Russia), Galileo positioning system (EU), Compass navigation system (China), and Regional Navigational Satellite System (India).

The term “social network service” may include a service provider that builds online communities of people, who share interests and/or activities, or who are interested in exploring the interests and/or activities of others. Social network services can be network-based and may provide a variety of ways for users to interact, such as e-mail and instant messaging services.

The term “social network” can refer to a network-based social network.

The term “screen,” “touch screen,” “touchscreen,” or “touch-sensitive display” refers to a physical structure that enables the user to interact with the computer by touching areas on the screen and provides information to a user through a display. The touch screen may sense user contact in a number of different ways, such as by a change in an electrical parameter (e.g., resistance or capacitance), acoustic wave variations, infrared radiation proximity detection, light variation detection, and the like. In a resistive touch screen, for example, normally separated conductive and resistive metallic layers in the screen pass an electrical current. When a user touches the screen, the two layers make contact in the contacted location, whereby a change in electrical field is noted and the coordinates of the contacted location calculated. In a capacitive touch screen, a capacitive layer stores electrical charge, which is discharged to the user upon contact with the touch screen, causing a decrease in the charge of the capacitive layer. The decrease is measured, and the contacted location coordinates determined. In a surface acoustic wave touch screen, an acoustic wave is transmitted through the screen, and the acoustic wave is disturbed by user contact. A receiving transducer detects the user contact instance and determines the contacted location coordinates.

The term “telematics” refers to the use of wireless devices and “black box” technologies to transmit data in real time to an organization, as used in the context of vehicles, whereby installed or after-factory boxes collect and transmit data on vehicle use, vehicle state, vehicle conditions and vehicle environment.

The term “geolocation” is the identification of the real-world geographic location of an object, such as a vehicle. Geolocation may refer to the practice of assessing the location, or to the actual assessed location. Geolocation commonly includes data regarding datums or reference points of practical interest, e.g. a street address or a roadway.

The term “buffer” is a data area shared by hardware devices or program processes that operate at different speeds or with different sets of priorities. The buffer allows each device or process to operate without being held up by the other. Like a cache, a buffer is a “midpoint holding place.”

The term “window” refers to a, typically rectangular, displayed image on at least part of a display that contains or provides content different from the rest of the screen. The window may obscure the desktop. The dimensions and orientation of the window may be configurable either by another module or by a user. When the window is expanded, the window can occupy substantially all of the display space on a screen or screens.

The terms “determine,” “calculate,” and “compute,” and variations thereof, as used herein, are used interchangeably and include any type of methodology, process, mathematical operation, or technique.

It shall be understood that the term “means,” as used herein, shall be given its broadest possible interpretation in accordance with 35 U.S.C., Section 112, Paragraph 6 or other applicable law. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The terms “vehicle,” “car,” “automobile,” and variations thereof may be used interchangeably herein and can refer to a device or structure for transporting animate and/or inanimate or tangible objects (e.g., persons and/or things), such as a self-propelled conveyance. A vehicle as used herein can include any conveyance or model of a conveyance, where the conveyance was originally designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, busses, automobiles, trains, railed conveyances, boats, ships, marine conveyances, submarine conveyances, airplanes, space craft, flying machines, human-powered conveyances, and the like.

The term “profile,” as used herein, can refer to any data structure, data store, and/or database that includes one or more items of information associated with a vehicle, a vehicle system, a device (e.g., a mobile device, laptop, mobile phone, etc.), or a person.

The term “in communication with,” as used herein, refers to any coupling, connection, or interaction using electrical signals to exchange information or data, using any system, hardware, software, protocol, or format, regardless of whether the exchange occurs wirelessly or over a wired connection.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™ processors, ARM® Cortex-A and ARM926EJ-S™ processors, other industry-equivalent processors, and may perform computational functions using any known or future-developed standard, instruction set, libraries, and/or architecture.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

FIG. 1 depicts an embodiment of a vehicle operating environment;

FIG. 2 is a block diagram of an embodiment of a vehicle system;

FIG. 3 is a block diagram of an embodiment of a vehicle control system environment;

FIG. 4 is a block diagram of an embodiment of a vehicle communications subsystem;

FIG. 5A is a first block diagram of an embodiment of a vehicle interior environment separated into areas and/or zones;

FIG. 5B is a second block diagram of an embodiment of a vehicle interior environment separated into areas and/or zones;

FIG. 5C is a third block diagram of an embodiment of a vehicle interior environment separated into areas and/or zones;

FIG. 6A depicts an embodiment of a sensor configuration for a vehicle;

FIG. 6B depicts an embodiment of a sensor configuration for a zone of a vehicle;

FIG. 7A is a block diagram of an embodiment of interior sensors for a vehicle;

FIG. 7B is a block diagram of an embodiment of exterior sensors for a vehicle;

FIG. 8A is a block diagram of an embodiment of a media subsystem for a vehicle;

FIG. 8B is a block diagram of an embodiment of a user and device interaction subsystem for a vehicle;

FIG. 8C is a block diagram of an embodiment of a Navigation subsystem for a vehicle;

FIG. 9 is a block diagram of an embodiment of a communications subsystem for a vehicle;

FIG. 10 is a block diagram of an embodiment of a software architecture for the vehicle control system;

FIG. 11A is a graphical representation of an embodiment of a gesture that a user may perform to provide input to a vehicle control system;

FIG. 11B is a graphical representation of an embodiment of a gesture that a user may perform to provide input to a vehicle control system;

FIG. 11C is a graphical representation of an embodiment of a gesture that a user may perform to provide input to a vehicle control system;

FIG. 11D is a graphical representation of an embodiment of a gesture that a user may perform to provide input to a vehicle control system;

FIG. 11E is a graphical representation of an embodiment of a gesture that a user may perform to provide input to a vehicle control system;

FIG. 11F is a graphical representation of an embodiment of a gesture that a user may perform to provide input to a vehicle control system;

FIG. 11G is a graphical representation of an embodiment of a gesture that a user may perform to provide input to a vehicle control system;

FIG. 11H is a graphical representation of an embodiment of a gesture that a user may perform to provide input to a vehicle control system;

FIG. 11I is a graphical representation of an embodiment of a gesture that a user may perform to provide input to a vehicle control system;

FIG. 11J is a graphical representation of an embodiment of a gesture that a user may perform to provide input to a vehicle control system;

FIG. 11K is a graphical representation of an embodiment of a gesture that a user may perform to provide input to a vehicle control system;

FIG. 12A is a diagram of an embodiment of a data structure for storing information about a user of a vehicle;

FIG. 12B is a diagram of an embodiment of a data structure for storing information about a device associated with or in a vehicle;

FIG. 12C is a diagram of an embodiment of a data structure for storing information about a system of a vehicle;

FIG. 12D is a diagram of an embodiment of a data structure for storing information about a vehicle;

FIG. 13 is a flow or process diagram of a method for storing one or more settings associated with a user;

FIG. 14 is a flow or process diagram of a method for establishing one or more settings associated with a user;

FIG. 15 is a flow or process diagram of a method for storing one or more settings associated with a user;

FIG. 16 is a flow or process diagram of a method for storing one or more gestures associated with a user;

FIG. 17 is a flow or process diagram of a method for reacting to a gesture performed by a user;

FIG. 18 is a flow or process diagram of a method for storing health data associated with a user;

FIG. 19 is a flow or process diagram of a method for reacting to a gesture performed by a user;

FIG. 20 is a block diagram of an embodiment of a vehicle system;

FIG. 21 is a block diagram of an embodiment of a vehicle control system environment;

FIG. 22 is a diagram of an embodiment of intercepted signal(s) for pairing a device with a vehicle;

FIG. 23 is a diagram of an embodiment of a data structure for pairing a device with a vehicle;

FIG. 24 is a flow or process diagram of a method for pairing a device with a vehicle.

FIG. 25 is a block diagram of an embodiment of a vehicle system;

FIG. 26 is a block diagram of an embodiment of a device having a calendar;

FIG. 27 is an embodiment of a table of supplemental factors;

FIG. 28 is an embodiment of a list of a set of conditions;

FIG. 29 is a block diagram of an embodiment of a vehicle system;

FIG. 30 is a flow or process diagram of a method for generating a smart alarm based on a calendar.

FIG. 31 is a flow or process diagram of a method for generating a smart alarm;

FIG. 32 is flow or process diagram of a method for generating a smart alarm based on a calendar event and a supplemental factor;

FIG. 33 is a block diagram of an embodiment of a vehicle system;

FIG. 34 is a block diagram of an embodiment of a configuration unit;

FIG. 34a is an embodiment of a text file created by a user;

FIG. 34b is an embodiment of a table of vehicle configurable elements;

FIG. 35 is a diagram of an embodiment of signal(s) for configuring a vehicle;

FIG. 36 is a flow or process diagram of a method for configuring a vehicle;

FIG. 37 is a block diagram of an embodiment of a vehicle system;

FIG. 38 is a block diagram of an embodiment of a sensing control system;

FIG. 39 is a flow or process diagram of a method for providing a notice based on vehicle information.

FIG. 40 is a flow or process diagram of a method for providing a notice based on vehicle information.

FIG. 41 is a block diagram of an embodiment of a vehicle system;

FIG. 42 is a block diagram of an embodiment of a bandwidth utilization system;

FIG. 43 is a diagram of an embodiment of signal(s) for accessing bandwidth;

FIG. 44 is a block diagram of an embodiment of a vehicle system;

FIG. 45 is a diagram of an embodiment of signal(s) for accessing bandwidth;

FIG. 46 is a diagram of an embodiment of characterization signal(s) for accessing bandwidth;

FIG. 47 is a block diagram of an embodiment of a vehicle system;

FIG. 48 is a flow or process diagram of a method for accessing bandwidth;

FIG. 49 is a block diagram of an embodiment of a networked device management system;

FIG. 50 is a diagram of an embodiment of a data structure for storing information associated with a device in a networked device management system;

FIG. 51 is a first embodiment of a flow or process diagram of a method for managing networked audio devices;

FIG. 52 is a second embodiment of a flow or process diagram of a method for managing networked audio devices

FIG. 53 is a flow or process diagram of a method for controlling and arranging communications based on detecting conditional events;

FIG. 54 is a block diagram of an embodiment of internal and external vehicle communications subsystems;

FIG. 55 is a flow or process diagram of a method for providing connectivity actions based on available services;

FIG. 56A is a block diagram of a communication environment having a number of access points and coverage areas;

FIG. 56B is a detail view of the communication environment having a number of access points and coverage areas;

FIG. 57 is a flow or process diagram of a method for configuring vehicle communication nodes;

FIG. 58 is a flow or process diagram of a method for sending data in a vehicle communication network;

FIG. 59 is a diagram of an embodiment of a data structure for storing information associated with vehicles in a communication system;

FIG. 60 is a flow or process diagram of a method for accessing a vehicle theme library;

FIG. 61 is a flow or process diagram of a method for presenting a vehicle theme in a vehicle;

FIG. 62 is a block diagram of a plug-and-play system for a vehicle;

FIG. 63 is a flow or process diagram of a method for configuring a vehicle plug-and-play device for communication with components of a vehicle;

FIG. 64 is a flow or process diagram of a method for communicating and installing vehicle updates;

FIG. 65A is a block diagram of a system for fleetwide vehicle telematics;

FIG. 65B is a diagram of an embodiment of a data structure for storing information about a vehicle, as used in the system of FIG. 65A;

FIG. 66 is a flow or process diagram of a fleetwide vehicle telematics method of use; and

FIG. 67 is a flow or process diagram of a fleetwide vehicle telematics method of use as focused on a single vehicle.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference letter or label.

### DETAILED DESCRIPTION

Presented herein are embodiments of systems, devices, processes, data structures, user interfaces, etc. The embodiments may relate to an automobile and/or an automobile environment. The automobile environment can include systems associated with the automobile and devices or other systems in communication with the automobile and/or automobile systems. Furthermore, the systems can relate to communications systems and/or devices and may be capable of communicating with other devices and/or to an individual or group of individuals. Further, the systems can receive user input in unique ways. The overall design and functionality of the systems provide for an enhanced user experience making the automobile more useful and more efficient. As described herein, the automobile systems may be electrical, mechanical, electro-mechanical, software-based, and/or combinations thereof.

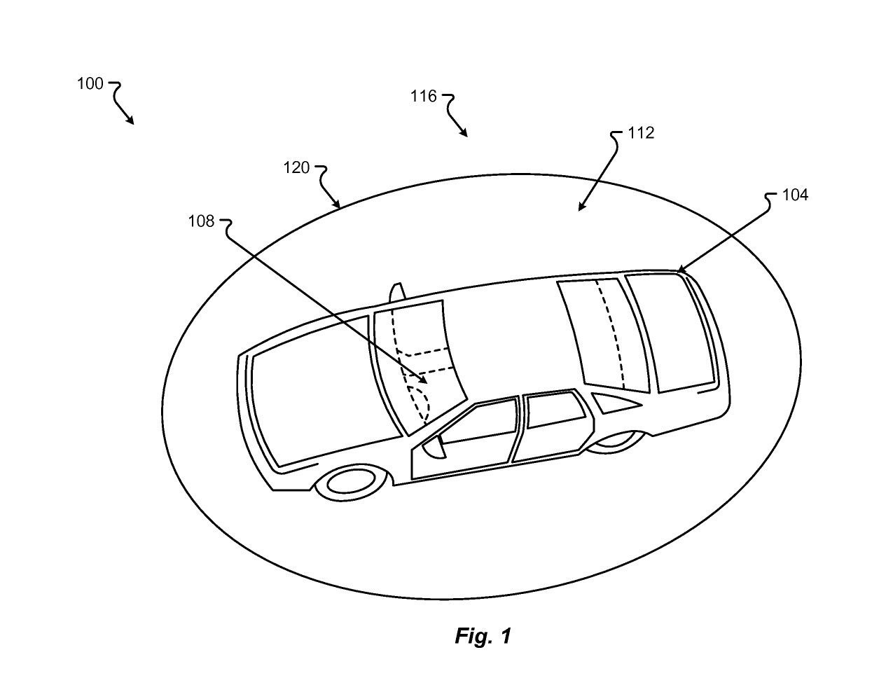

A vehicle environment 100 that may contain a vehicle ecosystem is shown in FIG. 1. The vehicle environment 100 can contain areas associated with a vehicle or conveyance 104. The vehicle 104 is shown as a car but can be any type of conveyance. The environment 100 can include at least three zones. A first zone 108 may be inside a vehicle 104. The zone 108 includes any interior space, trunk space, engine compartment, or other associated space within or associated with the vehicle 104. The interior zone 108 can be defined by one or more techniques, for example, geo-fencing.

A second zone 112 may be delineated by line 120. The zone 112 is created by a range of one or more sensors associated with the vehicle 104. Thus, the area 112 is exemplary of the range of those sensors and what can be detected by those sensors associated with the vehicle 104. Although sensor range is shown as a fixed and continuous oval, the sensor range may be dynamic and/or discontinuous. For example, a ranging sensor (e.g., radar, lidar, ladar, etc.) may provide a variable range depending on output power, signal characteristics, or environmental conditions (e.g., rain, fog, clear, etc.). The rest of the environment includes all space beyond the range of the sensors and is represented by space 116. Thus, the environment 100 may have an area 116 that includes all areas beyond the sensor range 112. The area 116 may include locations of travel that the vehicle 104 may proceed to in the future.

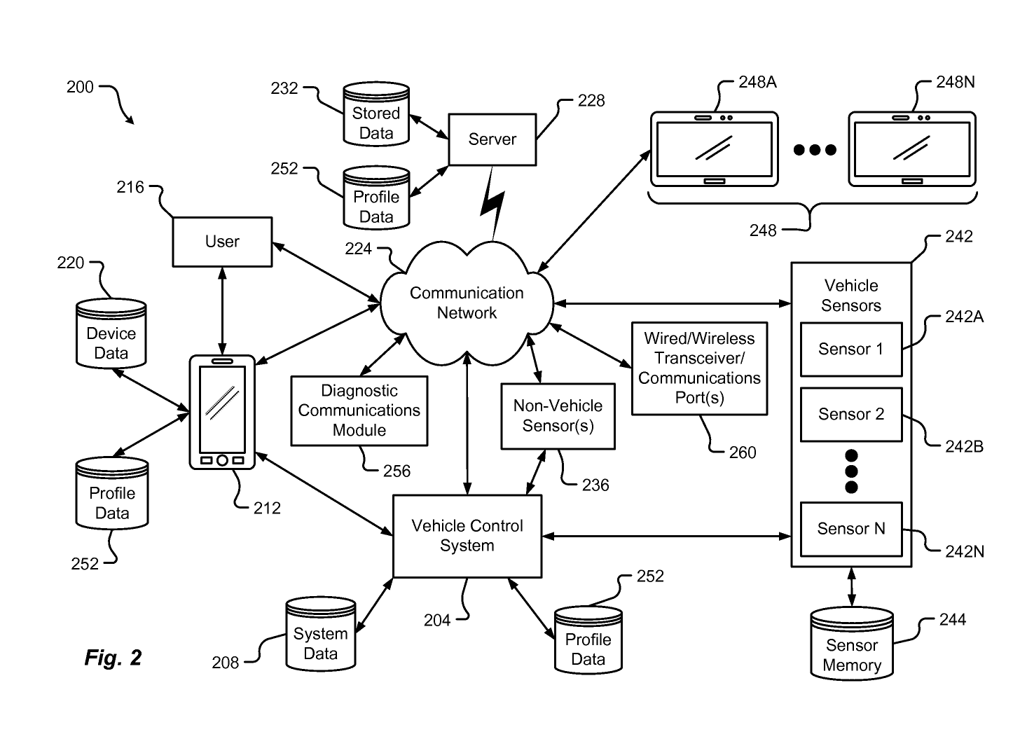

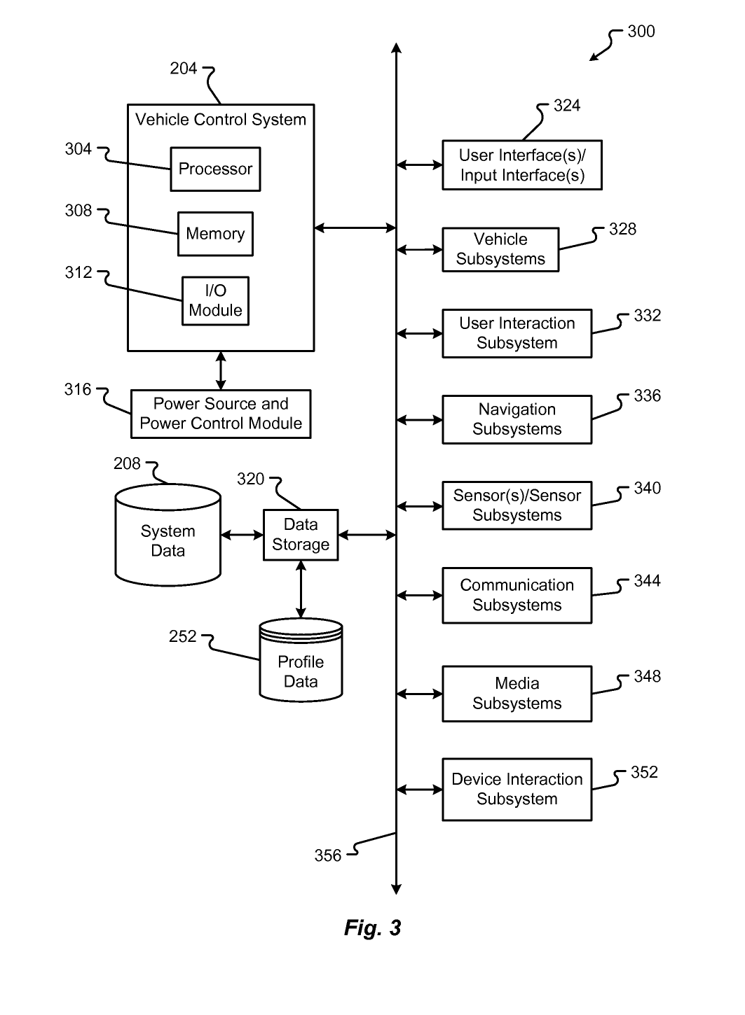

An embodiment of a vehicle system 200 is shown in FIG. 2. The vehicle system 200 may comprise hardware and/or software that conduct various operations for or with the vehicle 104. The operations can include, but are not limited to, providing information to the user 216, receiving input from the user 216, and controlling the functions or operation of the vehicle 104, etc. The vehicle system 200 can include a vehicle control system 204. The vehicle control system 204 can be any type of computing system operable to conduct the operations as described herein. An example of a vehicle control system may be as described in conjunction with FIG. 3.

The vehicle control system 204 may interact with a memory or storage system 208 that stores system data. System data 208 may be any type of data needed for the vehicle control system 204 to control effectively the vehicle 104. The system data 208 can represent any type of database or other storage system. Thus, the system data 208 can be a flat file data system, an object-oriented data system, or some other data system that may interface with the vehicle control system 204.

The vehicle control system 204 may communicate with a device or user interface 212, 248. The user interface 212, 248 may be operable to receive user input either through touch input, on one or more user interface buttons, via voice command, via one or more image sensors, or through a graphical user interface that may include a gesture capture region, as described in conjunction with the other figures provided herein. Further, the symbol 212, 248 can represent a device that is located or associated with the vehicle 104. The device 212, 248 can be a mobile device, including, but not limited to, a mobile telephone, a mobile computer, or other type of computing system or device that is either permanently located in or temporarily associated with, but not necessarily connected to, the vehicle 104. Thus, the vehicle control system 204 can interface with the device 212, 248 and leverage the device's computing capability to provide one or more of the features or functions as described herein.

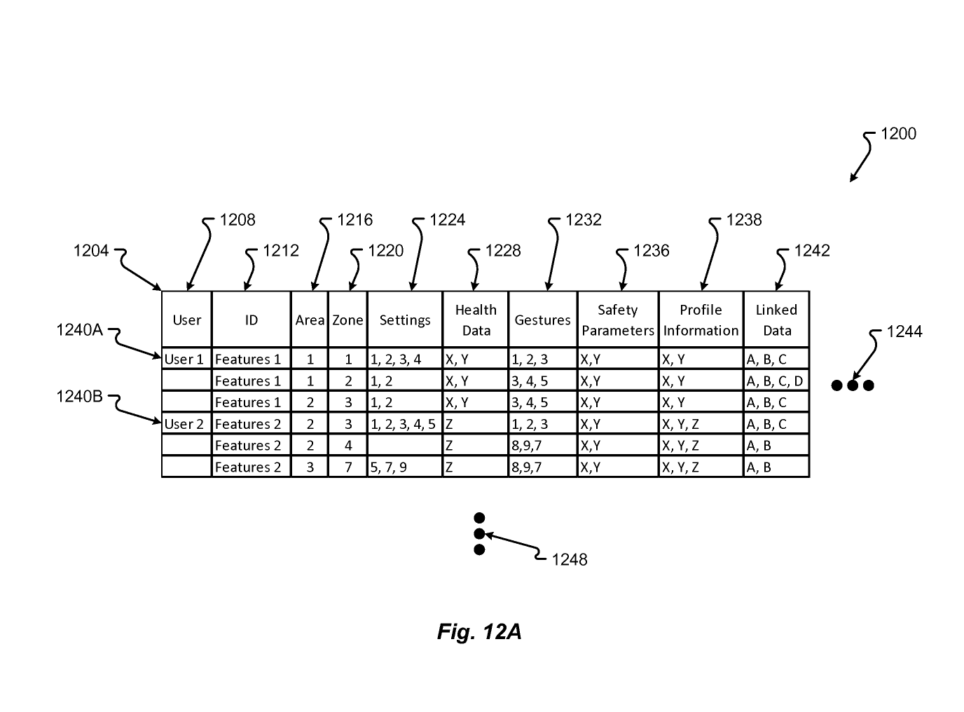

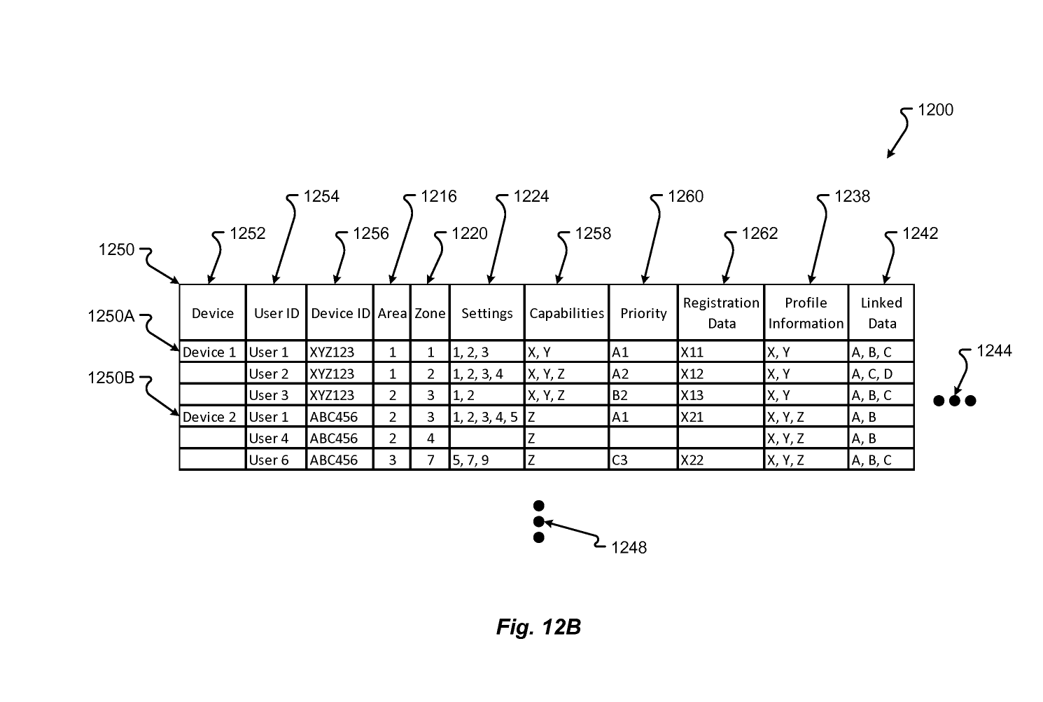

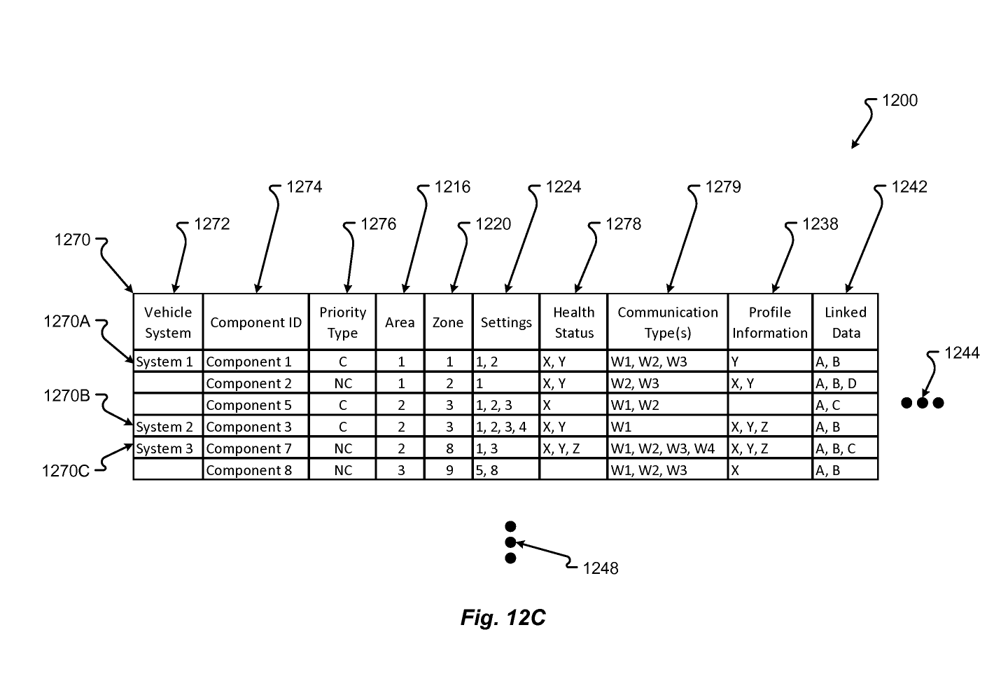

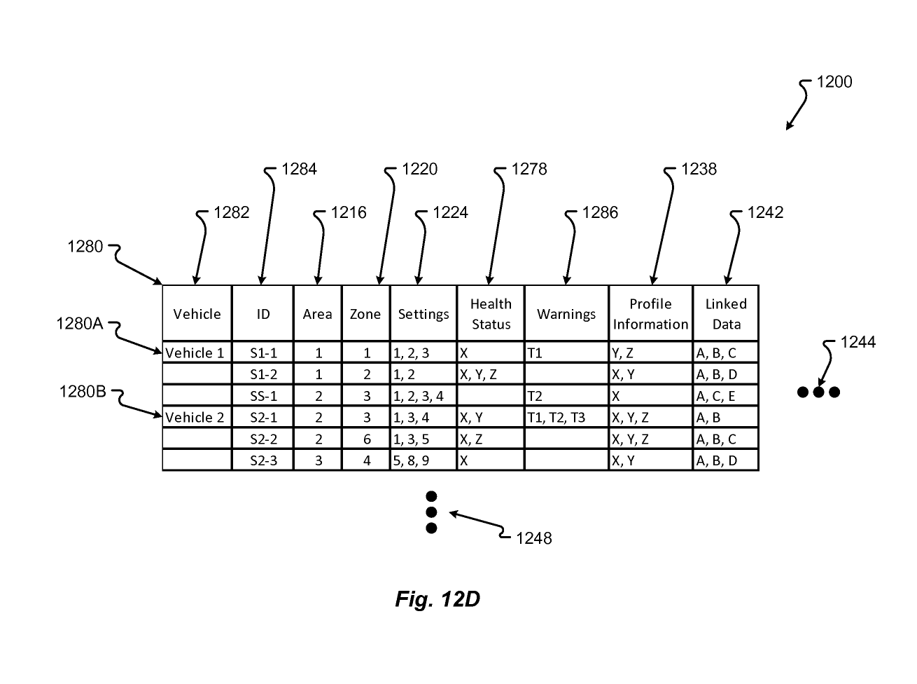

The device or user interface 212, 248 can receive input or provide information to a user 216. The user 216 may thus interact with the vehicle control system 204 through the interface or device 212, 248. Further, the device 212, 248 may include or have access to device data 220 and/or profile data 252. The device data 220 can be any type of data that is used in conjunction with the device 212, 248 including, but not limited to, multimedia data, preferences data, device identification information, or other types of data. The profile data 252 can be any type of data associated with at least one user 216 including, but in no way limited to, bioinformatics, medical information, driving history, personal information (e.g., home physical address, business physical address, contact addresses, likes, dislikes, hobbies, size, weight, occupation, business contacts—including physical and/or electronic addresses, personal contacts—including physical and/or electronic addresses, family members, and personal information related thereto, etc.), other user characteristics, advertising information, user settings and feature preferences, travel information, associated vehicle preferences, communication preferences, historical information (e.g., including historical, current, and/or future travel destinations), Internet browsing history, or other types of data. In any event, the data may be stored as device data 220 and/or profile data 252 in a storage system similar to that described in conjunction with FIGS. 12A through 12D.

As an example, the profile data 252 may include one or more user profiles. User profiles may be generated based on data gathered from one or more of vehicle preferences (e.g., seat settings, HVAC settings, dash configurations, and the like), recorded settings, geographic location information (e.g., provided by a satellite positioning system (e.g., GPS), Wi-Fi hotspot, cell tower data, etc.), mobile device information (such as mobile device electronic addresses, Internet browsing history and content, application store selections, user settings and enabled and disabled features, and the like), private information (such as user information from a social network, user presence information, user business account, and the like), secure data, biometric information, audio information from on board microphones, video information from on board cameras, Internet browsing history and browsed content using an on board computer and/or the local area network enabled by the vehicle 104, geographic location information (e.g., a vendor storefront, roadway name, city name, etc.), and the like.

The profile data 252 may include one or more user accounts. User accounts may include access and permissions to one or more settings and/or feature preferences associated with the vehicle 104, communications, infotainment, content, etc. In one example, a user account may allow access to certain settings for a particular user, while another user account may deny access to the settings for another user, and vice versa. The access controlled by the user account may be based on at least one of a user account priority, role, permission, age, family status, a group priority (e.g., the user account priority of one or more users, etc.), a group age (e.g., the average age of users in the group, a minimum age of the users in the group, a maximum age of the users in the group, and/or combinations thereof, etc.).

For example, a user 216 may be allowed to purchase applications (e.g., software, etc.) for the vehicle 104 and/or a device associated with the vehicle 104 based on information associated with the user account. This user account information may include a preferred payment method, permissions, and/or other account information. As provided herein, the user account information may be part of the user profile and/or other data stored in the profile data 252.

As another example, an adult user (e.g., a user with an age of 18 years old and/or over, etc.) may be located in an area of a vehicle 104, such as a rear passenger area. Continuing this example a child user (e.g., a user with an age of 17 years old and/or less, etc.) may be located in the same, or close, area. In this example, the user account information in the profile data 252 associated with both the adult user and the child user may be used by the vehicle 104 in determining whether content is appropriate for the area given the age of the child user. For instance, a graphic movie containing violence (e.g., a movie associated with a mature rating, such as a Motion Picture Association of America (MPAA) rating of “R,” “NC-17,” etc.) may be suitable to present to a display device associated with the adult user but may not be acceptable to present to the display device if a 12-year old child user may see and/or hear the content of the movie.

The vehicle control system 204 may also communicate with or through a communication network 224. The communication network 224 can represent any type of wireless and/or wired communication system that may be included within the vehicle 104 or operable to communicate outside the vehicle 104. Thus, the communication network 224 can include a local area communication capability and a wide area communication capability. For example, the communication network 224 can include a Bluetooth® wireless system, an 802.11x (e.g., 802.11G/802.11N/802.11AC, or the like, wireless system), a CAN bus, an Ethernet network within the vehicle 104, or other types of communication networks that may function with or be associated with the vehicle 104. Further, the communication network 224 can also include wide area communication capabilities, including one or more of, but not limited to, a cellular communication capability, satellite telephone communication capability, a wireless wide area network communication capability, or other types of communication capabilities that allow for the vehicle control system 204 to communicate outside the vehicle 104.

The vehicle control system 204 may communicate through the communication network 224 to a server 228 that may be located in a facility that is not within physical proximity to the vehicle 104. Thus, the server 228 may represent a cloud computing system or cloud storage that allows the vehicle control system 204 to either gain access to further computing capabilities or to storage at a location outside of the vehicle 104. The server 228 can include a computer processor and memory and be similar to any computing system as understood to one skilled in the art.

Further, the server 228 may be associated with stored data 232. The stored data 232 may be stored in any system or by any method, as described in conjunction with system data 208, device data 220, and/or profile data 252. The stored data 232 can include information that may be associated with one or more users 216 or associated with one or more vehicles 104. The stored data 232, being stored in a cloud or in a distant facility, may be exchanged among vehicles 104 or may be used by a user 216 in different locations or with different vehicles 104. Additionally or alternatively, the server may be associated with profile data 252 as provided herein. It is anticipated that the profile data 252 may be accessed across the communication network 224 by one or more components of the system 200. Similar to the stored data 232, the profile data 252, being stored in a cloud or in a distant facility, may be exchanged among vehicles 104 or may be used by a user 216 in different locations or with different vehicles 104.

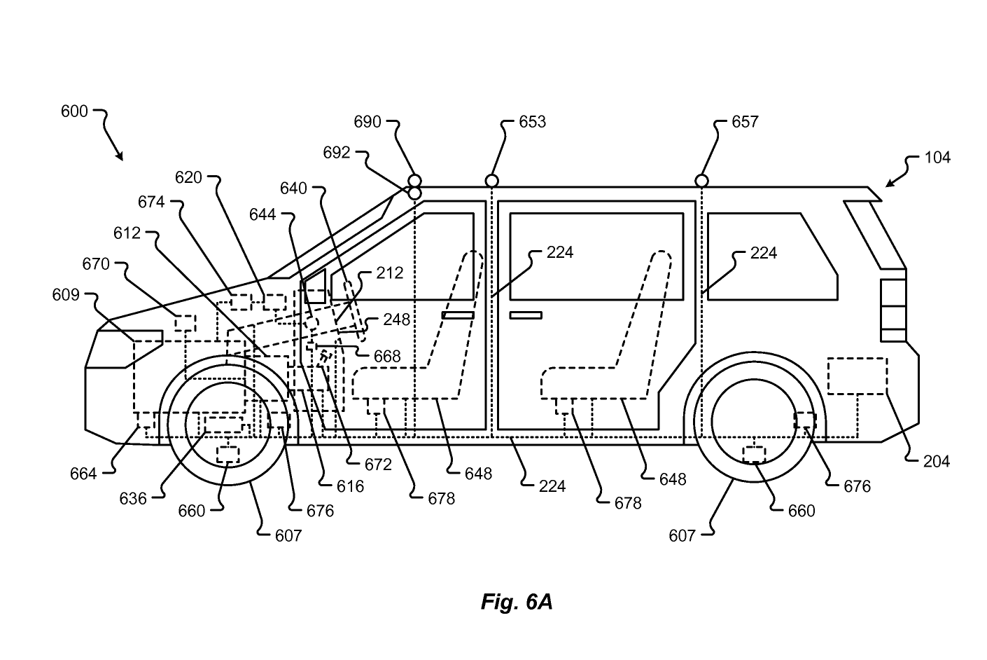

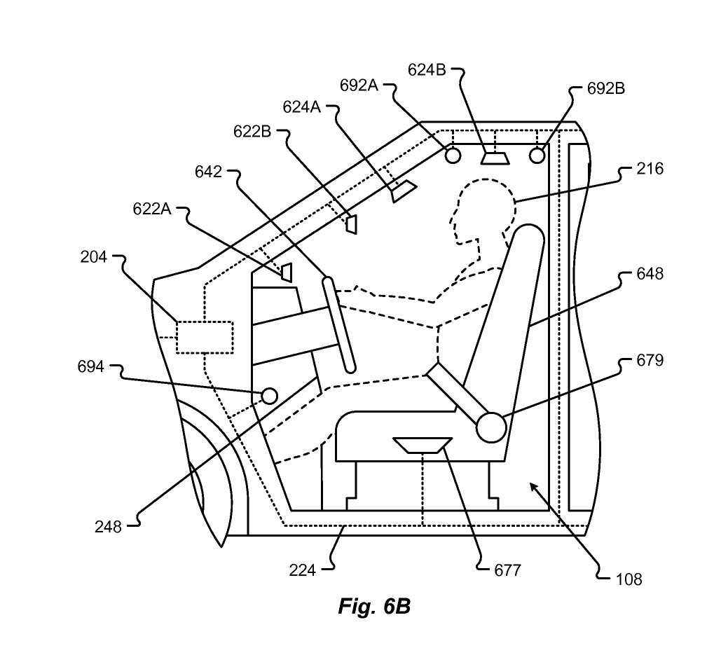

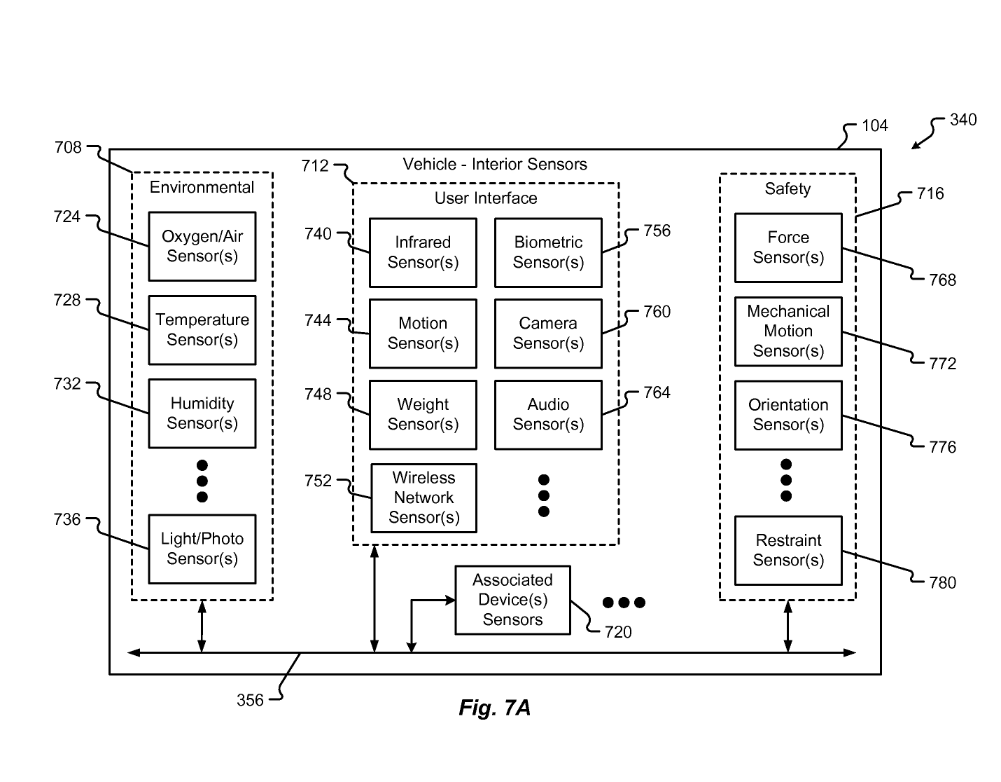

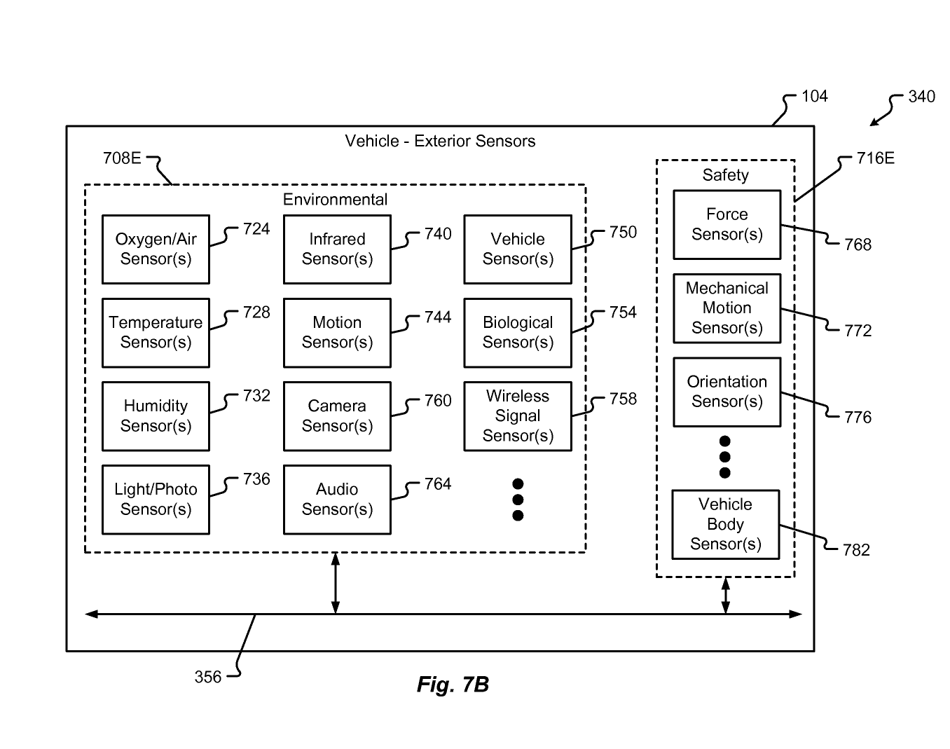

The vehicle control system 204 may also communicate with one or more sensors 236, 242, which are either associated with the vehicle 104 or communicate with the vehicle 104. Vehicle sensors 242 may include one or more sensors for providing information to the vehicle control system 204 that determine or provide information about the environment 100 in which the vehicle 104 is operating. Embodiments of these sensors may be as described in conjunction with FIGS. 6A-7B. Non-vehicle sensor 236 can be any type of sensor that is not currently associated with the vehicle 104. For example, non-vehicle sensor 236 can be sensors in a traffic system operated by a third party that provides data to the vehicle control system 204. Further, the non-vehicle sensor(s) 236 can be other types of sensors which provide information about the distant environment 116 or other information about the vehicle 104 or the environment 100. These non-vehicle sensors 236 may be operated by third parties but provide information to the vehicle control system 204. Examples of information provided by the sensors 236 and that may be used by the vehicle control system 204 may include weather tracking data, traffic data, user health tracking data, vehicle maintenance data, or other types of data, which may provide environmental or other data to the vehicle control system 204. The vehicle control system 204 may also perform signal processing of signals received from one or more sensors 236, 242. Such signal processing may include estimation of a measured parameter from a single sensor, such as multiple measurements of a range state parameter from the vehicle 104 to an obstacle, and/or the estimation, blending, or fusion of a measured state parameter from multiple sensors such as multiple radar sensors or a combination of a ladar/lidar range sensor and a radar sensor. Signal processing of such sensor signal measurements may comprise stochastic signal processing, adaptive signal processing, and/or other signal processing techniques known to those skilled in the art.

The various sensors 236, 242 may include one or more sensor memory 244. Embodiments of the sensor memory 244 may be configured to store data collected by the sensors 236, 242. For example, a temperature sensor may collect temperature data associated with a vehicle 104, user 216, and/or environment, over time. The temperature data may be collected incrementally, in response to a condition, or at specific time periods. In this example, as the temperature data is collected, it may be stored in the sensor memory 244. In some cases, the data may be stored along with an identification of the sensor and a collection time associated with the data. Among other things, this stored data may include multiple data points and may be used to track changes in sensor measurements over time. As can be appreciated, the sensor memory 244 can represent any type of database or other storage system.

The diagnostic communications module 256 may be configured to receive and transmit diagnostic signals and information associated with the vehicle 104. Examples of diagnostics signals and information may include, but is in no way limited to, vehicle system warnings, sensor data, vehicle component status, service information, component health, maintenance alerts, recall notifications, predictive analysis, and the like. Embodiments of the diagnostic communications module 256 may handle warning/error signals in a predetermined manner. The signals, for instance, can be presented to one or more of a third party, occupant, vehicle control system 204, and a service provider (e.g., manufacturer, repair facility, etc.).

Optionally, the diagnostic communications module 256 may be utilized by a third party (i.e., a party other than the user 216, etc.) in communicating vehicle diagnostic information. For instance, a manufacturer may send a signal to a vehicle 104 to determine a status associated with one or more components associated with the vehicle 104. In response to receiving the signal, the diagnostic communications module 256 may communicate with the vehicle control system 204 to initiate a diagnostic status check. Once the diagnostic status check is performed, the information may be sent via the diagnostic communications module 256 to the manufacturer. This example may be especially useful in determining whether a component recall should be issued based on the status check responses returned from a certain number of vehicles.

Wired/wireless transceiver/communications ports 260 may be included. The wired/wireless transceiver/communications ports 260 may be included to support communications over wired networks or links, for example with other communication devices, server devices, and/or peripheral devices. Examples of wired/wireless transceiver/communications ports 260 include Ethernet ports, Universal Serial Bus (USB) ports, Institute of Electrical and Electronics Engineers (IEEE) 1594, or other interface ports.

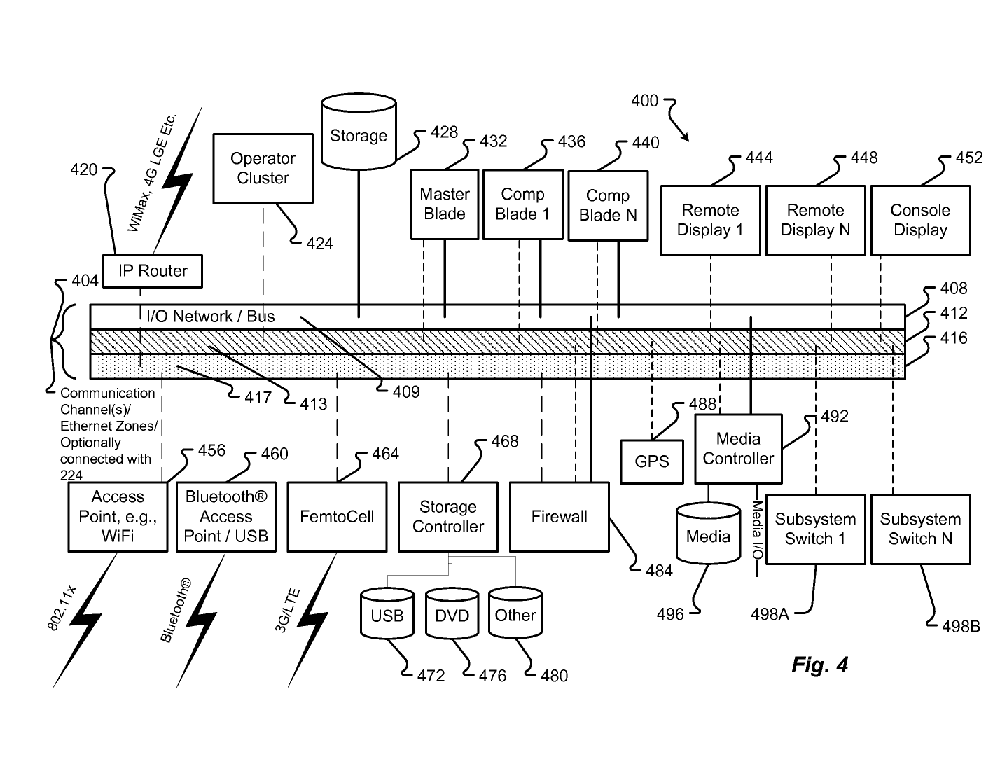

An embodiment of a vehicle control environment 300 including a vehicle control system 204 may be as shown in FIG. 3. Beyond the vehicle control system 204, the vehicle control environment 300 can include one or more of, but is not limited to, a power source and/or power control module 316, a data storage module 320, user interface(s)/input interface(s) 324, vehicle subsystems 328, user interaction subsystems 332, Global Positioning System (GPS)/Navigation subsystems 336, sensor(s) and/or sensor subsystems 340, communication subsystems 344, media subsystems 348, and/or device interaction subsystems 352. The subsystems, modules, components, etc. 316-352 may include hardware, software, firmware, computer readable media, displays, input devices, output devices, etc. or combinations thereof. The system, subsystems, modules, components, etc. 204, 316-352 may communicate over a network or bus 356. This communication bus 356 may be bidirectional and perform data communications using any known or future-developed standard or protocol. An example of the communication bus 356 may be as described in conjunction with FIG. 4.

The vehicle control system 204 can include a processor 304, memory 308, and/or an input/output (I/O) module 312. Thus, the vehicle control system 204 may be a computer system, which can comprise hardware elements that may be electrically coupled. The hardware elements may include one or more central processing units (CPUs) 304; one or more components of the I/O module 312 including input devices (e.g., a mouse, a keyboard, etc.) and/or one or more output devices (e.g., a display device, a printer, etc.).

The processor 304 may comprise a general purpose programmable processor or controller for executing application programming or instructions. The processor 304 may, optionally, include multiple processor cores, and/or implement multiple virtual processors. Additionally or alternatively, the processor 304 may include multiple physical processors. As a particular example, the processor 304 may comprise a specially configured application specific integrated circuit (ASIC) or other integrated circuit, a digital signal processor, a controller, a hardwired electronic or logic circuit, a programmable logic device or gate array, a special purpose computer, or the like. The processor 304 generally functions to run programming code or instructions implementing various functions of the vehicle control system 204.

The input/output module 312 and associated ports may be included to support communications over wired or wireless networks or links, for example with other communication devices, server devices, and/or peripheral devices. Examples of an input/output module 312 include an Ethernet port, a Universal Serial Bus (USB) port, Institute of Electrical and Electronics Engineers (IEEE) 1594, or other interface.

The vehicle control system 204 may also include one or more storage devices 308. By way of example, storage devices 308 may be disk drives, optical storage devices, solid-state storage devices such as a random access memory (“RAM”) and/or a read-only memory (“ROM”), which can be programmable, flash-updateable and/or the like. The vehicle control system 204 may additionally include a computer-readable storage media reader; a communications system (e.g., a modem, a network card (wireless or wired), an infra-red communication device, etc.); and working memory 308, which may include RAM and ROM devices as described above. The vehicle control system 204 may also include a processing acceleration unit, which can include a digital signal processor (DSP), a special-purpose processor, and/or the like.

The computer-readable storage media reader can further be connected to a computer-readable storage medium, together (and, optionally, in combination with storage device(s)) comprehensively representing remote, local, fixed, and/or removable storage devices plus storage media for temporarily and/or more permanently containing computer-readable information. The communications system may permit data to be exchanged with an external or internal network and/or any other computer or device described herein. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices, and/or other machine readable mediums for storing information.

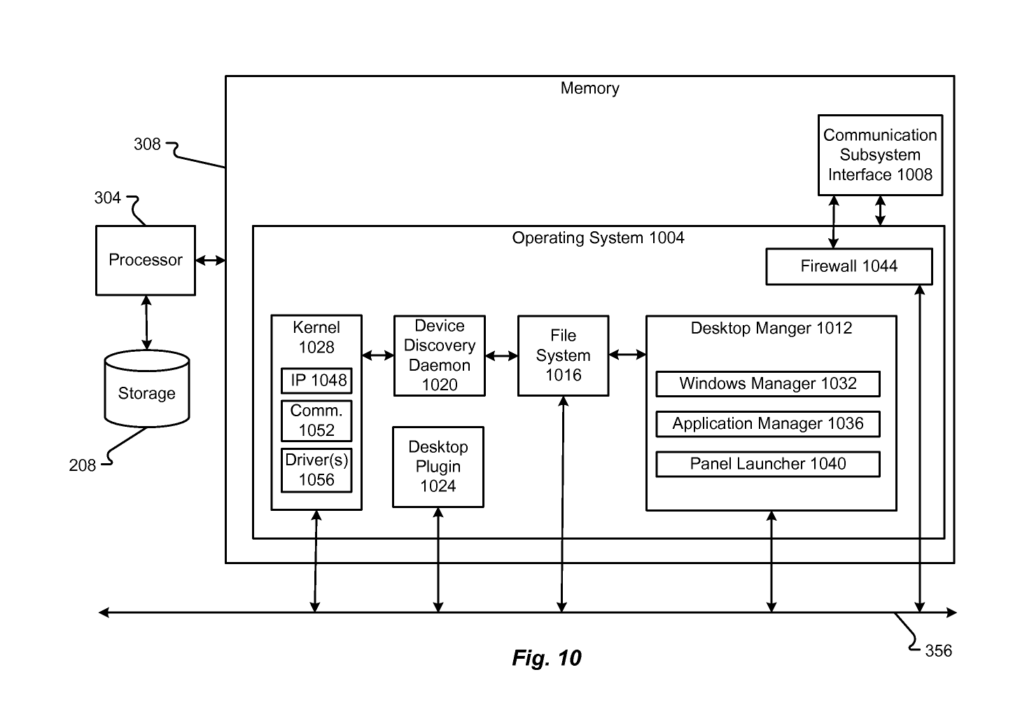

The vehicle control system 204 may also comprise software elements including an operating system and/or other code, as described in conjunction with FIG. 10. It should be appreciated that alternates to the vehicle control system 204 may have numerous variations from that described herein. For example, customized hardware might also be used and/or particular elements might be implemented in hardware, software (including portable software, such as applets), or both. Further, connection to other computing devices such as network input/output devices may be employed.

The power source and/or power control module 316 can include any type of power source, including, but not limited to, batteries, alternating current sources (from connections to a building power system or power line), solar cell arrays, etc. One or more components or modules may also be included to control the power source or change the characteristics of the provided power signal. Such modules can include one or more of, but is not limited to, power regulators, power filters, alternating current (AC) to direct current (DC) converters, DC to AC converters, receptacles, wiring, other converters, etc. The power source and/or power control module 316 functions to provide the vehicle control system 204 and any other system with power.

The data storage 320 can include any module for storing, retrieving, and/or managing data in one or more data stores and/or databases. The database or data stores may reside on a storage medium local to (and/or resident in) the vehicle control system 204 or in the vehicle 104. Alternatively, some of the data storage capability may be remote from the vehicle control system 204 or automobile, and in communication (e.g., via a network) to the vehicle control system 204. The database or data stores may reside in a storage-area network (“SAN”) familiar to those skilled in the art. Similarly, any necessary files for performing the functions attributed to the vehicle control system 204 may be stored locally on the respective vehicle control system 204 and/or remotely, as appropriate. The databases or data stores may be a relational database, and the data storage module 320 may be adapted to store, update, and retrieve data in response to specifically-formatted commands. The data storage module 320 may also perform data management functions for any flat file, object oriented, or other type of database or data store.

A first data store that may be part of the vehicle control environment 300 is a profile data store 252 for storing data about user profiles and data associated with the users. A system data store 208 can include data used by the vehicle control system 204 and/or one or more of the components 324-352 to facilitate the functionality described herein. The data stores 208 and/or 252 may be as described in conjunction with FIGS. 1 and/or 12A-12D.

The user interface/input interfaces 324 may be as described herein for providing information or data and/or for receiving input or data from a user. Vehicle systems 328 can include any of the mechanical, electrical, electromechanical, computer, or other systems associated with the function of the vehicle 100. For example, vehicle systems 328 can include one or more of, but is not limited to, the steering system, the braking system, the engine and engine control systems, the electrical system, the suspension, the drive train, the cruise control system, the radio, the heating, ventilation, air conditioning (HVAC) system, the windows and/or doors, etc. These systems are well known in the art and will not be described further.

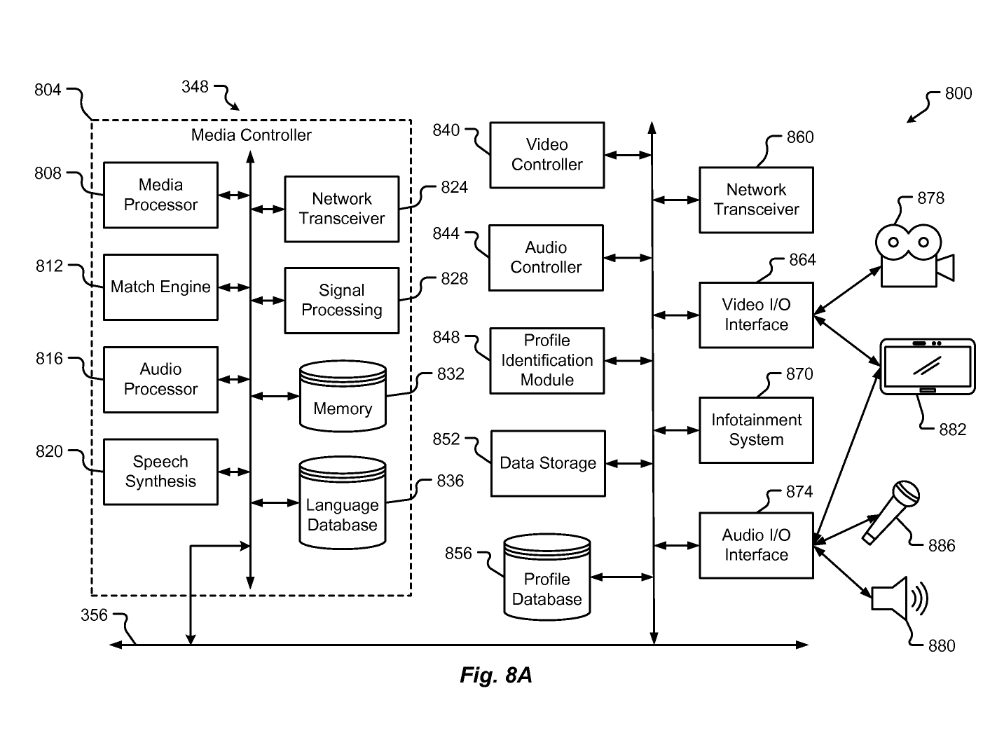

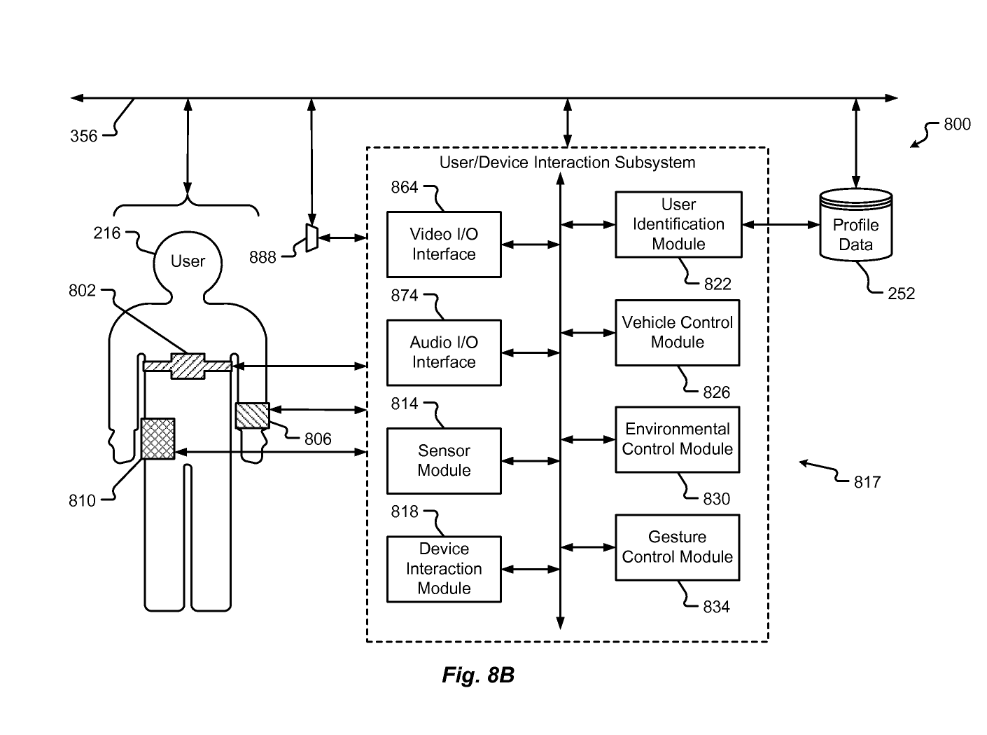

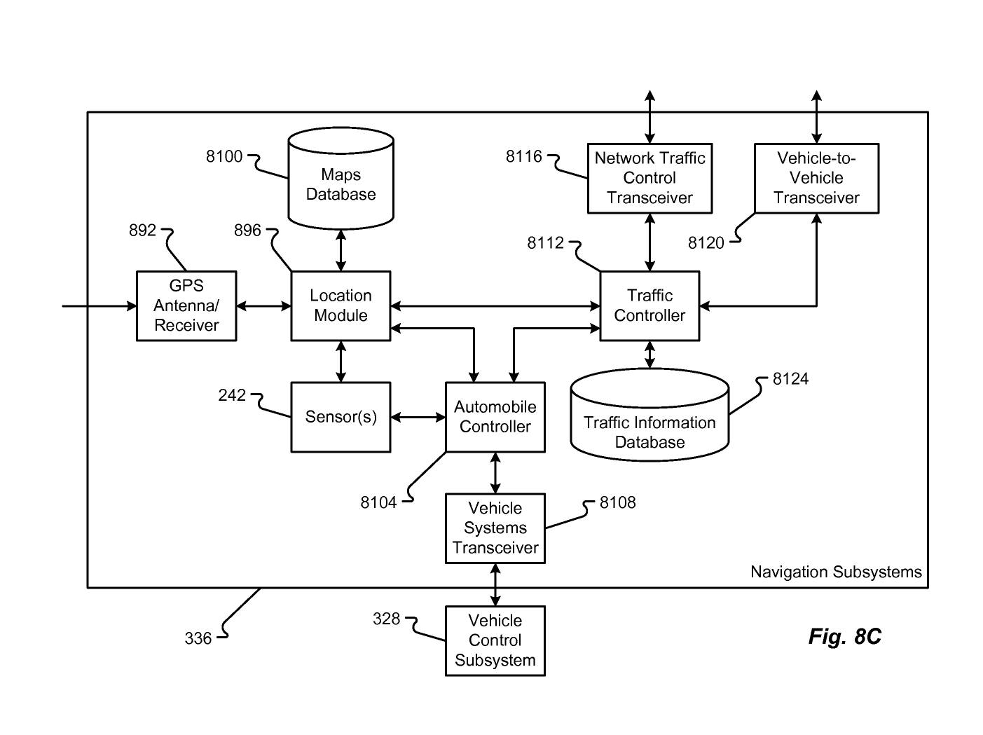

Examples of the other systems and subsystems 324-352 may be as described further herein. For example, the user interface(s)/input interface(s) 324 may be as described in FIGS. 2 and 8B; the vehicle subsystems 328 may be as described in FIG. 6a et. seq.; the user interaction subsystem 332 may be as described in conjunction with the user/device interaction subsystem 817 of FIG. 8B; the Navigation subsystem 336 may be as described in FIGS. 6A and 8C; the sensor(s)/sensor subsystem 340 may be as described in FIGS. 7A and 7B; the communication subsystem 344 may be as described in FIGS. 2, 4, 5B, 5C, and 9; the media subsystem 348 may be as described in FIG. 8A; and, the device interaction subsystem 352 may be as described in FIG. 2 and in conjunction with the user/device interaction subsystem 817 of FIG. 8B.

FIG. 4 illustrates an optional communications channel architecture 400 and associated communications components. FIG. 4 illustrates some of the optional components that can be interconnected via the communication channels/zones 404. Communication channels/zones 404 can carry information on one or more of a wired and/or wireless communications link with, in the illustrated example, there being three communications channels/zones, 408, 412, and 416.

This optional environment 400 can also include an IP router 420, an operator cluster 424, one or more storage devices 428, one or more blades, such as master blade 432, and computational blades 436 and 440. Additionally, the communications channels/zones 404 can interconnect one or more displays, such as, remote display 1 444, remote display N 448, and console display 452. The communications channels/zones 404 also interconnect an access point 456, a Bluetooth® access point/USB hub 460, a Femtocell 464, a storage controller 468, that is connected to one or more of USB devices 472, DVDs 476, or other storage devices 480. To assist with managing communications within the communication channel, the environment 400 optionally includes a firewall 484 which will be discussed hereinafter in greater detail. Other components that could also share the communications channel/zones 404 include GPS 488, media controller 492, which is connected to one or more media sources 496, and one or more subsystems, such as subsystem switches 498.

Optionally, the communications channels/zones 404 can be viewed as an I/O network or bus where the communications channels are carried on the same physical media. Optionally, the communication channels 404 can be split amongst one or more physical media and/or combined with one or more wireless communications protocols. Optionally, the communications channels 404 can be based on wireless protocols with no physical media interconnecting the various elements described herein.

The environment 400 shown in FIG. 4 can include a collection of blade processors that are housed in a “crate.” The crate can have a PC-style backplane connector 408 and a backplane Ethernet 408 that allows the various blades to communicate with one another using, for example, an Ethernet.

Various other functional elements illustrated in FIG. 4 can be integrated into this crate architecture with, as discussed hereinafter, various zones utilized for security. Optionally, as illustrated in FIG. 4, the backplane 404/408 can have two separate Ethernet zones that may or may not be on the same communications channel. Optionally, the zones exist on a single communications channel on the I/O network/bus 408. Optionally, the zones are actually on different communications channels, e.g., 412, 416; however, the implementation is not restricted to any particular type of configuration. Rather, as illustrated in FIG. 4, there can be a red zone 417 and a green zone 413, and the I/O backplane on the network/bus 408 that enables standard I/O operations. This backplane or I/O network/bus 408 also optionally can provide power distribution to the various modules and blades illustrated in FIG. 4. The red and green Ethernet zones, 417 and 413 respectively, can be implemented as Ethernet switches, with one on each side of the firewall 484. Two Ethernets (untrusted and trusted) are not connected in accordance with an optional embodiment. Optionally, the connector geometry for the firewall can be different for the Ethernet zones than for the blades that are a part of the system.

The red zone 417 only needs to go from the modular connector to the input side of the backplane connector of the firewall 484. While FIG. 4 indicates that there are five external red zone connectors to the firewall 484, provisions can be made for any number of ports with the connections being made at the access point 456, the Bluetooth® access point (combo controller) 460, Femtocell 464, storage controller 468, and/or firewall 484. Optionally, the external port connections can be made through a manufacturer configurable modular connector panel, and one or more of the red zone Ethernet ports could be available through a customer supplied crate which allows, for example, wired Ethernet connections from a bring-your-own-device (BYOD) to the firewall 484.

The green zone 413 goes from the output side of the firewall 484 and generally defines the trusted Ethernet. The Ethernet on the backplane 408 essentially implements an Ethernet switch for the entire system, defining the Ethernet backbone of the vehicle 104. All other modules, e.g., blades, etc., can connect to a standard backplane bus and the trusted Ethernet. Some number of switch ports can be reserved to connect to an output modular connector panel to distribute the Ethernet throughout the vehicle 104, e.g., connecting such elements as the console display 452, remote displays 444, 448, GPS 488, etc. Optionally, only trusted components, either provided or approved by the manufacturer after testing, can be attached to the green zone 413, which is by definition in the trusted Ethernet environment.

Optionally, the environment 400, shown in FIG. 4, utilizes IPv6 over Ethernet connections wherever possible. Using, for example, the Broadcom single-twisted pair Ethernet technology, wiring harnesses are simplified and data transmission speeds are maximized. However, while the Broadcom single-twisted pair Ethernet technology can be used, in general, systems and methods can work comparably well with any type of well-known Ethernet technology or other comparable communications technology.

As illustrated in FIG. 4 the I/O network/bus 408 is a split-bus concept that contains three independent bus structures:

The red zone 417—the untrusted Ethernet environment. This zone 417 may be used to connect network devices and customer provided devices to the vehicle information system with these devices being on the untrusted side of the firewall 484.
The green zone 413—the trusted Ethernet environment, this zone 413 can be used to connect manufacturer certified devices such as GPS units, remote displays, subsystem switches, and the like, to the vehicle network 404. Manufacturer certified devices can be implemented by vendors that allow the vehicle software system to validate whether or not a device is certified to operate with the vehicle 100. Optionally, only certified devices are allowed to connect to the trusted side of the network.
The I/O bus 409—the I/O bus may be used to provide power and data transmission to bus-based devices such as the vehicle solid state drive, the media controller blade 492, the computational blades 436, 440, and the like.

As an example, the split-bus structure can have the following minimum configuration:

Two slots for the red zone Ethernet;
One slot for built-in LTE/WiMax access 420 from the car to other network resources such as the cloud/Internet;
One slot for user devices or bring-your-own device access, this slot can implement, for example, WiFi, Bluetooth®, and/or USB connectivity 456, which can be provided in, for example, the customer crate;
One slot for combined red zone and green zone Ethernet, this slot can be reserved for the firewall controller;
Two slots for computational blades. Here the two computation blades are illustratively as shown the optional master blade and the multimedia blade or controller 492 which can be provided as standard equipment; and
The expansion controller that allows the I/O bus to be extended and provides additional Ethernet switch ports for one or more of the red or green zones, which may require that the basic green zone Ethernet switch implementation will support additional ports beyond the initial three that are needed for the basic exemplary system.
It should be possible to build 8 or 16 or more Ethernet switches that allow for the expansion with existing component(s) in a straight-forward manner.

The red zone 417 can be implemented as an 8-port Ethernet switch that has three actual bus ports within the crate with the remaining five ports being available on the customer crate. The crate implements red zone slots for the firewall controller 484, the combo controller which includes WiFi, Bluetooth®, USB hub (456, 460) and the IP router 420.

The firewall controller 484 can have a dedicated slot that bridges the red zone 417, green zone 413, and uses the I/O bus for power connections. In accordance with an optional low cost implementation, the firewall 484 can be implemented by a dummy module that simply bridges the red zone 417 and the green zone 413 without necessarily providing any firewall functionality. The combo controller 460 that includes the WiFi, Bluetooth®, and USB hub can be provided for consumer device connections. This controller can also implement the IPv6 (un-routable) protocol to insure that all information is packetized for transmission via IP over the Ethernet in the I/O network/bus 408.

The combo controller 460 with the USB hub can have ports in the customer crate. The combo controller 460 can implement USB discovery functions and packetizes the information for transmission via IP over Ethernet. The combo controller 460 can also facilitate installation of the correct USB driver for the discovered device, such as a BYOD from the user. The combo controller 460 and USB hub can then map the USB address to a “local” IPv6 address for interaction with one or more of the computational blades which is generally going to be the media controller 492.

The IP router 420 can implement Internet access through a manufacturer provided service. This service can allow, for example, a manufacturer to offer value-added services to be integrated into the vehicle information systems. The existence of the manufacturer provided Internet access can also allow the “e-Call” function and other vehicle data recorder functions to be implemented. IP router 420 also allows, for example, WiMax, 4G LTE, and other connections to the Internet through a service provider that can be, for example, contracted by the manufacturer. Internally, the IP router 420 can allow cellular handset connections to the Internet through a Femtocell 464 that is part of the IP router implementation. The IP router 420, with the Femtocell 464, can also allow a cone of silence functionality to be implemented. The IP router 420 can be an optional component for a vehicle provided by, for example, the manufacturer, a dealer, or installed by a user. In the absence of the IP router 420, it is possible to connect a consumer handheld device to the I/O network/bus 408 using, for example, either WiFi or Bluetooth® 456, 460. While functionality may be somewhat reduced when using a handheld device instead of a built-in Ethernet connection, systems and methods of this invention can also work utilizing this consumer handheld device which then connects to the Internet via, for example, WiMax, 4G, 4G LTE, or the like.

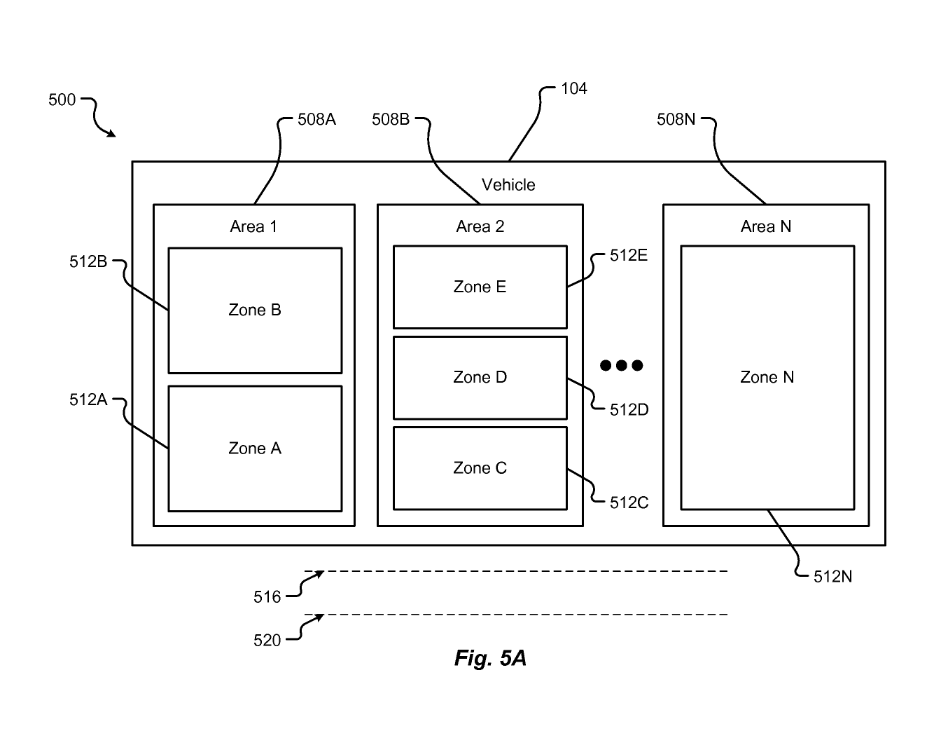

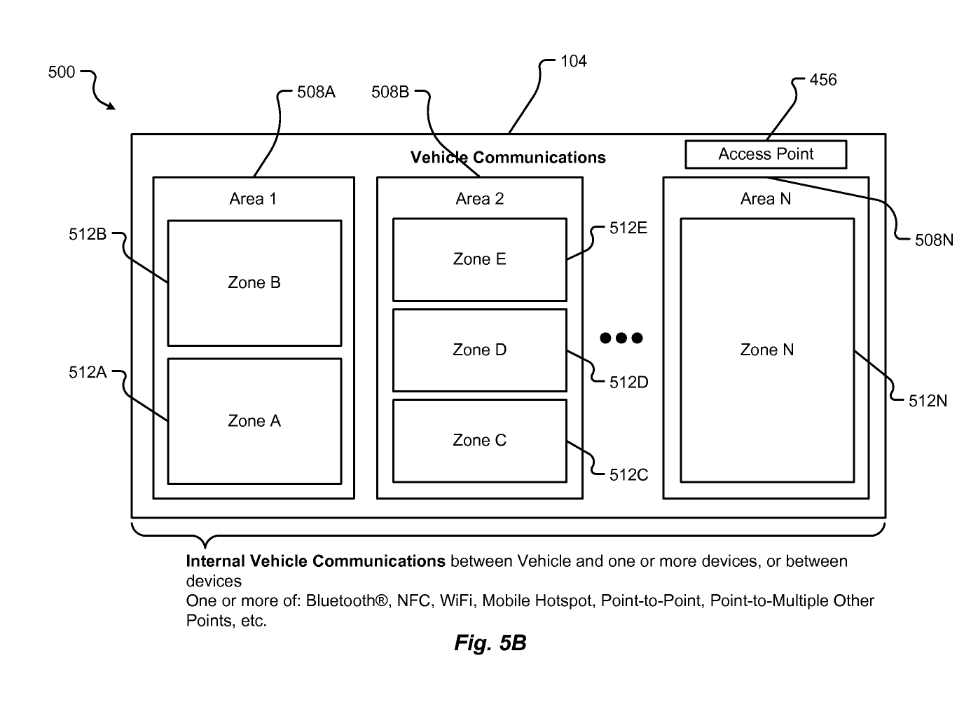

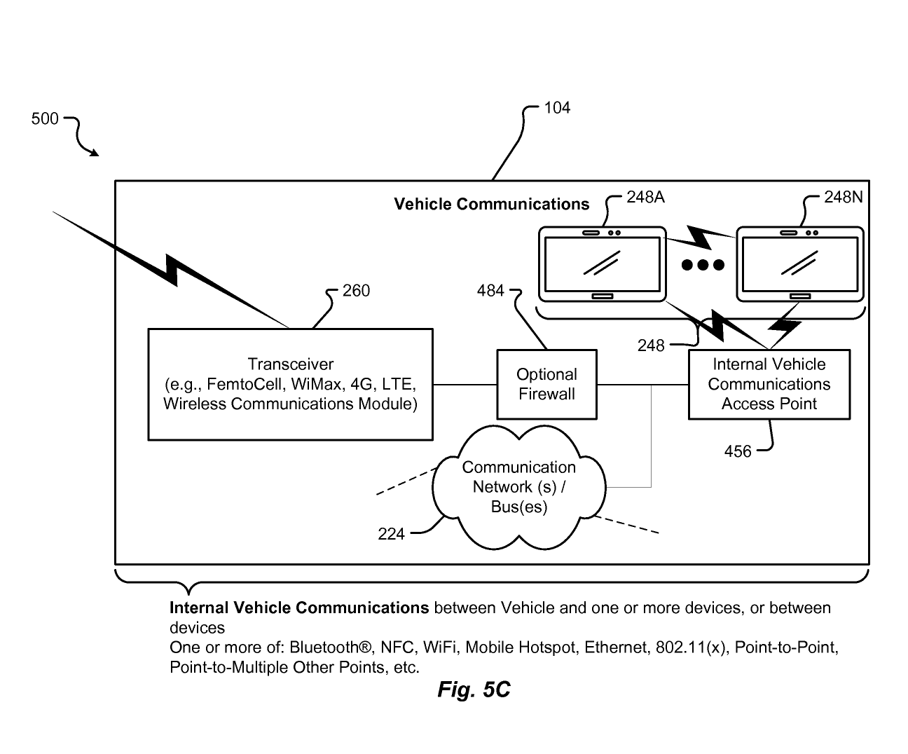

FIGS. 5A-5C show configurations of a vehicle 104. In general, a vehicle 104 may provide functionality based at least partially on one or more areas, zones, and distances, associated with the vehicle 104. Non-limiting examples of this functionality are provided herein below.

An arrangement or configuration for sensors within a vehicle 104 is as shown in FIG. 5A. The sensor arrangement 500 can include one or more areas 508 within the vehicle. An area can be a larger part of the environment inside or outside of the vehicle 104. Thus, area one 508A may include the area within the trunk space or engine space of the vehicle 104 and/or the front passenger compartment. Area two 508B may include a portion of the interior space 108 (e.g., a passenger compartment, etc.) of the vehicle 104. The area N, 508N, may include the trunk space or rear compartment area, when included within the vehicle 104. The interior space 108 may also be divided into other areas. Thus, one area may be associated with the front passenger's and driver's seats, a second area may be associated with the middle passengers' seats, and a third area may be associated with a rear passenger's seat. Each area 508 may include one or more sensors that are positioned or operate to provide environmental information about that area 508.

Each area 508 may be further separated into one or more zones 512 within the area 508. For example, area 1 508A may be separated into zone A 512A, and zone B 512B. Each zone 512 may be associated with a particular portion of the interior occupied by a passenger. For example, zone A 512A may be associated with a driver. Zone B 512B, may be associated with a front passenger. Each zone 512 may include one or more sensors that are positioned or configured to collect information about the environment or ecosystem associated with that zone or person.

A passenger area 508B may include more than two zones as described in conjunction with area 508A. For example, area 508B may include three zones, 512C, 512D, and 512E. These three separate zones 512C, 512D, and 512E may be associated with three passenger seats typically found in the rear passenger area of a vehicle 104. An area 508N and may include a single zone 512N as there may be no separate passenger areas but may include a single trunk area within the vehicle 104. The number of zones 512 is unlimited within the areas as the areas are also unlimited inside the vehicle 104. Further, it should be noted that there may be one or areas 508 or zones 512 that may be located outside the vehicle 104 that may have a specific set of sensors associated therewith.

Optionally, each area/access point 508, 456, 516, 520, and/or zone 512, associated with a vehicle 104, may comprise one or more sensors to determine a presence of a user 216 and/or device 212, 248 in and/or adjacent to each area 508, 456, 516, 520, and/or zone 512. The sensors may include vehicle sensors 242 and/or non-vehicle sensors 236 as described herein. It is anticipated that the sensors may be configured to communicate with a vehicle control system 204 and/or the diagnostic communications module 256. Additionally or alternatively, the sensors may communicate with a device 212, 248. The communication of sensors with the vehicle 104 may initiate and/or terminate the control of device 212, 248 features. For example, a vehicle operator may be located in a second outside area 520 associated with a vehicle 104. As the operator approaches the first outside area 516, associated with the vehicle 104, the vehicle control system 204 may determine to control features associated with one or more device 212, 248 and diagnostic communications module 256.

Optionally, the location of the device 212, 248 relative to the vehicle 104 may determine vehicle functionality and/or features to be provided and/or restricted to a user 216. By way of example, a device 212, 248 associated with a user 216 may be located at a second outside area 520 from the vehicle 104. In this case, and based at least partially on the distance of the device 212, 248 from the vehicle 104 (e.g., provided by detecting the device 212, 248 at or beyond the second outside area 520) the vehicle 104 may lock one or more features (e.g., ignition access, vehicle access, communications ability, etc.) associated with the vehicle 104. Optionally, the vehicle 104 may provide an alert based on the distance of the device 212, 248 from the vehicle 104. Continuing the example above, once the device 212, 248 reaches the first outside area 516 of the vehicle 104 at least one of the vehicle features may be unlocked. For instance, by reaching the first outside area 516, the vehicle 104 may unlock a door of the vehicle 104. In some cases, when the device is detected to be inside the vehicle 104, the various sensors 236, 242 may determine that the user 216 is in an area 508 and/or zone 512. As is further described herein, features of the vehicle 104, device 212, 248, and/or other components may be controlled based on rules stored in a memory.

FIG. 5B illustrates optional internal vehicle communications between one or more of the vehicle and one or more devices or between devices. Various communications can occur utilizing one or more Bluetooth®, NFC, WiFi, mobile hot spot, point-to-point communications, point-to-multipoint other point communications, an ad hoc network, or in general any known communications protocol over any known communications media or media-types.

Optionally, various types of internal vehicle communications can be facilitated using an access point 456 that utilizes one or more of Bluetooth®, NFC, WiFi, wireless Ethernet, mobile hot spot technology, or the like. Upon being connected with, and optionally authenticated to the access point 456, the connected device is able to communicate with one or more of the vehicle and one or more other devices that are connected to the access point 456. The type of connection to the access point 456 can be based on, for example, the zone 512, in which the device is located.

The user may identify their zone 512 in conjunction with an authentication procedure to the access point 456. For example, a driver in zone A 512A, upon authenticating to the access point 456, can cause the access point 456 to send a query to the device asking the device user in which zone 512 they are located. As discussed hereinafter, the zone 512 the user device is located in may have an impact on the type of communications, available bandwidth, the types of other devices or vehicle systems or subsystems the device could communicate with, and the like. As a brief introduction, internal communications with zone A 512A may be given preferential treatment over those communications originating from area 2 508B, which could have in itself, preferential treatment over communications originating within area N 508N.

Moreover, the device in zone A 512A can include profile information that governs the other devices that are allowed to connect to the access point 456 and what those devices have access to, how they can communicate, how much bandwidth they are allocated, and the like. While, optionally, the device associated with zone A 512A will be considered the “master” controller of the profile that governs the internal vehicle communications, it should be appreciated that this was arbitrarily chosen since it is assumed that there will always be a driver in a car that is present in zone A 512A. However, it should be appreciated the driver in zone A 512A, for example, may not have a communications device in which case a device associated with one of the other areas or zones, such as zone B 512B, area 2 508B, or area N 508N could also be associated with or control this master profile.

Optionally, various devices located within the various zones 512 can connect using, for example, ports provided by access point 456 or Bluetooth® access point/USB hub 460 as illustrated in FIG. 4. Similarly, the device(s) could connect utilizing the Femtocell 464 and optionally be directly connected via, for example, a standard Ethernet port.

As discussed, each one of the areas, area 1 508A, area 2 508B, and area N 508N, can each have associated therewith a profile that governs, for example, how many and what types of devices can connect from that area 508, bandwidth allocated to that area 508, the types of media or content available to device(s) within that area 508, the interconnection of devices within that area 508 or between areas 508, or, in general, can control any aspect of communication of an associated device with any one or more other associated devices/vehicle systems within the vehicle 104.

Optionally, area 2 508B devices can be provided with full access to multimedia and infotainment available within the vehicle 104, however, devices in area 2 508B may be restricted from any access to vehicle functions. Only devices in area 1 508A may be able to access vehicle control functions such as when “parents” are located in area 1 508A and the children are located in area 2 508B. Optionally, devices found in zone E 512E of area 2 508B may be able to access limited vehicle control functionality such as climate control within area 2. Similarly, devices in area N 508N may be able to control climate features within zone N 512N.

As will be appreciated, profiles can be established that allow management of communications within each of the areas 508, and further optionally within each of the zones 512. The profile can be granular in nature controlling not only what type of devices can connect within each zone 512, but how those devices can communicate with other devices and/or the vehicle and types of information that can be communicated.

To assist with identifying a location of a device within a zone 512, a number of different techniques can be utilized. One optional technique involves one or more of the vehicle sensors detecting the presence of an individual within one of the zones 512. Upon detection of an individual in a zone 512, communications subsystems 344 and the access point 456 can cooperate to not only associate the device within the zone 512 with the access point 456 but to also determine the location of the device within an area, and optionally within a zone 512. Once the device is established within a zone 512, a profile associated with the vehicle 104 can store information identifying that device and/or a person and optionally associating it with a particular zone 512 as a default. As discussed, there can be a master profile optionally associated with the device in zone A 512A, this master profile can govern communications with the communications subsystems 340 and where communications within vehicle 104 are to occur.

Some optional profiles are illustrated below where the Master Profile governs other device connectivity:

### Master Profile:

| | | Area | |
|---|---|---|---|
| Area 1 508A | Area 2 508B | N 508N | Other |
| All Communications | Allow Access to | No Access | Master Profile acts |
| | Infotainment | | as Firewall and |
| | | | Router |
| All Vehicle Controls | Allow Area 2 | | |
| | Climate Control | | |

Secondary Profile (e.g., device in Zone B 512B, Area 1 508A)

| Area 1 508A | Area 2 508B | Area N 508N | Other |
|---|---|---|---|
| All | Allow Access to | Allow Access to | Master Profile |
| Communications | Infotainment | Infotainment | acts as Firewall |
| | | | and Router |
| All Vehicle | Allow Area 2 | Allow Area 2 | |
| Controls | Climate Control | Climate Control | |

### Secondary Profile, Option 2

| Area 1 508A | Area 2 508B | Area N 508N | Other |
|---|---|---|---|
| All Communications | Allow Access to | Allow Access to | |
| | Infotainment, | Infotainment | |
| | Internet | | |
| All Vehicle Controls | Allow Area 2 | Allow Area 2 | |
| Except Driver- | Climate Control | Climate Control | |
| centric Controls | | | |

Some optional profiles are illustrated below where the Area/Zone governs device connectivity:

### Area 2 508B Profile:

| Area 1 508A | Area 2 508B | Area N 508N | Other |
|---|---|---|---|
| No Communications | Allow Access to | | |
| with Area 1 Devices | Infotainment, Allow | | |
| | Access to Other | | |
| | Area 2 or Zone N | | |
| | Devices, Internet | | |
| No Vehicle Controls | Allow Area 2 | | |
| | Climate Control | | |

### Area N 508N Profile:

| Area 1 508A | Area 2 508B | Area N 508N | Other |
|---|---|---|---|
| Communications | | Allow Access to | |
| with Area 1, Zone B | | Infotainment, Allow | |
| Device | | Access to Other | |
| | | Area N or Zone N | |
| | | Devices | |
| No Vehicle Controls | | Allow Area N | |
| | | Climate Control | |

### Area 2 508B Profile:

| Area 1 508A | Area 2 508B | Area N 508N | Other |
|---|---|---|---|
| Media Sharing with | Allow Access to | | |
| Area 1, Zone B and | Infotainment, Allow | | |
| Vehicle | Access to Other | | |
| | Area 2 or Zone N | | |
| | Devices, Internet | | |
| | and Femtocell | | |
| No Vehicle Controls | | | |

Optionally, a user's device, such as a SmartPhone, can store in, for example a profile, with which zone 512 the user's device is associated. Then, assuming the user sits in the same zone 512 and area 508 as previously, the user's device can re-establish the same communications protocols with the access point 456 as were previously established.

In addition or in the alternative, the areas 508 and zones 512 can have associated therewith restrictions as to which one or more other user's devices with which users' devices can connect. For example, a first user's device can connect with any other user device in area 2 508B or area N 508N, however is restricted from connecting with a user device in area 1 508A, zone A 512A. However, the first user device may be able to communicate with another user's device that is located in area 1 508A, zone B 512B. These communications can include any type of standard communications such as sharing content, exchanging messages, forwarding or sharing multimedia or infotainment, or in general can include any communications that would ordinarily be available between two devices and/or the vehicle and vehicle systems. As discussed, there may be restrictions on the type of communications that can be sent to the device in area 1 508A, zone A 512A. For example, the user's device in area 1 508A, zone A 512A may be restricted from receiving one or more of text messages, multimedia, infotainment, or in general anything that can be envisioned as a potential distraction to the driver. Moreover, it should be appreciated that the communications between the various devices and the various zones 512 need not necessarily occur with the assistance of access point 456, but the communications could also occur directly between the device(s).

FIG. 5C outlines optional internal vehicle communications between one or more of the vehicle and one or more devices. More specifically, FIG. 5C illustrates an example of vehicle communications where the vehicle 104 is equipped with the necessary transceivers to provide a mobile hot spot functionality to any user device(s) therein, such as user devices 248A and 248N.

Optionally, and as discussed above, one or more user devices can connect to the access point 456. This access point 456 is equipped to handle communications routing to not only the communication network/buses 224 for intra-vehicle communications, but optionally can also communicate with, for example, the Internet or the cloud, in cooperation with transceiver 260. Optionally included is a firewall 484 that has the capability of not only blocking certain types of content, such as a malicious content, but can also operate to exclude certain type of communications from emanating from the vehicle 104 and transceiver 260. As will be appreciated, various profiles could be established in the firewall 484 that controls not only the type of communications that can be received at the vehicle 104, but the type of communications that can be sent from the vehicle 104.

The transceiver 260 can be any type of well-known wireless transceiver that communicates using a known communications protocol such as WiMax, 4G, 4G LTE, 3G, or the like. The user devices can communicate via, for example, WiFi link 248 with the access point 456, with the transceiver 260 providing Internet connectivity to the various user devices. As will be appreciated, there may need to be an account associated with transceiver 260 with a wireless carrier to provide data and/or voice connectivity to enable the user devices to communicate with the Internet. Typically, the account is established on a month-to-month basis with an associated fee but could also be performed based on the amount of data to be transmitted, received, or in any other manner.

Moreover, one or more of the user's devices and access point 456 can maintain profile information that governs how the user's devices are able to communicate with other devices, and optionally the Internet. Optionally, a profile can exist that only allows the user's devices to communicate with other user's devices and/or the vehicle, multimedia and/or the vehicle infotainment system, and may not be allowed access to the Internet via transceiver 260. The profile can stipulate that the user's device could connect to the Internet via transceiver 260 for a specified period of time and/or up to a certain amount of data usage. The user's device can have full access to the Internet via transceiver 260 with no limit on time or data usage which would reduce the data usage of the user's device since it is connected via WiFi to the access point 456, but however, would increase the data usage by transceiver 260, and therefore, shift the billing for that data usage to the transceiver 260 instead of the user's device. Still further, and as previously discussed, the various profiles may stipulate which user's device has priority for use of the bandwidth provided by the transceiver 260. For example, a user's device located area 1 508A, zone A 512A may be given preferential routing treatment of data above that of a user's device in zone N 512N. In this manner, for example, a driver would be given priority for Internet access above that of the passengers. This could become important, for example, when the driver is trying to obtain traffic or direction information or, for example, when the vehicle is performing a download to update various software features.

As will be appreciated, the optional firewall 484 can cooperate with the access point 456 and the various profiles that area 508 associated with the various devices within the vehicle 104 and can fully implement communications restrictions, control bandwidth limits, Internet accessibility, malicious software blocking, and the like. Moreover, the optional firewall 484 can be accessed by an administrator with one or more of these configuration settings edited through an administrator's control panel. For example, in a scenario where parents are always in area 1 508A, it may be appropriate to give all of the user's devices in area 1 508A full access to the Internet utilizing transceiver 260, however, while restricting access and/or bandwidth to any other user devices within the vehicle 104. As the user's device and profile would be known by the firewall 484, upon the user's device being associated with the access point 456, the firewall 484 and transceiver 260 can be configured to allow communications in accordance with the stored profile.

A set of sensors or vehicle components 600 associated with the vehicle 104 may be as shown in FIG. 6A. The vehicle 104 can include, among many other components common to vehicles, wheels 607, a power source 609 (such as an engine, motor, or energy storage system (e.g., battery or capacitive energy storage system)), a manual or automatic transmission 612, a manual or automatic transmission gear controller 616, a power controller 620 (such as a throttle), a vehicle control system 204, the display device 212, a braking system 636, a steering wheel 640, a power source activation/deactivation switch 644 (e.g., an ignition), an occupant seating system 648, a wireless signal receiver 653 to receive wireless signals from signal sources such as roadside beacons and other electronic roadside devices, and a satellite positioning system receiver 657 (e.g., a Global Positioning System (“GPS”) (US), GLONASS (Russia), Galileo positioning system (EU), Compass navigation system (China), and Regional Navigational Satellite System (India) receiver), driverless systems (e.g., cruise control systems, automatic steering systems, automatic braking systems, etc.).

The vehicle 104 can include a number of sensors in wireless or wired communication with the vehicle control system 204 and/or display device 212, 248 to collect sensed information regarding the vehicle state, configuration, and/or operation. Exemplary sensors may include one or more of, but are not limited to, wheel state sensor 660 to sense one or more of vehicle speed, acceleration, deceleration, wheel rotation, wheel speed (e.g., wheel revolutions-per-minute), wheel slip, and the like, a power source energy output sensor 664 to sense a power output of the power source 609 by measuring one or more of current engine speed (e.g., revolutions-per-minute), energy input and/or output (e.g., voltage, current, fuel consumption, and torque) (e.g., turbine speed sensor, input speed sensor, crankshaft position sensor, manifold absolute pressure sensor, mass flow sensor, and the like), and the like, a switch state sensor 668 to determine a current activation or deactivation state of the power source activation/deactivation switch 644, a transmission setting sensor 670 to determine a current setting of the transmission (e.g., gear selection or setting), a gear controller sensor 672 to determine a current setting of the gear controller 616, a power controller sensor 674 to determine a current setting of the power controller 620, a brake sensor 676 to determine a current state (braking or non-braking) of the braking system 636, a seating system sensor 678 to determine a seat setting and current weight of seated occupant, if any) in a selected seat of the seating system 648, exterior and interior sound receivers 690 and 692 (e.g., a microphone, sonar, and other type of acoustic-to-electric transducer or sensor) to receive and convert sound waves into an equivalent analog or digital signal. Examples of other sensors (not shown) that may be employed include safety system state sensors to determine a current state of a vehicular safety system (e.g., air bag setting (deployed or undeployed) and/or seat belt setting (engaged or not engaged)), light setting sensor (e.g., current headlight, emergency light, brake light, parking light, fog light, interior or passenger compartment light, and/or tail light state (on or off)), brake control (e.g., pedal) setting sensor, accelerator pedal setting or angle sensor, clutch pedal setting sensor, emergency brake pedal setting sensor, door setting (e.g., open, closed, locked or unlocked) sensor, engine temperature sensor, passenger compartment or cabin temperature sensor, window setting (open or closed) sensor, one or more interior-facing or exterior-facing cameras or other imaging sensors (which commonly convert an optical image into an electronic signal but may include other devices for detection objects such as an electromagnetic radiation emitter/receiver that emits electromagnetic radiation and receives electromagnetic waves reflected by the object) to sense objects, such as other vehicles and pedestrians and optionally determine the distance, trajectory and speed of such objects, in the vicinity or path of the vehicle, odometer reading sensor, trip mileage reading sensor, wind speed sensor, radar transmitter/receiver output, brake wear sensor, steering/torque sensor, oxygen sensor, ambient lighting sensor, vision system sensor, ranging sensor, parking sensor, heating, venting, and air conditioning (HVAC) sensor, water sensor, air-fuel ratio meter, blind spot monitor, hall effect sensor, microphone, radio frequency (RF) sensor, infrared (IR) sensor, vehicle control system sensors, wireless network sensor (e.g., Wi-Fi and/or Bluetooth® sensor), cellular data sensor, and other sensors either future-developed or known to those of skill in the vehicle art.

In the depicted vehicle embodiment, the various sensors can be in communication with the display device 212, 248 and vehicle control system 204 via signal carrier network 224. As noted, the signal carrier network 224 can be a network of signal conductors, a wireless network (e.g., a radio frequency, microwave, or infrared communication system using a communications protocol, such as Wi-Fi), or a combination thereof. The vehicle control system 204 may also provide signal processing of one or more sensors, sensor fusion of similar and/or dissimilar sensors, signal smoothing in the case of erroneous “wild point” signals, and/or sensor fault detection. For example, ranging measurements provided by one or more RF sensors may be combined with ranging measurements from one or more IR sensors to determine one fused estimate of vehicle range to an obstacle target.

The control system 204 may receive and read sensor signals, such as wheel and engine speed signals, as a digital input comprising, for example, a pulse width modulated (PWM) signal. The processor 304 can be configured, for example, to read each of the signals into a port configured as a counter or configured to generate an interrupt on receipt of a pulse, such that the processor 304 can determine, for example, the engine speed in revolutions per minute (RPM) and the speed of the vehicle in miles per hour (MPH) and/or kilometers per hour (KPH). One skilled in the art will recognize that the two signals can be received from existing sensors in a vehicle comprising a tachometer and a speedometer, respectively. Alternatively, the current engine speed and vehicle speed can be received in a communication packet as numeric values from a conventional dashboard subsystem comprising a tachometer and a speedometer. The transmission speed sensor signal can be similarly received as a digital input comprising a signal coupled to a counter or interrupt signal of the processor 304 or received as a value in a communication packet on a network or port interface from an existing subsystem of the vehicle 104. The ignition sensor signal can be configured as a digital input, wherein a HIGH value represents that the ignition is on and a LOW value represents that the ignition is OFF. Three bits of the port interface can be configured as a digital input to receive the gear shift position signal, representing eight possible gear shift positions. Alternatively, the gear shift position signal can be received in a communication packet as a numeric value on the port interface. The throttle position signal can be received as an analog input value, typically in the range 0-5 volts. Alternatively, the throttle position signal can be received in a communication packet as a numeric value on the port interface. The output of other sensors can be processed in a similar fashion.

Other sensors may be included and positioned in the interior space 108 of the vehicle 104. Generally, these interior sensors obtain data about the health of the driver and/or passenger(s), data about the safety of the driver and/or passenger(s), and/or data about the comfort of the driver and/or passenger(s). The health data sensors can include sensors in the steering wheel that can measure various health telemetry for the person (e.g., heart rate, temperature, blood pressure, blood presence, blood composition, etc.). Sensors in the seats may also provide for health telemetry (e.g., presence of liquid, weight, weight shifts, etc.). Infrared sensors could detect a person's temperature; optical sensors can determine a person's position and whether the person has become unconscious. Other health sensors are possible and included herein.

Safety sensors can measure whether the person is acting safely. Optical sensors can determine a person's position and focus. If the person stops looking at the road ahead, the optical sensor can detect the lack of focus. Sensors in the seats may detect if a person is leaning forward or may be injured by a seat belt in a collision. Other sensors can detect that the driver has at least one hand on a steering wheel. Other safety sensors are possible and contemplated as if included herein.

Comfort sensors can collect information about a person's comfort. Temperature sensors may detect a temperature of the interior cabin. Moisture sensors can determine a relative humidity. Audio sensors can detect loud sounds or other distractions. Audio sensors may also receive input from a person through voice data. Other comfort sensors are possible and contemplated as if included herein.

FIG. 6B shows an interior sensor configuration for one or more zones 512 of a vehicle 104 optionally. Optionally, the areas 508 and/or zones 512 of a vehicle 104 may include sensors that are configured to collect information associated with the interior 108 of a vehicle 104. In particular, the various sensors may collect environmental information, user information, and safety information, to name a few. Embodiments of these sensors may be as described in conjunction with FIGS. 7A-8B.

Optionally, the sensors may include one or more of optical, or image, sensors 622A-B (e.g., cameras, etc.), motion sensors 624A-B (e.g., utilizing RF, IR, and/or other sound/image sensing, etc.), steering wheel user sensors 642 (e.g., heart rate, temperature, blood pressure, sweat, health, etc.), seat sensors 677 (e.g., weight, load cell, moisture, electrical, force transducer, etc.), safety restraint sensors 679 (e.g., seatbelt, airbag, load cell, force transducer, etc.), interior sound receivers 692A-B, environmental sensors 694 (e.g., temperature, humidity, air, oxygen, etc.), and the like.

The image sensors 622A-B may be used alone or in combination to identify objects, users 216, and/or other features, inside the vehicle 104. Optionally, a first image sensor 622A may be located in a different position within a vehicle 104 from a second image sensor 622B. When used in combination, the image sensors 622A-B may combine captured images to form, among other things, stereo and/or three-dimensional (3D) images. The stereo images can be recorded and/or used to determine depth associated with objects and/or users 216 in a vehicle 104. Optionally, the image sensors 622A-B used in combination may determine the complex geometry associated with identifying characteristics of a user 216. For instance, the image sensors 622A-B may be used to determine dimensions between various features of a user's face (e.g., the depth/distance from a user's nose to a user's cheeks, a linear distance between the center of a user's eyes, and more). These dimensions may be used to verify, record, and even modify characteristics that serve to identify a user 216. As can be appreciated, utilizing stereo images can allow for a user 216 to provide complex gestures in a 3D space of the vehicle 104. These gestures may be interpreted via one or more of the subsystems as disclosed herein. Optionally, the image sensors 622A-B may be used to determine movement associated with objects and/or users 216 within the vehicle 104. It should be appreciated that the number of image sensors used in a vehicle 104 may be increased to provide greater dimensional accuracy and/or views of a detected image in the vehicle 104.

The vehicle 104 may include one or more motion sensors 624A-B. These motion sensors 624A-B may detect motion and/or movement of objects inside the vehicle 104. Optionally, the motion sensors 624A-B may be used alone or in combination to detect movement. For example, a user 216 may be operating a vehicle 104 (e.g., while driving, etc.) when a passenger in the rear of the vehicle 104 unbuckles a safety belt and proceeds to move about the vehicle 104. In this example, the movement of the passenger could be detected by the motion sensors 624A-B. Optionally, the user 216 could be alerted of this movement by one or more of the devices 212, 248 in the vehicle 104. In another example, a passenger may attempt to reach for one of the vehicle control features (e.g., the steering wheel 640, the console, icons displayed on the head unit and/or device 212, 248, etc.). In this case, the movement (i.e., reaching) of the passenger may be detected by the motion sensors 624A-B. Optionally, the path, trajectory, anticipated path, and/or some other direction of movement/motion may be determined using the motion sensors 624A-B. In response to detecting the movement and/or the direction associated with the movement, the passenger may be prevented from interfacing with and/or accessing at least some of the vehicle control features (e.g., the features represented by icons may be hidden from a user interface, the features may be locked from use by the passenger, combinations thereof, etc.). As can be appreciated, the user 216 may be alerted of the movement/motion such that the user 216 can act to prevent the passenger from interfering with the vehicle 104 controls. Optionally, the number of motion sensors in a vehicle 104, or areas of a vehicle 104, may be increased to increase an accuracy associated with motion detected in the vehicle 104.

The interior sound receivers 692A-B may include, but are not limited to, microphones and other types of acoustic-to-electric transducers or sensors. Optionally, the interior sound receivers 692A-B may be configured to receive and convert sound waves into an equivalent analog or digital signal. The interior sound receivers 692A-B may serve to determine one or more locations associated with various sounds in the vehicle 104. The location of the sounds may be determined based on a comparison of volume levels, intensity, and the like, between sounds detected by two or more interior sound receivers 692A-B. For instance, a first interior sound receiver 692A may be located in a first area of the vehicle 104 and a second interior sound receiver 692B may be located in a second area of the vehicle 104. If a sound is detected at a first volume level by the first interior sound receiver 692A and a second, higher, volume level by the second interior sound receiver 692B in the second area of the vehicle 104, the sound may be determined to be closer to the second area of the vehicle 104. As can be appreciated, the number of sound receivers used in a vehicle 104 may be increased (e.g., more than two, etc.) to increase measurement accuracy surrounding sound detection and location, or source, of the sound (e.g., via triangulation, etc.).

Seat sensors 677 may be included in the vehicle 104. The seat sensors 677 may be associated with each seat and/or zone 512 in the vehicle 104. Optionally, the seat sensors 677 may provide health telemetry and/or identification via one or more of load cells, force transducers, weight sensors, moisture detection sensor, electrical conductivity/resistance sensor, and the like. For example, the seat sensors 677 may determine that a user 216 weighs 180 lbs. This value may be compared to user data stored in memory to determine whether a match exists between the detected weight and a user 216 associated with the vehicle 104. In another example, if the seat sensors 677 detect that a user 216 is fidgeting, or moving, in a seemingly uncontrollable manner, the system may determine that the user 216 has suffered a nervous and/or muscular system issue (e.g., seizure, etc.). The vehicle control system 204 may then cause the vehicle 104 to slow down and in addition or alternatively the automobile controller 8104 (described below) can safely take control of the vehicle 104 and bring the vehicle 104 to a stop in a safe location (e.g., out of traffic, off a freeway, etc).

Health telemetry and other data may be collected via the steering wheel user sensors 642. Optionally, the steering wheel user sensors 642 may collect heart rate, temperature, blood pressure, and the like, associated with a user 216 via at least one contact disposed on or about the steering wheel 640.

The safety restraint sensors 679 may be employed to determine a state associated with one or more safety restraint devices in a vehicle 104. The state associated with one or more safety restraint devices may serve to indicate a force observed at the safety restraint device, a state of activity (e.g., retracted, extended, various ranges of extension and/or retraction, deployment, buckled, unbuckled, etc.), damage to the safety restraint device, and more.

Environmental sensors 694, including one or more of temperature, humidity, air, oxygen, carbon monoxide, smoke, and other environmental condition sensors may be used in a vehicle 104. These environmental sensors 694 may be used to collect data relating to the safety, comfort, and/or condition of the interior space 108 of the vehicle 104. Among other things, the data collected by the environmental sensors 694 may be used by the vehicle control system 204 to alter functions of a vehicle. The environment may correspond to an interior space 108 of a vehicle 104 and/or specific areas 508 and/or zones 512 of the vehicle 104. It should be appreciate that an environment may correspond to a user 216. For example, a low oxygen environment may be detected by the environmental sensors 694 and associated with a user 216 who is operating the vehicle 104 in a particular zone 512. In response to detecting the low oxygen environment, at least one of the subsystems of the vehicle 104, as provided herein, may alter the environment, especially in the particular zone 512, to increase the amount of oxygen in the zone 512. Additionally or alternatively, the environmental sensors 694 may be used to report conditions associated with a vehicle (e.g., fire detected, low oxygen, low humidity, high carbon monoxide, etc.). The conditions may be reported to a user 216 and/or a third party via at least one communications module as provided herein.

Among other things, the sensors as disclosed herein may communicate with each other, with devices 212, 248, and/or with the vehicle control system 204 via the signal carrier network 224. Additionally or alternatively, the sensors disclosed herein may serve to provide data relevant to more than one category of sensor information including, but not limited to, combinations of environmental information, user information, and safety information to name a few.

FIGS. 7A-7B show block diagrams of various sensors that may be associated with a vehicle 104. Although depicted as interior and exterior sensors, it should be appreciated that any of the one or more of the sensors shown may be used in both the interior space 108 and the exterior space of the vehicle 104. Moreover, sensors having the same symbol or name may include the same, or substantially the same, functionality as those sensors described elsewhere in the present disclosure. Further, although the various sensors are depicted in conjunction with specific groups (e.g., environmental 708, 708E, user interface 712, safety 716, 716E, etc.) the sensors should not be limited to the groups in which they appear. In other words, the sensors may be associated with other groups or combinations of groups and/or disassociated from one or more of the groups shown. The sensors as disclosed herein may communicate with each other, the devices 212, 248, and/or the vehicle control system 204 via one or more communications channel(s) 356.

FIG. 7A is a block diagram of an embodiment of interior sensors 340 for a vehicle 104 is provided. The interior sensors 340 may be arranged into one or more groups, based at least partially on the function of the interior sensors 340. The interior space 108 of a vehicle 104 may include an environmental group 708, a user interface group 712, and a safety group 716. Additionally or alternatively, there may be sensors associated with various devices inside the vehicle (e.g., devices 212, 248, smart phones, tablets, mobile computers, etc.)

The environmental group 708 may comprise sensors configured to collect data relating to the internal environment of a vehicle 104. It is anticipated that the environment of the vehicle 104 may be subdivided into areas 508 and zones 512 in an interior space 108 of a vehicle 104. In this case, each area 508 and/or zone 512 may include one or more of the environmental sensors. Examples of environmental sensors associated with the environmental group 708 may include, but are not limited to, oxygen/air sensors 724, temperature sensors 728, humidity sensors 732, light/photo sensors 736, and more. The oxygen/air sensors 724 may be configured to detect a quality of the air in the interior space 108 of the vehicle 104 (e.g., ratios and/or types of gasses comprising the air inside the vehicle 104, dangerous gas levels, safe gas levels, etc.). Temperature sensors 728 may be configured to detect temperature readings of one or more objects, users 216, and/or areas 508 of a vehicle 104. Humidity sensors 732 may detect an amount of water vapor present in the air inside the vehicle 104. The light/photo sensors 736 can detect an amount of light present in the vehicle 104. Further, the light/photo sensors 736 may be configured to detect various levels of light intensity associated with light in the vehicle 104.

The user interface group 712 may comprise sensors configured to collect data relating to one or more users 216 in a vehicle 104. As can be appreciated, the user interface group 712 may include sensors that are configured to collect data from users 216 in one or more areas 508 and zones 512 of the vehicle 104. For example, each area 508 and/or zone 512 of the vehicle 104 may include one or more of the sensors in the user interface group 712. Examples of user interface sensors associated with the user interface group 712 may include, but are not limited to, infrared sensors 740, motion sensors 744, weight sensors 748, wireless network sensors 752, biometric sensors 756, camera (or image) sensors 760, audio sensors 764, and more.

Infrared sensors 740 may be used to measure IR light irradiating from at least one surface, user 216, or other object in the vehicle 104. Among other things, the Infrared sensors 740 may be used to measure temperatures, form images (especially in low light conditions), identify users 216, and even detect motion in the vehicle 104.

The motion sensors 744 may be similar to the motion detectors 624A-B, as described in conjunction with FIG. 6B. Weight sensors 748 may be employed to collect data relating to objects and/or users 216 in various areas 508 of the vehicle 104. In some cases, the weight sensors 748 may be included in the seats and/or floor of a vehicle 104.

Optionally, the vehicle 104 may include a wireless network sensor 752. This sensor 752 may be configured to detect one or more wireless network(s) inside the vehicle 104. Examples of wireless networks may include, but are not limited to, wireless communications utilizing Bluetooth®, Wi-Fi™, ZigBee, IEEE 802.11, and other wireless technology standards. For example, a mobile hotspot may be detected inside the vehicle 104 via the wireless network sensor 752. In this case, the vehicle 104 may determine to utilize and/or share the mobile hotspot detected via/with one or more other devices 212, 248 and/or components associated with the vehicle 104.

Biometric sensors 756 may be employed to identify and/or record characteristics associated with a user 216. It is anticipated that biometric sensors 756 can include at least one of image sensors, IR sensors, fingerprint readers, weight sensors, load cells, force transducers, heart rate monitors, blood pressure monitors, and the like as provided herein.

The camera sensors 760 may be similar to image sensors 622A-B, as described in conjunction with FIG. 6B. Optionally, the camera sensors may record still images, video, and/or combinations thereof. The audio sensors 764 may be similar to the interior sound receivers 692A-B, as described in conjunction with FIGS. 6A-6B. The audio sensors may be configured to receive audio input from a user 216 of the vehicle 104. The audio input from a user 216 may correspond to voice commands, conversations detected in the vehicle 104, phone calls made in the vehicle 104, and/or other audible expressions made in the vehicle 104.

The safety group 716 may comprise sensors configured to collect data relating to the safety of a user 216 and/or one or more components of a vehicle 104. The vehicle 104 may be subdivided into areas 508 and/or zones 512 in an interior space 108 of a vehicle 104 where each area 508 and/or zone 512 may include one or more of the safety sensors provided herein. Examples of safety sensors associated with the safety group 716 may include, but are not limited to, force sensors 768, mechanical motion sensors 772, orientation sensors 776, restraint sensors 780, and more.

The force sensors 768 may include one or more sensors inside the vehicle 104 configured to detect a force observed in the vehicle 104. One example of a force sensor 768 may include a force transducer that converts measured forces (e.g., force, weight, pressure, etc.) into output signals.

Mechanical motion sensors 772 may correspond to encoders, accelerometers, damped masses, and the like. Optionally, the mechanical motion sensors 772 may be adapted to measure the force of gravity (i.e., G-force) as observed inside the vehicle 104. Measuring the G-force observed inside a vehicle 104 can provide valuable information related to a vehicle's acceleration, deceleration, collisions, and/or forces that may have been suffered by one or more users 216 in the vehicle 104. As can be appreciated, the mechanical motion sensors 772 can be located in an interior space 108 or an exterior of the vehicle 104.

Orientation sensors 776 can include accelerometers, gyroscopes, magnetic sensors, and the like that are configured to detect an orientation associated with the vehicle 104. Similar to the mechanical motion sensors 772, the orientation sensors 776 can be located in an interior space 108 or an exterior of the vehicle 104.

The restraint sensors 780 may be similar to the safety restraint sensors 679 as described in conjunction with FIGS. 6A-6B. These sensors 780 may correspond to sensors associated with one or more restraint devices and/or systems in a vehicle 104. Seatbelts and airbags are examples of restraint devices and/or systems. As can be appreciated, the restraint devices and/or systems may be associated with one or more sensors that are configured to detect a state of the device/system. The state may include extension, engagement, retraction, disengagement, deployment, and/or other electrical or mechanical conditions associated with the device/system.

The associated device sensors 720 can include any sensors that are associated with a device 212, 248 in the vehicle 104. As previously stated, typical devices 212, 248 may include smart phones, tablets, laptops, mobile computers, and the like. It is anticipated that the various sensors associated with these devices 212, 248 can be employed by the vehicle control system 204. For example, a typical smart phone can include, an image sensor, an IR sensor, audio sensor, gyroscope, accelerometer, wireless network sensor, fingerprint reader, and more. It is an aspect of the present disclosure that one or more of these associated device sensors 720 may be used by one or more subsystems of the vehicle system 200.

In FIG. 7B, a block diagram of an embodiment of exterior sensors 340 for a vehicle 104 is shown. The exterior sensors may include sensors that are identical, or substantially similar, to those previously disclosed in conjunction with the interior sensors of FIG. 7A. Optionally, the exterior sensors 340 may be configured to collect data relating to one or more conditions, objects, users 216, and other events that are external to the interior space 108 of the vehicle 104. For instance, the oxygen/air sensors 724 may measure a quality and/or composition of the air outside of a vehicle 104. As another example, the motion sensors 744 may detect motion outside of a vehicle 104.

The external environmental group 708E may comprise sensors configured to collect data relating to the external environment of a vehicle 104. In addition to including one or more of the sensors previously described, the external environmental group 708E may include additional sensors, such as, vehicle sensors 750, biological sensors, and wireless signal sensors 758. Vehicle sensors 750 can detect vehicles that are in an environment surrounding the vehicle 104. For example, the vehicle sensors 750 may detect vehicles in a first outside area 516, a second outside area 520, and/or combinations of the first and second outside areas 516, 520. Optionally, the vehicle sensors 750 may include one or more of RF sensors, IR sensors, image sensors, and the like to detect vehicles, people, hazards, etc. that are in an environment exterior to the vehicle 104. Additionally or alternatively, the vehicle sensors 750 can provide distance/directional information relating to a distance (e.g., distance from the vehicle 104 to the detected object) and/or a direction (e.g., direction of travel, etc.) associated with the detected object.

The biological sensors 754 may determine whether one or more biological entities (e.g., an animal, a person, a user 216, etc.) is in an external environment of the vehicle 104. Additionally or alternatively, the biological sensors 754 may provide distance information relating to a distance of the biological entity from the vehicle 104. Biological sensors 754 may include at least one of RF sensors, IR sensors, image sensors and the like that are configured to detect biological entities. For example, an IR sensor may be used to determine that an object, or biological entity, has a specific temperature, temperature pattern, or heat signature. Continuing this example, a comparison of the determined heat signature may be compared to known heat signatures associated with recognized biological entities (e.g., based on shape, locations of temperature, and combinations thereof, etc.) to determine whether the heat signature is associated with a biological entity or an inanimate, or non-biological, object.

The wireless signal sensors 758 may include one or more sensors configured to receive wireless signals from signal sources such as Wi-Fi™ hotspots, cell towers, roadside beacons, other electronic roadside devices, and satellite positioning systems. Optionally, the wireless signal sensors 758 may detect wireless signals from one or more of a mobile phone, mobile computer, keyless entry device, RFID device, near field communications (NFC) device, and the like.

The external safety group 716E may comprise sensors configured to collect data relating to the safety of a user 216 and/or one or more components of a vehicle 104. Examples of safety sensors associated with the external safety group 716E may include, but are not limited to, force sensors 768, mechanical motion sensors 772, orientation sensors 776, vehicle body sensors 782, and more. Optionally, the exterior safety sensors 716E may be configured to collect data relating to one or more conditions, objects, vehicle components, and other events that are external to the vehicle 104. For instance, the force sensors 768 in the external safety group 716E may detect and/or record force information associated with the outside of a vehicle 104. For instance, if an object strikes the exterior of the vehicle 104, the force sensors 768 from the exterior safety group 716E may determine a magnitude, location, and/or time associated with the strike.

The vehicle 104 may include a number of vehicle body sensors 782. The vehicle body sensors 782 may be configured to measure characteristics associated with the body (e.g., body panels, components, chassis, windows, etc.) of a vehicle 104. For example, two vehicle body sensors 782, including a first body sensor and a second body sensor, may be located at some distance apart. Continuing this example, the first body sensor may be configured to send an electrical signal across the body of the vehicle 104 to the second body sensor, or vice versa. Upon receiving the electrical signal from the first body sensor, the second body sensor may record a detected current, voltage, resistance, and/or combinations thereof associated with the received electrical signal. Values (e.g., current, voltage, resistance, etc.) for the sent and received electrical signal may be stored in a memory. These values can be compared to determine whether subsequent electrical signals sent and received between vehicle body sensors 782 deviate from the stored values. When the subsequent signal values deviate from the stored values, the difference may serve to indicate damage and/or loss of a body component. Additionally or alternatively, the deviation may indicate a problem with the vehicle body sensors 782. The vehicle body sensors 782 may communicate with each other, a vehicle control system 204, and/or systems of the vehicle system 200 via a communications channel 356. Although described using electrical signals, it should be appreciated that alternative embodiments of the vehicle body sensors 782 may use sound waves and/or light to perform a similar function.

FIG. 8A is a block diagram of an embodiment of a media controller subsystem 348 for a vehicle 104. The media controller subsystem 348 may include, but is not limited to, a media controller 804, a media processor 808, a match engine 812, an audio processor 816, a speech synthesis module 820, a network transceiver 824, a signal processing module 828, memory 832, and a language database 836. Optionally, the media controller subsystem 348 may be configured as a dedicated blade that implements the media-related functionality of the system 200. Additionally or alternatively, the media controller subsystem 348 can provide voice input, voice output, library functions for multimedia, and display control for various areas 508 and/or zones 512 of the vehicle 104.

Optionally, the media controller subsystem 348 may include a local IP address (e.g., IPv4, IPv6, combinations thereof, etc.) and even a routable, global unicast address. The routable, global unicast address may allow for direct addressing of the media controller subsystem 348 for streaming data from Internet resources (e.g., cloud storage, user accounts, etc.). It is anticipated, that the media controller subsystem 348 can provide multimedia via at least one Internet connection, or wireless network communications module, associated with the vehicle 104. Moreover, the media controller subsystem 348 may be configured to service multiple independent clients simultaneously.

The media processor 808 may comprise a general purpose programmable processor or controller for executing application programming or instructions related to the media subsystem 348. The media processor 808 may include multiple processor cores, and/or implement multiple virtual processors. Optionally, the media processor 808 may include multiple physical processors. By way of example, the media processor 808 may comprise a specially configured application specific integrated circuit (ASIC) or other integrated circuit, a digital signal processor, a controller, a hardwired electronic or logic circuit, a programmable logic device or gate array, a special purpose computer, or the like. The media processor 808 generally functions to run programming code or instructions implementing various functions of the media controller 804.

The match engine 812 can receive input from one or more components of the vehicle system 800 and perform matching functions. Optionally, the match engine 812 may receive audio input provided via a microphone 886 of the system 800. The audio input may be provided to the media controller subsystem 348 where the audio input can be decoded and matched, via the match engine 812, to one or more functions available to the vehicle 104. Similar matching operations may be performed by the match engine 812 relating to video input received via one or more image sensors, cameras 878, and the like.

The media controller subsystem 348 may include a speech synthesis module 820 configured to provide audio output to one or more speakers 880, or audio output devices, associated with the vehicle 104. Optionally, the speech synthesis module 820 may be configured to provide audio output based at least partially on the matching functions performed by the match engine 812.

As can be appreciated, the coding/decoding, the analysis of audio input/output, and/or other operations associated with the match engine 812 and speech synthesis module 820, may be performed by the media processor 808 and/or a dedicated audio processor 816. The audio processor 816 may comprise a general purpose programmable processor or controller for executing application programming or instructions related to audio processing. Further, the audio processor 816 may be similar to the media processor 808 described herein.

The network transceiver 824 can include any device configured to transmit and receive analog and/or digital signals. Optionally, the media controller subsystem 348 may utilize a network transceiver 824 in one or more communication networks associated with the vehicle 104 to receive and transmit signals via the communications channel 356. Additionally or alternatively, the network transceiver 824 may accept requests from one or more devices 212, 248 to access the media controller subsystem 348. One example of the communication network is a local-area network (LAN). As can be appreciated, the functionality associated with the network transceiver 824 may be built into at least one other component of the vehicle 104 (e.g., a network interface card, communications module, etc.).

The signal processing module 828 may be configured to alter audio/multimedia signals received from one or more input sources (e.g., microphones 886, etc.) via the communications channel 356. Among other things, the signal processing module 828 may alter the signals received electrically, mathematically, combinations thereof, and the like.

The media controller 804 may also include memory 832 for use in connection with the execution of application programming or instructions by the media processor 808, and for the temporary or long term storage of program instructions and/or data. As examples, the memory 832 may comprise RAM, DRAM, SDRAM, or other solid state memory.

The language database 836 may include the data and/or libraries for one or more languages, as are used to provide the language functionality as provided herein. In one case, the language database 836 may be loaded on the media controller 804 at the point of manufacture. Optionally, the language database 836 can be modified, updated, and/or otherwise changed to alter the data stored therein. For instance, additional languages may be supported by adding the language data to the language database 836. In some cases, this addition of languages can be performed via accessing administrative functions on the media controller 804 and loading the new language modules via wired (e.g., USB, etc.) or wireless communication. In some cases, the administrative functions may be available via a vehicle console device 248, a user device 212, 248, and/or other mobile computing device that is authorized to access administrative functions (e.g., based at least partially on the device's address, identification, etc.).

One or more video controllers 840 may be provided for controlling the video operation of the devices 212, 248, 882 associated with the vehicle. Optionally, the video controller 840 may include a display controller for controlling the operation of touch sensitive screens, including input (touch sensing) and output (display) functions. Video data may include data received in a stream and unpacked by a processor and loaded into a display buffer. In this example, the processor and video controller 840 can optimize the display based on the characteristics of a screen of a display device 212, 248, 882. The functions of a touch screen controller may be incorporated into other components, such as a media processor 808 or display subsystem.

The audio controller 844 can provide control of the audio entertainment system (e.g., radio, subscription music service, multimedia entertainment, etc.), and other audio associated with the vehicle 104 (e.g., navigation systems, vehicle comfort systems, convenience systems, etc.). Optionally, the audio controller 844 may be configured to translate digital signals to analog signals and vice versa. As can be appreciated, the audio controller 844 may include device drivers that allow the audio controller 844 to communicate with other components of the system 800 (e.g., processors 816, 808, audio I/O 874, and the like).

The system 800 may include a profile identification module 848 to determine whether a user profile is associated with the vehicle 104. Among other things, the profile identification module 848 may receive requests from a user 216, or device 212, 228, 248, to access a profile stored in a profile database 856 or profile data 252. Additionally or alternatively, the profile identification module 848 may request profile information from a user 216 and/or a device 212, 228, 248, to access a profile stored in a profile database 856 or profile data 252. In any event, the profile identification module 848 may be configured to create, modify, retrieve, and/or store user profiles in the profile database 856 and/or profile data 252. The profile identification module 848 may include rules for profile identification, profile information retrieval, creation, modification, and/or control of components in the system 800.

By way of example, a user 216 may enter the vehicle 104 with a smart phone or other device 212. In response to determining that a user 216 is inside the vehicle 104, the profile identification module 848 may determine that a user profile is associated with the user's smart phone 212. As another example, the system 800 may receive information about a user 216 (e.g., from a camera 878, microphone 886, etc.), and, in response to receiving the user information, the profile identification module 848 may refer to the profile database 856 to determine whether the user information matches a user profile stored in the database 856. It is anticipated that the profile identification module 848 may communicate with the other components of the system to load one or more preferences, settings, and/or conditions based on the user profile. Further, the profile identification module 848 may be configured to control components of the system 800 based on user profile information.

Optionally, data storage 852 may be provided. Like the memory 832, the data storage 852 may comprise a solid state memory device or devices. Alternatively or in addition, the data storage 852 may comprise a hard disk drive or other random access memory. Similar to the data storage 852, the profile database 856 may comprise a solid state memory device or devices.

An input/output module 860 and associated ports may be included to support communications over wired networks or links, for example with other communication devices, server devices, and/or peripheral devices. Examples of an input/output module 860 include an Ethernet port, a Universal Serial Bus (USB) port, CAN Bus, Institute of Electrical and Electronics Engineers (IEEE) 1594, or other interface. Users may bring their own devices (e.g., Bring Your Own Device (BYOD), device 212, etc.) into the vehicle 104 for use with the various systems disclosed. Although most BYOD devices can connect to the vehicle systems (e.g., the media controller subsystem 348, etc.) via wireless communications protocols (e.g., Wi-Fi™, Bluetooth®, etc.) many devices may require a direct connection via USB, or similar. In any event, the input/output module 860 can provide the necessary connection of one or more devices to the vehicle systems described herein.

A video input/output interface 864 can be included to receive and transmit video signals between the various components in the system 800. Optionally, the video input/output interface 864 can operate with compressed and uncompressed video signals. The video input/output interface 864 can support high data rates associated with image capture devices. Additionally or alternatively, the video input/output interface 864 may convert analog video signals to digital signals.

The infotainment system 870 may include information media content and/or entertainment content, informational devices, entertainment devices, and the associated programming therefor. Optionally, the infotainment system 870 may be configured to handle the control of one or more components of the system 800 including, but in no way limited to, radio, streaming audio/video devices, audio devices 880, 882, 886, video devices 878, 882, travel devices (e.g., GPS, navigational systems, etc.), wireless communication devices, network devices, and the like. Further, the infotainment system 870 can provide the functionality associated with other infotainment features as provided herein.

An audio input/output interface 874 can be included to provide analog audio to an interconnected speaker 880 or other device, and to receive analog audio input from a connected microphone 886 or other device. As an example, the audio input/output interface 874 may comprise an associated amplifier and analog to digital converter. Alternatively or in addition, the devices 212, 248 can include integrated audio input/output devices 880, 886 and/or an audio jack for interconnecting an external speaker 880 or microphone 886. For example, an integrated speaker 880 and an integrated microphone 886 can be provided, to support near talk, voice commands, spoken information exchange, and/or speaker phone operations.

Among other things, the system 800 may include devices that are part of the vehicle 104 and/or part of a device 212, 248 that is associated with the vehicle 104. For instance, these devices may be configured to capture images, display images, capture sound, and present sound. Optionally, the system 800 may include at least one of image sensors/cameras 878, display devices 882, audio input devices/microphones 886, and audio output devices/speakers 880. The cameras 878 can be included for capturing still and/or video images. Alternatively or in addition, image sensors 878 can include a scanner or code reader. An image sensor/camera 878 can include or be associated with additional elements, such as a flash or other light source. In some cases, the display device 882 may include an audio input device and/or an audio output device in addition to providing video functions. For instance, the display device 882 may be a console, monitor, a tablet computing device, and/or some other mobile computing device.

FIG. 8B is a block diagram of an embodiment of a user/device interaction subsystem 817 in a vehicle system 800. The user/device interaction subsystem 817 may comprise hardware and/or software that conduct various operations for or with the vehicle 104. For instance, the user/device interaction subsystem 817 may include at least one user interaction subsystem 332 and device interaction subsystem 352 as previously described. These operations may include, but are not limited to, providing information to the user 216, receiving input from the user 216, and controlling the functions or operation of the vehicle 104, etc. Among other things, the user/device interaction subsystem 817 may include a computing system operable to conduct the operations as described herein.

Optionally, the user/device interaction subsystem 817 can include one or more of the components and modules provided herein. For instance, the user/device interaction subsystem 817 can include one or more of a video input/output interface 864, an audio input/output interface 874, a sensor module 814, a device interaction module 818, a user identification module 822, a vehicle control module 826, an environmental control module 830, and a gesture control module 834. The user/device interaction subsystem 817 may be in communication with other devices, modules, and components of the system 800 via the communications channel 356.

The user/device interaction subsystem 817 may be configured to receive input from a user 216 and/or device via one or more components of the system. By way of example, a user 216 may provide input to the user/device interaction subsystem 817 via wearable devices 802, 806, 810, video input (e.g., via at least one image sensor/camera 878, etc.) audio input (e.g., via the microphone, audio input source, etc.), gestures (e.g., via at least one image sensor 878, motion sensor 888, etc.), device input (e.g., via a device 212, 248 associated with the user, etc.), combinations thereof, and the like.

The wearable devices 802, 806, 810 can include heart rate monitors, blood pressure monitors, glucose monitors, pedometers, movement sensors, wearable computers, and the like. Examples of wearable computers may be worn by a user 216 and configured to measure user activity, determine energy spent based on the measured activity, track user sleep habits, determine user oxygen levels, monitor heart rate, provide alarm functions, and more. It is anticipated that the wearable devices 802, 806, 810 can communicate with the user/device interaction subsystem 817 via wireless communications channels or direct connection (e.g., where the device docks, or connects, with a USB port or similar interface of the vehicle 104).

A sensor module 814 may be configured to receive and/or interpret input provided by one or more sensors in the vehicle 104. In some cases, the sensors may be associated with one or more user devices (e.g., wearable devices 802, 806, 810, smart phones 212, mobile computing devices 212, 248, and the like). Optionally, the sensors may be associated with the vehicle 104, as described in conjunction with FIGS. 6A-7B.

The device interaction module 818 may communicate with the various devices as provided herein. Optionally, the device interaction module 818 can provide content, information, data, and/or media associated with the various subsystems of the vehicle system 800 to one or more devices 212, 248, 802, 806, 810, 882, etc. Additionally or alternatively, the device interaction module 818 may receive content, information, data, and/or media associated with the various devices provided herein.

The user identification module 822 may be configured to identify a user 216 associated with the vehicle 104. The identification may be based on user profile information that is stored in profile data 252. For instance, the user identification module 822 may receive characteristic information about a user 216 via a device, a camera, and/or some other input. The received characteristics may be compared to data stored in the profile data 252. Where the characteristics match, the user 216 is identified. As can be appreciated, where the characteristics do not match a user profile, the user identification module 822 may communicate with other subsystems in the vehicle 104 to obtain and/or record profile information about the user 216. This information may be stored in a memory and/or the profile data storage 252.

The vehicle control module 826 may be configured to control settings, features, and/or the functionality of a vehicle 104. In some cases, the vehicle control module 826 can communicate with the vehicle control system 204 to control critical functions (e.g., driving system controls, braking, accelerating, etc.) and/or noncritical functions (e.g., driving signals, indicator/hazard lights, mirror controls, window actuation, etc.) based at least partially on user/device input received by the user/device interaction subsystem 817.

The environmental control module 830 may be configured to control settings, features, and/or other conditions associated with the environment, especially the interior environment, of a vehicle 104. Optionally, the environmental control module 830 may communicate with the climate control system (e.g. changing cabin temperatures, fan speeds, air direction, etc.), oxygen and/or air quality control system (e.g., increase/decrease oxygen in the environment, etc.), interior lighting (e.g., changing intensity of lighting, color of lighting, etc.), an occupant seating system 648 (e.g., adjusting seat position, firmness, height, etc.), steering wheel 640 (e.g., position adjustment, etc.), infotainment/entertainment system (e.g., adjust volume levels, display intensity adjustment, change content, etc.), and/or other systems associated with the vehicle environment. Additionally or alternatively, these systems can provide input, set-points, and/or responses, to the environmental control module 830. As can be appreciated, the environmental control module 830 may control the environment based at least partially on user/device input received by the user/device interaction subsystem 817.

The gesture control module 834 is configured to interpret gestures provided by a user 216 in the vehicle 104. Optionally, the gesture control module 834 may provide control signals to one or more of the vehicle systems 300 disclosed herein. For example, a user 216 may provide gestures to control the environment, critical and/or noncritical vehicle functions, the infotainment system, communications, networking, and more. Optionally, gestures may be provided by a user 216 and detected via one or more of the sensors as described in conjunction with FIGS. 6B-7A. As another example, one or more motion sensors 888 may receive gesture input from a user 216 and provide the gesture input to the gesture control module 834. Continuing this example, the gesture input is interpreted by the gesture control module 834. This interpretation may include comparing the gesture input to gestures stored in a memory. The gestures stored in memory may include one or more functions and/or controls mapped to specific gestures. When a match is determined between the detected gesture input and the stored gesture information, the gesture control module 834 can provide a control signal to any of the systems/subsystems as disclosed herein.

FIG. 8C illustrates a GPS/Navigation subsystem(s) 336. The Navigation subsystem(s) 336 can be any present or future-built navigation system that may use location data, for example, from the Global Positioning System (GPS), to provide navigation information or control the vehicle 104. The Navigation subsystem(s) 336 can include several components or modules, such as, one or more of, but not limited to, a GPS Antenna/receiver 892, a location module 896, a maps database 8100, an automobile controller 8104, a vehicle systems transceiver 8108, a traffic controller 8112, a network traffic transceiver 8116, a vehicle-to-vehicle transceiver 8120, a traffic information database 8124, etc. Generally, the several components or modules 892-8124 may be hardware, software, firmware, computer readable media, or combinations thereof.

A GPS Antenna/receiver 892 can be any antenna, GPS puck, and/or receiver capable of receiving signals from a GPS satellite or other navigation system, as mentioned hereinbefore. The signals may be demodulated, converted, interpreted, etc. by the GPS Antenna/receiver 892 and provided to the location module 896. Thus, the GPS Antenna/receiver 892 may convert the time signals from the GPS system and provide a location (e.g., coordinates on a map) to the location module 896. Alternatively, the location module 896 can interpret the time signals into coordinates or other location information.

The location module 896 can be the controller of the satellite navigation system designed for use in automobiles. The location module 896 can acquire position data, as from the GPS Antenna/receiver 892, to locate the user or vehicle 104 on a road in the unit's map database 8100. Using the road database 8100, the location module 896 can give directions to other locations along roads also in the database 8100. When a GPS signal is not available, the location module 896 may apply dead reckoning to estimate distance data from sensors 242 including one or more of, but not limited to, a speed sensor attached to the drive train of the vehicle 104, a gyroscope, an accelerometer, etc. GPS signal loss and/or multipath can occur due to urban canyons, tunnels, and other obstructions. Additionally or alternatively, the location module 896 may use known locations of Wi-Fi hotspots, cell tower data, etc. to determine the position of the vehicle 104, such as by using time difference of arrival (TDOA) and/or frequency difference of arrival (FDOA) techniques.

The maps database 8100 can include any hardware and/or software to store information about maps, geographical information system information, location information, etc. The maps database 8100 can include any data definition or other structure to store the information. Generally, the maps database 8100 can include a road database that may include one or more vector maps of areas of interest. Street names, street numbers, house numbers, and other information can be encoded as geographic coordinates so that the user can find some desired destination by street address. Points of interest (waypoints) can also be stored with their geographic coordinates. For example, a point of interest may include speed cameras, fuel stations, public parking, and “parked here” (or “you parked here”) information. The map database contents can be produced or updated by a server connected through a wireless system in communication with the Internet, even as the vehicle 104 is driven along existing streets, yielding an up-to-date map.

An automobile controller 8104 can be any hardware and/or software that can receive instructions from the location module 896 or the traffic controller 8112 and operate the vehicle 104. The automobile controller 8104 receives this information and data from the sensors 242 to operate the vehicle 104 without driver input. Thus, the automobile controller 8104 can drive the vehicle 104 along a route provided by the location module 896. The route may be adjusted by information sent from the traffic controller 8112. Discrete and real-time driving can occur with data from the sensors 242. To operate the vehicle 104, the automobile controller 8104 can communicate with a vehicle systems transceiver 8108.

The vehicle systems transceiver 8108 can be any present or future-developed device that can comprise a transmitter and/or a receiver, which may be combined and can share common circuitry or a single housing. The vehicle systems transceiver 8108 may communicate or instruct one or more of the vehicle control subsystems 328. For example, the vehicle systems transceiver 8108 may send steering commands, as received from the automobile controller 8104, to an electronic steering system, to adjust the steering of the vehicle 100 in real time. The automobile controller 8104 can determine the effect of the commands based on received sensor data 242 and can adjust the commands as need be. The vehicle systems transceiver 8108 can also communicate with the braking system, the engine and drive train to speed or slow the car, the signals (e.g., turn signals and brake lights), the headlights, the windshield wipers, etc. Any of these communications may occur over the components or function as described in conjunction with FIG. 4.

A traffic controller 8112 can be any hardware and/or software that can communicate with an automated traffic system and adjust the function of the vehicle 104 based on instructions from the automated traffic system. An automated traffic system is a system that manages the traffic in a given area. This automated traffic system can instruct cars to drive in certain lanes, instruct cars to raise or lower their speed, instruct a car to change their route of travel, instruct cars to communicate with other cars, etc. To perform these functions, the traffic controller 8112 may register the vehicle 104 with the automated traffic system and then provide other information including the route of travel. The automated traffic system can return registration information and any required instructions. The communications between the automated traffic system and the traffic controller 8112 may be received and sent through a network traffic transceiver 8116.

The network traffic transceiver 8116 can be any present or future-developed device that can comprise a transmitter and/or a receiver, which may be combined and can share common circuitry or a single housing. The network traffic transceiver 8116 may communicate with the automated traffic system using any known or future-developed, protocol, standard, frequency, bandwidth range, etc. The network traffic transceiver 8116 enables the sending of information between the traffic controller 8112 and the automated traffic system.

The traffic controller 8112 can also communicate with another vehicle, which may be in physical proximity (i.e., within range of a wireless signal), using the vehicle-to-vehicle transceiver 8120. As with the network traffic transceiver 8116, the vehicle-to-vehicle transceiver 8120 can be any present or future-developed device that can comprise a transmitter and/or a receiver, which may be combined and can share common circuitry or a single housing. Generally, the vehicle-to-vehicle transceiver 8120 enables communication between the vehicle 104 and any other vehicle. These communications allow the vehicle 104 to receive traffic or safety information, control or be controlled by another vehicle, establish an alternative communication path to communicate with the automated traffic system, establish a node including two or more vehicle that can function as a unit, etc. The vehicle-to-vehicle transceiver 8120 may communicate with the other vehicles using any known or future-developed, protocol standard, frequency, bandwidth range, etc.

The traffic controller 8112 can control functions of the automobile controller 8104 and communicate with the location module 896. The location module 896 can provide current location information and route information that the traffic controller 8112 may then provide to the automated traffic system. The traffic controller 8112 may receive route adjustments from the automated traffic system that are then sent to the location module 896 to change the route. Further, the traffic controller 8112 can also send driving instructions to the automobile controller 8104 to change the driving characteristics of the vehicle 104. For example, the traffic controller 8112 can instruct the automobile controller 8104 to accelerate or decelerate to a different speed, change lanes, or perform another driving maneuver. The traffic controller 8112 can also manage vehicle-to-vehicle communications and store information about the communications or other information in the traffic information database 8124.

The traffic information database 8124 can be any type of database, such as relational, hierarchical, object-oriented, and/or the like. The traffic information database 8124 may reside on a storage medium local to (and/or resident in) the vehicle control system 204 or in the vehicle 104. The traffic information database 8124 may be adapted to store, update, and retrieve information about communications with other vehicles or any active instructions from the automated traffic system. This information may be used by the traffic controller 8112 to instruct or adjust the performance of driving maneuvers.

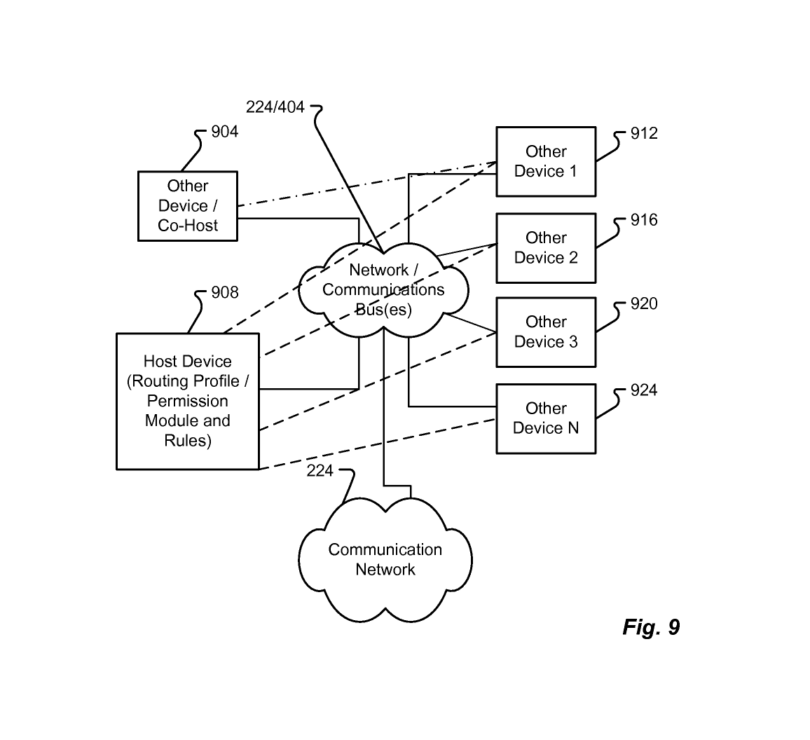

FIG. 9 illustrates an optional communications architecture where, the host device 908 may include one more routing profiles, permission modules, and rules that control how communications within the vehicle 104 are to occur. This communications architecture can be used in conjunction with the routing tables, rules and permissions associated with access point 456 and optional firewall 484, or can be in lieu thereof. For example, the host device 908 acts as a mobile hot spot to one or more other devices within vehicle 104, such as, other device 1 912, other device 2 916, other device 3 920, and other device N 924. Optionally, one or more of the other devices 912 can communicate directly with the host device 908 which then provides Internet access to those devices 912 via the device 908. The host device 908 can act as a mobile hot spot for any one or more of the other devices 912, which may not need to communicate over the network/communications buses 224/404, but could instead connect directly to the host device 908 via, for example, NFC, Bluetooth®, WiFi, or the like. When the device 908 is acting as the host device, the device 908 can include one or more routing profiles, permissions, rules modules, and can also act as a firewall for the various inter and intra vehicle communications.

As will be appreciated, there could be alternative host devices, such as, host 904 which could also act as, for example, a co-host in association with device 908. Optionally, one or more of the routing profile, permission information, and rules could be shared between the co-host devices 904, 908, both of those devices being usable for Internet access for one or more of the other devices, 912-924. As will be appreciated, the other devices 912-924 need not necessarily connect to one or more of host device 908 and the other device 904 via a direct communications link, but could also interface with those devices 904, 908 utilizing the network/communications buses 224/404 associated with the vehicle 100. As previously discussed, one or more of the other devices can connect to the network/communications buses 224/404 utilizing the various networks and/or buses discussed herein which would therefore enable, for example, regulation of the various communications based on the Ethernet zone that the other device 912 is associated with.

An embodiment of one or more modules that may be associated with the vehicle control system 204 may be as shown in FIG. 10. The modules can include a communication subsystem interface 1008 in communication with an operating system 1004. The communications may pass through a firewall 1044. The firewall 1044 can be any software that can control the incoming and outgoing communications by analyzing the data packets and determining whether the packets should be allowed through the firewall, based on applied rule set. A firewall 1044 can establish a “barrier” between a trusted, secure internal network and another network (e.g., the Internet) that is not assumed to be secure and trusted.

In some situations, the firewall 1044 may establish security zones that are implemented by running system services and/or applications in restricted user groups and accounts. A set of configuration files and callbacks may then be linked to an IP table firewall. The IP table firewall can be configured to notify a custom filter application at any of the layers of the Ethernet packet. The different users/group rights to access the system may include: system users, which may have exclusive right over all device firewall rules and running software; a big-brother user, which may have access to on board device (OBD) control data and may be able to communicate with the vehicle subsystem 328 and may be able to alter the parameters in the vehicle control system 204; a dealer user, which can have rights to read OBD data for diagnostics and repairs; a dashboard user, which can have rights to launch dashboard applications and/or authenticate guest users and change their permissions to trusted/friend/family, and can read but cannot write into OBD diagnostic data; a world wide web (WWW) data user, which can have HTTP rights to respond to HTTP requests (the HTTP requests also can target different user data, but may be filtered by default user accounts); a guest user, which may have no rights; a family/friend user, which may have rights to play media from the media subsystem 348 and/or to stream media to the media subsystem 348.

The operating system 1004 can be a collection of software that manages computer hardware resources and provides common services for applications and other programs. The operating system 1004 may schedule time-sharing for efficient use of the system. For hardware functions, such as input, output, and memory allocation, the operating system 1004 can act as an intermediary between applications or programs and the computer hardware. Examples of operating systems that may be deployed as operating system 1004 include Android, BSD, iOS, Linux, OS X, QNX, Microsoft Windows, Windows Phone, IBM z/OS, etc.

The operating system 1004 can include one or more sub-modules. For example, a desktop manager 1012 can manage one or more graphical user interfaces (GUI) in a desktop environment. Desktop GUIs can help the user to easily access and edit files. A command-line interface (CLI) may be used if full control over the operating system (OS) 1004 is required. The desktop manager 1012 is described further hereinafter.

A kernel 1028 can be a computer program that manages input/output requests from software and translates them into data processing instructions for the processor 304 and other components of the vehicle control system 204. The kernel 1028 is the fundamental component of the operating system 1004 that can execute many of the functions associated with the OS 1004.

The kernel 1028 can include other software functions, including, but not limited to, driver(s) 1056, communication software 1052, and/or Internet Protocol software 1048. A driver 1056 can be any computer program that operates or controls a particular type of device that is attached to a vehicle control system 204. A driver 1056 can communicate with the device through the bus 356 or communications subsystem 1008 to which the hardware connects. When a calling program invokes a routine in the driver 1056, the driver 1056 may issue one or more commands to the device. Once the device sends data back to the driver 1056, the driver 1056 may invoke routines in the original calling program. Drivers can be hardware-dependent and operating-system-specific. Driver(s) 1056 can provide the interrupt handling required for any necessary asynchronous time-dependent hardware interface.

The IP module 1048 can conduct any IP addressing, which may include the assignment of IP addresses and associated parameters to host interfaces. The address space may include networks and sub-networks. The IP module 1048 can perform the designation of network or routing prefixes and may conduct IP routing, which transports packets across network boundaries. Thus, the IP module 1048 may perform all functions required for IP multicast operations.

The communications module 1052 may conduct all functions for communicating over other systems or using other protocols not serviced by the IP module 1048. Thus, the communications module 1052 can manage multicast operations over other busses or networks not serviced by the IP module 1048. Further, the communications module 1052 may perform or manage communications to one or more devices, systems, data stores, services, etc. that are in communication with the vehicle control system 204 or other subsystems through the firewall 1044. Thus, the communications module 1052 can conduct communications through the communication subsystem interface 1008.

A file system 1016 may be any data handling software that can control how data is stored and retrieved. The file system 1016 can separate the stored data into individual pieces, and giving each piece a name, can easily separate and identify the pieces of data. Each piece of data may be considered a “file”. The file system 1016 can construct data structure and logic rules used to manage the information and the identifiers for the information. The structure and logic rules can be considered a “file system.”

A device discovery daemon 1020 may be a computer program that runs as a background process that can discover new devices that connect with the network 356 or communication subsystem 1008 or devices that disconnect from the network 356 or communication subsystem 1008. The device discovery daemon 1020 can ping the network 356 (the local subnet) when the vehicle 104 starts, when a vehicle door opens or closes, or upon the occurrence of other events. Additionally or alternatively, the device discovery daemon 1020 may force Bluetooth®, USB, and/or wireless detection. For each device that responds to the ping, the device discovery daemon 1020 can populate the system data 208 with device information and capabilities, using any of one or more protocols, including one or more of, but not limited to, IPv6 Hop-by-Hop Option (HOPOPT), Internet Control Message Protocol (ICMP), Internet Group Management Protocol (IGMP), Gateway-to-Gateway Protocol (GGP), Internet Protocol (IP), Internet Stream Protocol (ST), Transmission Control Protocol (TCP), Exterior Gateway Protocol (EGP), CHAOS, User Datagram Protocol (UDP), etc.

For example, the device discovery daemon 1020 can determine device capabilities based on the opened ports the device exposes. If a camera exposes port 80, then the device discovery daemon 1020 can determine that the camera is using a Hypertext Transfer Protocol (HTTP). Alternatively, if a device is supporting Universal Plug and Play (UPnP), the system data 208 can include more information, for example, a camera control universal resource locator (URL), a camera zoom URL, etc. When a scan stops, the device discovery daemon 1020 can trigger a dashboard refresh to ensure the user interface reflects the new devices on the desktop.

A desktop manager 1012 may be a computer program that manages the user interface of the vehicle control system 204. The desktop environment may be designed to be customizable and allow the definition of the desktop configuration look-and-feel for a wide range of appliances or devices from computer desktops, mobile devices, computer tablets, etc. Launcher(s), panels, desktop areas, the desktop background, notifications, panes, etc., can be configured from a dashboard configuration file managed by the desktop manager 1012. The graphical elements in which the desktop manager 1012 controls can include launchers, the desktop, notification bars, etc.

The desktop may be an area of the display where the applications are running. The desktop can have a custom background. Further, the desktop may be divided into two or more areas. For example, the desktop may be divided into an upper half of a display and a lower half of the display. Each application can be configured to run in a portion of the desktop. Extended settings can be added to the desktop configuration file, such that, some objects may be displayed over the whole desktop or in custom size out of the context of the divided areas.

The notification bar may be a part of a bar display system, which may provide notifications by displaying, for example, icons and/or pop-up windows that may be associated with sound notifications. The notification mechanism can be designed for separate plug-ins, which run in separate processes and may subscribe to a system Intelligent Input Bus (IBUS)/D-BUS event service. The icons on the notifications bar can be accompanied with application short-cuts to associated applications, for example, a Bluetooth® manager, a USB manager, radio volume and or tone control, a security firewall, etc.

The desktop manager 1012 may include a windows manager 1032, an application launcher 1036, and/or a panel launcher 1040. Each of these components can control a different aspect of the user interface. The desktop manager 1012 can use a root window to create panels that can include functionality for one or more of, but not limited to: launching applications, managing applications, providing notifications, etc.

The windows manager 1032 may be software that controls the placement and appearance of windows within a graphical user interface presented to the user. Generally, the windows manager 1032 can provide the desktop environment used by the vehicle control system 204. The windows manager 1032 can communicate with the kernel 1028 to interface with the graphical system that provides the user interface(s) and supports the graphics hardware, pointing devices, keyboard, touch-sensitive screens, etc. The windows manager 1032 may be a tiling window manager (i.e., a window manager with an organization of the screen into mutually non-overlapping frames, as opposed to a coordinate-based stacking of overlapping objects (windows) that attempts to fully emulate the desktop metaphor). The windows manager 1032 may read and store configuration files, in the system data 208, which can control the position of the application windows at precise positions.

An application manager 1036 can control the function of any application over the lifetime of the process. The process or application can be launched from a panel launcher 1040 or from a remote console. The application manager 1036 can intercept the process name and may take appropriate action to manage that process. If the process is not running, the application manager 1036 can load the process and may bring the process to a foreground in a display. The application manager 1036 may also notify the windows manager 1032 to bring the associated window(s) to a top of a window stack for the display. When a process starts from a shell or a notification out of the context of the desktop, the application manager 1036 can scan files to match the process name with the entry name provided. When a match is found, the application manager 1036 can configure the process according to a settings file.

In some situations, the application manager 1036 may restrict an application as singleton (i.e., restricts the instantiation of a class to one object). If an application is already running and the application manager 1036 is asked to run the application again, the application manager 1036 can bring the running process to a foreground on a display. There can be a notification event exchange between the windows manager 1032 and the application manager 1036 for activating the appropriate window for the foreground process. Once an application is launched, the application may not be terminated or killed. The application can be sent to the background, except, possibly, for some applications (e.g., media player, Bluetooth®, notifications, etc.), which may be given a lowest process priority.

The panel launcher 1040 can be a widget configured to be placed along a portion of the display. The panel launcher 1040 may be built from desktop files from a desktop folder. The desktop folder location can be configured by a configuration file stored in system data 208. The panel launcher 1040 can allow for the launching or executing of applications or processes by receiving inputs from a user interface to launch programs.

A desktop plugin 1024 may be a software component that allows for customization of the desktop or software interface through the initiation of plug-in applications.

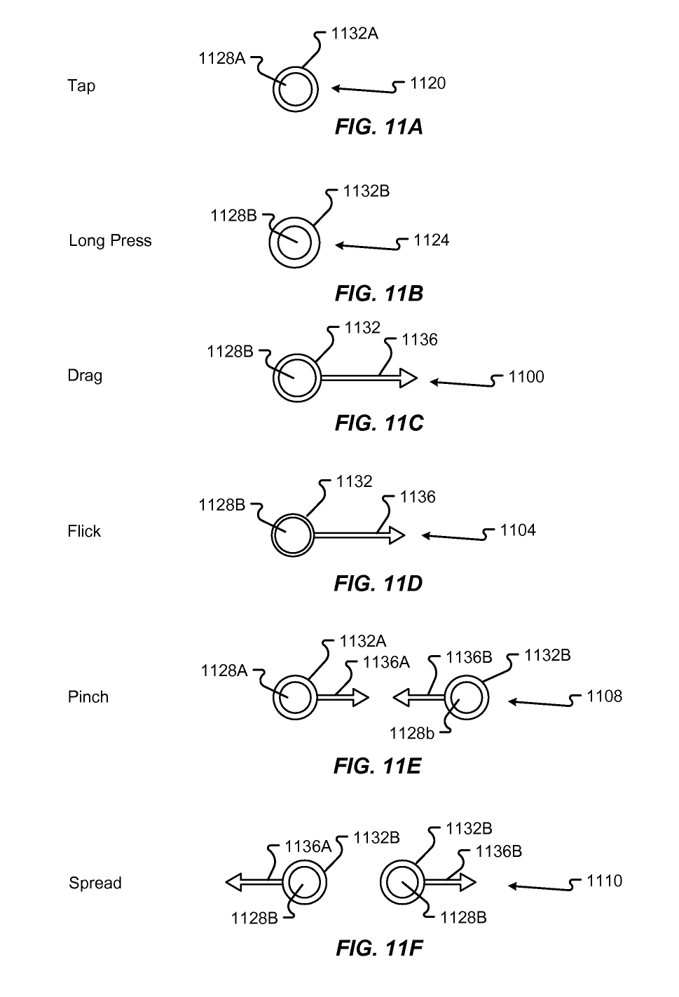

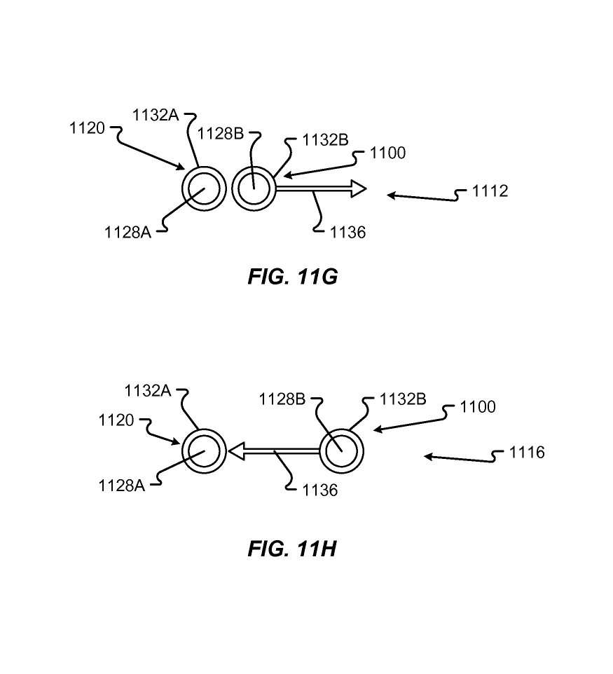

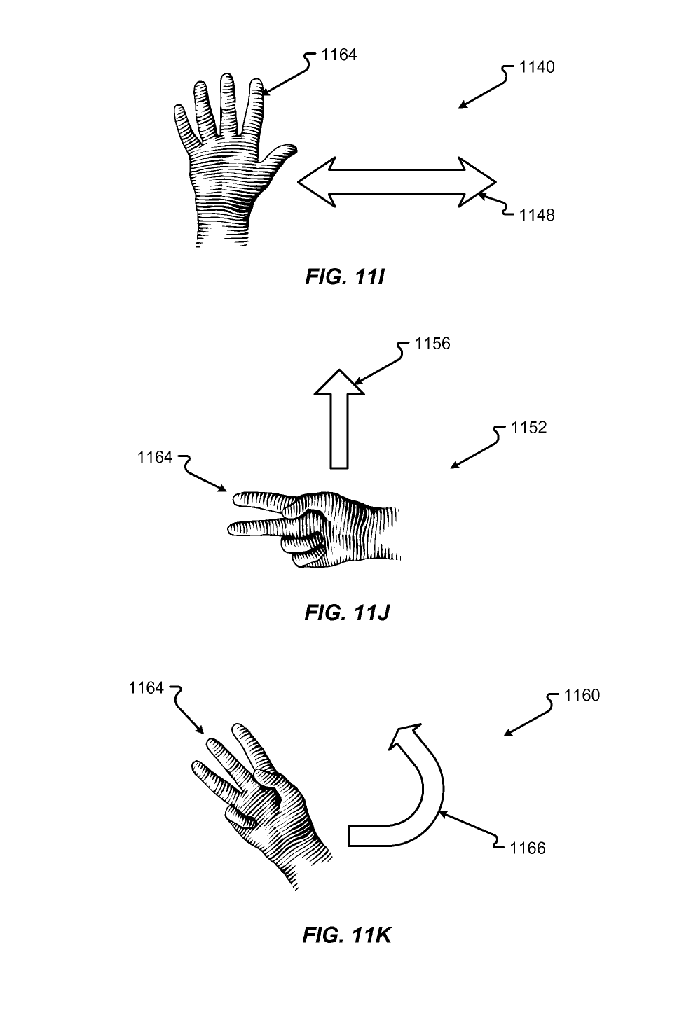

One or more gestures used to interface with the vehicle control system 204 may be as described in conjunction with FIG. 11A through 11K. FIGS. 11A through 11H depict various graphical representations of gesture inputs that may be recognized by the devices 212, 248. The gestures may be performed not only by a user's body part, such as a digit, but also by other devices, such as a stylus, that may be sensed by the contact sensing portion(s) of a screen associated with the device 212, 248. In general, gestures are interpreted differently, based on where the gestures are performed (either directly on a display or in a gesture capture region). For example, gestures in a display may be directed to a desktop or application, and gestures in a gesture capture region may be interpreted as for the system.

With reference to FIGS. 11A-11H, a first type of gesture, a touch gesture 1120, is substantially stationary on a portion (e.g., a screen, a display, etc.) of a device 212, 248 for a selected length of time. A circle 1128 represents a touch or other contact type received at particular location of a contact sensing portion of the screen. The circle 1128 may include a border 1132, the thickness of which indicates a length of time that the contact is held substantially stationary at the contact location. For instance, a tap 1120 (or short press) has a thinner border 1132A than the border 1132B for a long press 1124 (or for a normal press). The long press 1124 may involve a contact that remains substantially stationary on the screen for longer time period than that of a tap 1120. As will be appreciated, differently defined gestures may be registered depending upon the length of time that the touch remains stationary prior to contact cessation or movement on the screen.

With reference to FIG. 11C, a drag gesture 1100 on the screen is an initial contact (represented by circle 1128) with contact movement 1136 in a selected direction. The initial contact 1128 may remain stationary on the screen for a certain amount of time represented by the border 1132. The drag gesture typically requires the user to contact an icon, window, or other displayed image at a first location followed by movement of the contact in a drag direction to a new second location desired for the selected displayed image. The contact movement need not be in a straight line but have any path of movement so long as the contact is substantially continuous from the first to the second locations.

With reference to FIG. 11D, a flick gesture 1104 on the screen is an initial contact (represented by circle 1128) with truncated contact movement 1136 (relative to a drag gesture) in a selected direction. A flick may have a higher exit velocity for the last movement in the gesture compared to the drag gesture. The flick gesture can, for instance, be a finger snap following initial contact. Compared to a drag gesture, a flick gesture generally does not require continual contact with the screen from the first location of a displayed image to a predetermined second location. The contacted displayed image is moved by the flick gesture in the direction of the flick gesture to the predetermined second location. Although both gestures commonly can move a displayed image from a first location to a second location, the temporal duration and distance of travel of the contact on the screen is generally less for a flick than for a drag gesture.

With reference to FIG. 11E, a pinch gesture 1108 on the screen is depicted. The pinch gesture 1108 may be initiated by a first contact 1128A to the screen by, for example, a first digit and a second contact 1128B to the screen by, for example, a second digit. The first and second contacts 1128A,B may be detected by a common contact sensing portion of a common screen, by different contact sensing portions of a common screen, or by different contact sensing portions of different screens. The first contact 1128A is held for a first amount of time, as represented by the border 1132A, and the second contact 1128B is held for a second amount of time, as represented by the border 1132B. The first and second amounts of time are generally substantially the same, and the first and second contacts 1128A,B generally occur substantially simultaneously. The first and second contacts 1128A,B generally also include corresponding first and second contact movements 1136A,B, respectively. The first and second contact movements 1136A,B are generally in opposing directions. Stated another way, the first contact movement 1136A is towards the second contact 1136B, and the second contact movement 1136B is towards the first contact 1136A. More simply stated, the pinch gesture 1108 may be accomplished by a user's digits touching the screen in a pinching motion.

With reference to FIG. 11F, a spread gesture 1110 on the screen is depicted. The spread gesture 1110 may be initiated by a first contact 1128A to the screen by, for example, a first digit, and a second contact 1128B to the screen by, for example, a second digit. The first and second contacts 1128A,B may be detected by a common contact sensing portion of a common screen, by different contact sensing portions of a common screen, or by different contact sensing portions of different screens. The first contact 1128A is held for a first amount of time, as represented by the border 1132A, and the second contact 1128B is held for a second amount of time, as represented by the border 1132B. The first and second amounts of time are generally substantially the same, and the first and second contacts 1128A,B generally occur substantially simultaneously. The first and second contacts 1128A,B generally also include corresponding first and second contact movements 1136A,B, respectively. The first and second contact movements 1136A,B are generally in an opposing direction. Stated another way, the first and second contact movements 1136A,B are away from the first and second contacts 1128A,B. More simply stated, the spread gesture 1110 may be accomplished by a user's digits touching the screen in a spreading motion.

The above gestures may be combined in any manner, such as those shown by FIGS. 11G and 11H, to produce a determined functional result. For example, in FIG. 11G a tap gesture 1120 is combined with a drag or flick gesture 1112 in a direction away from the tap gesture 1120. In FIG. 11H, a tap gesture 1120 is combined with a drag or flick gesture 1116 in a direction towards the tap gesture 1120.

The functional result of receiving a gesture can vary depending on a number of factors, including a state of the vehicle 104, display, or screen of a device, a context associated with the gesture, or sensed location of the gesture, etc. The state of the vehicle 104 commonly refers to one or more of a configuration of the vehicle 104, a display orientation, and user and other inputs received by the vehicle 104. Context commonly refers to one or more of the particular application(s) selected by the gesture and the portion(s) of the application currently executing, whether the application is a single- or multi-screen application, and whether the application is a multi-screen application displaying one or more windows. A sensed location of the gesture commonly refers to whether the sensed set(s) of gesture location coordinates are on a touch sensitive display or a gesture capture region of a device 212, 248, whether the sensed set(s) of gesture location coordinates are associated with a common or different display, or screen, or device 212, 248, and/or what portion of the gesture capture region contains the sensed set(s) of gesture location coordinates.

A tap, when received by a touch sensitive display of a device 212, 248, can be used, for instance, to select an icon to initiate or terminate execution of a corresponding application, to maximize or minimize a window, to reorder windows in a stack, and/or to provide user input such as by keyboard display or other displayed image. A drag, when received by a touch sensitive display of a device 212, 248, can be used, for instance, to relocate an icon or window to a desired location within a display, to reorder a stack on a display, or to span both displays (such that the selected window occupies a portion of each display simultaneously). A flick, when received by a touch sensitive display of a device 212, 248 or a gesture capture region, can be used to relocate a window from a first display to a second display or to span both displays (such that the selected window occupies a portion of each display simultaneously). Unlike the drag gesture, however, the flick gesture is generally not used to move the displayed image to a specific user-selected location but to a default location that is not configurable by the user.

The pinch gesture, when received by a touch sensitive display or a gesture capture region of a device 212, 248, can be used to minimize or otherwise increase the displayed area or size of a window (typically when received entirely by a common display), to switch windows displayed at the top of the stack on each display to the top of the stack of the other display (typically when received by different displays or screens), or to display an application manager (a “pop-up window” that displays the windows in the stack). The spread gesture, when received by a touch sensitive display or a gesture capture region of a device 212, 248, can be used to maximize or otherwise decrease the displayed area or size of a window, to switch windows displayed at the top of the stack on each display to the top of the stack of the other display (typically when received by different displays or screens), or to display an application manager (typically when received by an off-screen gesture capture region on the same or different screens).

The combined gestures of FIG. 11G, when received by a common display capture region in a common display or screen of a device 212, 248, can be used to hold a first window location constant for a display receiving the gesture while reordering a second window location to include a window in the display receiving the gesture. The combined gestures of FIG. 11H, when received by different display capture regions in a common display or screen of a device 212, 248 or in different displays or screens of one more devices 212, 248, can be used to hold a first window location for a display receiving the tap part of the gesture while reordering a second window location to include a window in the display receiving the flick or drag gesture. Although specific gestures and gesture capture regions in the preceding examples have been associated with corresponding sets of functional results, it is to be appreciated that these associations can be redefined in any manner to produce differing associations between gestures and/or gesture capture regions and/or functional results.

Gestures that may be completed in three-dimensional space and not on a touch sensitive screen or gesture capture region of a device 212, 248 may be as shown in FIGS. 11I-11K. The gestures may be completed in an area where a sensor, such as an optical sensor, infrared sensor, or other type of sensor, may detect the gesture. For example, the gesture 1140 in FIG. 11I may be executed by a person when the person opens their hand 1164 and moves their hand in a back and forth direction 1148 as a gesture 1140 to complete some function with the vehicle 104. For example gesture 1140 may change the station of the radio in the vehicle 104. The sensors 242 may both determine the configuration of the hand 1164 and the vector of the movement. The vector and hand configuration can be interpreted to mean certain things to the vehicle control system 204 and produce different results.

In another example of a gesture 1152 in FIG. 11J, a user may configure their hand 1164 to extend two fingers and move the hand 1164 in an up and down operation 1156. This gesture 1152 may control the volume of the radio or some other function. For instance, this gesture 1152 may be configured to place the vehicle in a “valet” mode to, among other things, restrict access to certain features associated with the vehicle. Again, the sensors 242 may determine how the person has configured their hand 1164, and the vector of the movement. In another example of a gesture 1160 shown in FIG. 11K, a user may extend their middle three fingers at an angle that is substantially 45° for vertical from straight vertical and circle the hand in a counter-clockwise motion 1166. This gesture 1160 may cause the automobile to change the heat setting or do some other function. As can be understood by one skilled in the art, the configurations of the hand and the types of movement are variable. Thus, the user may configure the hand 1164 in any way imaginable and may also move that hand 1164 in any direction with any vector in three-dimensional space.

The gestures 1140, 1152, 1160, as shown in FIGS. 11I-11K, may occur in a predetermined volume of space within the vehicle 104. For example, a sensor may be configured to identify such gestures 1140, 1152, 1160 between the front passenger's and front driver's seats over a console area within the passenger compartment of the vehicle 104. The gestures 1140, 1152, 1160 may be made within area 1 508A between zones A 512A and B 512B. However, there may be other areas 508 where a user may use certain gestures, where sensors 242 may be able to determine a certain function is desired. Gestures that may be similar but used in different areas within the vehicle 104 may cause different functions to be performed. For example, the gesture 1140 in FIG. 11I, if used in zone E 512E, may change the heat provided in zone E 512E, but may change the station of a radio if used in zone A 512A and/or zone B 512B. Further, the gestures may be made with other body parts or, for example, different expressions of a person's face and may be used to control functions in the vehicle 104. Also, the user may use two hands in some circumstances or do other types of physical movements that can cause different reactions in the vehicle 104.

FIGS. 12A-12D show various embodiments of a data structure 1200 to store different settings. The data structure 1200 may include one or more of data files or data objects 1204, 1250, 1270, 1280. Thus, the data structure 1200 may represent different types of databases or data storage, for example, object-oriented data bases, flat file data structures, relational database, or other types of data storage arrangements. Embodiments of the data structure 1200 disclosed herein may be separate, combined, and/or distributed. As indicated in FIGS. 12A-12D, there may be more or fewer portions in the data structure 1200, as represented by ellipses 1244. Further, there may be more or fewer files in the data structure 1200, as represented by ellipses 1248.

Referring to FIG. 12A, a first data structure is shown. The data file 1204 may include several portions 1208-1242 representing different types of data. Each of these types of data may be associated with a user, as shown in portion 1208.

There may be one or more user records 1240 and associated data stored within the data file 1204. As provided herein, the user can be any person that uses or rides within the vehicle or conveyance 104. The user may be identified in portion 1212. For the vehicle 104, the user may include a set of one or more features that may identify the user. These features may be the physical characteristics of the person that may be identified by facial recognition or some other type of system. In other situations, the user may provide a unique code to the vehicle control system 204 or provide some other type of data that allows the vehicle control system 204 to identify the user. The features or characteristics of the user are then stored in portion 1212.

Each user, identified in portion 1208, may have a different set of settings for each area 508 and/or each zone 512 within the vehicle 104. Thus, each set of settings may also be associated with a predetermined zone 512 or area 508. The zone 512 is stored in portion 1220, and the area 508 is stored in portion 1216.

One or more settings may be stored in portion 1224. These settings 1224 may be the configurations of different functions within the vehicle 104 that are specified by or for that user. For example, the settings 1224 may be the position of a seat, the position of a steering wheel, the position of accelerator and/or brake pedals, positions of mirrors, a heating/cooling setting, a radio setting, a cruise control setting, or some other type of setting associated with the vehicle 104. Further, in vehicles adapted to have a configurable console or a configurable dash or heads-up display, the settings 1224 may also provide for how that heads-up display, dash, or console are configured for this particular user.

Each setting 1224 may be associated with a different area 508 or zone 512. Thus, there may be more settings 1224 for when the user is the driver and in zone A 512A, 512A, of area 1, 508A. However, there may be similar settings 1224 among the different zones 512 or areas 508 as shown in portion 1224. For example, the heating or radio settings for the user may be similar in every zone 512.

The sensors 242 within the vehicle 104 may be able to either obtain or track health data in portion 1228. Health data 1228 may include any type of physical characteristic associated with the user. For example, a heart rate, a blood pressure, a temperature, or other types of heath data may be obtained and stored in portion 1228. The user may have this health data tracked over a period of time to allow for statistical analysis of the user's health while operating the vehicle 104. In this way, if some function of the user's health deviates from a norm (e.g., a baseline measurement, average measurements taken over time, and the like), the vehicle 104 may be able to determine there is a problem with the person and react to that data.

One or more gestures may be stored in portion 1232. Thus, the gestures used and described in conjunction FIG. 11A through 11K may be configurable. These gestures may be determined or created by the user and stored in portion 1132. A user may have different gestures for each zone 512 or area 508 within the vehicle. The gestures that do certain things while driving may do other things while in a different area 508 of the vehicle 104. Thus, the user may use a first set of gestures while driving and a second set while a passenger. Further, one or more users may share gestures as shown in portion 1232. Each driver may have a common set of gestures that they use in zone A 512A, 512A. Each of these gestures may be determined or captured and then stored with their characteristics (e.g., vector, position of gesture, etc.) in portion 1232.

One or more sets of safety parameters may be stored in portion 1236. Safety parameters 1236 may be common operating characteristics for this driver/passenger or for all drivers/passengers that if deviated from may determine there is a problem with the driver/passenger or the vehicle 104. For example, a certain route may be taken repeatedly and an average speed or mean speed may be determined. If the mean speed deviates by some number of standard deviations, a problem with the vehicle 104 or the user may be determined. In another example, the health characteristics or driving experience of the user may be determined. If the user drives in a certain position where their head occupies a certain portion of three-dimensional space within the vehicle 104, the vehicle control system 204 may determine that the safety parameter includes the users face or head being within this certain portion of the vehicle interior space. If the user's head deviates from that interior space for some amount of time, the vehicle control system 204 can determine that something is wrong with the driver and change the function or operation of the vehicle 104 to assist the driver. This may happen, for example, when a user falls asleep at the wheel. If the user's head droops and no longer occupies a certain three dimensional space, the vehicle control system 204 can determine that the driver has fallen asleep and may take control of the operation of the vehicle 204 and the automobile controller 8104 may steer the vehicle 204 to the side of the road. In other examples, if the user's reaction time is too slow or some other safety parameter is not nominal, the vehicle control system 204 may determine that the user is inebriated or having some other medical problem. The vehicle control system 204 may then assume control of the vehicle to ensure that the driver is safe.

Information corresponding to a user and/or a user profile may be stored in the profile information portion 1238. For example, the profile information 1238 may include data relating to at least one of current data, historical data, a user preference, user habit, user routine, observation, location data (e.g., programmed and/or requested destinations, locations of parking, routes traveled, average driving time, etc.), social media connections, contacts, brand recognition (e.g., determined via one or more sensors associated with the vehicle 104, a device 212, 248, etc.), audible recording data, text data, email data, political affiliation, preferred retail locations/sites (e.g., physical locations, web-based locations, etc.), recent purchases, behavior associated with the aforementioned data, and the like. The data in the profile information portion 1238 may be stored in one or more of the data structures 1200 provided herein. As can be appreciated, these one or more data structures may be stored in one or more memory locations. Examples of various memory locations are described in conjunction with FIG. 2.

One or more additional data fields may be stored in the linked data portion 1242 as data and/or locations of data. The linked data 1242 may include at least one of pointers, addresses, location identification, data source information, and other information corresponding to additional data associated with the data structure 1200. Optionally, the linked data portion 1242 may refer to data stored outside of a particular data structure 1200. For example, the linked data portion 1242 may include a link/locator to the external data. Continuing this example, the link/locator may be resolved (e.g., via one or more of the methods and/or systems provided herein, etc.) to access the data stored outside of the data structure 1200. Additionally or alternatively, the linked data portion 1242 may include information configured to link the data objects 1204 to other data files or data objects 1250, 1270, 1280. For instance, the data object 1204 relating to a user may be linked to at least one of a device data object 1250, a vehicle system data object 1270, and a vehicle data object 1280, to name a few.

An embodiment of a data structure 1200 to store information associated with one or more devices is shown in FIG. 12B. The data file 1250 may include several portions 1216-1262 representing different types of data. Each of these types of data may be associated with a device, as shown in portion 1252.

There may be one or more device records 1250 and associated data stored within the data file 1250. As provided herein, the device may be any device that is associated with the vehicle 104. For example, a device may be associated with a vehicle 104 when that device is physically located within the interior space 108 of the vehicle 104. As another example, a device may be associated with a vehicle 104 when the device registers with the vehicle 104. Registration may include pairing the device with the vehicle 104 and/or one or more of the vehicle systems (e.g., as provided in FIG. 3). In some cases, the registration of a device with a vehicle 104 may be performed manually and/or automatically. An example of automatic registration may include detecting, via one or more of the vehicle systems, that a device is inside the vehicle 104. Upon detecting that the device is inside the vehicle 104, the vehicle system may identify the device and determine whether the device is or should be registered. Registration may be performed outside of a vehicle 104 via providing a unique code to the vehicle 104 and/or at least one of the vehicle systems.

The device may be identified in portion 1256. Among other things, the device identification may be based on the hardware associated with the device (e.g., Media Access Control (MAC) address, Burned-In Address (BIM, Ethernet Hardware Address (EHA), physical address, hardware address, and the like).

Optionally, a device may be associated with one or more users. For example, a tablet and/or graphical user interface (GUI) associated with the vehicle 104 may be used by multiple members of a family. For instance, the GUI may be located in a particular area 508 and/or zone 512 of the vehicle 104. Continuing this example, when a family member is located in the particular area 508 and/or zone 512, the device may include various settings, features, priorities, capabilities, and the like, based on an identification of the family member. The user may be identified in portion 1254. For the device, the user identification portion 1254 may include a set of one or more features that may identify a particular user. These features may be the physical characteristics of the person that may be identified by facial recognition, or some other type of system, associated with the device and/or the vehicle 104. Optionally, the user may provide a unique code to the device, or provide some other type of data, that allows the device to identify the user. The features or characteristics of the user are then stored in portion 1254.

Each device identified in the device identification portion 1256 may have a different set of settings for each area 508 and/or each zone 512, and/or each user of the device. Thus, each set of settings may also be associated with a predetermined zone 512, area 508, and/or user. The zone 512 is stored in portion 1220 and the area 508 is stored in portion 1216.

One or more settings may be stored in portion 1224. These settings 1224 may be similar and/or identical to those previously described. Further, the settings 1224 may also provide for how a device is configured for a particular user. Each setting 1224 may be associated with a different area 508 or zone 512. Thus, there may be more restrictive settings 1224 (e.g., restricted multimedia, texting, limited access to device functions, and the like) for the device when the user is the driver and in zone A 512A, 512A, of area 1, 508A. However, when the user is in another zone 512 or area 508, for example, where the user is not operating a vehicle 104, the settings 1224 may provide unrestricted access to one or more features of the device (e.g., allowing texting, multimedia, etc.).

Optionally, the capabilities of a device may be stored in portion 1258. Examples of device capabilities may include, but are not limited to, a communications ability (e.g., via wireless network, EDGE, 3G, 4G, LTE, wired, Bluetooth®, Near Field Communications (NFC), Infrared (IR), etc.), hardware associated with the device (e.g., cameras, gyroscopes, accelerometers, touch interface, processor, memory, display, etc.), software (e.g., installed, available, revision, release date, etc.), firmware (e.g., type, revision, etc.), operating system, system status, and the like. Optionally, the various capabilities associated with a device may be controlled by one or more of the vehicle systems provided herein. Among other things, this control allows the vehicle 104 to leverage the power and features of various devices to collect, transmit, and/or receive data.

One or more priorities may be stored in portion 1260. The priority may correspond to a value, or combination of values, configured to determine how a device interacts with the vehicle 104 and/or its various systems. The priority may be based on a location of the device (e.g., as stored in portions 1216, 1220). A default priority can be associated with each area 508 and/or zone 512 of a vehicle 104. For example, the default priority associated with a device found in zone 1 512A of area 1 508A (e.g., a vehicle operator position) may be set higher than an (or the highest of any) alternative zone 512 or area 508 of the vehicle 104. Continuing this example, the vehicle 104 may determine that, although other devices are found in the vehicle, the device, having the highest priority, controls features associated with the vehicle 104. These features may include vehicle control features, critical and/or non-critical systems, communications, and the like. Additionally or alternatively, the priority may be based on a particular user associated with the device. Optionally, the priority may be used to determine which device will control a particular signal in the event of a conflict.

Registration data may be stored in portion 1262. As described above, when a particular device registers with a vehicle 104, data related to the registration may be stored in the registration data portion 1262. Such data may include, but is not limited to, registration information, registration codes, initial registration time, expiration of registration, registration timers, and the like. Optionally, one or more systems of the vehicle 104 may refer to the registration data portion 1262 to determine whether a device has been previously registered with the vehicle 104. As shown in FIG. 12B, User 4 of Device 2 has not been registered. In this case, the registration data field 1262, for this user, may be empty, contain a null value, or other information/indication that there is no current registration information associated with the user.

Additionally or alternatively, the data structure 1200 may include a profile information portion 1238 and/or a linked data portion 1242. Although the profile information portion 1238 and/or the linked data portion 1242 may include different information from that described above, it should be appreciated that the portions 1238, 1242 may be similar, or identical, to those as previously disclosed.

An embodiment of a data structure 1200 to store information associated with one or more vehicle systems is shown in FIG. 12C. The data file 1270 may include several portions 1216-1279 representing different types of data. Each of these types of data may be associated with a vehicle system, as shown in portion 1272.

There may be one or more system records 1270 and associated data stored within the data file 1270. As provided herein, the vehicle systems may be any system and/or subsystem that is associated with the vehicle 104. Examples of various systems are described in conjunction with FIG. 3 and other related figures (e.g., systems 324-352, etc.). One example of a system associated with the vehicle 104 is the vehicle control system 204. Other systems may include communications subsystems 344, vehicle subsystems 328, and media subsystems 348, to name a few. It should be appreciated that the various systems may be associated with the interior space 108 and/or the exterior of the vehicle 104.

Each system may include one or more components. The components may be identified in portion 1274. Identification of the one or more components may be based on hardware associated with the component. This identification may include hardware addresses similar to those described in conjunction with the devices of FIG. 12B. Additionally or alternatively, a component can be identified by one or more signals sent via the component. Such signals may include an Internet Protocol (IP), or similar, address as part of the signal. Optionally, the signal may identify the component sending the signal via one or more of a header, a footer, a payload, and/or an identifier associated with the signal (e.g., a packet of a signal, etc.).

Each system and/or component may include priority type information in portion 1276. Among other things, the priority type information stored in portion 1276 may be used by the various methods and systems provided herein to differentiate between critical and non-critical systems. Non-limiting examples of critical systems may correspond to those systems used to control the vehicle 104, such as, steering control, engine control, throttle control, braking control, and/or navigation informational control (e.g., speed measurement, fuel measurement, etc.) Non-critical systems may include other systems that are not directly related to the control of the vehicle 104. By way of example, non-critical systems may include media presentation, wireless communications, comfort settings systems (e.g., climate control, seat position, seat warmers, etc.), and the like. Although examples of critical and/or non-critical systems are provided above, it should be appreciated that the priority type of a system may change (e.g., from critical to non-critical, from non-critical to critical, etc.) depending on the scenario. For instance, although the interior climate control system may be classified as a non-critical system at a first point in time, it may be subsequently classified as a critical system when a temperature inside/outside of the vehicle 104 is measured at a dangerous level (e.g., sub-zero Fahrenheit, greater than 90-degrees Fahrenheit, etc.). As such, the priority type may be associated with temperature conditions, air quality, times of the day, condition of the vehicle 104, and the like.

Each system may be associated with a particular area 508 and/or zone 512 of a vehicle 104. Among other things, the location of a system may be used to assess a state of the system and/or provide how the system interacts with one or more users of the vehicle 104. As can be appreciated each system may have a different set of settings for each area 508 and/or each zone 512, and/or each user of the system. Thus, each set of settings may also be associated with a predetermined zone 512, area 508, system, and/or user. The zone 512 is stored in portion 1220 and the area 508 is stored in portion 1216.

One or more settings may be stored in portion 1224. These settings 1224 may be similar and/or identical to those previously described. Further, the settings 1224 may also provide for how a system is configured for a particular user. Each setting 1224 may be associated with a different area 508 or zone 512. For instance, a climate control system may be associated with more than one area 508 and/or zone 512. As such, a first user seated in zone 1 512A of area 1 508A may store settings related to the climate control of that zone 512A that are different from other users and/or zones 512 of the vehicle 104. Optionally, the settings may not be dependent on a user. For instance, specific areas 508 and/or zones 512 of a vehicle 104 may include different, default, or the same settings based on the information stored in portion 1224.

The various systems and/or components may be able to obtain or track health status data of the systems and/or components in portion 1278. The health status 1278 may include any type of information related to a state of the systems. For instance, an operational condition, manufacturing date, update status, revision information, time in operation, fault status, state of damage detected, inaccurate data reporting, and other types of component/system health status data may be obtained and stored in portion 1278.

Each component and/or system may be configured to communicate with users, systems, servers, vehicles, third parties, and/or other endpoints via one or more communication type. At least one communication ability and/or type associated with a system may be stored in the communication type portion 1279. Optionally, the communication types contained in this portion 1279 may be ordered in a preferential order of communication types. For instance, a system may be configured to preferably communicate via a wired communication protocol over one or more wired communication channels (e.g., due to information transfer speeds, reliability, and the like). However, in this instance, if the one or more wired communication channels fail, the system may transfer information via an alternative communication protocol and channel (e.g., a wireless communication protocol and wireless communication channel, etc.). Among other things, the methods and systems provided herein may take advantage of the information stored in the communication type portion 1279 to open available communication channels in the event of a communication channel failure, listen on other ports for information transmitted from the systems, provide a reliability rating based on the number of redundant communication types for each component, and more. Optionally, a component or system may be restricted from communicating via a particular communication type (e.g., based on rules, traffic, critical/non-critical priority type, and the like). In this example, the component or system may be forced by the vehicle control system 204 to use an alternate communication type where available, cease communications, or store communications for later transfer.

Additionally or alternatively, the data structure 1200 may include a profile information portion 1238 and/or a linked data portion 1242. Although the profile information portion 1238 and/or the linked data portion 1242 may include different information from that described above, it should be appreciated that the portions 1238, 1242 may be similar, or identical, to those as previously disclosed.

Referring now to FIG. 12D, a data structure 1200 is shown optionally. The data file 1280 may include several portions 1216-1286 representing different types of data. Each of these types of data may be associated with a vehicle, as shown in portion 1282.

There may be one or more vehicle records 1280 and associated data stored within the data file 1282. As provided herein, the vehicle 104 can be any vehicle or conveyance 104 as provided herein. The vehicle 104 may be identified in portion 1282. Additionally or alternatively, the vehicle 104 may be identified by one or more systems and/or subsystems. The various systems of a vehicle 104 may be identified in portion 1284. For example, various features or characteristics of the vehicle 104 and/or its systems may be stored in portion 1284. Optionally, the vehicle 104 may be identified via a unique code or some other type of data that allows the vehicle 104 to be identified.

Each system may be associated with a particular area 508 and/or zone 512 of a vehicle 104. Among other things, the location of a system may be used to assess a state of the system and/or provide how the system interacts with one or more users of the vehicle 104. As can be appreciated each system may have a different set of settings for each area 508 and/or each zone 512, and/or each user of the system. Thus, each set of settings may also be associated with a predetermined zone 512, area 508, system, and/or user. The zone 512 is stored in portion 1220 and the area 508 is stored in portion 1216.

One or more settings may be stored in portion 1224. These settings 1224 may be similar and/or identical to those previously described. Further, the settings 1224 may also provide for how a vehicle and/or its systems are configured for one or more users. Each setting 1224 may be associated with a different area 508 or zone 512. Optionally, the settings may not be dependent on a particular user. For instance, specific areas 508 and/or zones 512 of a vehicle 104 may include different, default, or the same settings based on the information stored in portion 1224.

The various systems and/or components may be able to obtain or track health status data of the systems and/or components in portion 1278. The health status 1278 may include any type of information related to a state of the systems. For instance, an operational condition, manufacturing date, update status, revision information, time in operation, fault status, state of damage detected, inaccurate data reporting, and other types of component/system health status data may be obtained and stored in portion 1278.

One or more warnings may be stored in portion 1286. The warnings data 1286 may include warning generated by the vehicle 104, systems of the vehicle 104, manufacturer of the vehicle, federal agency, third party, and/or a user associated with the vehicle. For example, several components of the vehicle may provide health status information (e.g., stored in portion 1278) that, when considered together, may suggest that the vehicle 104 has suffered some type of damage and/or failure. Recognition of this damage and/or failure may be stored in the warnings data portion 1286. The data in portion 1286 may be communicated to one or more parties (e.g., a manufacturer, maintenance facility, user, etc.). In another example, a manufacturer may issue a recall notification for a specific vehicle 104, system of a vehicle 104, and/or a component of a vehicle 104. It is anticipated that the recall notification may be stored in the warning data field 1286. Continuing this example, the recall notification may then be communicated to the user of the vehicle 104 notifying the user of the recall issued by the manufacturer.

Additionally or alternatively, the data structure 1200 may include a profile information portion 1238 and/or a linked data portion 1242. Although the profile information portion 1238 and/or the linked data portion 1242 may include different information from that described above, it should be appreciated that the portions 1238, 1242 may be similar, or identical, to those as previously disclosed.

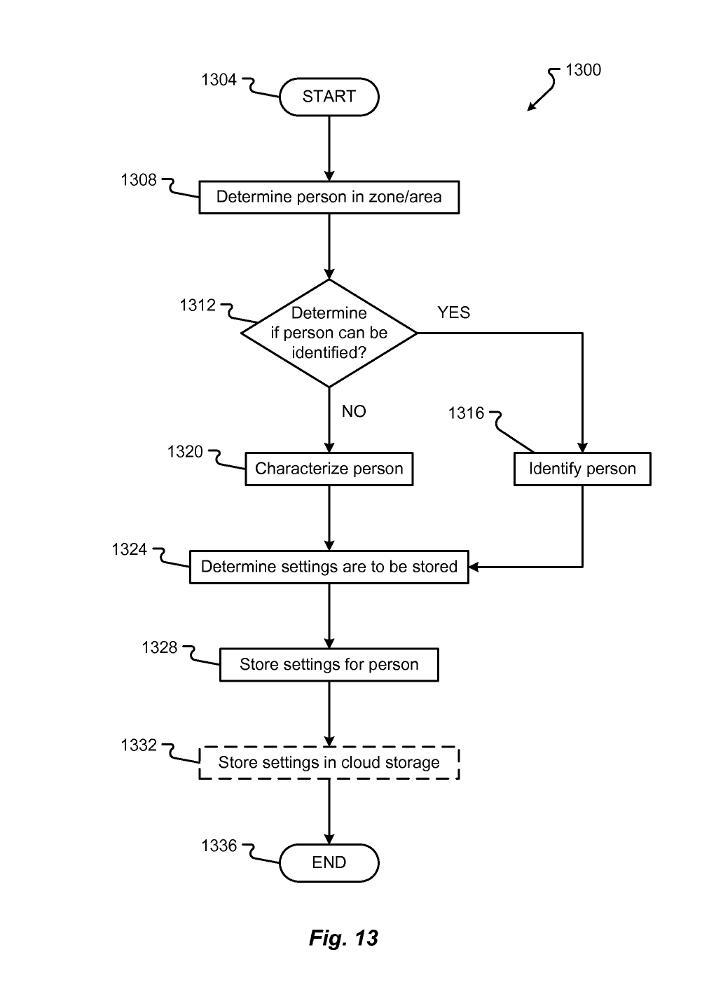

An embodiment of a method 1300 for storing settings for a user 216 associated with vehicle 104 is shown in FIG. 13. While a general order for the steps of the method 1300 is shown in FIG. 13, the method 1300 can include more or fewer steps or can arrange the order of the steps differently than those shown in FIG. 13. Generally, the method 1300 starts with a start operation 1304 and ends with an end operation 1336. The method 1300 can be executed as a set of computer-executable instructions executed by a computer system and encoded or stored on a computer readable medium. Hereinafter, the method 1300 shall be explained with reference to the systems, components, modules, software, data structures, user interfaces, etc. described in conjunction with FIGS. 1-12.

A person may enter the vehicle space 108. One or more sensors 242 may then identify that a person is sitting within the vehicle 104, in step 1308. For example, sensors 242 in a seat, may determine that some new amount of weight has been registered. The amount of weight may fall within predetermined parameters (e.g., over a threshold, in a specific range, etc.). This weight may then be determined to be a person by one or more optical or other sensors 242. The vehicle control system 204 may then determine that a person is in a certain zone 512 or area 508. For example, the sensors 242 may send signals to the vehicle controls system 204 that an event has occurred. This information may be sent to the vehicle control system processor 304 to determine the zone 512 and area 508 where the event occurred. Further, the vehicle control system 204 may then identify the person, in step 1312.

The vehicle control system 204 can receive the information from the sensors 242 and use that information to search the database 1200 that may be stored within the system data 208. The sensor data may be compared to ID characteristics 1212 to determine if the person has already been identified. The vehicle control system 204 may also send the characteristic data from the sensors to the communication network 224 to a server 228 to compare the sensor data to stored data 232 that may be stored in a cloud system. The person's features can be compared to stored features 1212 to determine if the person in the vehicle 104 can be identified.

If the person has been identified previously and their characteristics stored in portion 1212, the method 1300 proceeds YES to step 1316 where that person may be identified. In identifying a person, the information associated with that person 1240 may be retrieved and provided to the vehicle control system 204 for further action. If a person cannot be identified by finding their sensor characteristics in portion 1212, the method 1300 proceeds NO to step 1320. In step 1320, the vehicle control system 204, using an application, may create a new record in table 1200 for the user. This new record may store a user identifier and their characteristics 1212. It may also store the area 508 and zone 512 in data portions 1216 and 1220. The new record may then be capable of receiving new settings data for this particular user. In this way, the vehicle 104 can automatically identify or characterize a person so that settings may be established for the person in the vehicle 104.

The input module 312 may then determine if settings are to be stored, in step 1324. Settings might be any configuration of the vehicle 104 that may be associated with the user. The determination may be made after receiving a user input from the user. For example, the user may make a selection on a touch sensitive display indicating that settings currently made are to be stored. In other situations, a period of time may elapse after the user has made a configuration. After determining that the user is finished making changes to the settings, based on the length of the period of time since the setting was established, the vehicle control system 204 can save the setting. Thus, the vehicle control system 204 can make settings automatically based on reaching a steady state for settings for user.

The vehicle control system 204 may then store the settings for the person, in step 1328. The user interaction subsystem 332 can make a new entry for the user 1208 in data structure 1204. The new entry may be either a new user or a new settings listed in 1224. The settings may be stored based on the area 508 and zone 512. As explained previously, the settings can be any kind of configuration of the vehicle 104 that may be associated with the user in that area 508 and the zone 512.

The settings may also be stored in cloud storage, in step 1332. Thus, the vehicle control system 204 can send the new settings to the server 228 to be stored in storage 232. In this way, these new settings may be ported to other vehicles for the user. Further, the settings in storage system 232 may be retrieved, if local storage does not include the settings in storage system 208.

Additionally or alternatively, the settings may be stored in profile data 252. As provided herein, the profile data 252 may be associated with one or more devices 212, 248, servers 228, vehicle control systems 204, and the like. Optionally, the settings in profile data 252 may be retrieved in response to conditions. For instance, the settings may be retrieved from at least one source having the profile data if local storage does not include the settings in storage system 208. As another example, a user 216 may wish to transfer settings stored in profile data 252 to the system data 208. In any event, the retrieval and transfer of settings may be performed automatically via one or more devices 204, 212, 248, associated with the vehicle 104.

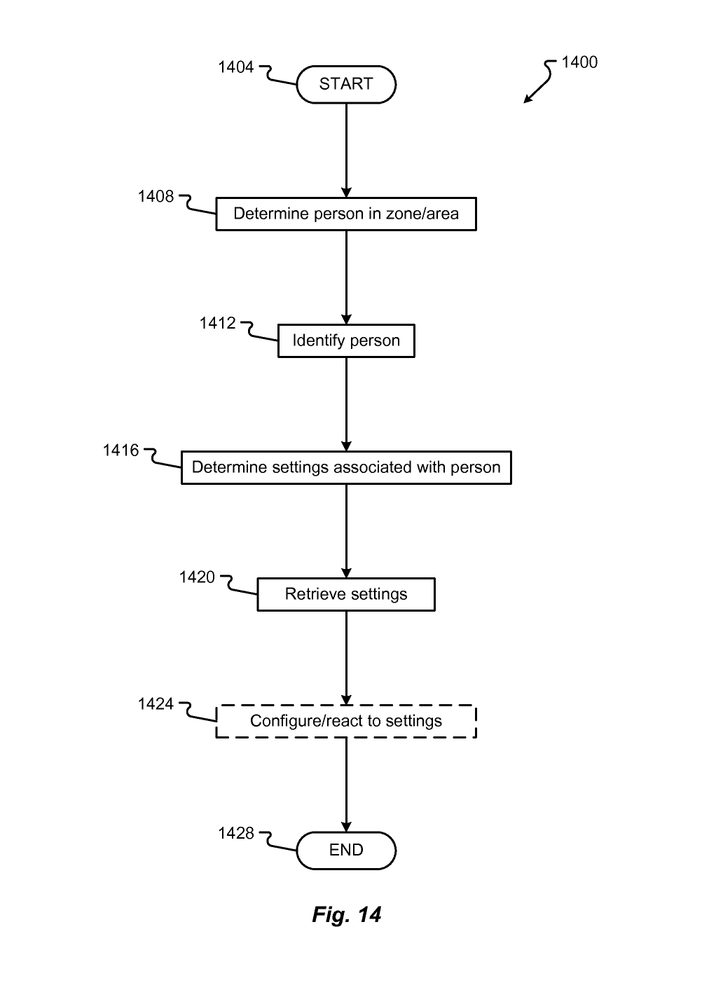

An embodiment of a method 1400 to configure the vehicle 104 based on stored settings is shown in FIG. 14. A general order for the steps of the method 1400 is shown in FIG. 14. Generally, the method 1400 starts with a start operation 1404 and ends with an end operation 1428. The method 1400 can include more or fewer steps or can arrange the order of the steps differently than those shown in FIG. 14. The method 1400 can be executed as a set of computer-executable instructions executed by a computer system and encoded or stored on a computer readable medium. Hereinafter, the method 1400 shall be explained with reference to the systems, components, modules, software, data structures, user interfaces, etc. described in conjunction with FIGS. 1-13.

The vehicle control system 204 can determine if a person is in a zone 512 or area 508, in step 1408. This determination may be made by receiving data from one or more sensors 242. The vehicle 104 can use facial recognition, weight sensors, heat sensors, or other sensors to determine whether a person is occupying a certain zone 512.

Using the information from the sensors 242, the vehicle control system 204 can identify the person, in step 1412. The vehicle control system 204 can obtain characteristics for the user currently occupying the zone 512 and compare those characteristics to the identifying features in portion 1212 of data structure 1204. Thus, the settings in portion 1224 may be retrieved by identifying the correct zone 512, area 508, and characteristics for the user.

The vehicle control system 204 can first determine if there are settings associated with the identified person for that zone 512 and/or area 508, in step 1416. After identifying the user by matching characteristics with the features in portion 1212, the vehicle control system 204 can determine if there are settings for the user for the area 1216 and zone 1220 the user currently occupies. If there are settings, then the vehicle control system 204 can make the determination that there are settings in portion 1224, and the vehicle control system 204 may then read and retrieve those settings, in step 1420. The settings may be then used to configure or react to the presence of the user, in step 1424. Thus, these settings may be obtained to change the configuration of the vehicle 104, for example, how the position of the seats or mirrors are set, how the dash, console, or heads up display is configured, how the heat or cooling is configured, how the radio is configured, or how other different configurations are made.

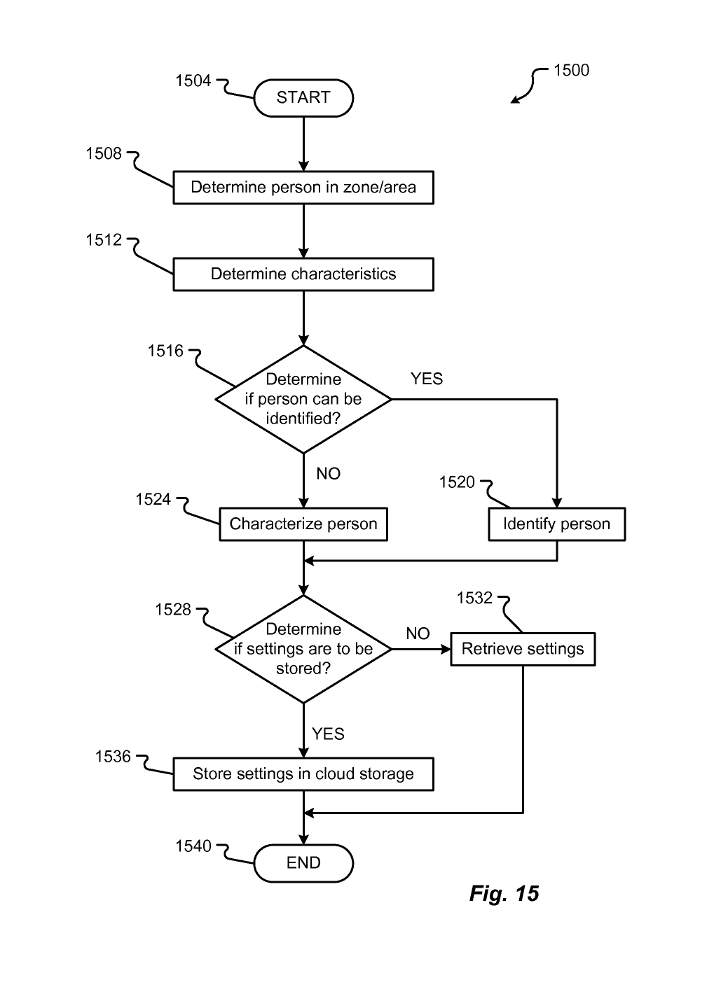

Embodiments of a method 1500 for storing settings in cloud storage are shown in FIG. 15. A general order for the steps of the method 1500 is shown in FIG. 15. Generally, the method 1500 starts with a start operation 1504 and ends with an end operation 1540. The method 1500 can include more or fewer steps or can arrange the order of the steps differently than those shown in FIG. 15. The method 1500 can be executed as a set of computer-executable instructions executed by a computer system and encoded or stored on a computer readable medium. Hereinafter, the method 1500 shall be explained with reference to the systems, components, modules, software, data structures, user interfaces, etc. described in conjunction with FIGS. 1-14.

The vehicle control system 204 can determine if a person is in a zone 512 or area 508, in step 1508. As explained previously, the vehicle control system 204 can receive vehicle sensor data from vehicle sensors 242 that show a person has occupied a zone 512 or an area 508 of the vehicle 104. Using the vehicle sensor data, the vehicle control system 204 can determine characteristics of the person, in step 1512. These characteristics are compared to the features in portion 1212 of the data structure 1204. From this comparison, the vehicle control system 204 can determine if the person is identified within the data structure 1204, in step 1516. If there is a comparison and the person can be identified, the method 1500 proceeds YES to step 1520. However, if the person cannot be identified, the method 1500 proceeds NO, to step 1524.

In step 1520, the person is identified in portion 1208 by the successful comparison of the characteristics and the features. It should be noted that there may be a degree of variability between the characteristics and the features in portion 1212. Thus, the comparison may not be an exact comparison but may use methods known in the art to make a statistically significant comparison between the characteristics received from the sensors 242 and the features stored in portion 1212. In step 1524, the characteristics received from sensors 242 are used to characterize the person. In this way, the received characteristics may be used as an ID, in portion 1212, for a new entry for a new user in portion 1208.

The user may make one or more settings for the vehicle 104. The vehicle control system 204 may determine if the settings are to be stored, in step 1528. If the settings are to be stored, the method 1500 proceeds YES to step 1536. If the settings are not to be stored or if there are no settings to be stored, the method 1500 proceeds NO to step 1532. In step 1532, the vehicle control system 204 can retrieve the settings in the portion 1224 of the data structure 1204. Retrieval of the settings may be as described in conjunction with FIG. 14. If settings are to be stored, the vehicle control system 204 can send those settings to server 228 to be stored in data storage 232, in step 1536. Data storage 232 acts as cloud storage that can be used to retrieve information on the settings from other vehicles or from other sources. Thus, the cloud storage 232 allows for permanent and more robust storage of user preferences for the settings of the vehicle 104.

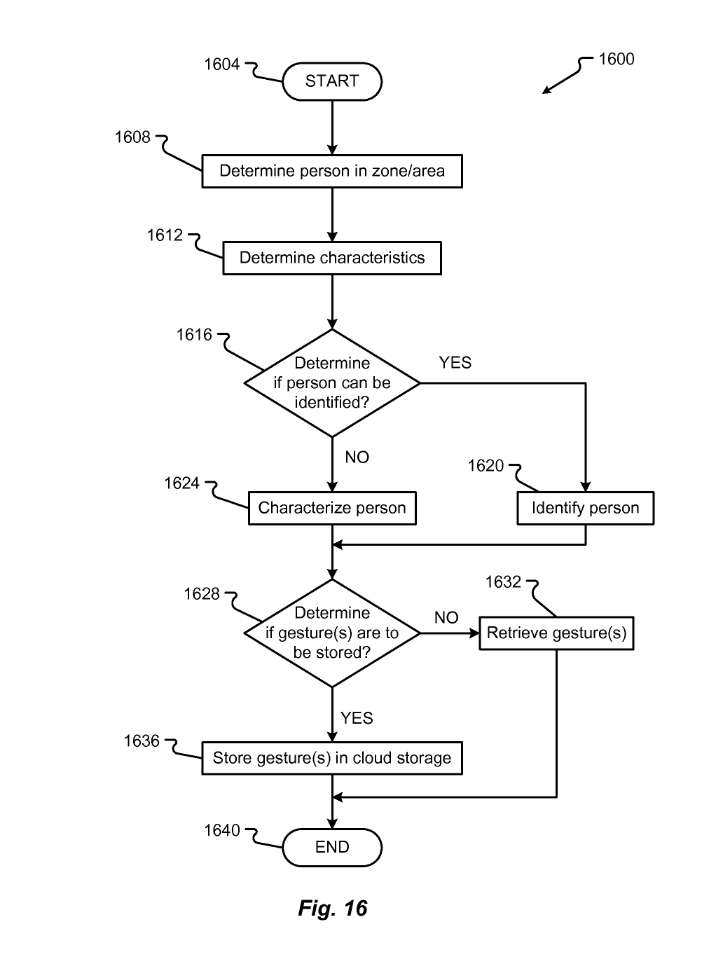

An embodiment of a method 1600 for storing gestures associated with the user is shown in FIG. 16. A general order for the steps of the method 1600 is shown in FIG. 16. Generally, the method 1600 starts with a start operation 1604 and ends with an end operation 1640. The method 1600 can include more or fewer steps or can arrange the order of the steps differently than those shown in FIG. 16. The method 1600 can be executed as a set of computer-executable instructions executed by a computer system and encoded or stored on a computer readable medium. Hereinafter, the method 1600 shall be explained with reference to the systems, components, modules, software, data structures, user interfaces, etc. described in conjunction with FIGS. 1-15.

Vehicle control system 204 may receive sensor data from sensors 242 to determine a person is occupying a zone 512 in an area 508 of the vehicle 104, in step 1608. The sensor data may provide characteristics for the person, in step 1612. The vehicle control system 204 may then use the characteristics to determine if the person can be identified, in step 1616. The vehicle control system 204 may compare the characteristics to the features in portion 1212 for the people having been recognized and having data associated therewith. If a comparison is made between the characteristics and the features in portion 1212, the person can be identified, and the method 1600 proceeds YES to step 1620. If there is no comparison, the method 1600 may proceed NO to step 1624. In step 1620, the person may be identified by the vehicle control system 204. Thus, the person's features and associated data record 1240 may be determined and the user identified in portion 1208. If the person is not identified, the vehicle control system 204 can characterize the person in step 1624 by establishing a new record in data structure 1204 using the characteristics, received from the sensors 242, for the features in portion 1212.

Thereinafter, the vehicle control system 204 may determine if gestures are to be stored and associated with the user, in step 1628. The vehicle control system 204 may receive user input on a touch sensitive display or some other type of gesture capture region which acknowledges that the user wishes to store one or more gestures. Thus, the user may create their own gestures such as those described in conjunction with FIGS. 11A-11K. These gestures may then be characterized and stored in data structure 1204. If there are gestures to be stored, the method 1600 proceeds YES to step 1636. If gestures are not to be stored the method 1600 may proceed NO to step 1632.

In step 1632, the vehicle control system 204 can retrieve current gestures from portion 1232, which are associated with user 1240. These gestures may be used then to configure how the vehicle 104 will react if a gesture is received. If gestures are to be stored, the vehicle control system 204 may store characteristics, in step 1636, as received from sensor 242 or from one more user interface inputs. These characteristics may then be used to create the stored gestures 1232, in data structure 1204. The characteristics may include what the gesture looks like or appears and also what affect the gesture should have. This information may then be used to change the configuration or operation of the vehicle 104 based on the gesture if it is received at a later time.

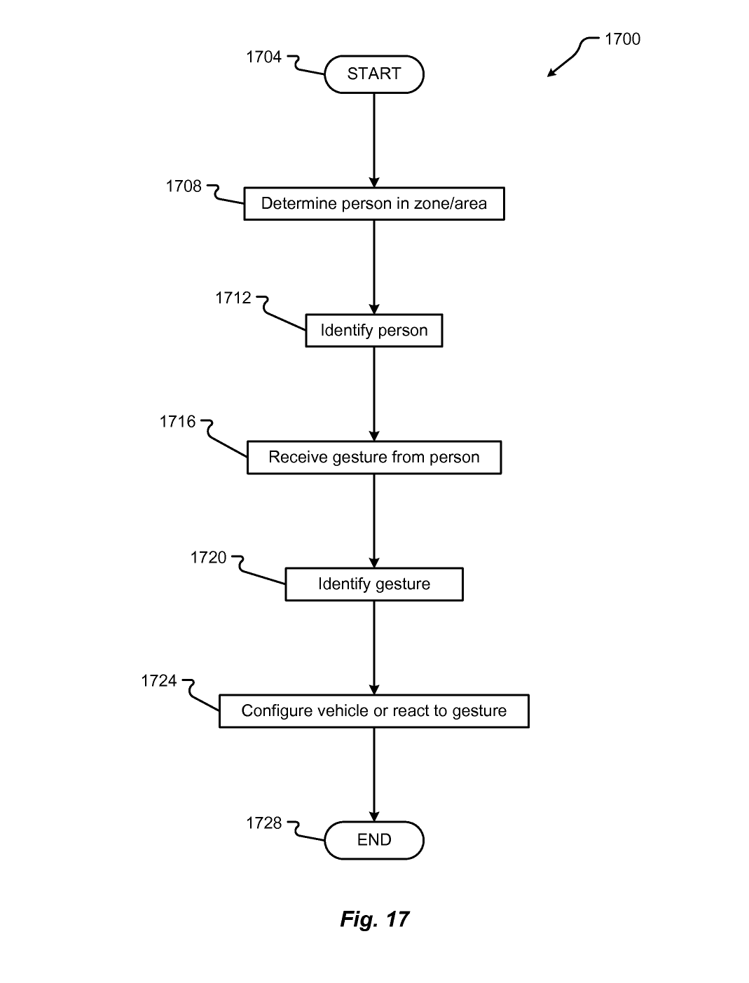

An embodiment of a method 1700 for receiving a gesture and configuring the vehicle 104 based on the gesture may be as provided in FIG. 17. A general order for the steps of the method 1700 is shown in FIG. 17. Generally, the method 1700 starts with a start operation 1704 and ends with an end operation 1728. The method 1700 can include more or fewer steps or can arrange the order of the steps differently than those shown in FIG. 17. The method 1700 can be executed as a set of computer-executable instructions executed by a computer system and encoded or stored on a computer readable medium. Hereinafter, the method 1700 shall be explained with reference to the systems, components, modules, software, data structures, user interfaces, etc. described in conjunction with FIGS. 1-16.

A vehicle control system 204 can receive sensor data from vehicle sensors 242. The vehicle sensor data can be used by the vehicle control system 204 to determine that a person is in a zone 512 or area 508, in step 1708. The vehicle sensor data may then be used to compare against feature characteristics 1212 to identify a person, in step 1712. The vehicle control system 204 thereinafter may receive a gesture, in step 1716. The gesture may be perceived by vehicle sensors 242 or received in a gesture capture region. The gesture may be as described in conjunction with FIGS. 11A-11K. Upon receiving the gesture, the vehicle control system 204 can compare the gesture to gesture characteristics in portion 1232, in step 1720. The comparison may be made so that a statistically significant coorelation between the sensor data or gesture data and the gesture characteristic 1232 is made. Upon identifying the gesture, the vehicle control system 204 can configure the vehicle 104 and/or react to the gesture, in step 1724. The configuration or reaction to the gesture may be as prescribed in the gesture characteristic 1232.

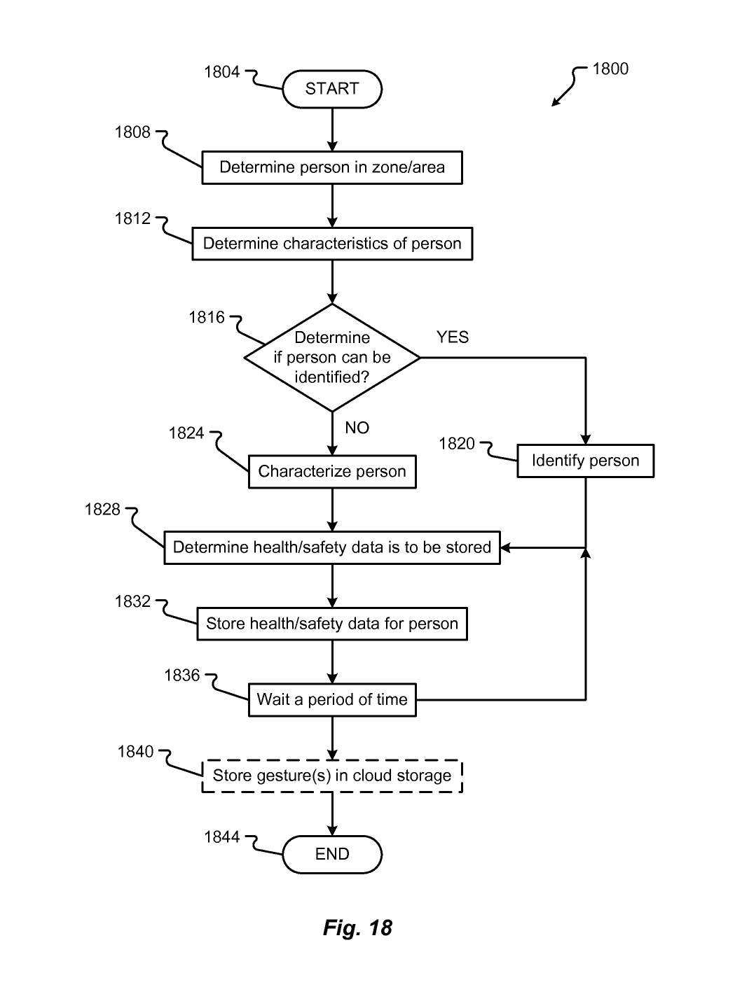

An embodiment of a method 1800 for storing health data may be as shown in FIG. 18. A general order for the steps of the method 1800 is shown in FIG. 18. Generally, the method 1800 starts with a start operation 1804 and ends with an end operation 1844. The method 1800 can include more or fewer steps or can arrange the order of the steps differently than those shown in FIG. 18. The method 1800 can be executed as a set of computer-executable instructions executed by a computer system and encoded or stored on a computer readable medium. Hereinafter, the method 1800 shall be explained with reference to the systems, components, modules, software, data structures, user interfaces, etc. described in conjunction with FIGS. 1-17.

Vehicle control system 204 can receive sensor data from sensors 242. The sensor data may be used to determine that a person is in a zone 512 or area 508, in step 1808. The sensor data may then be used to determine characteristics of the person, in step 1812. From the characteristics, the vehicle control system 204 can determine if a person may be identified in data structure 1204, in step 1816. If it is determined that the person can be identified in step 1816, the method 1800 proceeds YES to step 1820. If the person cannot be identified, the method 1800 proceeds NO to step 1824. A person may be identified by matching the characteristics of a person from the sensor data to the features shown in portion 1212. If these comparisons are statistically significant, the person may be identified in portion 1208, in step 1820. However, if the person is not identified in portion 1208, the vehicle control system 204 can characterize the person using the vehicle sensor data, in step 1824. In this way, the vehicle control system 204 can create a new record for a new user in data structure 1204.

Thereinafter, the vehicle control system 204 may receive health and/or safety data from the vehicle sensors 242, in step 1828. The vehicle control system 204 can determine if the health or safety data is to be stored, in step 1832. The determination is made as to whether or not there is sufficient health data or safety parameters, in portion 1228 and 1236, to provide a reasonable baseline data pattern for the user 1240. If there is data to be received and stored, the vehicle control system 204 can store the data for the person in portions 1228 and 1236 of the data structure 1204, in step 1832.

The vehicle control system 204 may then wait a period of time, in step 1836. The period of time may be any amount of time from seconds to minutes to days. Thereinafter, the vehicle control system 204 can receive new data from vehicle sensors 242, in step 1828. Thus, the vehicle control system 204 can receive data periodically and update or continue to refine the health data and safety parameters in data structure 1204. Thereinafter, the vehicle control system 204 may optionally store the health and safety data in cloud storage 232 by sending it through the communication network 224 to the server 228, in step 1840.

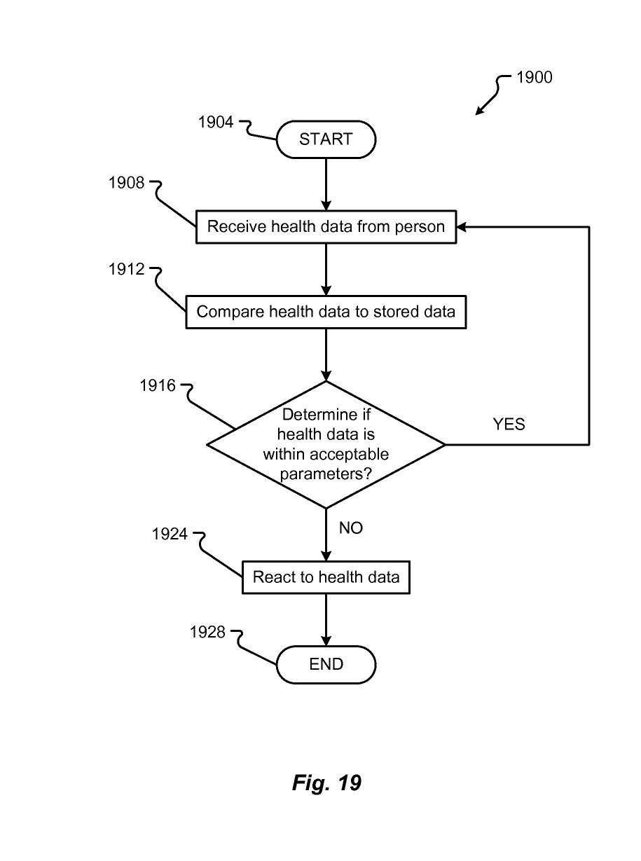

An embodiment of a method 1900 for monitoring the health of a user may be as shown in FIG. 19. A general order for the steps of the method 1900 is shown in FIG. 19. Generally, the method 1900 starts with a start operation 1904 and ends with an end operation 1928. The method 1900 can include more or fewer steps or can arrange the order of the steps differently than those shown in FIG. 19. The method 1900 can be executed as a set of computer-executable instructions executed by a computer system and encoded or stored on a computer readable medium. Hereinafter, the method 1900 shall be explained with reference to the systems, components, modules, software, data structures, user interfaces, etc. described in conjunction with FIGS. 1-18.

The vehicle control system 204 can receive health data from sensors 242. The health data may be received in step 1908. The vehicle control system 204 may then compare the received health data to stored health parameters in portion 1228 or portion 1236, in step 1912. The comparison may check if there is statistically significant separation or disagreement between the received health data and the stored health data. Thus, the vehicle control system 204 can make a health comparison of the user based on a baseline of health data previously stored. A statistically significant comparison may include determining if there are any parameters more than three standard deviations from the average or norm, any parameter that is increasing or decreasing over a period of eight different measurements, a measurement that is more than two standard deviations from the norm more than three measurements consecutively, or other types of statistical comparisons.

If the vehicle control system 204 determines that measured health parameter does deviate from the norm, the vehicle control system 204 can determine whether the health data is within acceptable limits, in step 1916. If the health data is within acceptable limits, the method 1900 proceeds YES back to receiving new health data, in step 1908. In this way, the health data is periodically or continually monitored to ensure that the driver is in a healthy state and able to operate the vehicle. If the health data is not within acceptable parameters, the method 1900 may proceed NO to step 1924 where the vehicle control system 204 may react to the change in the health data. The reaction may include any measure to provide for the safety of the user, such as stopping the vehicle, beginning to drive the vehicle, driving the vehicle to a new location, such as a hospital, waking the driver with an alarm or other noise, or performing some other function that may help maintain the health or safety of the user.

The health data received may be a reaction from the driver. For example, the driver may call for help or ask the vehicle for assistance. For example, the driver or passenger may say that they are having a medical emergency and ask the car to perform some function to help. The function to help may include driving the person to a hospital or stopping the car and calling for emergency assistance.

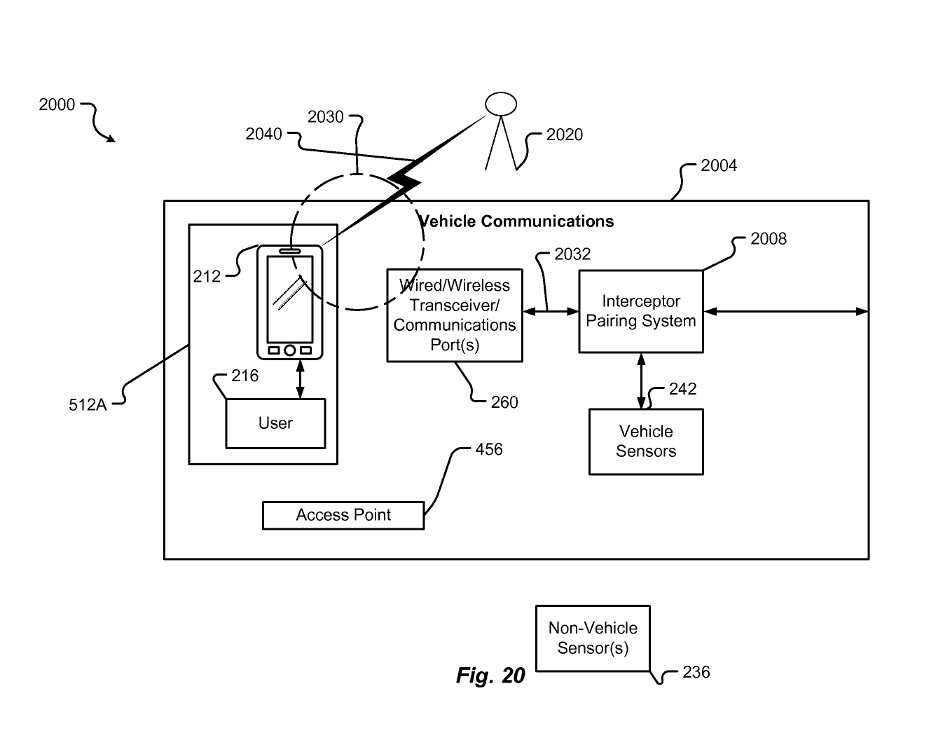

An embodiment of an optional vehicle system 2000 is shown in FIG. 20. The illustrated vehicle system 2000 includes a vehicle 2004/104, an interceptor pairing system 2008, a wired/wireless transceiver/communications port(s) 260, a transmitter-receiver 2020, vehicle sensors 242, non-vehicle sensors 236, a device 212, and a user 216. Transmitter-receiver 2020 may be, for example, a cell tower, base station, etc. Interceptor pairing system 2004 is coupled to vehicle 2004/104. Wired/wireless transceiver/communications port(s) 260 is coupled to interceptor pairing system 2008. Coupling, as defined herein, may include physical coupling and/or electronic coupling. Vehicle 2004 may be partitioned into zones including, for example, zone 512A as described previously.

In one optional configuration, wired/wireless transceiver/communications port(s) 260 intercepts signal(s) 2040 received and/or transmitted by device 212. Intercepted signal(s) 2040 may be, for example, signals not intended for general use by vehicle 2004. Intercepted signal(s) 2040 may include, for example, cell tower registration signals, messages, packets, and/or device identifiers intended used or intended for use by device 212. Wired/wireless transceiver/communications port(s) 260 provides intercepted signal(s) 2040 to interceptor pairing system 2008 as intercepted signal(s) 2032. Interceptor pairing system 2008 receives intercepted signal(s) 2032 and determines whether intercepted signal(s) 2032 contain an identifier. Identifiers may be, for example, a MAC address, and/or any other identifier assigned to a network device and/or interface. When intercepted signal(s) 2032 include an identifier, interceptor pairing system 2008 determines whether the identifier(s) corresponding to device 212 can be isolated. In one embodiment, if an identifier cannot be identified, interceptor pairing system 2008 does not isolate the identifier and does not pair device 212 with vehicle 2004. In one embodiment, if an identifier cannot be identified, interceptor pairing system 2008 does not isolate the identifier and repeats the identification process until an identifier may be identified or makes a determination that there is not an identifier in the intercepted signal(s). If an identifier(s) can be isolated, interceptor pairing system 2008 isolates the identifier(s). In one embodiment, interceptor pairing system 2008 isolates the identifier(s) based on at least one of a cell tower registration signal, a sent message, and/or a sent packet. In another embodiment, interceptor pairing system 2008 isolates the identifier(s) based on at least one of a cell tower registration signal, a sent message, and/or a sent packet instead of utilizing an active pair handshake. Using the isolated identifier(s), interceptor pairing system 2008 pairs vehicle 2004 with device 212.

In one embodiment, subsequent to or upon pairing device 212 with vehicle 2004, interceptor pairing system 2008 registers device 212 with vehicle 2008. Upon registering device 212 with vehicle control system 212, pairing of device 212 with vehicle 2004 may be initiated by vehicle 2004 to device 212. In another embodiment of vehicle system 2000, pairings and/or subsequent pairings of device 212 with vehicle 2004 may be initiated by user 216 of device 212.

In other embodiments of vehicle system 2000, registering device 212 with interceptor pairing system 2008 may include registering device 212 with one or more vehicles, zones of vehicle(s), or user(s). In one embodiment, interceptor pairing system 2008 may receive intercepted signal(s) 2032 from wired/wireless transceiver/communications port(s) 260 and determine the zone 512 in which device 212 is located based on the intercepted signal(s) 2032.

In one configuration, vehicle 2004 may be paired with a plurality of devices 212 using interceptor pairing system 2008. Interceptor pairing system 2008 isolates identifiers of a plurality of devices simultaneously and/or in sequence and pair vehicle 2004 with the plurality of vehicles. For example, a first, second, or third device may be paired with vehicle 2004. In one configuration, interceptor pairing system 2008 may request permission from user 216 prior to pairing device 212 with vehicle 2004.

In one embodiment, vehicle 2004 may intercept emitted signals from one or more devices 212 in or about the vehicle to pair a device 212 with vehicle 2004. The emitted signals may be detected, for example, via one or more sensors, antennas, receivers, transmitters, and/or combinations thereof. In one embodiment, rather than requiring an active pair handshake, vehicle 2004 may utilize certain receivers to “listen” for cell tower registration signals, sent messages, sent packets (packet sniffing), etc. From this information, vehicle 2004 may isolate a MAC address, or other identifier, associated with device 212 and register device 212 with vehicle 2004, a vehicle zone 512A, a user 216, etc. In one embodiment, upon detecting a device signal, vehicle 2004 may request permission from a user 212 before pairing device 212. In one embodiment, pairing may be initiated by vehicle 2004 (upon a first registration) to a user's device (e.g., device 212). In one embodiment, subsequent pairings may be initiated by user's device 212 to the vehicle 2004. In one embodiment, one or more of Bluetooth®, Near Field Communications (NFC), and/or other protocols may be used to pair device 212 with vehicle 2004.

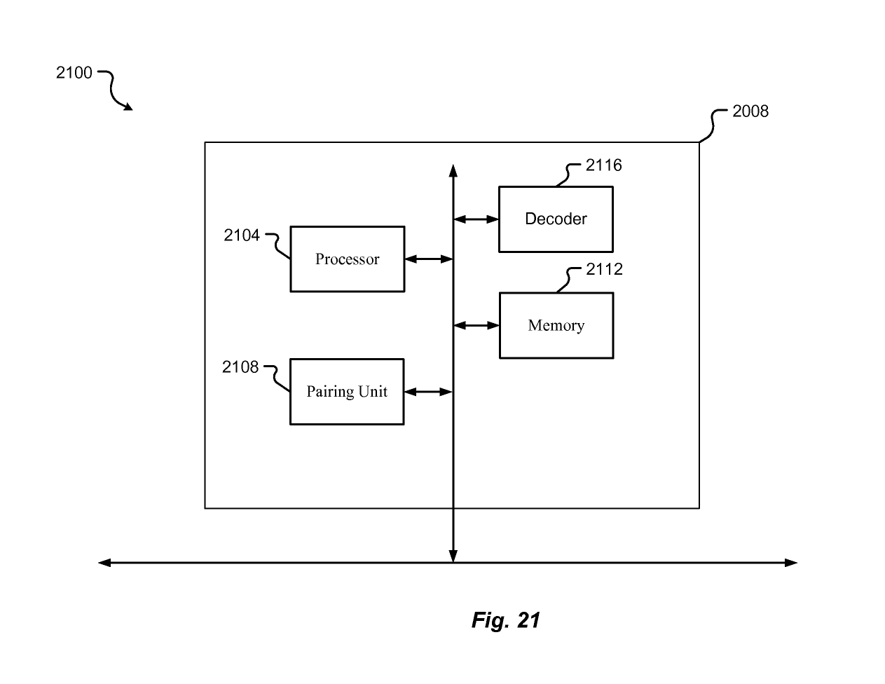

An embodiment of an optional interceptor pairing system 2008 is shown in FIG. 21. The illustrated interceptor pairing system 2008 includes a processor 2104, a memory 2112, a decoder 2116, and a pairing unit 2108. In one configuration, pairing unit 2108 is coupled to processor 2104, pairing unit 2108, memory 2112, and decoder 2116. Processor 2104 may be used, for example, to process intercepted signal(s) 2032, signal(s) received from vehicle sensors 242, and/or signal(s) received from non-vehicle sensors 236. Decoder 2116 may be used, for example, to decode encoded or encrypted intercepted signal(s) 2032, signal(s) received from vehicle sensors 242, and/or signal(s) received from non-vehicle sensors 236. Memory 2112 may be used, for example, to store intercepted signal(s) 2032, signal(s) received from vehicle sensors 242, and/or signal(s) received from non-vehicle sensors 236.

In one embodiment, pairing unit 2108 of interceptor pairing system 2008 receives intercepted signal(s) 2032. Pairing unit 2108 parses intercepted signal(s) 2032 to determine if intercepted signal(s) 2032 include an identifier. In one embodiment, pairing unit 2108 may perform the identifier determination by comparing individual portions of intercepted signal(s) 2032 to known identifiers. Known identifiers may be stored in, for example, memory 2112 for further use by, for example, interceptor pairing system 2008. Upon determination that intercepted signal(s) 2032 include identifiers, pairing unit 2108 determines if the identifier(s) may be isolated. If, for example, the identifier(s) may be isolated, pairing unit 2108 isolates the identifier(s). Once the identifier(s) have been isolated, interceptor pairing system 2008 pairs device 212 with vehicle 2004.

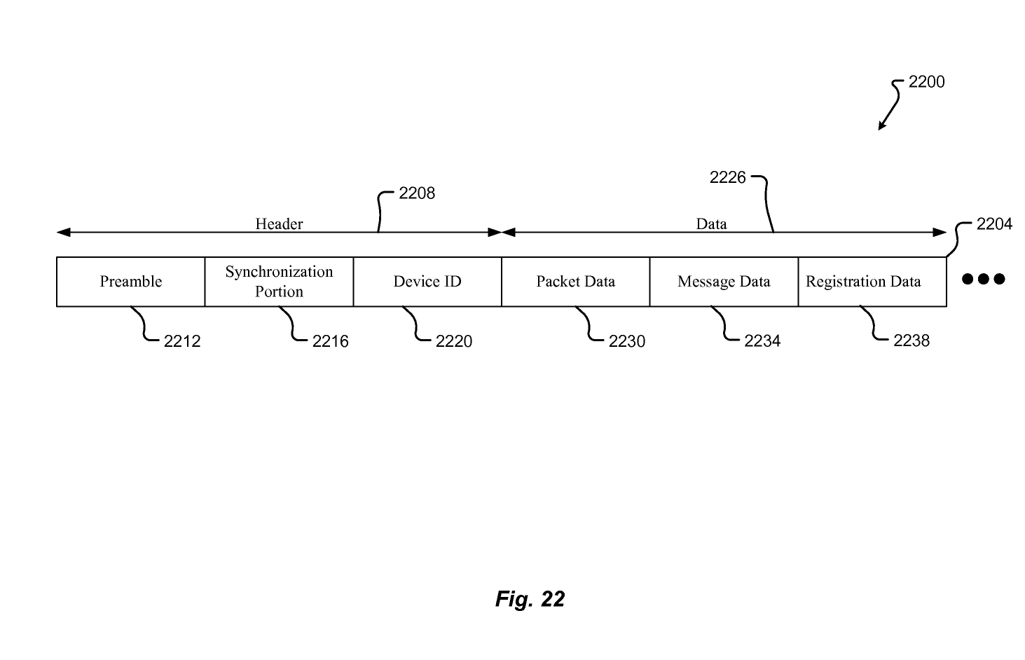

An embodiment of the optional intercepted signal(s) 2030 is shown in FIG. 22. In one embodiment, intercepted signal(s) 2030 may include a preamble 2212, synchronization portion 2216, device ID 2220, and data 2226. Data 2226 may include, for example, packet data 2230, message data 2234, and registration data 2238. In addition, data 2226 may include, for example, video data, voice data, or any other kind of data that may be transmitted or received by transmitter-receiver 2020. In some embodiments, header 2308 may include preamble 2212, synchronization portion 221, and device ID 2220. Preamble 2212 may be used by interceptor pairing system 2008 to determine whether a data packet has been transmitted to device 212 to be intercepted. Synchronization portion 2216 may be used by interceptor pairing system 2008 to allow for synchronization between interceptor pairing system 2008 and intercepted signal(s) 2030 and/or device 212. Device ID 2220 may be used, for example, to identify device 212.

An embodiment of an optional data structure 1200 to store information associated with one or more devices is shown in FIG. 2300. The data file 1250 may include several portions 1216-1262, 2356, 2360, 2362 representing different types of data. Each of these types of data may be associated with a device, as shown in portion 1252 and previously described in the description of FIG. 12B. Pairing data 2360 may include, for example, data generated by interceptor pairing system 2008 related to the pairing of the corresponding device with vehicle 2004. Registration data 2362 may include registration data related to the device corresponding to the intercepted signals. In one embodiment, the device id(s) 1220 and/or zone locations for pairing may be stored in, for example, data structure 1200.

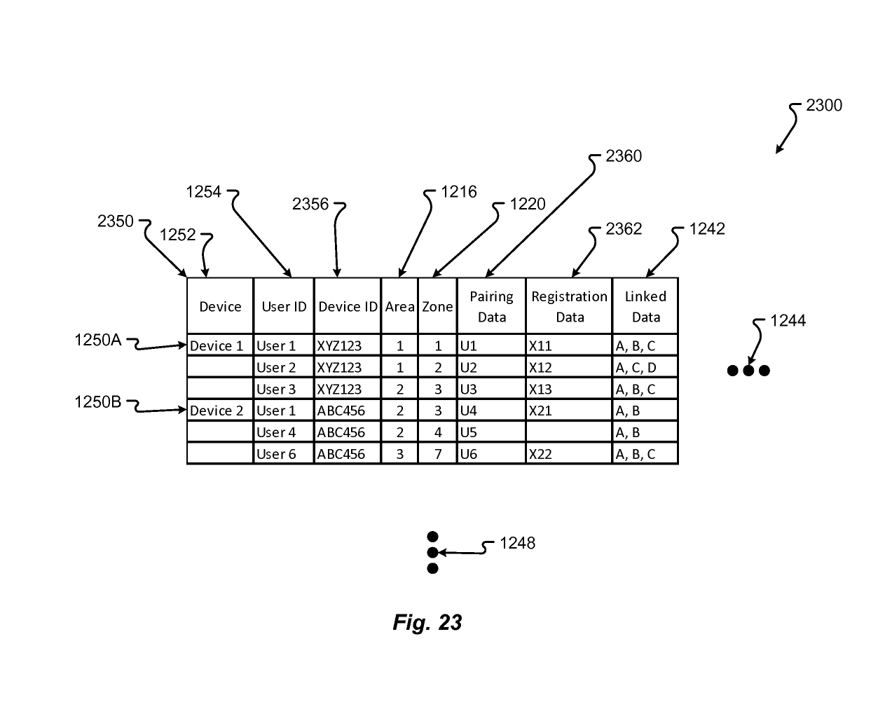

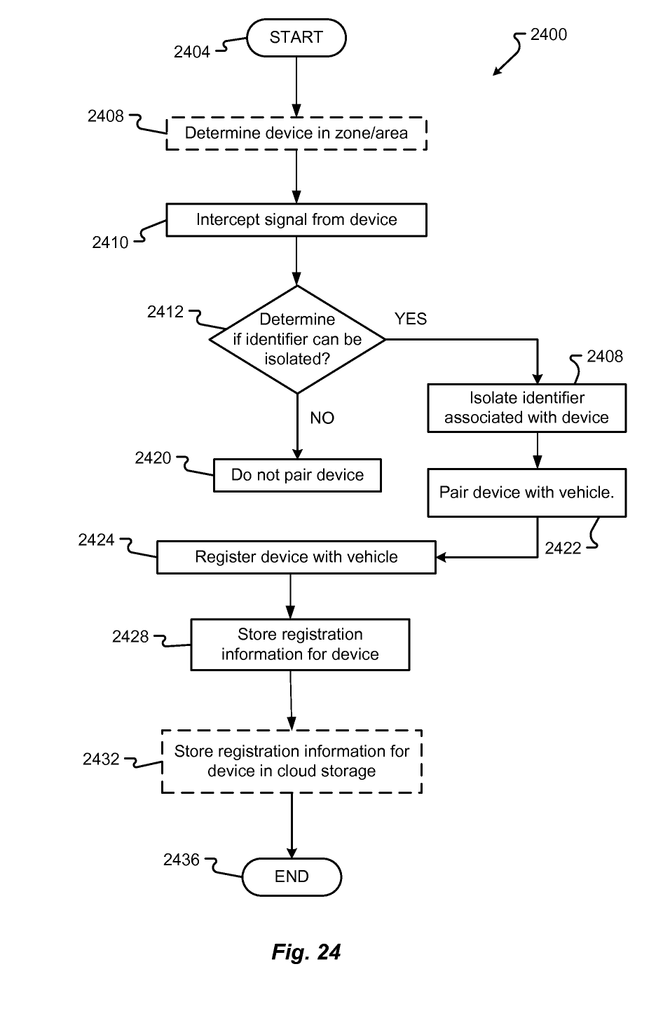

An embodiment of an optional method 2400 for pairing a device with a vehicle may be as shown in FIG. 24. A general order for the steps of the method 2400 is shown in FIG. 24. Generally, the method 2400 starts with a start operation 2404 and ends with an end operation 2404. The method 2400 can include more or fewer steps or can arrange the order of the steps differently than those shown in FIG. 24. The method 2400 can be executed as a set of computer-executable instructions executed by a computer system and encoded or stored on a computer readable medium. Hereinafter, the method 2400 shall be explained with reference to the systems, components, modules, software, data structures, user interfaces, etc. described in conjunction with FIGS. 1-23.

In step 2408, interceptor pairing system 2008 optionally determines the zone/area of device 212 and/or user 216. For example, heat sensing could be used to determine the location of the device in vehicle 2004. In another example, the power dissipated by device 212 could also be used to determine the location of device 212 in vehicle 2004. In another example, intercepted signal(s) 2030 may be used to determine zone/are of device 212. In general, any of the sensors disclosed herein can be used to assist with determining the zone/area of device 212. In step 2410, wired/wireless transceiver/communications port(s) 260 intercepts signal(s) 2030 from device 212 and/or transmitter-receiver 2020. Interceptor pairing system 2008 receives intercepted signal(s) 2040 or derivative thereof, such as, for example, intercepted signal(s) 2032, from wired/wireless transceiver/communications port(s) 260. Interceptor pairing system 2008 determines if the intercepted signal(s) 2032 have an identifier. In step 2412, if the intercepted signal(s) have an identifier(s), interceptor pairing system 2008 determines if the identifier(s) can be isolated. In step 2420, if the identifier(s) cannot be isolated, device 212 is not paired with vehicle 2004. In step 2408, if the identifier(s) can be isolated, interceptor pairing system 2008 isolates the identifier(s). In step 2422, pairing unit 2108 pairs device 212 with vehicle 2004. In step 2424, interceptor pairing system 2008 registers device 212 with vehicle 2004. In step 2428, interceptor pairing system 2008 may store registration information for device 212. In step 2432, cloud storage may be used to store registration information. In step 2436, method 2400 ends.

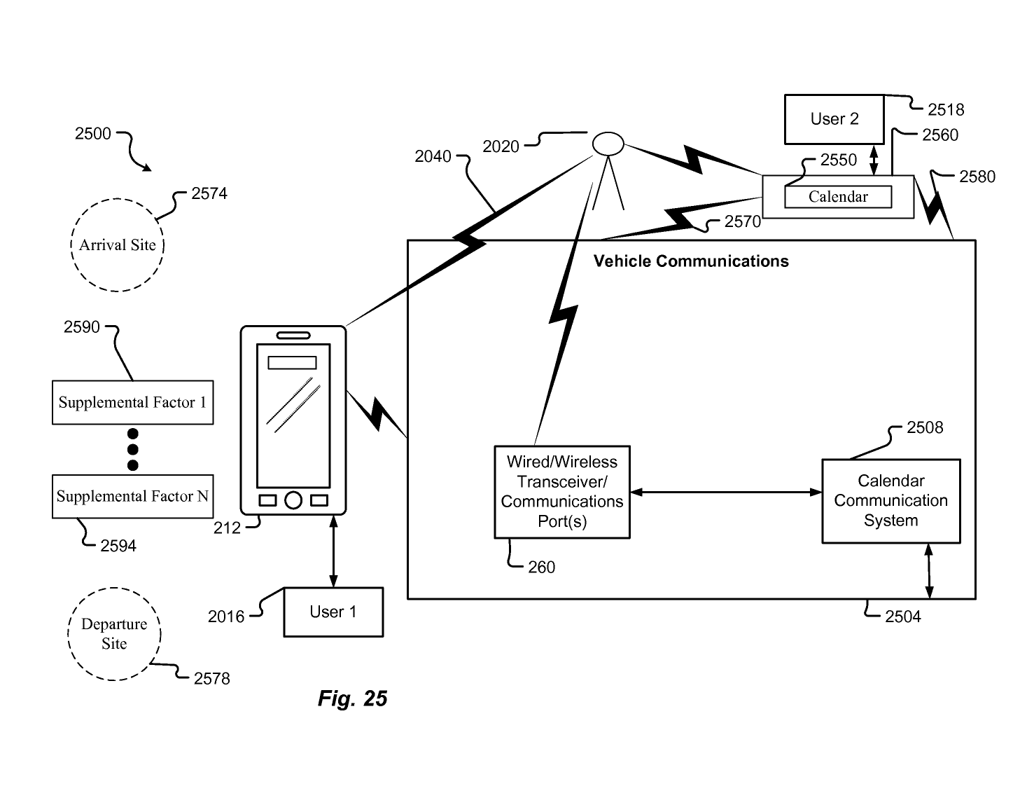

An optionally embodiment of a vehicle system 2500 is shown in FIG. 25. The illustrated vehicle system 2500 includes a vehicle 2504, an arrival site 2574, a departure site 2578, supplemental factors 2590-2594, a transmitter-receiver 2020, a device 212, a device 2560, a user 2518, and a user 216. Transmitter-receiver 2020 may be, for example, a cell tower, a base-station, etc. Vehicle 2504 includes a calendar communication system 2508 and wired/wireless transceiver/communications port(s) 260. In one embodiment, calendar communication system 2508 is coupled to vehicle 2504. Wired/wireless transceiver/communications port(s) 260 is coupled to calendar communication system 2508. Vehicle 2504 is capable of communicating wirelessly with transmitter-receiver 2020 and calendared device 212. Device 212 is capable of communicating wirelessly with transmitter-receiver 2020 and vehicle 2504. Device 2560 may be any wireless device capable of communicating wirelessly with vehicle 2504 and device 212.

In one configuration, vehicle 2504 transmits signal(s) 2580 to device 2560 to determine whether device 2560 is associated with vehicle 2504. In another configuration, device 2560 may initiate communication with vehicle 2504 by sending signal(s) 2570 to vehicle 2504. In response, vehicle 2504 receives signal(s) 2570 and determines whether device 2560 is associated with vehicle 2504. When device 2560 is associated with vehicle 2504, calendar communication system 2508 of vehicle 2504 sends signal(s) 2580 to device 2560 to determine whether device 2560 has a calendar, such as, for example, calendar 2550, associated with device 2560. If device 2560 has a calendar associated with it, vehicle 2560 determines whether device 2550 or user 2518 of device 2550 agrees to synchronize calendar 2550 with vehicle 2504. When vehicle 2504 receives a positive confirmation that device 2560 agrees to synchronize with vehicle 2504, vehicle 2504 synchronizes with calendar 2550. Upon synchronization or thereafter, vehicle 2504 determines the events scheduled in calendar 2550 in order to provide (and/or adjust if necessary) a smart-alarm or notice that may be provided to device 212, device 2560, user 2518, user 2016, and/or other persons/devices associated with the event. The smart-alarm may be based on, for example, the departure site of vehicle 2504 and/or a person or device associated with vehicle 2504, device 2560, the location of the event, and/or supplemental factors that may increase or decrease the time at which the smart-alarm is generated.

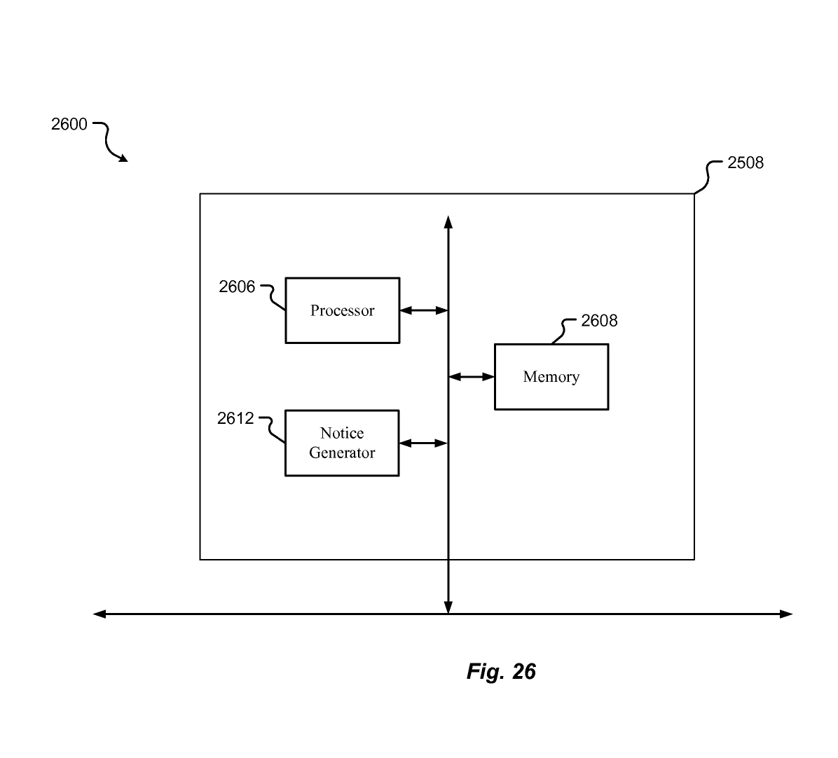

An embodiment of a calendar communication system 2600 is shown in FIG. 26. In one configuration, calendar communication system 2508 includes a processor 2606, a memory 2608, and a notice generator 2612. Notice generator 2612 is coupled to processor 2606 and memory 2608 via a bus and/or equivalent. Coupling described herein may include physical coupling and/or electronic coupling.

In one configuration, notice generator 2612 of calendar communication system 2508 receives signal(s) 2570 from device 2560. Notice generator 2612 uses signal(s) 2570 to determine whether device 2560 is associated with vehicle 2504. Being associated with vehicle 2560 may, for example, allow for synchronization features to occur automatically when vehicle 2560 is in proximity to device 2560, or at other instances dictated by device 2560 and/or vehicle 2504. If device 2560 is not associated with vehicle 2504, notice generator 2612 send signal(s) to device 2560 to ascertain whether device 2560 wishes to be associated with vehicle 2504. If device 2560 agrees to be associated with vehicle 2560, notice generator 2612 determines whether device 2560 has a calendar 2550 associated with device 2560.

In one embodiment, processor 2606 may be used to determine whether device 2560 has a calendar associated with it. In one embodiment, calendar flag bit(s) provided in signal(s) 2570 may be used by calendar communication system 2508 to ascertain whether device 2560 has a calendar 2550. In one embodiment, calendar communication system 2508 may determine whether device 2560 has a calendar associated with it by asking a user associated with device 2560 whether the user has a calendar on device 2560.

Notice generator 2612 requests permission of a user of device 2560 to synchronize calendar 2550 with vehicle 2504. After or upon synchronization with calendar 2550, notice generator 2612 ascertains whether events are scheduled in calendar 2550. Examples of events may include, for example, a meeting, an airline flight, a convention, etc. Notice generator 2612 ascertains the location of the scheduled events. In one embodiment, ascertaining the location of an event may be accomplished by accessing the location portion of calendar 2550. In one embodiment, when the location is not stated in the location portion of calendar 2550, notice generator 2612 may petition the user of device 2560 to provide the location of the event. In one embodiment, notice generator 2612 may petition an attendee of the event for the location of the event. For example, notice generator 2612 may ascertain from calendar 2550 an electronic correspondence address (email, text address, etc.) of an attendee. Notice generator 2612 may then request from the attendee the location of the event.

Upon ascertaining the location of the event, notice generator 2612 determines the length of time until the event takes place. In one embodiment, a length of time calculation may be utilized to determine whether it is time for notice generator 2612 to make a supplemental factor determination. A supplemental factor may be, for example, a factor that may cause additional time to be added to a notice for a scheduled event. For example, a supplemental factor may be an accident (e.g., vehicle accident), weather (e.g., a rain storm), traffic (e.g., a traffic jam), or any other event that could contribute to adding additional time to the notice.

In one embodiment, if the length of time until the event takes place does not meet a certain threshold, notice generator 2612 may not yet make a supplemental factor determination. If the length of time does meet a certain threshold, the notice generator 2612 may make a supplemental factor determination. In one embodiment, for example, a threshold may be, fifteen minutes to forty-eight hours until the event occurs. A threshold may be of even longer or shorter duration depending on the nature of the event. For example, if the event takes place in three months, i.e., the length of time until the event takes place is three months, it may not yet be necessary to perform a supplemental factor calculation if it does not meet the threshold. In one embodiment, the supplemental factor determination may be delayed by notice generator 2612 until the length of time until the event meets the certain threshold.

In one embodiment, upon ascertaining the location of the event and the length of time required until the scheduled event meets a certain threshold, notice generator 2612 determines whether there are supplemental factors and calculates the additional time the supplemental factors will add to the notice. For example, notice generator 2612 may check a weather website to determine whether it is raining in the city corresponding to the location of the scheduled event. Notice generator 2612 may then perform a calculation to determine the amount of additional time required to account for the supplemental factor. Notice generator 2612 then adds the additional time to the original notice time. In one embodiment, a supplemental factor classified as severe could add, for example, X minutes to the notice. A supplemental factor classified as mild could, for example, add Y minutes to the notice. A supplemental factor classified as minor could add, for example, Z minutes to the notice. X, Y, and Z may be variables representing a predetermined amount of time for the supplemental factor and/or an amount of time calculated by formula. For example, a weather storm classified as a severe storm could add one hour to the notice. A weather storm classified as a mild storm could add thirty minutes to the notice. A weather storm classified as minor could add 15 minutes to the notice. The additional time calculated and/or predetermined by notice generator may be added to a notice to generate a smart alarm. The smart alarm may then be provided by notice generator 2612 to a user of calendar 2550 and/or a person or device associated with device 2560 and/or one or more attendees of the event.

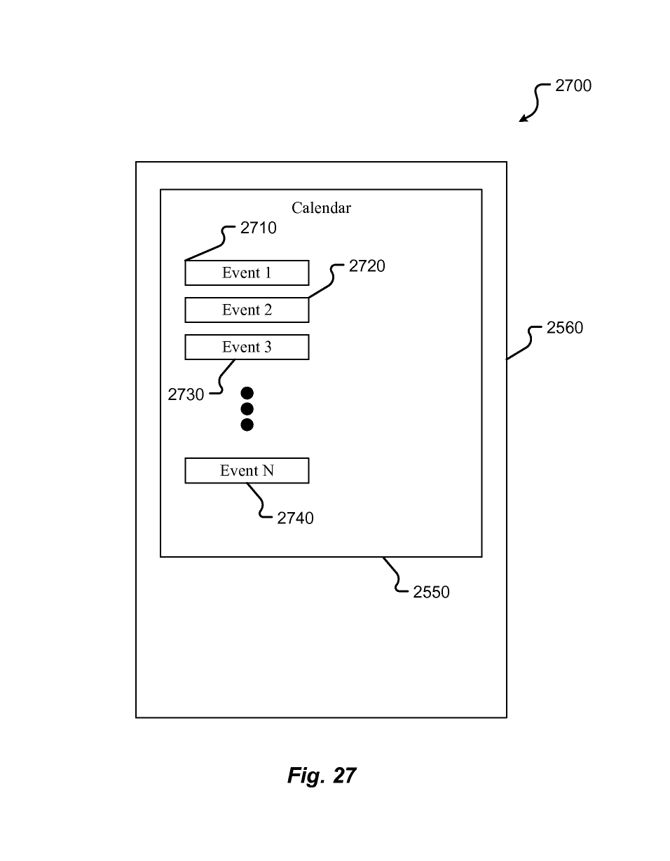

An optional embodiment of a device 2560 is shown in FIG. 27. Device 2560 includes a calendar 2550. Calendar 2550 includes event 1 2710, event 2 2720, event 3 2730, to event N 2740. Events 2770-2740 may include, for example, any item(s) scheduled on calendar 2550. Examples of events 2770 -2740 may include, for example, a meeting, an airline flight, a convention, etc.

In one embodiment, vehicle 2504 can sync with calendar(s) 2550 to create (i) smarter alarms and (ii) updates. For example, instead of a standard 15 minute warning before a meeting, if the meeting is an offsite meeting with an address entered, a smart alarm system can determine how much time it will take based upon traffic, previous driving habits, the amount of time it generally takes to exit the office and get to the car, etc., and change the warning accordingly. In one embodiment, the updates can be triggered based upon the time of arrival determination from the GPS or as calculated above and send SMS notices to other attendees or prompt to call the meeting leader. In another embodiment, for example, if vehicle 2504 determines vehicle 2504 and/or a driver/passenger of vehicle 2504 is stopping at a coffee shop, it can remotely ask other meeting attendees if they want anything from the coffee shop.

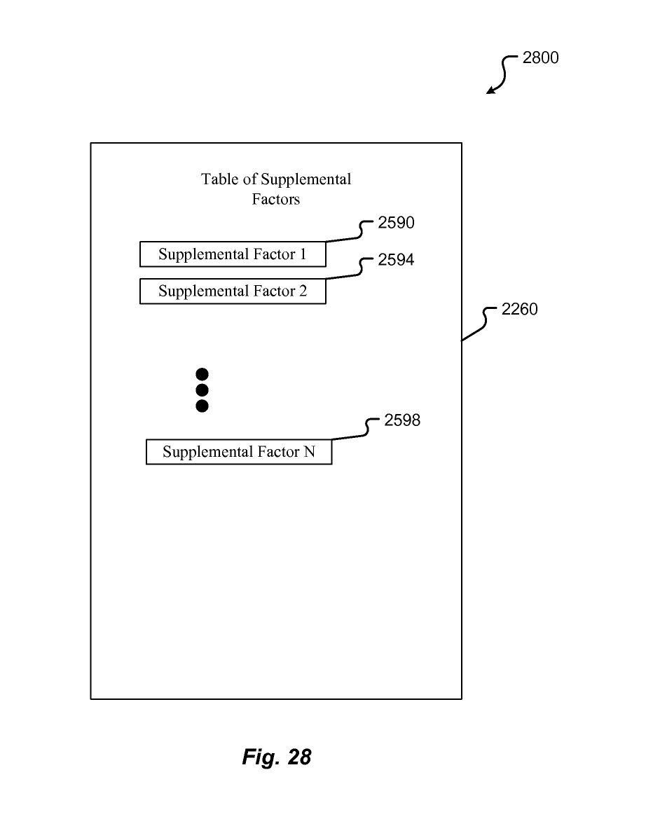

An embodiment of an optional table of supplemental factors is shown in FIG. 28. Table of supplemental factors 2260 includes supplemental factor 1 2590, supplemental factor 2 2594, to supplemental factor 2598. Supplemental factors 2590-2598 may be based on, for example, an amount of traffic from a departure site to an arrival site. Supplemental factors 2590-2598 may be based on an amount of time required for user 2016 to arrive at vehicle 2504 from a departure site. A departure site may be for example, a location from which user 212 is departing. In general, the supplemental factors can include any information that may have an impact on one or more of the calendared items.

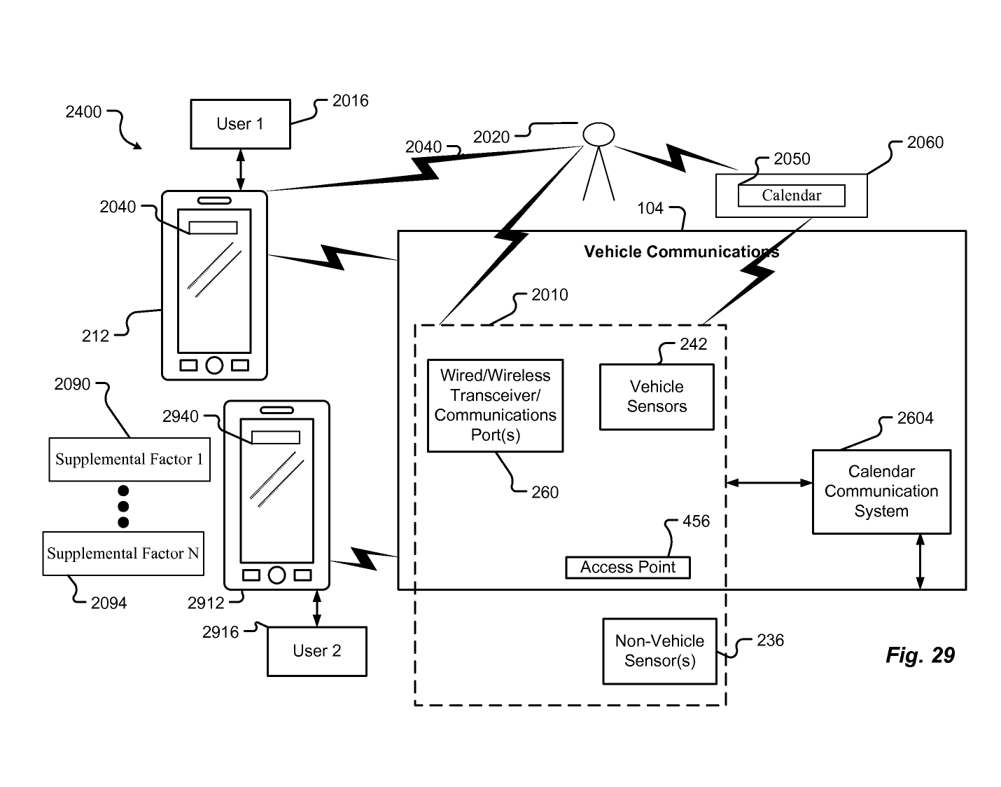

An embodiment of an optional set of conditions is shown in FIG. 29. Set of conditions 2320 includes, for example, condition 1 2930, condition 2 2940, to condition N 2950. Set of conditions 2920 may provide conditions as to when a notice will be sent from the calendar communication system to device 2912 and/or user 2916. For example, at least one of the set of conditions may be based on user 2916 being a colleague of user 2016. In another example, a condition may be based on user 2016 being a party to the event scheduled on calendar 2050. Other conditions may also be implemented as necessary.

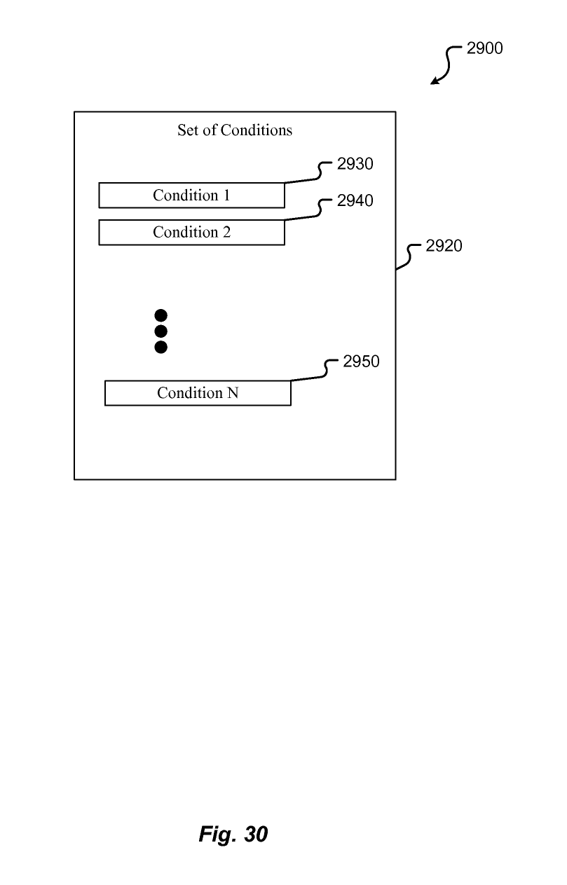

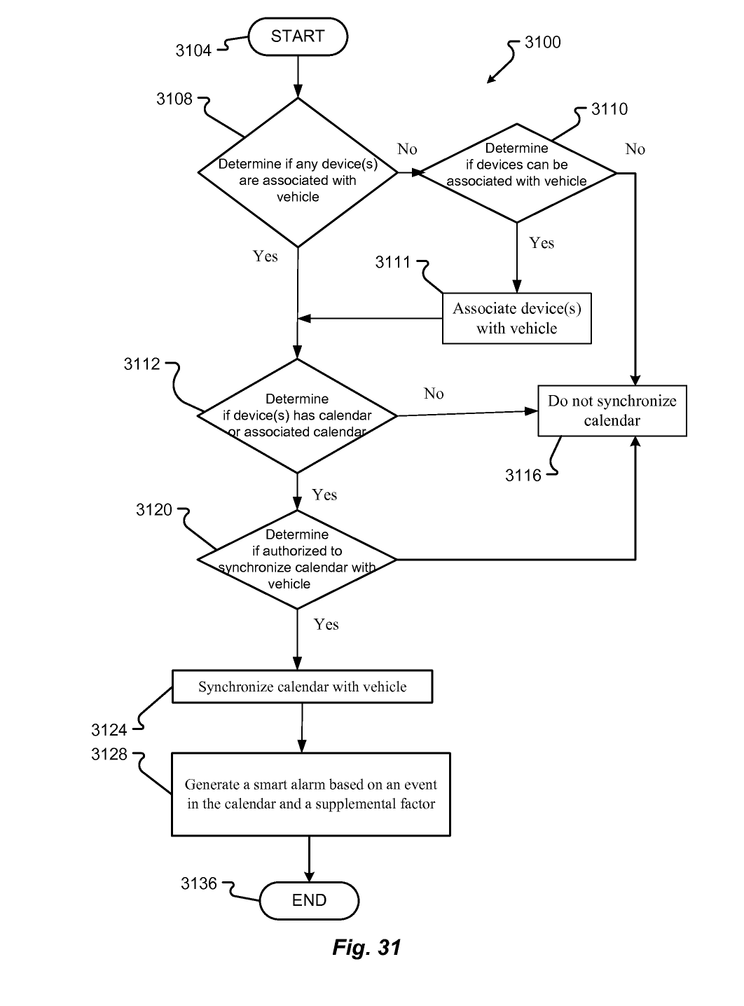

An embodiment of an optional method 3100 for generating a smart alarm is shown in FIG. 31. A general order for the steps of the method 3100 is shown in FIG. 31. Generally, the method 3100 starts with a start operation 3104 and ends with an end operation 3136. The method 3100 can include more or fewer steps or can arrange the order of the steps differently than those shown in FIG. 31. The method 3100 can be executed as a set of computer-executable instructions executed by a computer system and encoded or stored on a computer readable medium. Hereinafter, the method 3100 shall be explained with reference to the systems, components, modules, software, data structures, user interfaces, etc. described in conjunction with FIGS. 1-30.

In step 3108, calendar communication system 2508 may determine whether any devices located internal or external to vehicle 2504 (such as, for example, device 212 and/or device 2560) are or can be associated with the vehicle. If device 212 and/or device 2560 are not associated with vehicle 2504, step 3110, calendar communication system 2508 determines if device 212 and/or device 2560 can be associated with vehicle 2504. If device 212 and/or device 2560 can be associated with vehicle 2504, in step 3111, device 212 and/or device 2560 are associated with vehicle 2504. If device 212 and/or device 2560 cannot be associated with vehicle 2504, in step 3116, calendars on device 212 and/or device 2560 are not synchronized with calendar communication system 2508.

In step 3112, if device 212 and/or device 2560 is associated with vehicle 2504 or subsequently becomes associated with vehicle 2504, calendar communication system 2508 determines if the device has a calendar or has a calendar associated with it. If device 2560 has a calendar 2550 associated with it, in step 3120, calendar communication system 2508 determines if it is authorized to synchronize calendar 2550 with vehicle 2504. If calendar communication system 2508 is authorized to synchronized calendar 2550 with vehicle 2504, in step 3124, calendar communication system 2508 synchronizes calendar 2550 with vehicle 2504. For example, calendar communication system 2508 and/or vehicle control system 204 may be synchronized with calendar 2550. In step 3128, a smart alarm is generated based on an event 2710 in calendar 2550 and a supplemental factor 2590. In step 2436, method 2400 ends.

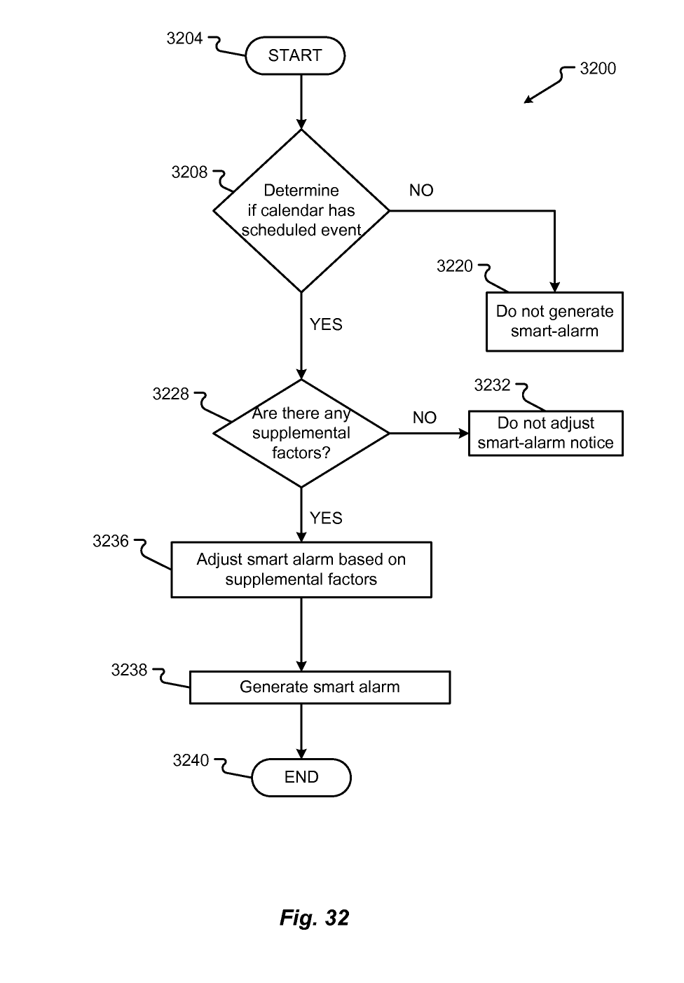

An embodiment of an optional method 3200 for step 3128 shown in FIG. 32. A general order for the steps of the method 3100 is shown in FIG. 31. Generally, the method 3200 starts with a start operation 3204 and ends with an end operation 3240. The method 3200 can include more or fewer steps or can arrange the order of the steps differently than those shown in FIG. 31. The method 3200 can be executed as a set of computer-executable instructions executed by a computer system and encoded or stored on a computer readable medium. Hereinafter, the method 3200 shall be explained with reference to the systems, components, modules, software, data structures, user interfaces, etc. described in conjunction with FIGS. 1-31.

In step 3208, calendar communication system 2508 determines if calendar 2550 has a scheduled event 2710-2740. In step 3220, if there is not an event scheduled in calendar 2550, a smart-alarm is not generated. In step 3228, if there is an event scheduled in calendar 2550, calendar communication system 2508 determines if there are any supplemental factors 2590-2598 associated with the event. In step 3232, if there are not any supplemental factors, the smart-alarm is not adjusted. In step 3236, if there are supplemental factors 2590-2598, the smart-alarm is adjusted based on the supplemental factors 2590-2598. In step 3238, a smart-alarm is generated. In step 3240, method 3200 ends.

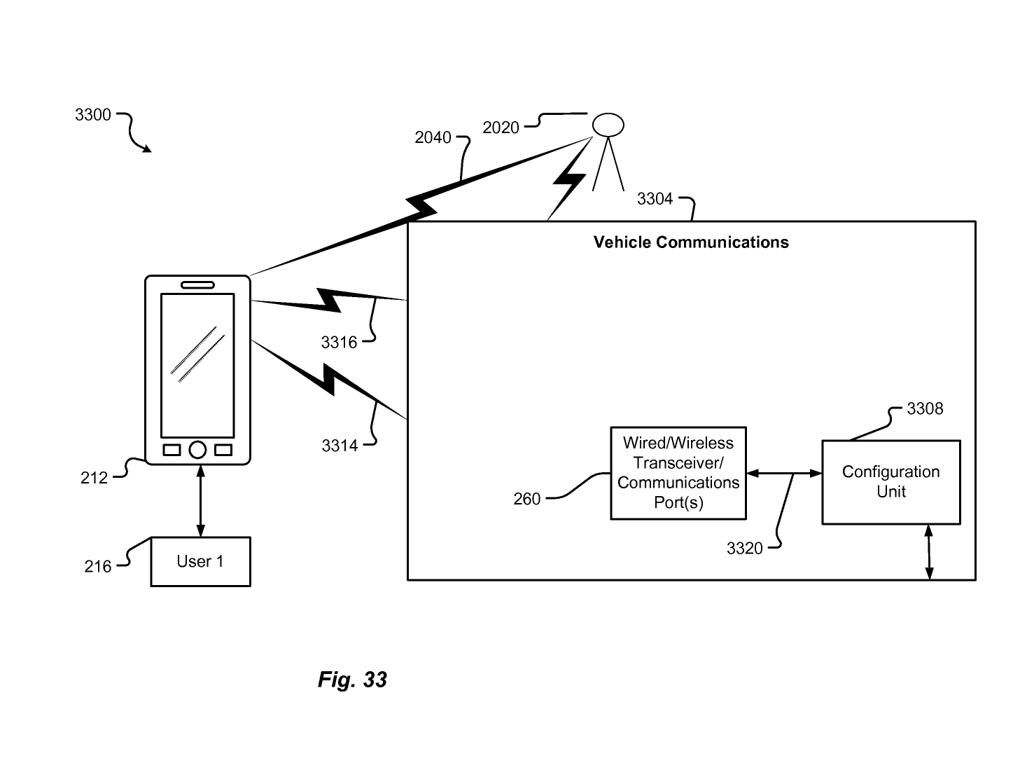

An embodiment of an optional vehicle system 3300 is shown in FIG. 33. The illustrated vehicle system 3300 includes a vehicle 3304, a transmitter-receiver 2020, a device 212, and a user 216. In one embodiment, vehicle 3304 includes a configuration unit 3308 and a wired/wireless transceiver/communications port(s) 260. Wired/wireless transceiver/communications port(s) 260 is coupled to configuration unit 3308. Configuration unit 3308 is coupled to vehicle 3304. Transmitter-receiver 2020 may be, for example, a cell tower, base-station, etc. Vehicle 3304 is capable of communicating wirelessly with transmitter-receiver 2020 and device 212. Device 212 is capable of communicating wirelessly with transmitter-receiver 2020. Transmitter-receiver 2020 is capable of communicating wirelessly with vehicle 3304 and device 212. Vehicle 3304 may be electronically coupled to device 212 and transmitter-receiver 2020.

In one embodiment, configuration unit 3308 of vehicle 3304 transmits signal(s) 3314 to device 212 via wired/wireless transceiver/communications port(s) 260 to determine whether user 216 has accessed and/or created information using device 212. For example, the information accessed or created may be in the form of a file, web page, etc. Information created and/or accessed by user 216 may be, for example, a text message, an email, a phone recording, a social-networking status, or a social networking post. Device 212 receives the signal(s) and determines whether user 216 has accessed and/or created information. If user 216 has accessed/created information, device 221 sends the information to vehicle 3304. Vehicle 3304 receives the information via wired/wireless transceiver/communications port(s) 260 and provides the received information to configuration unit 3308. Configuration unit 3308 assesses the information received from device 212. Using the information, configuration unit 3308 determines whether vehicle 3304 should be configured based upon the information. When configuration unit 3308 determines that vehicle 3304 should be configured, configuration unit 3308 configures vehicle 3304 based on the information. In one embodiment, configuration unit 3308 may display the received information, such as, for example, a map accessed by user 216.

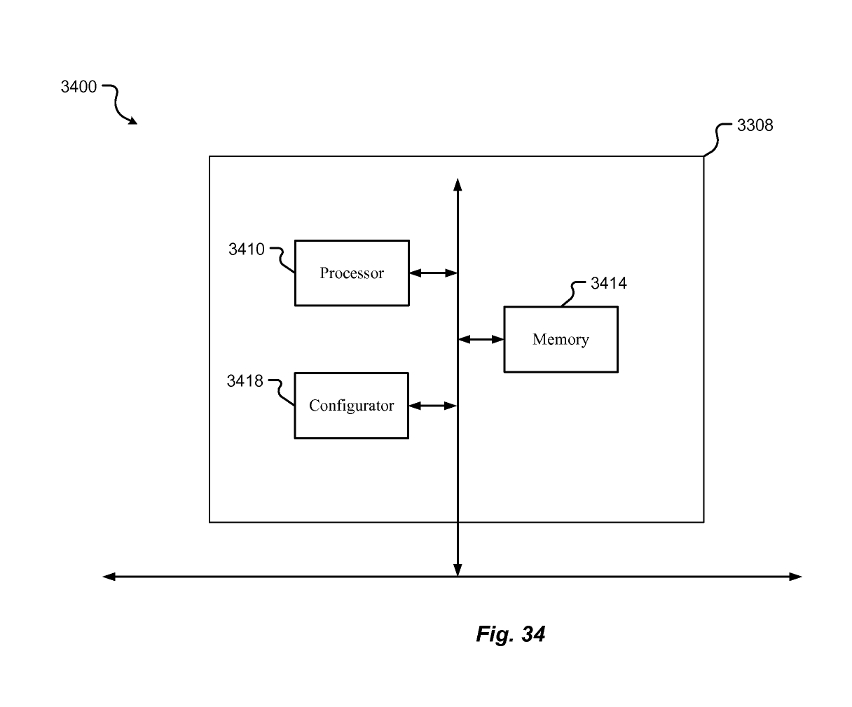

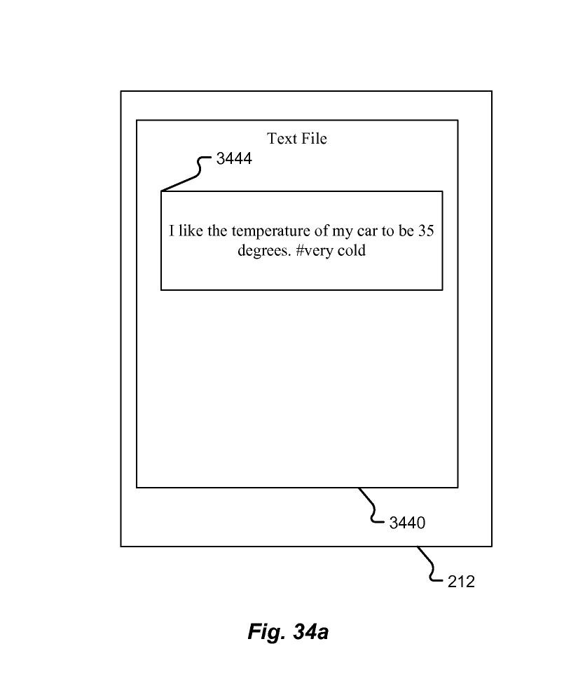

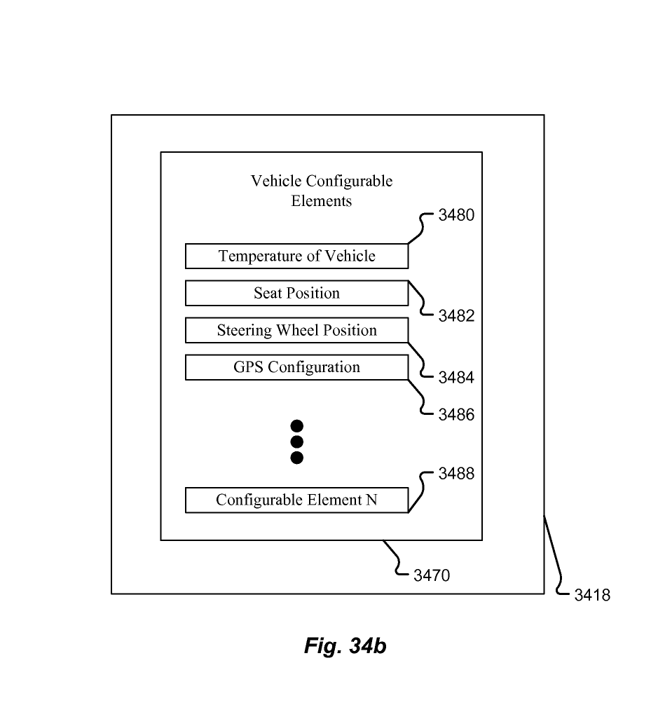

An embodiment of a configuration unit 3308 is shown in FIG. 34. In one embodiment, illustrated configuration unit 3308 includes a processor 3410, a memory 3418, and a configurator 3418. Processor 3410, memory 3418, audio I/O interface 4274, and sensing control system 3708 may be coupled together via a bus and/or equivalent.

In one embodiment, configurator 3418 of configuration unit 3308 receives signal(s) 3320 from device 212. Configurator 3418 accesses the configuration portion of signal(s) 3320. Configurator 3418 categorizes the configuration portion of the received signal(s) 3320. For example, the configuration portion may be in the form of a text file, word file, image file, etc. Configurator 3418 reviews the information contained in the configuration portion to determine the content of the information. For example, configurator 3418 may review the information contained in the configuration portion to ascertain whether it has content that can be used to configure vehicle 3304. Configurator 3418 compares the reviewed content to a predetermined table of configurable elements of vehicle 3304. When configurator 3418 determines that the content of the configuration portion maps to a configurable element of vehicle 3304, configuration unit 3308 configures vehicle 3308 to the prescribed configuration.

In one embodiment, the predetermined table of configurable elements of vehicle 3304 that may be configured may be stored in memory 3414. Configurator 3418 compares key words, images, etc. associated with the predetermined configurable elements.

For example, configurator 3418 may review a file to determine that text in the file contains references to vehicle temperature. Configurator 3418 may then configure vehicle 3304 to the prescribed temperature described in the text. In another embodiment, after reviewing a social networking post provided by device 212, configurator 3418 may determine user 216 prefers to have the vehicle seat placed at a certain distance from the steering wheel. Configurator 3418 may then configure vehicle 3304 to the prescribed seating placement.

In one embodiment, for example, a user 216 performs a search at an office or at home using device 212. The result of the search by user 216 may yield a direction/map. Device 212 may send the direction/map automatically to vehicle 3304. The direction/map may be sent to the GPS system of vehicle 3304 for configuration. In another embodiment, upon determining that user 216 has performed a map search, configurator 3418 may provide the map to configure the GPS system of vehicle 3304, or simply display the map for use by user 216.

In one embodiment, the information may be stored in the cloud. In another embodiment, the information may be detected by vehicle 3304 upon receiving a registration signal from device 212 that is associated with the user. In one configuration, for example, the vehicle may review text messages, email, phone recordings, social networking status, social networking posts, and the like to determine information used to configure specific vehicle settings.

In one configuration, the information may be transferred to vehicle 3304 via a SmartHome (e.g., an associated home automation system). For example, one or more home devices and vehicle 3304 may be synchronized. The syncing may occur, for example, when the vehicle is in proximity to the home, parked in the garage, or travelling away from the home. In one embodiment, the syncing may be caused by a timer and/or other event.

An embodiment of a text file is shown in FIG. 34a. Text file 3440 includes text 3444 generated by user 216 on device 212. Text 3444 is an example of text that can be provided to vehicle 3304 for use by configuration unit 3308. Configuration unit 3308 receives the text file and may review text file 3440 to configure vehicle 3304. For example, in FIG. 34a, the user 216 generated a text stating “I like the temperature of my car to be 35 degrees. #very cold”. In one embodiment, configuration unit 3308 may review the content of text file 3440 and configure vehicle 3304 to a temperature indicated in the file.

An embodiment of a table of vehicle configurable elements is shown in FIG. 34b. Table of vehicle configurable elements 3470 includes temperature of vehicle 3480, seat position 3482, steering wheel position 3484, GPS Configuration 3486, and configurable element N. Table of vehicle configurable elements 3470 may be stored in configurator 3418, processor 3410, and/or memory 3414. Other vehicle configurable elements related to the configuration of vehicle 3304 may be added to table of vehicle of configurable elements 3470 as needed to configure vehicle 3304.

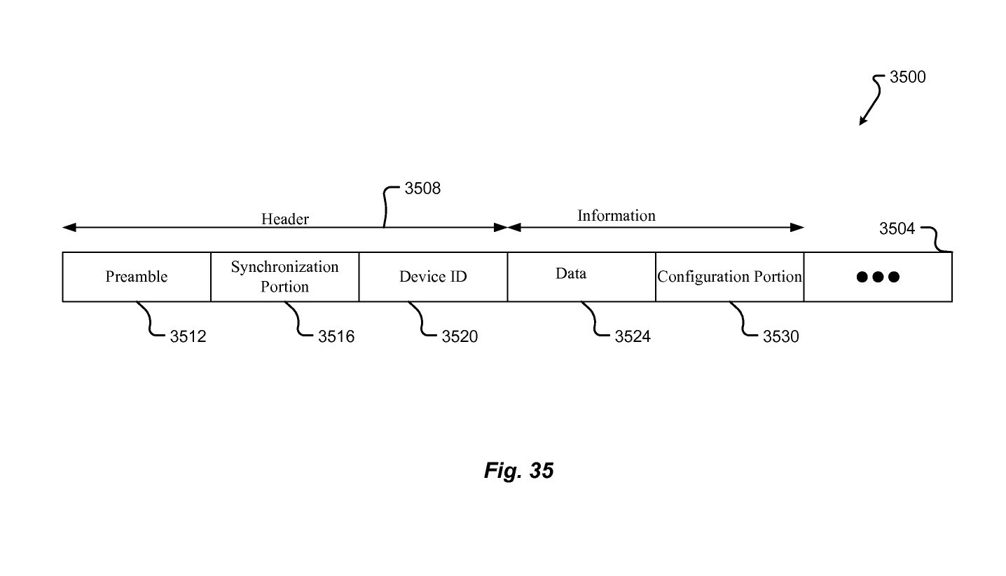

An embodiment of optional signal(s) 3320 is shown in FIG. 35. In one embodiment, signal(s) 3320 may include a preamble 3512, synchronization portion 3516, device ID 3520, data 3524, and configuration portion 3530. Configuration portion 3530 may include, for example, data files corresponding text, email, audio recordings, video recordings, social networks, images, maps, and/or any other files user 216 may be capable of generating and/or storing using device 212. In one embodiment, the configuration portion 3530 ascertained by vehicle 4404 may be used by configuration unit 3308 to configure vehicle 3304.

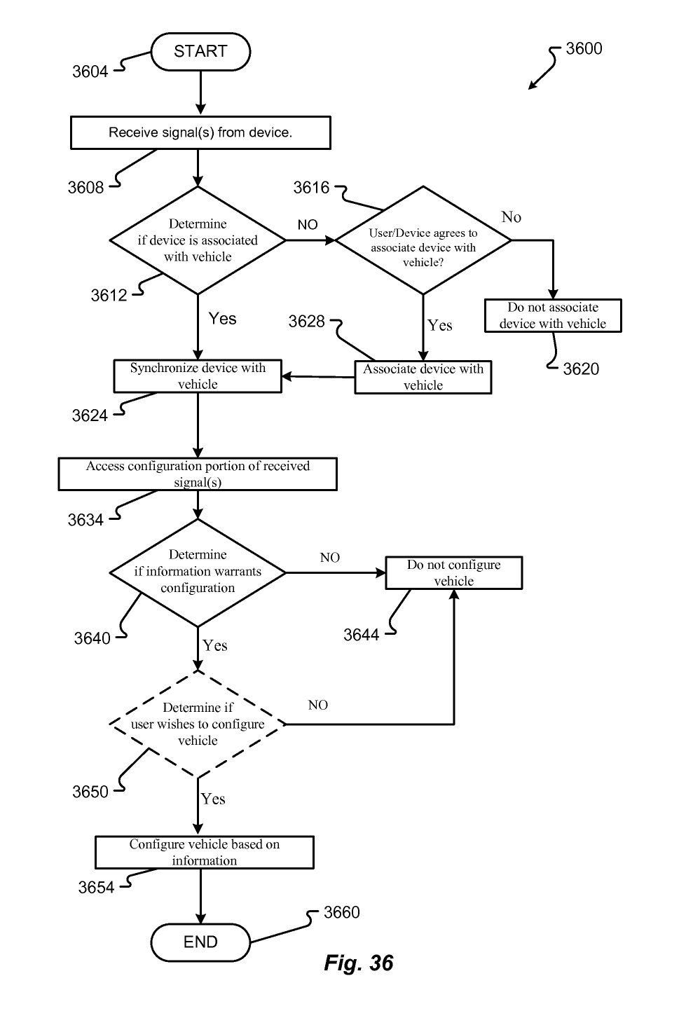

An embodiment of an optional method 3600 for configuring a vehicle may be as shown in FIG. 36. A general order for the steps of the method 3600 is shown in FIG. 36. Generally, the method 3600 starts with a start operation 3604 and ends with an end operation 3660. The method 3600 can include more or fewer steps or can arrange the order of the steps differently than those shown in FIG. 36. The method 3600 can be executed as a set of computer-executable instructions executed by a computer system and encoded or stored on a computer readable medium. Hereinafter, the method 3600 shall be explained with reference to the systems, components, modules, software, data structures, user interfaces, etc. described in conjunction with FIGS. 1-35.

In step 3604, method 3600 commences. In step 3608, wired/wireless transceiver/communications port(s) 260 of vehicle 3304 receive signal(s) 3314 from device 212. In step 3612, configuration unit 3308 determines whether device 212 is associated with vehicle 3304. In step 3616, when device is not associated with vehicle 3304, configuration unit 3308 determines whether device 212 agrees to be associated with vehicle 3304. In step 3620, when device 212 does not agree to be associated with vehicle 3304, configuration unit 3620 does not associate device 212 with vehicle 3304. In step 3628, when device 212 agrees to be associated with vehicle 3304, configuration unit 3308 associates device 212 with vehicle 3304. In step 3624, configuration unit 3624 synchronizes device 212 with vehicle 3304. In step 3634, configuration unit 2208 accesses the configuration portion of signal(s) 3314. In step 3640, configuration unit 3308 may optionally determine if user 216 agrees to configure vehicle 3304. In step 3644, when user 216 does not agree to configure vehicle 3304, configuration unit 3308 does not configure vehicle 3304. In step 3654, configuration unit 3308 configures vehicle 3304. In one embodiment, in step 3654, configuration unit 3308 configures vehicle 3304 after user 216 agrees to configure vehicle 3304. In step 3660, method 3600 ends.

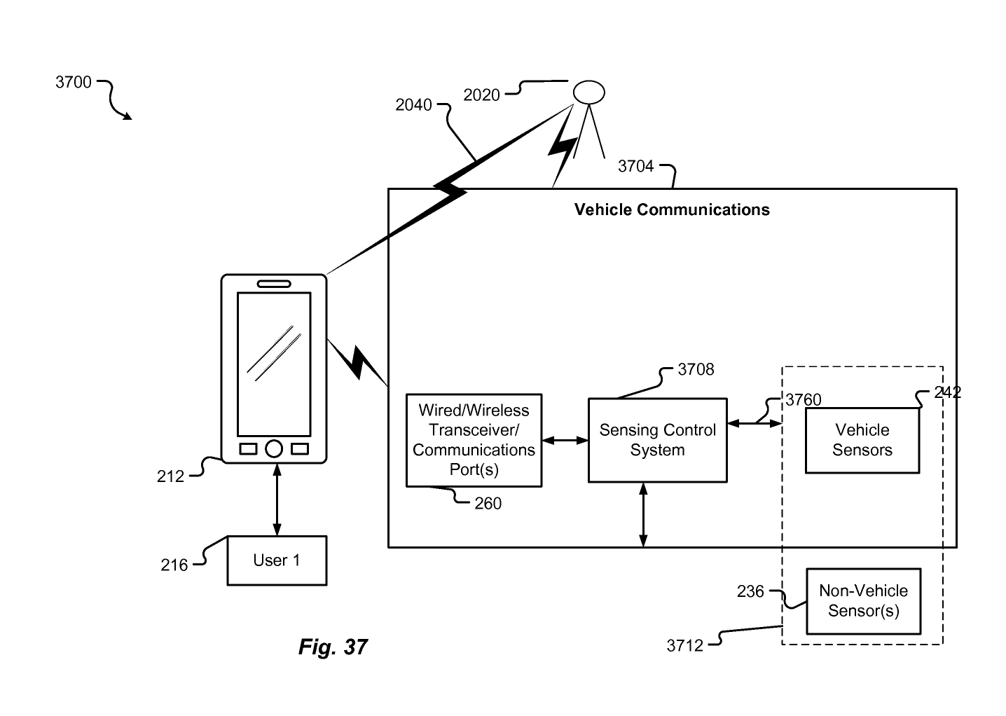

An embodiment of an optional vehicle system 3700 is shown in FIG. 37. The illustrated vehicle system 3700 includes a vehicle 3704, a transmitter-receiver 2020, a device 212, and a user 216. Transmitter-receiver 2020 may be, for example, a cell tower, base-station, etc. Vehicle 3704 is capable of communicating wirelessly with transmitter-receiver 2020 and device 212. Device 212 is capable of communicating wirelessly with transmitter-receiver 2020. Transmitter-receiver 2020 is capable of communicating wirelessly with vehicle 4104 and device 212. Vehicle 3704 may be electronically coupled to device 212 and transmitter-receiver 2020.

In one embodiment, vehicle 3704 includes a sensing control system 3708, wired/wireless transceiver/communications port(s) 260, and a sensor unit 3712. Sensor unit 3712 may include vehicle sensors 242, and/or non-vehicle sensors 236. In one configuration, sensor unit 3712 is coupled to sensing control system 3708. Sensing control system 3708 is coupled to wired/wireless transceiver/communications port(s) 260 and vehicle 3704.

In one embodiment, sensing control system 3708 sends signal(s) 3760 to sensor unit 3712 as a command for sensor unit 3712 to sense the status of vehicle 3704. The status of vehicle 3704 may include sensing vehicle information such as, for example, the amount of voltage in the battery of vehicle 3704, the amount of oil in vehicle 3704, the amount of starter fluid in vehicle 3704, and/or the character of the windshield wipers of vehicle 3704, and/or any other type of vehicle information related to vehicle 3704 capable of being sensed by sensor unit 3712.

Sensor unit 3712 provides the vehicle information to sensing control system 3708. In one embodiment, sensing control system 3708 assesses the vehicle information. Sensing control system 3708 uses the vehicle information to determine the proper action to be taken. For example, sensing control system 3708 may use the vehicle information provided by sensor unit 3712 to determine whether vehicle 3704 needs an oil change, whether the wipers of vehicle 3704 need to replaced, whether the battery of vehicle 3704 needs to replaced, whether the voltage of the battery of vehicle 3704 is low, etc. A vehicle action may be, for example, the act of changing the oil, replacing the wipers, and/or replacing the battery. In one embodiment, vehicle 3704 may be, for example, a vehicle that does not rely on petroleum-based-fuel for its energy. The vehicle information sensed by sensor unit 3712 may allow vehicle 3704 to determine whether vehicle 3704 needs to be charged.

Sensing control system provides the result of its assessment (e.g., the vehicle issue and/or the vehicle action required) to wired/wireless transceiver/communications port 290 for transmission to device 212, user 216, or any other device or user associated with vehicle 3704 capable of receiving the result of the assessment.

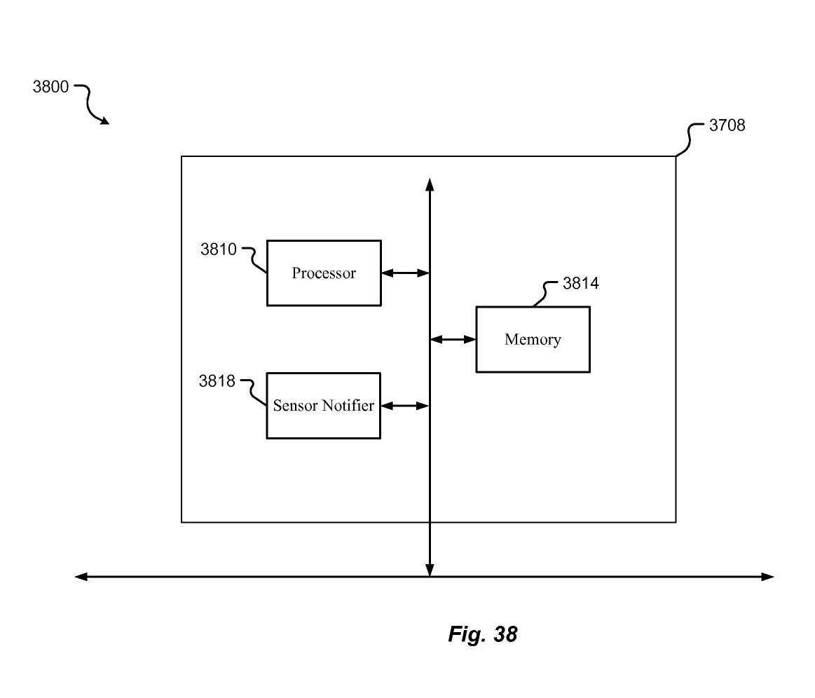

An embodiment of an optional sensing control system 3708 is shown in FIG. 38. In one configuration, illustrated sensing control system 3708 includes a processor 3810, a memory 3814, and a sensor notifier 3818. Processor 3810, memory 4214, and sensing control system 3708 may be coupled together via a bus and/or equivalent.

In one configuration, sensor notifier 3818 of sensing control system 3708 receives signal(s) 3760 from sensor unit 3760. In one embodiment, signal(s) 3760 include vehicle information related to the status of the vehicle 4104. In one embodiment, thresholds may be established by sensing control system 3708 to allow sensor notifier 3818 to assess whether a notice should be sent to, for example, device 212, and/or user 216. The thresholds may be stored in memory 3814, processor 3810, and/or sensor notifier 3818. Sensor notifier 3818 compares the received vehicle information to predetermined thresholds. Based on the assessment by sensor notifier 3818, sensing control system 3708 provides a notice to wired/wireless transceiver/communications port(s) 260 for delivery to device 212 and/or user 216.

In one embodiment, vehicle 3704 may sense when it needs something related to vehicle health, maintenance, and the like. For example, vehicle 3704 may sense when it needs an oil change, windshield washer fluid, and/or wiper blades. Vehicle 3704 may notify, for example, the driver of vehicle 3704 as needed. In one example, vehicle 3704 may create a shopping list for a user 216. In one embodiment, user 216 can define the items/actions user 216 wants to address. For example, some users may want to change their oil, while other users may only feel comfortable changing out wiper blades. In one embodiment, notifications may be timed to arrive during safe driving situations or only during safe driving situations. For example, notifications may be timed to arrive while vehicle 3704 is at a red light or during a time when vehicle 3704 is on a long, straight stretch of road. In some cases, the shopping list and/or notification may be sent to one or more devices associated with a user of the vehicle.

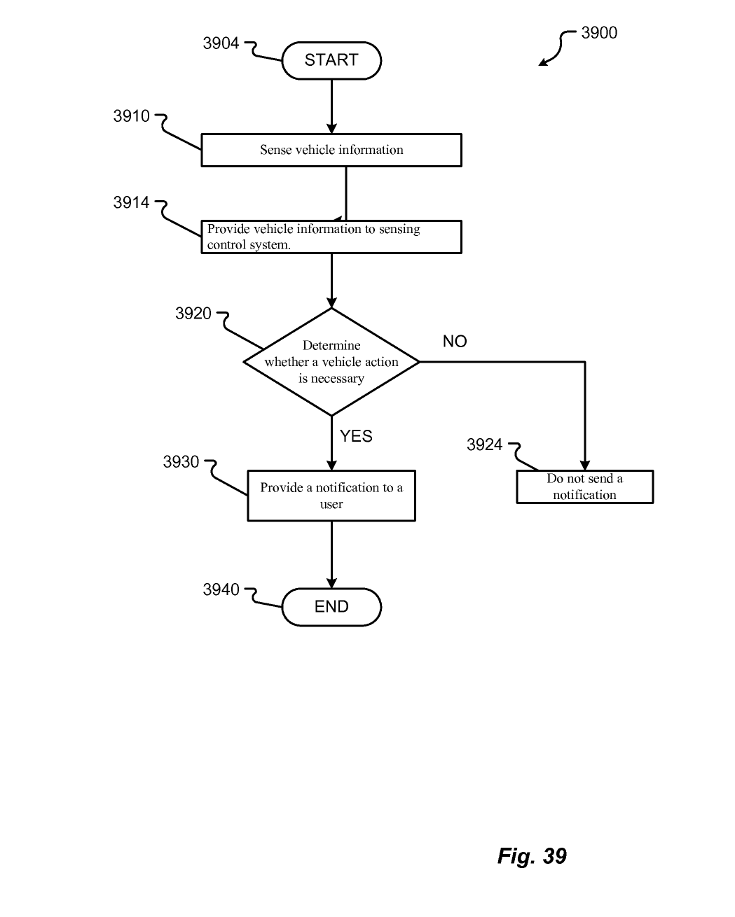

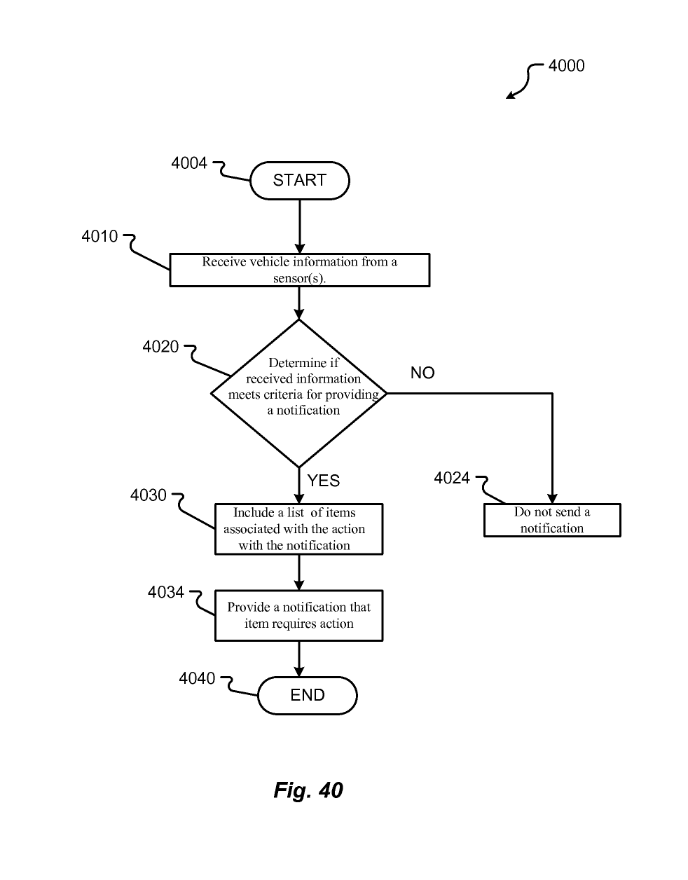

An embodiment of a method 3900 for providing the optional notification may be as shown in FIG. 40. A general order for the steps of the method 3900 is shown in FIG. 39. Generally, the method 3900 starts with a start operation 3904 and ends with an end operation 3940. The method 3900 can include more or fewer steps or can arrange the order of the steps differently than those shown in FIG. 39. The method 3900 can be executed as a set of computer-executable instructions executed by a computer system and encoded or stored on a computer readable medium. Hereinafter, the method 3900 shall be explained with reference to the systems, components, modules, software, data structures, user interfaces, etc. described in conjunction with FIGS. 1-38.

In step 3904, method 3900 commences. In step 3910, sensor unit 3712 senses vehicle information related to vehicle 3704. In step 3914, sensor unit 3712 provides the vehicle information to sensing control system 3708. In step 3920, based on the vehicle information, sensing control system 3708 determines whether a vehicle action is necessary. In step 3924, when a vehicle action is not necessary, sensing control system 3708 does not send a notification to user 216. In step 3930, when a vehicle action is necessary, sensing control system provides a notification to user 216. In step 3940, method 3900 ends.

An embodiment of a method 4000 for providing an optional notification may be as shown in FIG. 40. A general order for the steps of the method 4000 is shown in FIG. 40. Generally, the method 4000 starts with a start operation 4004 and ends with an end operation 4040. The method 4000 can include more or fewer steps or can arrange the order of the steps differently than those shown in FIG. 40. The method 4000 can be executed as a set of computer-executable instructions executed by a computer system and encoded or stored on a computer readable medium. Hereinafter, the method 4000 shall be explained with reference to the systems, components, modules, software, data structures, user interfaces, etc. described in conjunction with FIGS. 1-39.

In step 4004, method 4000 commences. In step 4010, sensing control system 3708 receives vehicle information from sensor unit 3712. In step 402, sensing control system 3708 determines if the received vehicle information meets a criteria and/or threshold for providing a notification to, for example, user device 212 and/or another party, user, or device authorized by sensing control system 3708 and/or associated with vehicle 3704. In step 4024, when sensing control system 3708 determines that the received vehicle information has not met the criteria for providing a notification, sensing control system 3708 does not provide a notification to user device 212. In step 4030, when sensing control system 3708 determines that the received vehicle information has met the criteria for providing a notification, sensing control system 3708 includes a list of items associated with the action. In one embodiment, the list(s) of items may be included as a shopping list associated with the vehicle action. For example, for a change of oil vehicle action, the list may include 3 quarts of oil, an oil stick, etc. In step 4024, sensing control system 3708 provides a notification to user device 212. In step 4040, method 4000 ends.

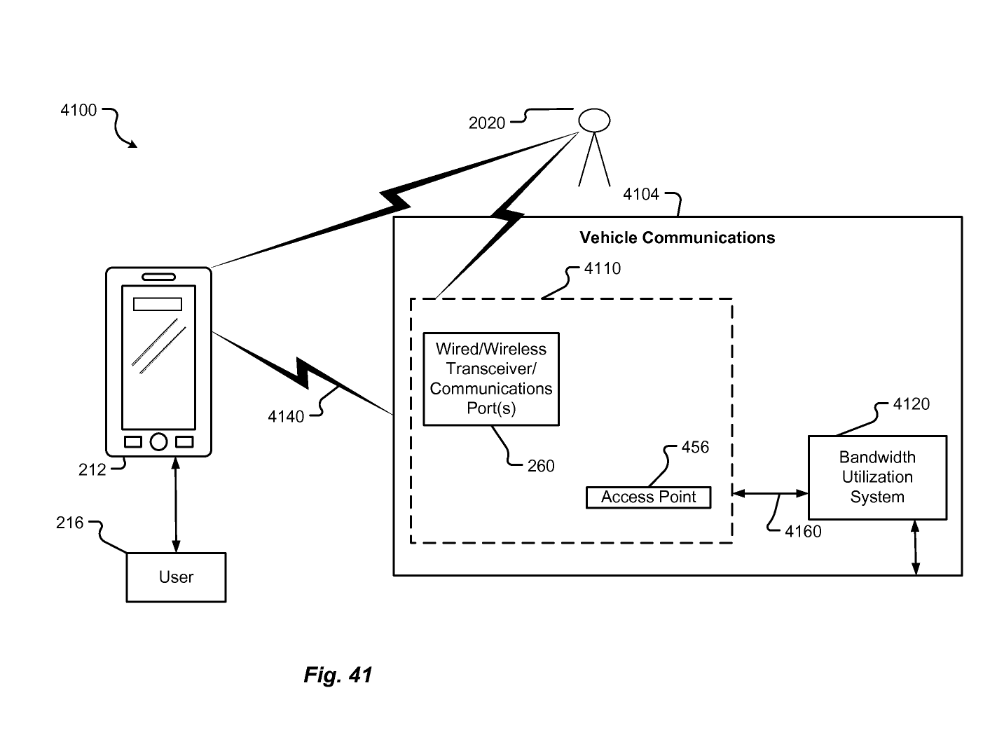

An embodiment of an optional vehicle system 4100 is shown in FIG. 41. The illustrated vehicle system 4100 includes a vehicle 4104, a transmitter-receiver 2020, a device 212, and a user 216. Transmitter-receiver 2020 may be, for example, a cell tower, base-station, etc. Vehicle 4104 is capable of communicating wirelessly with transmitter-receiver 2020 and device 212. Device 212 is capable of communicating wirelessly with transmitter-receiver 2020. Transmitter-receiver 2020 is capable of communicating wirelessly with vehicle 4104 and device 212. Vehicle 4104 may be electronically coupled to device 212 and transmitter-receiver 2020.

In one embodiment, vehicle 4104 includes a bandwidth utilization system 4110, and a communications unit 2010. Although not entirely depicted in FIG. 41, communications unit 2010 may include wired/wireless transceiver/communications port(s) 260, access point 456, vehicle sensors 242, and/or non-vehicle sensors 236. In one configuration, communications unit 2010 is coupled to bandwidth utilization system 4104. Bandwidth utilization system 4104 is coupled to vehicle 4104.

In one configuration, vehicle 4104 pings a distance around vehicle 4104 to ascertain whether there are one or more of devices 212 within a communication vicinity. A communication vicinity may be, for example, a vicinity at which vehicle 4104 is able to communicate with device 212. The pinging distance may be based on, for example, the amount of transmit power available to vehicle 4104 and/or device 212. In one configuration, when a device 212 is located within a transmit/receive distance to vehicle 4104, communications unit 2010 receives signal(s) 4140 from device 212. Signal(s) 4140 received from device 212 may be based on a pinging from bandwidth utilization system 4110. For example, bandwidth utilization system 4110 may ping device 212 to determine whether it is in the vicinity of vehicle 4104 for potential use to access its bandwidth. Based on header information provided in signal(s) 4140, communications unit 2010 synchronizes with device 212 and provides signal(s) 4160 to bandwidth utilization system 4110.

In one configuration, bandwidth utilization system 4110 receives signal(s) 4160 from communications unit 2010. Signal(s) 4160 contain information related to whether vehicle 4104 may access the bandwidth available to device 212. Bandwidth utilization system 4110 uses authorization information provided by device 212 to determine whether bandwidth utilization system 4110 has permission to access or use the bandwidth available to device 212. When bandwidth utilization system 4110 determines that permission has been granted to access the bandwidth provided by device 212, bandwidth utilization system 4110 may then access the bandwidth available by device 212 to transmit/receive data.

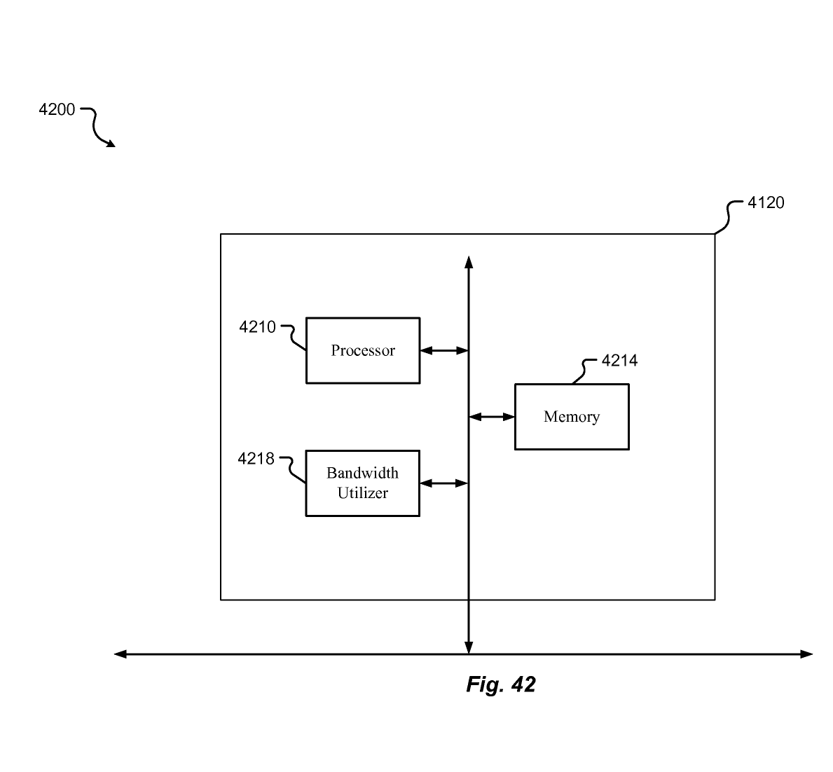

An embodiment of an optional bandwidth utilization system 4110 is shown in FIG. 42. In one configuration, illustrated bandwidth utilization system 4104 includes a processor 4210, a memory 4214, and a bandwidth utilizer 4218. Processor 4210, memory 4214, and bandwidth utilizer 4218 may be coupled together via a bus or equivalent.

In one configuration, bandwidth utilizer 4218 of bandwidth utilization system 4110 receives signal(s) 4160 from communications unit 2010. Signal(s) 4160 contain information related to whether vehicle 4104 may access the bandwidth available to device 212. Bandwidth utilizer 4218 uses the authorization information to determine whether bandwidth utilization system 4110 has permission to access or use the bandwidth available to device 212. In one embodiment, bandwidth utilizer 4218 determines whether permission has been granted by checking the bit status of authorization bits and/or permission bits provided in the received signal(s) 4160. When bandwidth utilizer 4218 determines that permission has been granted to access the bandwidth provided by device 212, bandwidth utilizer 4218 utilizes the bandwidth provided by device 212. In one embodiment, when bandwidth utilizer 4218 determines that permission has been granted to access the bandwidth provided by device 212, bandwidth utilizer 4218 signals to processor 4210 to utilize the bandwidth provided by device 212. Bandwidth utilization system 4110 may then utilize the bandwidth available by device 212 to transmit/receive signals.

In one embodiment, bandwidth utilizer 4218 continuously checks the permission status of authorization data 4330 to ensure that it is authorized to utilize the bandwidth of device 212. In one configuration, when bandwidth utilizer 4218 determines that it is not authorized to utilize the bandwidth available to device 212, it may disengage in accessing bandwidth until permission is granted to utilize the bandwidth available to device 212.

In one configuration, bandwidth utilizer 4218 determines whether there is a device 212 in proximity to vehicle 4104 capable of providing bandwidth to vehicle 4104. Because vehicle 4104 and/or device 212 may be constantly in motion, the determination as to whether device 212 is in proximity to vehicle 4104 may be made on a continuous basis. In one embodiment, device 212 may signal to vehicle 4104 that it is within communication vicinity to vehicle 4104.

In one configuration, a plurality of devices 212 may be available for bandwidth utilization. When, for example, a plurality of devices are available for bandwidth utilization, bandwidth utilization system 4110 may utilize the bandwidth of both devices 212 simultaneously and/or serially.

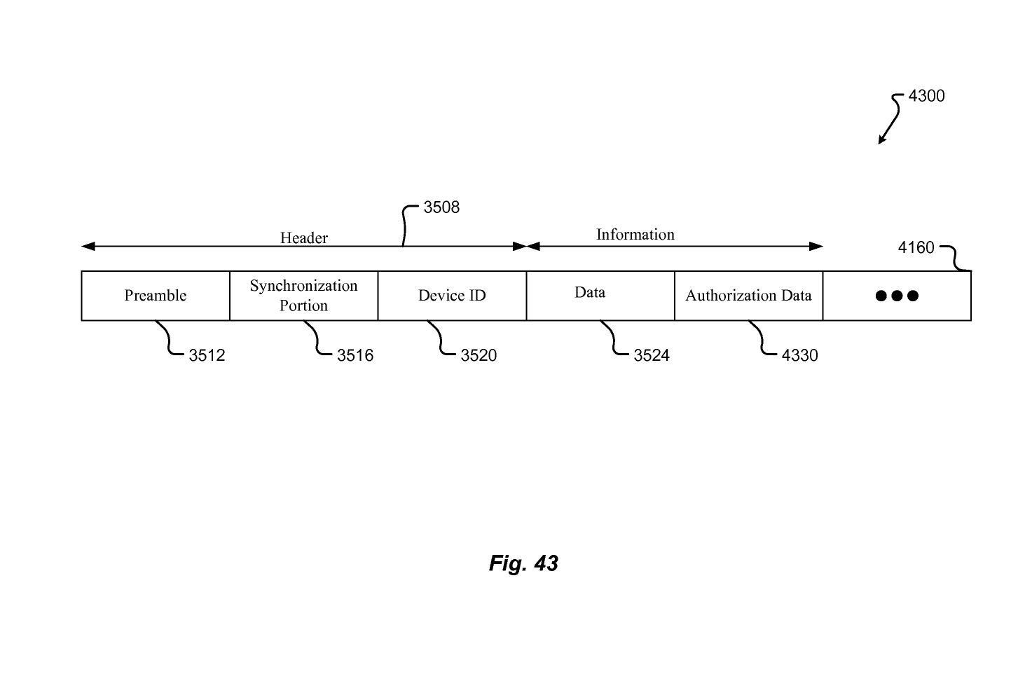

An embodiment of signal(s) 4304 is shown in FIG. 43. In one embodiment, signal(s) 4304 may include a preamble 3512, synchronization portion 3516, device ID 3520, data 3524, and authorization data 4330. In some embodiments, header 3512 may include preamble 3512, synchronization portion 221, and device ID 2220.

In one embodiment, authorization data 4330 may include, for example, data that denotes whether vehicle 4104 is authorized to access the bandwidth available to device 212. In one embodiment, authorization may be given manually by user 216. For example, vehicle 4104 and/or a person in vehicle 4104 may request, from user 216, the use of the bandwidth available to device 212. User 216 may affirm or deny authorization and the result provided in authorization data 4330 to vehicle 4104.

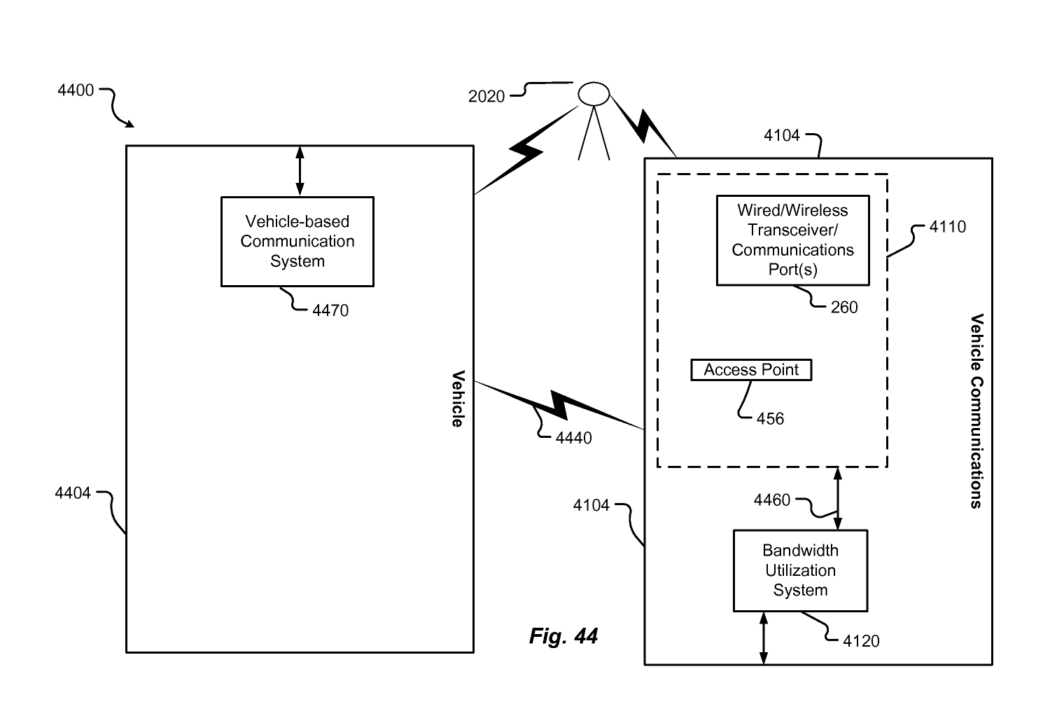

An embodiment of an optional vehicle system 4400 is shown in FIG. 44. The illustrated vehicle system 4400 includes a vehicle 4104, a vehicle 4404, and a transmitter-receiver 2020. Vehicle 4104 is capable of communicating wirelessly with transmitter-receiver 2020 and vehicle 4404. Vehicle 4404 is capable of communicating wirelessly with transmitter-receiver 2020. Transmitter-receiver 2020 is capable of communicating wirelessly with vehicle 4104 and vehicle 4404. Vehicle 4104 may be electronically coupled to vehicle 4404 and transmitter-receiver 2020.

In one configuration, vehicle 4404 includes a bandwidth utilization system 4120 and a communications unit 4110. Communications unit 4110 is coupled to bandwidth utilization system 4120. Bandwidth utilization system 4120 is coupled to vehicle 4404. Vehicle 4404 includes vehicle-based communication system 4470. Vehicle-based communication system 4470 may be coupled to vehicle 4404. In one embodiment, vehicle-based communication system 4470 may be any type of wireless communication system capable of communicating wirelessly with vehicle 4104.

In one configuration, vehicle 4104 pings a distance around vehicle 4104 to ascertain whether there are one or more vehicles 4404 within a communication vicinity. A communication vicinity may be, for example, a vicinity at which vehicle 4104 is able to communicate with vehicle 4404. The pinging distance may be based on, for example, the amount of transmit power available to vehicle 4104 and/or vehicle 4404. For example, bandwidth utilization system 4120 may ping vehicle-based communication system 4470 to determine whether vehicle 4404 is in the vicinity of vehicle 4104 for potential use to access the bandwidth of vehicle-based system 4470. Based on header information provided in signal(s) 4440, communications unit 4110 synchronizes with vehicle-based communication system 4470 and provides signal(s) 4460 to bandwidth utilization system 4120. In one configuration, when a vehicle 4404 is located within a transmit/receive distance to vehicle 4104, vehicle 4404 provides signal(s) 4440 to vehicle 4104.

In one configuration, communications unit 4110 receives signal(s) 4440 from vehicle-based communication system 4470. Communications unit 4119 provides signal(s) 4460 to bandwidth utilizer 4218. Bandwidth utilizer 4218 of bandwidth utilization system 4110 receives signal(s) 4460 from communications unit 4110. Signal(s) 4460 contain information related to whether vehicle 4104 may access the bandwidth available to vehicle-based communication system 4470. In addition, signal(s) 4460 may contain information related to the character of vehicle 4404. Bandwidth utilizer 4218 uses the authorization information to determine whether bandwidth utilization system 4120 has permission to access or use the bandwidth available to vehicle-based communication system 4470. When bandwidth utilizer 4218 determines that permission has been granted to access the bandwidth provided by vehicle-based communication system 4470, bandwidth utilizer 4218 may then utilize the bandwidth available by device 212 to transmit/receive signals.

In one embodiment, bandwidth utilizer 4218 determines whether permission has been granted by vehicle 4404 by checking the bit status of authorization information and/or permission bits provided in the received signal(s) 4160. When bandwidth utilizer 4218 determines that permission has been granted to access the bandwidth provided by vehicle-based communication system 4470, bandwidth utilizer 4218 signals to processor 4210 to utilize the bandwidth provided by device 212. Processor 4210 may then utilize the bandwidth available by device 212 to transmit/receive data.

In one embodiment, bandwidth utilizer 4218 continuously checks the permission status of authorization data 4330 to ensure that it is authorized to utilize the bandwidth of vehicle-based communication system 4470. In one configuration, when bandwidth utilizer 4218 determines that it is not authorized to utilize the bandwidth available to vehicle-based communication system 4470, it may disengage in the use of the bandwidth until further permission has been granted to utilize the bandwidth available to vehicle-based communication system 4470.

In one configuration, bandwidth utilizer 4218 determines whether there is a vehicle 4404 and/or vehicle-based communication system 4470 in proximity to vehicle 4104 capable of providing bandwidth to vehicle 4104. Because vehicle 4104 and/or vehicle 4404 may be constantly in motion, the assessment may be made on a continuous basis as to whether a vehicle in proximity is capable of providing available bandwidth to vehicle 4104.

In one configuration, when a plurality of vehicle-based communication systems 4470 are available for bandwidth utilization, for example, a vehicle-based communication system 4470 and another vehicle-based communication system 4470, bandwidth utilization system 4120 may utilize the bandwidth of the plurality of vehicle-based communication systems simultaneously or serially.

In one embodiment, based on a request by vehicle 4104 to access the bandwidth of vehicle 4404, vehicle 4404 may be able to check the character of vehicle 4104 by assessing an image of vehicle 4104. The image may be taken, for example, a camera coupled to vehicle 4404. Similarly, in one embodiment, vehicle 4104 may be able to check the character of vehicle 4404 by assessing an image of vehicle 4404. The image may be taken, for example, a camera coupled to vehicle 4104. For example, the camera may take an image of vehicle 4404 when vehicle 4404 is in a range of vehicle 4104.

In one embodiment, vehicles may communicate with one another to share cellular, WiFi, and/or other communications bandwidth. Sharing of bandwidth may be, for example, based on permissions. In one embodiment, for example, vehicle 4104 may not have Internet access at a specific location (e.g., whether based on signal strength, paid-for service, and/or lack thereof). One or more vehicles 4404 nearby may have signal(s) and/or bandwidth (e.g., internet communications ability) that they are willing to share with others. The one or more vehicles may provide the shared signal(s) and/or communications ability to, for example, vehicle 4104.

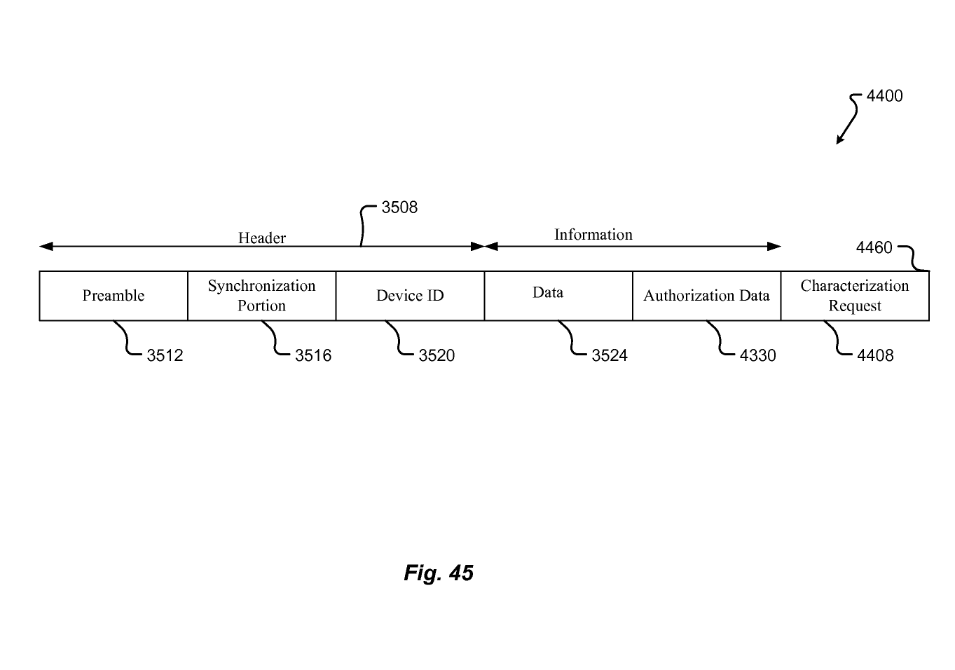

An embodiment of signal(s) 4460 is shown in FIG. 45. In one embodiment, signal(s) 4460 may include a preamble 3512, synchronization portion 3516, device ID 3520, data 3524, authorization data 4330, and characterization request 4408. Characterization request 4408 may include, for example, a request by vehicle 4404 for information as to the character of vehicle 4104. In one configuration, a single bit or series of bits may indicate, for example, a request for the make of vehicle 4104, the model of vehicle 4104, the location where vehicle 4404 was manufactured, and/or the purchase price of vehicle 4404, etc. Information ascertained by vehicle 4404 regarding vehicle 4104 may be used to determine whether vehicle 4404 authorizes vehicle 4104 to utilize the bandwidth available to vehicle 4404.

In one embodiment, in order to determine whether vehicle 4404 will grant access to its bandwidth, vehicle 4404 will utilize the character request portion of 4460. Based on the response of vehicle 4104 to the characterization request, vehicle 4404 may grant or refuse to grant access to its bandwidth to vehicle 4104.

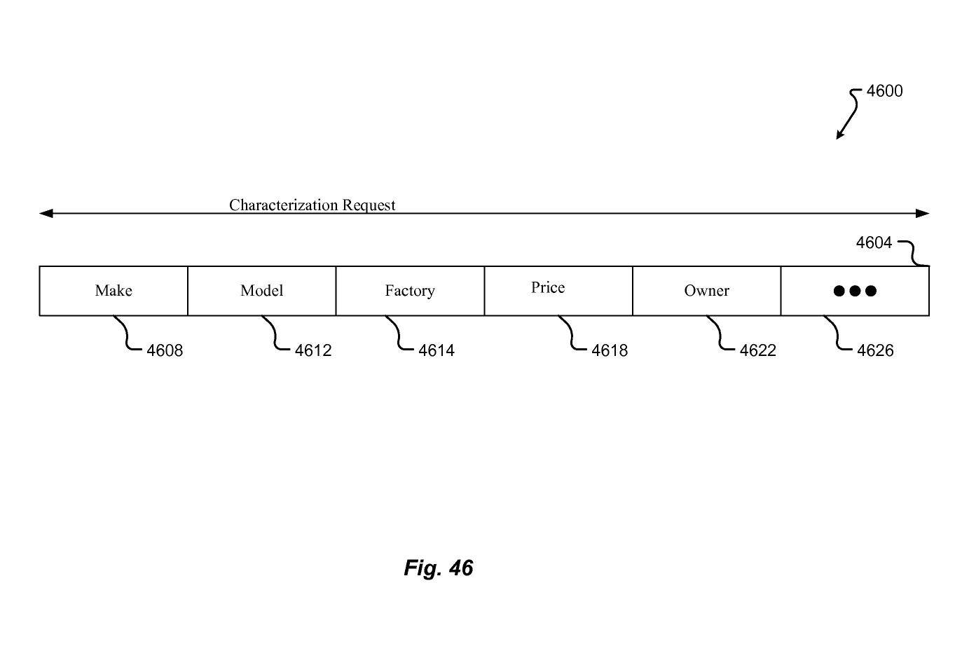

An embodiment of characterization request 4408 is shown in FIG. 46. In one embodiment, character request 4408 may include a make portion 4608, a model portion 4612, a factory portion 4614, a price portion 4618, and an owner portion 4622. In one configuration, a single bit or series of bits may indicate, for example, a response by vehicle 4104 to the request by vehicle 4404 for the make of vehicle, the model of vehicle, the location where vehicle was manufactured, and/or the purchase price of vehicle, etc.

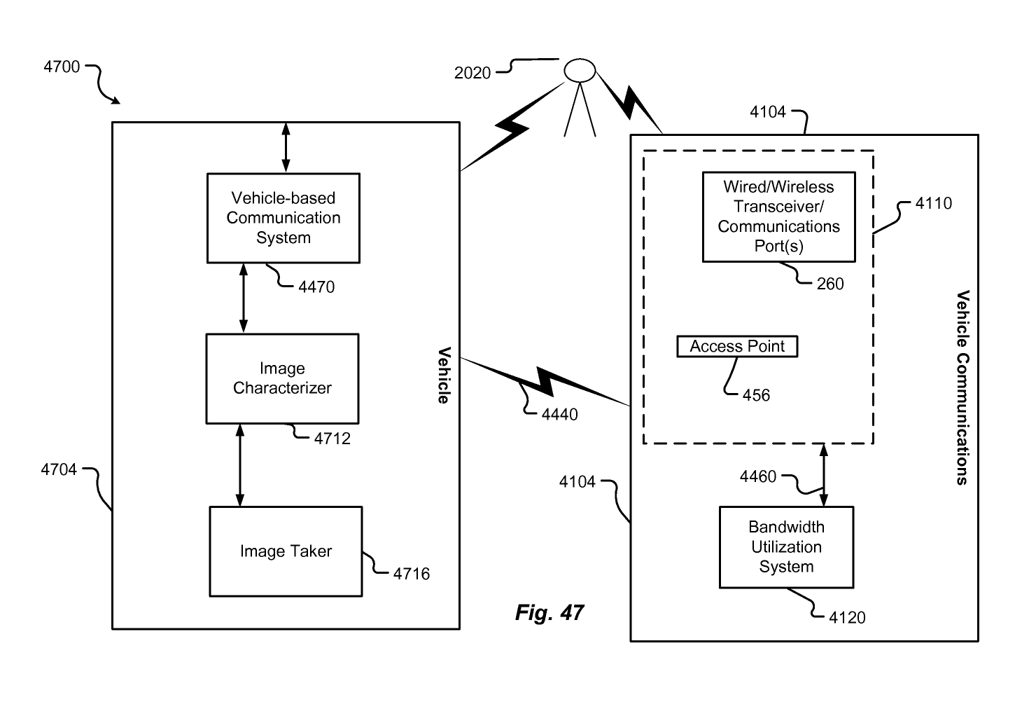

An embodiment of an optional vehicle system 4700 is shown in FIG. 47. The illustrated vehicle system 4700 includes a vehicle 4104, a vehicle 4704, and a transmitter-receiver 2020. Vehicle 4104 is capable of communicating wirelessly with transmitter-receiver 2020 and/or vehicle 4704. Vehicle 4704 is capable of communicating wirelessly with transmitter-receiver 2020. Transmitter-receiver 2020 is capable of communicating wirelessly with vehicle 4104 and/or vehicle 4704. Vehicle 4104 may be electronically coupled to vehicle 4704 and/or transmitter-receiver 2020.

In one configuration, vehicle 4104 includes bandwidth utilization system 4120 and communications unit 4410. Communications unit 4410 is coupled to bandwidth utilization system 4104. Bandwidth utilization system 4104 is coupled to vehicle 4404. Vehicle 4404 includes vehicle-based communication system 4470, an image characterizer 4704, and an image taker 4716. Vehicle-based communication system 4470 is coupled to image characterizer 4712 and vehicle 4704. Image characterizer 4712 is coupled to image taker 4716 and vehicle-based communication system 4470. Image taker 4716 may include, for example, a camera 878, a device 212, or any other device capable of taking images of vehicle 4104 for use by vehicle 4704. Image characterizer 4704 may, for example, characterize images provided by image taker 4716 and/or any other device capable of providing images to image characterizer 4712.

In one embodiment, for example, vehicle 4704 receives a request from a vehicle, such as, for example, vehicle 4104, to access the bandwidth of vehicle 4704. Image taker 4716 takes an image of vehicle 4104 and/or the driver/passengers of vehicle 4104. The image may be taken by, for example, a camera coupled to vehicle 4704. For example, the camera may take an image of vehicle 4404 when vehicle 4404 is in a range of vehicle 4104. Image taker 4716 provides the image to image characterizer 4712. Image characterizer 4712 characterizes the image and determines, whether, based on the image, vehicle 4704 authorizes vehicle 4104 to access the bandwidth of vehicle 4704 to vehicle 4104. Vehicle 4704 then provides the authorization result to vehicle 4104.

In one embodiment, vehicle 4404 may take an image of vehicle 4104 based on a request by vehicle 4104 to access the bandwidth of vehicle 4404 in order to ascertain whether vehicle 4104 meets the character traits vehicle 4704 requires to access the bandwidth of vehicle 4704. In one embodiment image characterizer 4712 ascertains whether it will allow vehicle 4104 to access the bandwidth of vehicle 4704 based on a comparison of the image taken by image taker 4716 to a repository of acceptable images or characteristics of the persons in the image.

In one embodiment, based on a request by vehicle 4104 to access the bandwidth of vehicle-based communication system 4470, image characterizer 4712 may assess an image of vehicle 4104 to determine whether vehicle 4104 meets a threshold characterization, such as, for example, a specific make and/or model of vehicle.

In one embodiment, based on a request by vehicle 4104 to access the bandwidth of vehicle-based communication system 4470, an image is taken of a person inside vehicle 4104 to determine whether the person meets threshold characteristic traits to allow for access to the bandwidth. For example, if the person's character traits are negative, access to bandwidth may be denied. If the person's character traits are positive, access to bandwidth may be authorized. For example, driver of vehicle 4404 may not wish to provide access to a negatively characterized person (e.g., a felon) or a vehicle associated with the negatively characterized person. Based on the characterization of the image, vehicle 4704 may authorize or refuse to authorize vehicle 4104 to access the bandwidth of vehicle 4704.

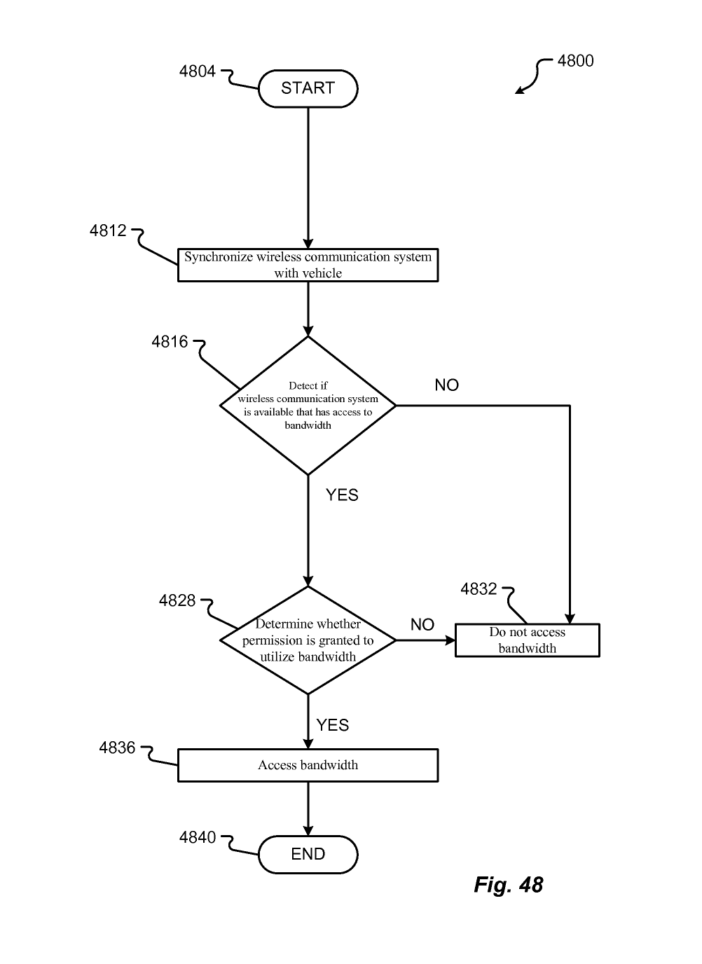

An embodiment of an optional method 4800 for accessing bandwidth by a vehicle may be as shown in FIG. 48. A general order for the steps of the method 4800 is shown in FIG. 48. Generally, the method 4800 starts with a start operation 4804 and ends with an end operation 4840. The method 4800 can include more or fewer steps or can arrange the order of the steps differently than those shown in FIG. 48. The method 4800 can be executed as a set of computer-executable instructions executed by a computer system and encoded or stored on a computer readable medium. Hereinafter, the method 4800 shall be explained with reference to the systems, components, modules, software, data structures, user interfaces, etc. described in conjunction with FIGS. 1-47.

In step 4804, method 4800 commences. In step 4812, bandwidth utilization system 4120 synchronizes a wireless communication device with vehicle 4104. For example, in one embodiment, the wireless communication device may be a device 212 and/or a vehicle-based communication system 4470. In step 4816, bandwidth utilization system 4120 determines whether the wireless communication device has access to bandwidth. In step 4832, when the wireless communication system does not have access to bandwidth, vehicle 4104 does not access the bandwidth. In step 4828, when the wireless communication system has access to bandwidth, bandwidth utilization system 4120 determines whether permission has been granted by the wireless communication device to access its bandwidth. In step 4832, when vehicle 4104 does not have permission to access the bandwidth of the wireless communication device, vehicle 4104 does not access the bandwidth. In step 4836, when vehicle 4104 has permission to access the bandwidth of the wireless communication device, vehicle 4104 accesses the bandwidth for use by vehicle 4104. In step 4840, method 4800 ends.

Networked Audio and Device Management:

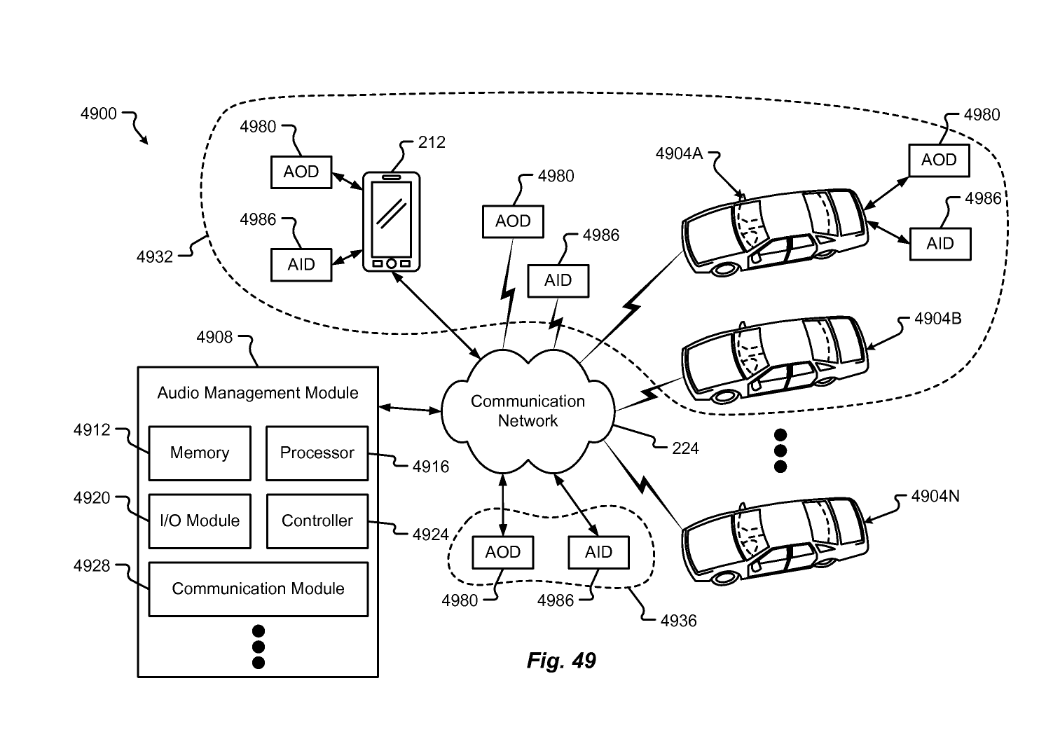

An embodiment of a networked device management system 4900 is shown in FIG. 49. The networked device management system 4900 may include a communication network 224, an audio management module 4908, and at least one of a vehicle 4904A-N, a user interface device 212, an audio output device (AOD) 4980, an audio input device (AID) 4986. The vehicles 4904A-N may be substantially similar, if not identical, to any of the vehicles 104 as described herein.

In some embodiments, the AOD 4980 may correspond to a networked or interconnected speaker 880, a speaker 880 controlled by a networked device 212 and/or vehicle 4904A-N, and/or a speaker 880 connected with a controller and wireless communication module configured to communicate with at least one other component (e.g., vehicle 4904A-N, AOD 4980, AID 4986, user interface device 212, audio management module 4908, etc., and/or combinations thereof) of the networked device management system 4900.

In one embodiment, the AID 4986 may correspond to a networked or interconnected microphone 886, a microphone 886 controlled by a networked device 212 and/or vehicle 4904A-N, and/or a microphone 886 connected with a controller and wireless communication module configured to communicate with at least one other component (e.g., vehicle 4904A-N, AOD 4980, AID 4986, user interface device 212, audio management module 4908, etc., and/or combinations thereof) of the networked device management system 4900.

The networked device management system 4900 may provide for an operational control of at least one of the components in the system 4900. In some embodiments, the operational control may be provided by an audio management module 4908. The audio management module 4908 may include, but is not limited to, at least one of a standalone device, an application running on a computer, and an application running on a central server across a communication network 224 of the system 4900. The operational control may include controlling a power and/or signal state, input, output, handoff, access, adjustment rate, profile, interruptibility, etc., and/or combinations thereof. Additionally or alternatively, the operational control may be based at least partially on one or more of permissions, rules, authentication, security, times, locations (e.g., geographical, component proximity-based, system proximity-based, etc., and/or combinations thereof), etc., of the at least one component of the system 4900.

Among other things, the audio management module 4908 may control a number of audio devices 4980, 4986 based on a received control request. By way of example, when people gather outside of a house, there is often a desire to listen to music as a group. However, unless significant planning has been performed, traditional systems cannot provide the ability to quickly share a number of devices, such as speakers, nor can traditional systems provide a synchronized audio or other output via the devices or speakers. Although Bluetooth® speakers have recently gained popularity in an attempt to solve this problem, the Bluetooth® speakers tend to be underpowered for larger groups and must be carried around to perform the specific task of playing audio. Moreover, using traditional Bluetooth® speakers may only allow a single user device to be connected to the speakers at a time. As can be appreciated, any change from one user device to another requires a complicated and time consuming pairing operation via the Bluetooth® communication protocol.

It is an aspect of the present disclosure to allow for the control of networked devices, such as an AOD 4980 and/or AID 4986, via an audio management module 4908. The audio management module 4908 can be executed as a set of computer-executable instructions (e.g., as an application) executed by a computer system and encoded or stored on a computer readable medium. The present disclosure is not limited to use in a vehicle 4904A-N (e.g., the audio management module 4908 can work with other devices, smart phones, tablets, PCs, mobile computers, and even in a bar with a connected jukebox). In any event, users may download an audio management application that is configured to connect one or more AOD 4980 and AID 4986 (e.g., stereo systems) so that a number of the devices 4980, 4986 in a system 4900 are playing the same audio output (e.g., music, presentations, speech, tones, sirens, etc.). In one embodiment, this connection of one or more devices can create an amplification affect for a gathering. The master device, (e.g., the device choosing the music or providing the sounds) may be selected through the application. Other devices that want to play their music or provide sound, can select a button via an application running on the other devices to queue up (such that the next device in queue can provide the sound via the one or more devices). The application can run from a vehicle 4904A-N, a user interface device 212, or other component of the system 4900. As can be appreciated, the application may provide audio output from stored music, a radio, and/or an online station.

In one embodiment, the audio management module 4908 may be configured as an application for public address purposes. For instance, if a person wanted to give a speech, the person's voice can be played out of the speakers associated one or more vehicles 4904A-N, devices 212, and AODs 4980. The speakers of user interface devices 212 may include, but are not limited to, the speakers in smart phones.

Continuing the previous example, if a speech is being made by a speaker and a listener wants to ask a question, the listener may utilize the audio management module 4908 to queue up a question. Once the speaker elects to take questions, the listener may be signaled via the audio management application that it is the listener's turn to speak and the listener may speak into the smart phone/device/vehicle microphone, or AID 4986, and the question can be broadcast to the other devices connected in the system 4900. In one embodiment, when the question is complete (or the listener has satisfied a control condition, etc.) control of the audio output to the devices connected in the system 4900 may be returned to the speaker.

As yet another example, a number of users may be located in a bar having a jukebox AOD 4980. In this example, the jukebox may be connected and a user may utilize the audio management module 4908 to provide a request that the jukebox play a song from the user's device 212. In some cases, the request and/or use of the audio management module 4908 may be associated with a cost charge. In other cases, the request and/or use of the audio management module 4908 may be cost free. In any event, and depending on the conditions, the user's request may be queued for playing by the jukebox. Until the jukebox reaches the queued user request, the jukebox can continue to play music (e.g., either provided by other users or as part of a playlist or routine). Once the music provided by other users and/or the playlist is played, the jukebox can play the music queued by the user. In some embodiments, an audio management application can provide feedback to a user (e.g., via at least one user interface device 212) regarding one or more of a position in the queue, estimated time of current playlists, countdown timers, countup timers, costs associated with use, etc., and the like. As can be appreciated, a user may pay to jump in front of another user (e.g., increase priority, cut in line, etc.) in the queue. This ability to jump users in a queue may be limited by a number of jumps. Additionally or alternatively, the ability to jump users in a queue may be associated with an escalating cost associated with each successive jump (e.g., first jump=$1, second jump=$5, third jump=$15, fourth jump=$50, etc.).

The devices and components of the system 4900 can utilize a number of communication protocols and/or permissions to connect to one another. For example, an device requesting connection can be issued a common token, which opens a single channel for use. The token may be useful in case a device gets placed with the wrong group so that it can be adjusted manually. As can be appreciated, there are multiple other ways to handle an issue of which devices to connect to in a system 4900.

In one embodiment, devices may be connected based at least partially on a location of the devices. For instance, users of the application may be in a similar geographical location and/or proximity. In this example, when a user is trying to organize the group, the other users in the geographical location may be pinged to open the application so that the devices associated with the users can become part of a broadcast community. As shown in FIG. 49, user interface device 212 (having an AOD 4980 and an AID 4986), AOD 4980, AID 4986, a first vehicle 4904A, and a second vehicle 4904B, may be part of a first broadcast community 4932. In one case, an AOD 4980 and an AID 4986 may be part of a second broadcast community 4936 that is separate and apart from the first broadcast community 4932. A broadcast community may include a general location, or area, that may be based on wireless signals detected between the devices, GPS data, and/or other location data/information provided by the devices. For instance, a master device may provide a first location and set a range surrounding the master device as the first broadcast community 4932 area/location.

In some embodiments, the broadcast community may be associated with indoor and/or outdoor restrictions. For instance, an indoor restriction may include only devices which are within an area/location of a master device and are indoors (e.g., inside a building, etc.). In this instance, devices which may be within an area/location of a master device but are located outside of a building can be excluded from the broadcast community. Similarly, an outdoor restriction may include only devices which are within an area/location of a master device but are outdoors (e.g., outside of a building, etc.). In the example of a jukebox at a bar, the jukebox may be authorized to play and/or receive requests from patrons of the bar only. In this case, only the devices inside the bar may be allowed to control the jukebox via an audio control application subject to the indoor restriction.

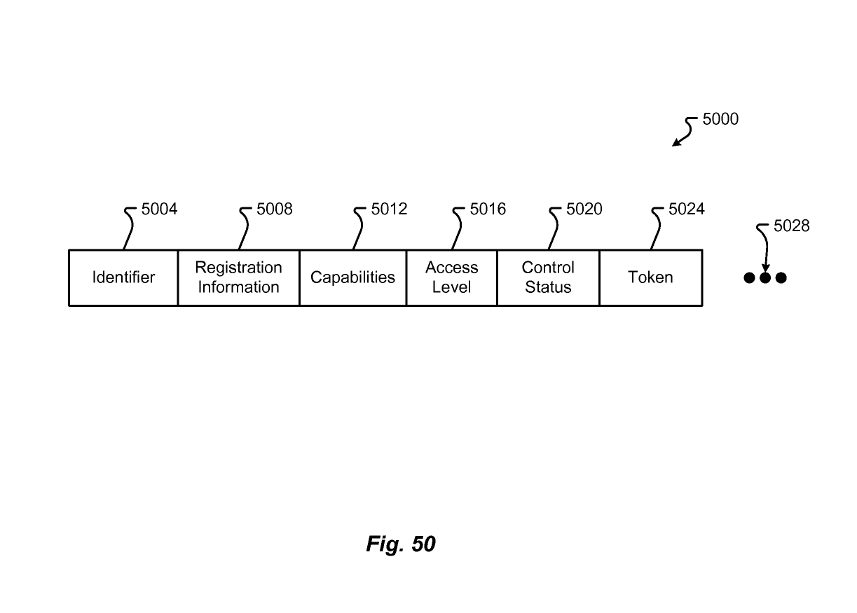

FIG. 50 shows a data structure 5000 for storing information associated with a device in a networked device management system 4900 in accordance with embodiments of the present disclosure. The data structure 5000 may comprise an identifier field 5004, a registration information field 5008, a capabilities field 5012, an access level field 5016, a control status field 5020, a token field 5024, and/or more 5028.

The identifier field 5004 may comprise data that identifies a device. This field 5004 may be used by the audio management module 4908 in controlling the device and/or an AOD 4980 and/or an AID 4986 associated with the device. The identifier field 5004 may be used to grant/deny controls to a device, create preferences associated with a device, and/or include a device in a broadcast community. Additionally, or alternatively, the identifier field 5004 may include data to uniquely identify a particular device. For example, the identifier field 5004 may include device data such as a Media Access Control (MAC) address, hardware address, network address, digital signature, device code, etc., and/or combinations thereof. Among other things, the identifier field 5004 may comprise data that can be used to differentiate between various devices in a networked device management system 4900.

The registration information field 5008 may comprise one or more bits, or bit values, that identify a registration of a device with a broadcast community, another device, a group of devices, and/or at least one other component of a networked device management system 4900. For example, a first device may include a registration status in the registration information field 5008 that indicates the first device is currently registered with a particular broadcast community. The registration status may indicate a registered, unregistered, expiring registration, restricted registration, and/or other registration status. Additionally or alternatively, the registration status may be accompanied by a broadcast community registration identifier (e.g., that serves to identify one broadcast community from another). In some cases, the registration may include historical information relating to the registration of the device in one or more broadcast community or group of devices.

The capabilities field 5012 may comprise data that identifies one or more capabilities of the device. Capabilities can include device hardware (e.g., keypad, touchscreen, AOD 4980, AID 4986, etc., and/or any other hardware associated with the device), software (e.g., applications installed, versions of applications installed, software compatibility, etc.), power levels, signal strength, available network bandwidth, OS installed, etc. Additionally or alternatively, the capabilities field 5012 may include one or more allowed/restricted capability of the device.

The access level field 5016 may comprise data that provides what features of the device are available to remote, or wireless, connections to the device. For instance, the access level may allow use of the AOD 4980 of a device, but restrict access to the AID 4986 of the device. In some embodiments, the access level of the device may be configured and/or set via a user of the device, an administrator of the device, a company, and/or combinations thereof. In one embodiment, the access level of a device may be adjusted by an audio management module 4908 in a networked device management system 4900. For example, an audio management module 4908 may determine that a number of devices can only receive audio. In this example, the audio management module 4908 may alter the access level of the device to use the device as an audio output only device and prevent and audio input from the device. As can be appreciated, the audio management module may dynamically alter the access level of the device in a system 4900. Dynamic alteration of the access level may be used in granting and denying control in an audio management scenario.

The control status field 5020 may comprise data that defines whether the device is able to control other devices in a networked device management system 4900. In some cases, the control status may include conditional settings that automatically determine a control status of the device. For instance, in a public address scenario, a device of a speaker may have a control status set to “audio output control.” This setting may allow the speaker to use the device to control the audio output to a number of networked devices in the system 4900. Continuing this example, a device of a listener of the public address may have a control status of “listen only.” This setting essentially makes the device of the listener an audio output only device. The audio management module 4908 may determine that control should shift between the speaker and the listener (e.g., during a question-answer session, etc., as provided above). At this point, the audio management module 4908 may temporarily, semi-permanently, or permanently change the control status of the device of the listener to “audio output control.” After the listener has spoken, the audio management module 4908 may determine to return “audio output control” to the speaker for a reply. In some cases, the audio management module 4908 may return the device of the listener to “listen only” when the speaker is speaking and/or when another user has the “audio output control” status set.

The token field 5024 may comprise one or more bits, or bit values, that identify a security token of the device and/or the networked device management system 4900. For instance, a specific broadcast community may require an exchange of security keys before access is granted to the device, via the audio management module 4908, to participate in a networked device management communication. The token may be provided via a user, an administrator, a company, the audio management module 4908 and/or a broadcast community of a system 4908. In some cases, the token contained in the token field 5024 may be configured to expire after a communication session, a predetermined time, or upon a device registering with another broadcast community or network.

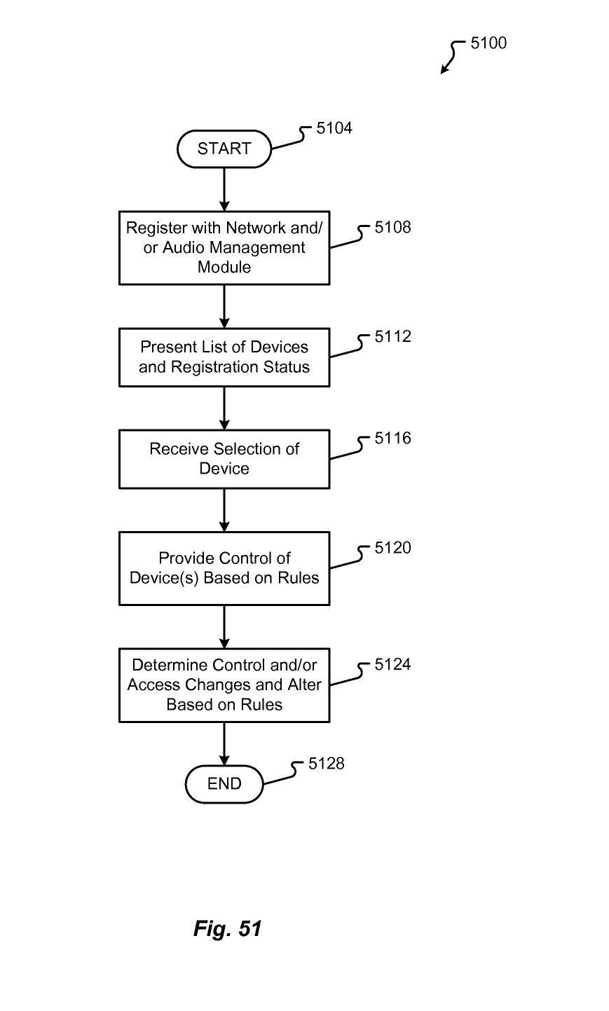

An embodiment of a method 5100 for managing networked audio devices is shown in FIG. 51. While a general order for the steps of the method 5100 is shown in FIG. 51, the method 5100 can include more or fewer steps or can arrange the order of the steps differently than those shown in FIG. 51. Generally, the method 5100 starts with a start operation 5104 and ends with an end operation 5128. The method 5100 can be executed as a set of computer-executable instructions executed by a computer system and encoded or stored on a computer readable medium. Hereinafter, the method 5100 shall be explained with reference to the systems, components, modules, software, data structures, user interfaces, etc. described in conjunction with FIGS. 1-50.

The method 5100 begins at step 5104 and proceeds by registering a device with a network, device management group, and/or the audio management module 4908 (step 5108). In one embodiment, registration may include devices that are physically connected to a wired network. Registration may include a device connecting to an available wireless network. For example, a device may detect an available wireless network that is located within range of the device. In some cases, the device may be provided with a number of available wireless networks from which a user may make a selection (e.g., “choose a network”). This number of available wireless networks may include a list of available wireless networks. The list may include the network name, a service set identification (SSID), wireless gateway network name, or other network identifier associated with an available network. Upon detecting the available wireless network, the device may be prompted to join the network and/or provide credentials to join the network. In some embodiments, a previously joined network may be stored in memory and even joined automatically.

In some embodiments, registration may include a device connecting to an available device management group via wired or wireless connections. The device management group may be created by the audio management module 4908. The device management group may include a number of devices that are located within an area of a master device, a device running an audio management application, and/or some other device having the audio management module 4908.

Next, the method 5100 may continue by presenting a list of devices that are registered with the network and/or device management group (step 5112). The list can be presented to at least one device in the network and/or device management group. In one embodiment, the list may be presented to a master device. Additionally or alternatively, the list may be presented in a registration order, in a location-distance order, capabilities order, access control order, and/or the like. In some cases the list may be represented graphically. For example, the list may be arranged on a visual “radar” style map. In this example, the center of the radar may represent the user's device (e.g., a master device, etc.) with other registered devices surrounding the user's device at different distances and/or locations.

The list of devices, whether represented as a detailed list, graphical representation, icon representation, etc., and/or combinations thereof, can include a registration status of each device. For example, a first device may be registered with a network (e.g., via wireless connection, physical connection, etc.) but may not be registered with a device management group. Continuing this example, a second device may be registered with the network and may also be registered, or associated, with a device management group. In one case, a master device utilizing an audio management module 4908 may determine to select devices that are registered with the network and the device management group and may determine to exclude devices that are only registered with the network. In another case, the master device utilizing an audio management module 4908 may determine to send an invitation to devices that are registered with the network only. The invitation may be configured to invite the devices to join, or register with, the device management group.

The method 5100 continues when a selection of a device to be controlled is received at the audio management module 4908 (step 5116). The selection may be made manually by a user controlling a device running an audio management application. In some embodiments, the selection may be made by the audio management module 4908 based at least partially on rules stored in memory 4912. Some examples of rules may include, but are not limited to, the distance of one device to another (e.g., master device and slave devices, etc.), device permissions, device capabilities, etc., and/or any other information contained in the data structure for a device in a networked device management system 4900.

Upon receiving a selection of at least one registered device, the method 5100 continues by providing control of the selected device based at least partially on rules (step 5120). Control can include one device controlling at least one other device's hardware, software, and/or other features. Additionally or alternatively, control can include the ability of one device to access and/or determine the behavior of at least one other device. For example, devices that are part of the device management group may be controlled for audio, alerts, volume, and the like. As previously stated, the devices may include at least one AOD 4980. Where a number of devices have an AOD 4980, the output from each of the AOD 4980 may be a common signal (e.g., the same signal output by each device in the group) and/or be synchronized to produce a unified sound output or amplification. In some cases, the sound output of each device may be adjusted as a group (e.g., together with other devices) or individually to fine tune sound output characteristics of the group.

By way of example, a speaker may be using a device (having at least one AID 4986) that is controlling two or more devices with AODs 4980. In this example, the audio management module 4908 may determine (e.g., using the AID 4986 of the speaker's device, and/or an AID 4986 of other devices) that sound emanating from at least one of the controlled devices has undesirable characteristics when compared with the sound emanating from another one of the controlled devices in the group. In this case, the audio management module 4908 may send an audio control signal to the at least one device having undesirable characteristics to change the volume, sound equalization, output timing, and/or the like.

The method 5100 continues by determining control and/or access changes and making any necessary modifications to the control and/or access based at least partially on rules stored in memory (step 5124). In some cases, the control of devices in the device management group may be transferred from one device to another. In one embodiment, the control of devices in the management group may be shared between a number of devices. In any event, the control of devices may be changed in response to a control change condition. One example of a control change condition may include an authorized request from a controlled device. Authorized requests may include queued control requests, queued questions, rotating control allocation (e.g., predetermined, random, paid for, etc.), and the like. For instance, in a question-answer session, control may switch back-and-forth between a speaker and one or more listeners/questioners. In one embodiment, the control change condition may include an expiration of a control time associated with the controlling device (e.g., the master device, etc.). For example, a particular user may have control of the various devices in the group to play music for a period of time. Upon expiration of the time, the control may shift from the particular user to another user (e.g., a user previously participating in the group, etc.) for another period of time, and so on. The method 5100 ends at step 5128.

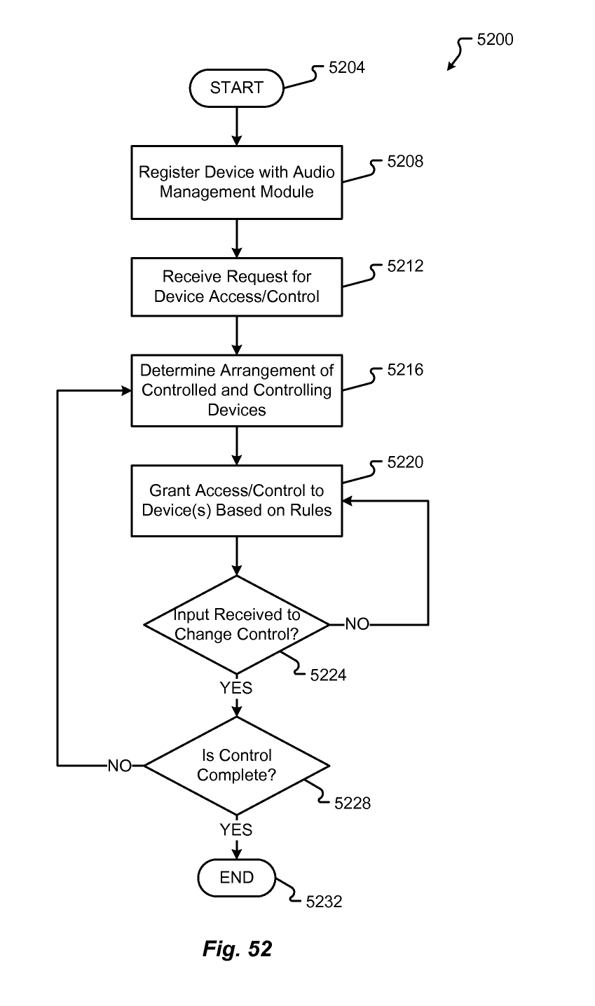

Another embodiment of a method 5200 for managing networked audio devices is shown in FIG. 52. While a general order for the steps of the method 5200 is shown in FIG. 52, the method 5200 can include more or fewer steps or can arrange the order of the steps differently than those shown in FIG. 52. Generally, the method 5200 starts with a start operation 5204 and ends with an end operation 5228. The method 5200 can be executed as a set of computer-executable instructions executed by a computer system and encoded or stored on a computer readable medium. Hereinafter, the method 5200 shall be explained with reference to the systems, components, modules, software, data structures, user interfaces, etc. described in conjunction with FIGS. 1-51.

The method 5200 begins at step 5204 and proceeds when a device registers with the audio management module 4908 (step 5208). The registration of the device with the audio management module 4908 may be substantially similar, if not identical, to the device registration described in conjunction with FIG. 51. Registration may include determining, via the audio management module 4908, an identification, capabilities, access levels, control status, security information, etc., and the like associated with a device.

Next, the method 5200 may continue by receiving a request for device access and/or control (step 5212). The request may correspond to a master device request (e.g., a request by a device to be the master device in a group, etc.), a queued control request, a temporary control request, a switching control request, and/or some other access and/or control request. In response to receiving the request, the audio management module 4908 may determine to grant, deny, or queue the request for access/control. This determination may be based on data stored in a data structure associated with the device in the system 4900.

The method 5200 may proceed by the audio management module 4908 determining an arrangement of controlled and controlling devices in a system 4900 (step 5216). Among other things, the audio management module 4908 may refer to the control status field 5020 of a data structure 5000 associated with a device to determine whether a device is controlling, controlled, or a combination thereof. In some cases, the audio management module 4908 may refer to the registration information field 5008 and/or other field of a data structure 5000 to determine an arrangement of controlled and controlling devices in a system 4900.

The audio management module 4908 may then grant access and/or control to one or more of the devices in the system 4900 based at least partially on rules (step 5220). Control may be similar, if not identical, to the control as described in conjunction with step 5120 of FIG. 51. As provided herein, the control may be associated with a time (e.g., expiration timer, etc.), a location (e.g., control is available while in a specific location and/or near other devices that form a group, etc.), a condition, etc., combinations thereof, and/or the like.

Next, the method 5200 may proceed by determining whether an input is received to change control (step 5224). In some embodiments, this determination may be made by the audio management module 4908. The input may correspond to one or more of the expiration of a timer, a change in location, an input manually provided by a user at a device, an input automatically provided by a device, termination of control by a master device, etc., and combinations thereof. For instance, a device may be configured as a controlling device for a period of time, when the period of time expires, the device may be switched from a “controlling” to a controlled status. In some embodiments, the device may just be removed from a “controlling” status, without switching the device to a “controlled” status. As another example, a device may be part of a broadcast community, where the broadcast community is based on a geographical location of a number of devices and/or or a master device. In this example, when a device leaves the geographical location, or leaves a general proximity to the other devices in the broadcast community, the device may provide an input to remove the device from the broadcast community and/or alter a “controlled” or “controlling” status. In the event that no input is received to change the control, the method 5200 continues to provide access/control based at least partially on rules (step 5220).

In the event that an input is received to change the control associated with a networked device management system 4900, the method 5200 proceeds by determining whether control of the devices in the system 4900 is complete (step 5228). For example if a control session is finished, the method 5200 ends at step 5232. However, if the control of devices in the system is not complete (e.g., control is changed in some form), the method returns to step 5216 to determine the arrangement of controlled and controlling devices.

Conditional Event Triggering:

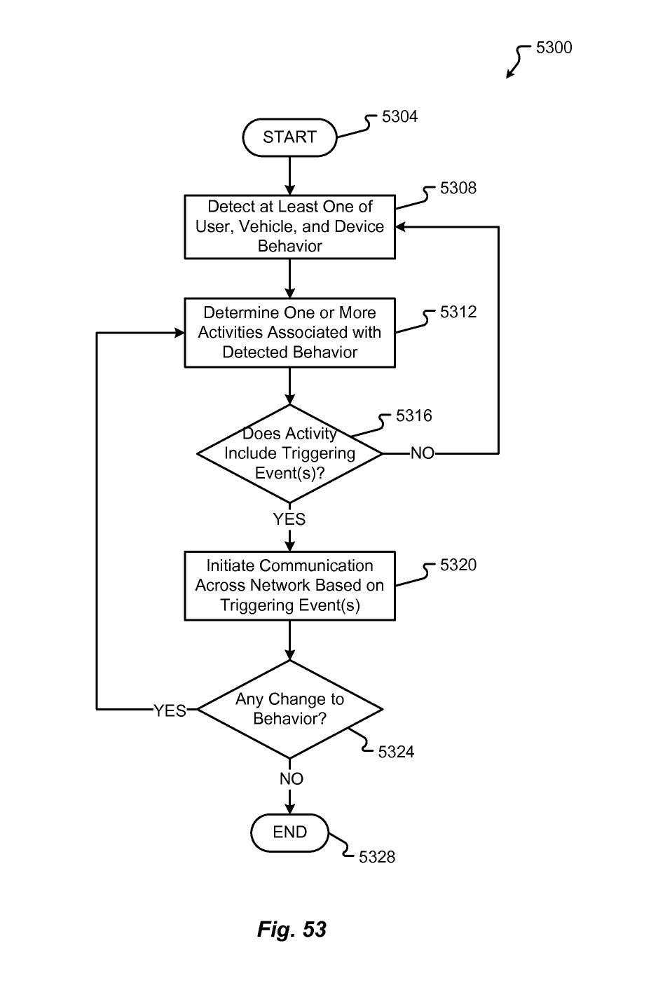

An embodiment of a method 5300 for controlling and arranging communications based on detecting conditional events is shown in FIG. 53. While a general order for the steps of the method 5300 is shown in FIG. 53, the method 5300 can include more or fewer steps or can arrange the order of the steps differently than those shown in FIG. 53. Generally, the method 5300 starts with a start operation 5304 and ends with an end operation 5328. The method 5300 can be executed as a set of computer-executable instructions executed by a computer system and encoded or stored on a computer readable medium. Hereinafter, the method 5300 shall be explained with reference to the systems, components, modules, software, data structures, user interfaces, etc. described in conjunction with FIGS. 1-52.

It is an aspect of the present disclosure that a series of events could be triggered by one or more separate events (1:∞ or ∞:∞). By way of example, a vehicle control system 204 may determine based upon past travel (e.g., roads usually taken by a user from work to home, etc.) and time (e.g., the time a user usually goes home, etc.) that the user is likely on the way home. This behavioral data may be obtained from a user profile and or user profile data 252 associated with the user. In any event, the vehicle 104 may initiate a communication based on the behavioral data to inform the user's home to adjust heating venting and air conditioning (HVAC) controls (e.g., turn up the heat, turn on the A/C, etc.), turn on the lights, and/or activate an infotainment system (e.g., turn on the stereo). In this circumstance, one event (e.g., that of a user going home) triggers a series of other events (e.g., home controls, home automation, etc.).

Another example may include a user pulling up to the user's driveway outside the user's home. The vehicle 104 may open the garage door, but maintain the door to the inside of the home (e.g., from the garage) in a locked state (e.g., via networked home automation controls, etc.). When the user is fully inside the garage, the vehicle 104 may send a signal to unlock the door to the home, and close the garage. Additionally or alternatively, (e.g., for security reasons, etc.) the vehicle 104 may record that the same set of instructions/signals are performed/sent each night when the user comes home. As such, the vehicle 104 may repeat at least a subset of the commands when the user is travelling away from home (e.g., when the user's vehicle 104 is parked at the airport), so it looks like the user is at home (e.g., lights are turned on and/or off at certain times based on a signal received from the vehicle 104).

In some embodiments, multiple triggers may be initiated from a detected event. An example of multiple triggers may include when a user is heading toward a booked hotel. For the sake of example, the weather may be raining as the user is driving. The vehicle 104, using any number of sensors previously disclosed, can detect the rainy weather and notify the concierge desk of the hotel to have the bell hops ready to meet the user at the vehicle 104 with umbrellas. Additionally or alternatively, the vehicle 104 may also communicate with the hotel checking system and check-in based on an estimated time of arrival and other information (e.g., credit card information, user identification, calendar information, traffic information, etc.). In some embodiments, the vehicle 104 may determine a number of special needs for the user and/or passengers detected in the vehicle 104. For example, if there is a baby detected in an area 508 or zone 512 of the vehicle 104, the vehicle 104 may communicate with the hotel computer system to inform the staff that a crib may be required in the user's room.

The method 5300 begins at step 5304 and proceeds by detecting a behavior associated with at least one behavioral entity, such as, a user, vehicle, device, etc., to name a few (step 5308). The detected behavior may be based on historical data associated with the behavioral entity. This historical data can be stored in a memory associated with the behavioral entity. In some cases, the data may be stored locally (e.g., in a locally accessible memory, etc.) and/or remotely (e.g., in the cloud, in a memory accessible across a communication network, etc.). In some embodiments, the detection of the behavior may be performed by a vehicle control system 104 and/or other computer system in conjunction with the various sensors of a vehicle 104. For instance, a behavioral detection system may include a processor, memory, and a communications module configured to communicate with at least one behavioral entity and/or sensors associated with the behavioral entity in determining a behavior. The behavior may be associated with one or more users.

Once a behavior has been detected, the method 5300 can continue by determining one or more activities associated with the detected behavior (step 5312). Examples of activities may include, but are not limited to, travelling to a destination (e.g., going home, going to work, going to lunch, going on vacation, etc.), performing a task (e.g., shopping, refueling a vehicle, purchasing food, running an errand, checking-in to a hotel, booking a vacation, etc.), engaging in recreational activities (e.g., walking, hiking, jogging, running, cycling, swimming, skiing, snowboarding, boating, playing sports, singing, drinking, etc.), moving from one geographical region to another geographical region, entering and/or exiting specific communication networks, etc., and combinations thereof.

Next, the method 5300 determines whether the activity includes any triggering events (step 5316). In some embodiments, triggering events may be associated with one or more activities. The association may be made by a user and/or an administrator (e.g., in the form of settings, preferences, etc.). In one embodiment, the triggering events may be determined based on historical data associated with a particular activity or combination of activities.

For example, a user may drive her vehicle 104 to a park and go for an hour long run. After the run, the user may drive her vehicle 104 to a juice shop and purchase a health drink. When the user returns home from her run and purchase, she may take a shower while smooth jazz plays on her home radio. This combination of activities may be part of a routine the user participates in on a daily, weekly, or monthly period (etc.). In some cases the activities may have previously occurred at least once in a substantially similar manner and combination. The current and at least one previous occurrence may be used to establish a behavior and activities associated with that behavior. Additionally or alternatively, the activities and/or behavior may include certain triggering events.

In the previous example, the activity of driving to a park may act as the trigger to initiate communications with other devices. For instance, once the behavioral detection system receives location information from the vehicle 104, and associates the location with the park, the behavioral detection system may refer to a memory and determine that the user will be away from the vehicle 104 for approximately one hour. The location of the user may be monitored by the vehicle 104 and/or behavioral detection system communicating with the user's smart phone (which the user takes on her run), and determine a position of the user and an estimated time of arrival at the vehicle 104. Additionally or alternatively, the behavioral detection system may anticipate that the user will next drive to the juice shop. In this case, the vehicle 104 and/or behavioral detection system may initiate a communication with the juice shop to place a preliminary order for a specific juice drink previously ordered by the user. The order may be placed in advance for an estimated time or the order may be placed when the user begins to travel toward the juice shop. At the same time, subsequently, or even prior to communicating with the juice shop, the behavioral detection system can communicate with the user's home automation system to start the shower and even tune the infotainment system of the home to the smooth jazz station. These activities having actions that are subsequent to another action may be considered as including triggering events. Triggering events can be linked and/or grouped together. As can be appreciated, the triggering events can be multiplied and dynamically altered as a behavioral entity's behavior develops.

If no triggering events are associated with either the behavior or the activity, the method 5300 returns to step 5308 to detect subsequent behaviors of the behavioral entity. In some cases, the behavioral detection system may record the previous activity and/or behavior and determine whether any other events are related to previous activity and/or behavior. Such a system can provide for dynamic learning (of relationships between behaviors, activities, and triggering events) and the continual refinement of the behavioral monitoring and responses offered by embodiments of the method 5300.

In the event that the activity and/or behavior includes at least one triggering event, the method 5300 continues by initiating a communication across a network based on the at least triggering event (step 5320). As provided above, the communication may be made via at least one component of a vehicle 104 and/or the behavioral detection system. In some embodiments, the behavioral detection system may be a part of the vehicle 104, device, or other nonhuman behavioral entity. The communication may be include one or more of requests, commands, instructions, information, and/or other data. In some cases, the communication may be conversational in nature and/or be made between the behavioral detection system and a human (via a computer terminal in communication with the behavioral detection system).

Next, the method 5300 proceeds by determining whether there is any change to the behavior of the behavioral entity (step 5324). If no change to the behavior is detected, the method 5300 ends at step 5328. However, in the event that a change to the behavior is detected, the method 5300 returns to step 5312 in determining activities associated with the changed behavior. Detection of the change to the behavior of the behavioral entity may be substantially similar, if not identical, to detecting the behavior described in conjunction with step 5308.

Vehicle Networks and Communications:

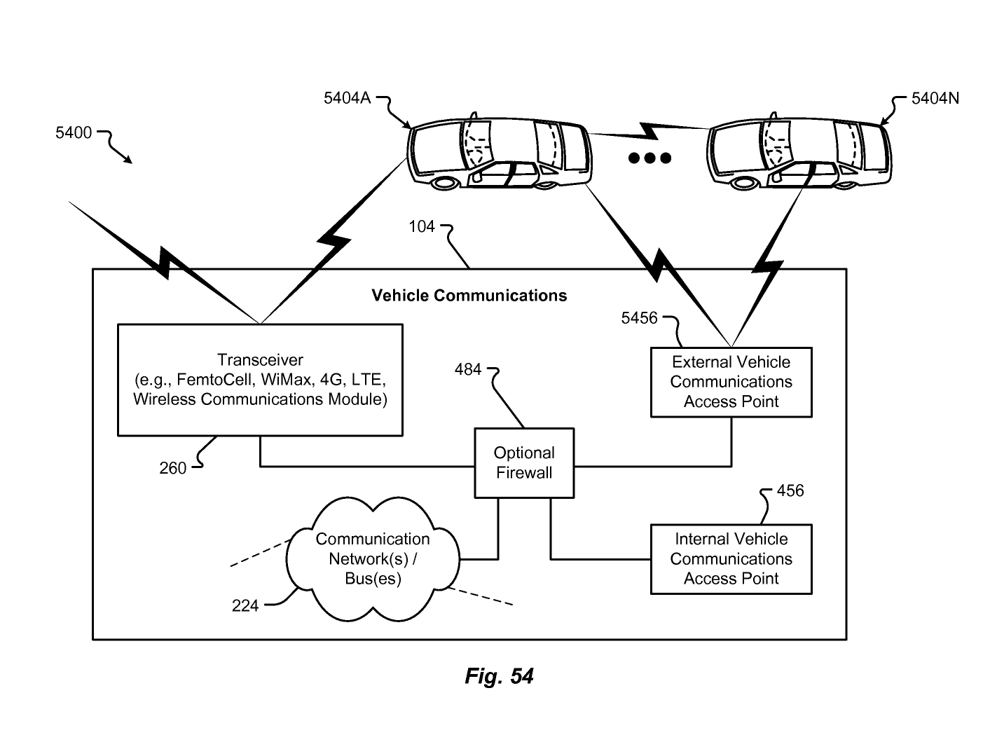

FIG. 54 outlines internal and external vehicle communications between one or more of the vehicle 104 and one or more other vehicles 5404A-N. Similar to the components described in conjunction with FIG. 5C, the vehicle 104 is equipped with the necessary transceivers to provide an internal mobile hot spot (e.g., wireless network, etc.) functionality to any user device(s) therein and/or an external mobile hot spot (e.g., wireless network, etc.) functionality to one or more vehicles 5404A-N adjacent to the vehicle 104.

In one embodiment, an open Wi-Fi structure may be provided that can allow each vehicle 104 to have Wi-Fi internally and at the same time transmit externally. In some cases, neighboring or adjacent vehicles can identify the Wi-Fi signal and even connect to the Wi-Fi identified. The open Wi-Fi structure shown in FIG. 54 may use an SSID structure that allows a particular vehicle to be uniquely identified. In some embodiments, the open Wi-Fi structure may allowing only designated communications, or communications from authorized entities. For example, the vehicle 104 may maintain a whitelist of approved connection entities, a blacklist of blocked and/or restricted connection entities, and/or combinations thereof. In some cases, those entities that have previously connected to a vehicle 104 may be automatically added to the whitelist. The blacklist and/or whitelist may be stored at the connecting vehicle, the connected vehicle, and/or some other memory (e.g., local or remote, on the cloud, etc.). In some embodiments, the blacklist and/or whitelist may be controlled and/or maintained by a central server.

By way of example, the inside of the vehicle 104 may broadcast an internal SSID of “InternalRicci” and may be available to link to any device. The internal SSID may be purposely weak (e.g., configured to reach only points within the vehicle 104, include an attenuated signal, etc.). In some cases, the SSID may even be shielded within the vehicle 104. The external SSID, or the SSID broadcast outside of the vehicle 104, may be used for vehicle-to-vehicle communication. The external SSID used by vehicles may be associated with a unique name, like “TOPI” followed by the vehicle's identification number (e.g., Vehicle Identification Number, or VIN, etc.). Utilizing unique identification numbers and/or SSIDs, passwords may be encoded and only used by vehicles and not for general purpose connections. Since each vehicle is then both an access point and a receiver, whichever vehicle detects another vehicle's SSID first may be designated as the receiver. The transmitting vehicle may note the VIN of the receiving vehicle so the communications do not need to link the other way.

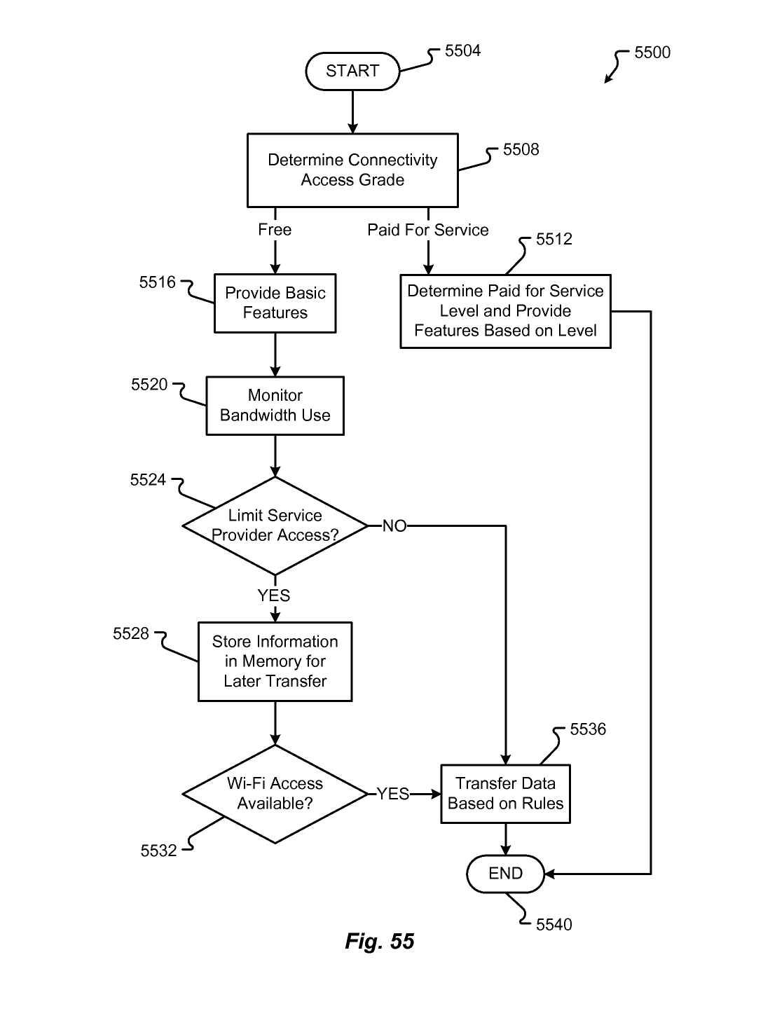

An embodiment of a method 5500 for providing connectivity actions based on available services is shown in FIG. 55. While a general order for the steps of the method 5500 is shown in FIG. 55, the method 5500 can include more or fewer steps or can arrange the order of the steps differently than those shown in FIG. 55. Generally, the method 5500 starts with a start operation 5504 and ends with an end operation 5540. The method 5500 can be executed as a set of computer-executable instructions executed by a computer system and encoded or stored on a computer readable medium. Hereinafter, the method 5500 shall be explained with reference to the systems, components, modules, software, data structures, user interfaces, etc. described in conjunction with FIGS. 1-54.

In one embodiment, the method 5500 may provide a business plan such that every vehicle will have some level of connectivity. The first level of connectivity may be cost free. In return for a user agreeing that user data can be used and/or accessed by a third-party (e.g., a company, organization, individual, combinations thereof, etc.) basic connectivity features may be allowed (e.g., such as e-calling, accessing an app store, or accessing software upgrades from the OEM, etc.). The user may be required to upgrade to receive better connectivity and or feature access. Although the cost free connectivity version may be free to a user, the version costs money to some other entity, for example, when carrier access is utilized, the method 5500 may provide various techniques to maintain low costs (e g, minimizing bandwidth usage, access time, file size, number of transfers, etc.). One way to keep the carrier bandwidth usage of a user to a minimum may include relying on Wi-Fi whenever available. For example, when the vehicle is in the garage, the vehicle may have access to a home Wi-Fi access point. At this location, the vehicle may synchronize data when it has such Wi-Fi access. Some vehicles, however, will not have access to Wi-Fi at home, work, or any of the common places the vehicle may be. By way of example, a construction worker who lives in a trailer park may not have Wi-Fi access at the jobsite or at home. For these types of users, at least one carrier fee may need to be paid in order to utilize the carrier's bandwidth and access user data. However, access to the user's data may be obtained through a different connectivity scheme.

It is an aspect of the present disclosure that some vehicles have such great free connectivity access that the vehicle may transmit data at any given time (e.g., over night, during non-peak hours, during low-cost access times, every night, etc.). In the case of a vehicle with no network access, the vehicle may transmit a signal when a sufficient network access signal is detected and the vehicle has multiple days of information backed up (e.g., stored at the vehicle or a device associated with the vehicle, etc.). For example, when the vehicle normally having no network access comes into proximity of the vehicle having access, a transfer can take place (e.g., from vehicle-to-vehicle) and the vehicle with access can send the data via Wi-Fi (e.g., during a low usage time). In some cases, this vehicle-to-vehicle communication may utilize one or more of the vehicle-to-vehicle communication techniques as provided herein (e.g., as described in conjunction with FIG. 54, etc.). As can be appreciated, using this communication and/or transfer, the lack of service for one user is not adversely affected and carrier costs are maintained at acceptable levels.

In one embodiment, the method 5500 begins at step 5504 and proceeds by determining a connectivity access grade associated with a vehicle and/or user (step 5508). In general, the connectivity access grade can include at least the options of a cost “free” grade and a “paid for service” grade. It should be appreciated that each connectivity access grade may be subdivided and/or categorized with multiple levels or echelons of a particular grade. For instance, a paid for service grade may include a first level of paid for service offering a limited number of connectivity features (e.g., bandwidth, availability, usage, etc.), a second level of paid for service offering a number of connectivity features greater than those features associated with the previous level (e.g., increased bandwidth, increased usage, increased coverage area, preferential data transmission, etc.), and so on. In some embodiments, each successive level may be associated with an increase in monetary cost when compared to a monetary cost associated with at least one of the previous levels in the paid for service grade of the connectivity access grade. Additionally or alternatively, the free service grade may include first, second, third levels, and so on. Rather than increasing a monetary cost associated with the increasing service levels, the service levels associated with the free service grade may be associated with an increase in the amount of data collected from a user having a particular level of free service grade. In one example, a user who wishes to have a better free connectivity access, may allow more information to be collected about the user.

In the event that a paid for service connectivity access grade is determined, the method 5500 proceeds by determining the level of the paid for service and providing features based on the determined level (step 5512). Once the features have been provided, the method 5500 may end at step 5540. Depending on the level of the paid for service, the method 5500 may continue at step 5520, which is described in further detail below.

In some embodiments, when a free connectivity access grade is determined, the method 5500 continues by providing basic features to a user (step 5516). Basic features may include, but are not limited to, at least one of e-calling access, application store access (e.g., vehicle application store, device application store, etc.), limited Internet browser access, limited communication access, limited data transfer ability, news report access, weather report access, and the like.

In any event, the method 5500 may proceed by monitoring bandwidth use via the connectivity access (step 5520). As can be appreciated, the bandwidth use may be based on data transmitted and/or received by at least one component of a vehicle. Monitoring bandwidth may include monitoring bandwidth associated with different connectivity types. For example, a bandwidth associated with Wi-Fi access points may be monitored for general usage information. As another example, a bandwidth associated with carrier access (e.g., cell tower, carrier services, and/or other paid for carrier access or carrier services associated with a monetary cost) may be monitored for number of bytes transmitted and/or received, time of transmission and/or reception, frequency of use, etc. In some cases, bandwidth use associated with a monetary cost (e.g., a monetary cost for any entity) may be more closely monitored than the bandwidth use associated with little or no monetary cost (e.g., Wi-Fi, etc.).

Next, the method 5500 determines whether to limit service provider (e.g., carrier) access based at least partially on the monitored bandwidth use (step 5524). The determination of whether to limit service provider access may be based at least partially on a service grade level associated with a connectivity access grade. In some embodiments, service provider access may be limited based on detected and/or predicted network traffic. Additionally or alternatively, the service provider access may be limited based on specific service provider or carrier rules.

In the event that access is determined not to be limited, the method 5500 may proceed by allowing the transfer of data according to rules (step 5536). Rules may include allowing the transfer of one or more of user data, vehicle information, vehicle statistics, vehicle and/or user behavior, location information, files, communications, etc. In some embodiments, the rules may further define allowable transfer data sizes, transfer times, transfer locations, and/or the like.

When service provider access is determined to be limited, the method 5500 may continue by limiting service provider access in a number of ways. For instance, the method 5500 may determine to store any noncritical information in a local memory for later transfer (step 5538). Noncritical information may include, but is not limited to, any information that is not time sensitive and/or not critical to an operation of the vehicle (e.g., nonemergency communications, standard requests, routine commands, etc.). Conversely, critical information may include, but is not limited to, time sensitive information (real-time vehicle information, traffic reporting, accident reporting, etc.), security information (e.g., security updates, security patches, etc.), emergency communications, and the like. In some embodiments, and as described herein, a vehicle may monitor and/or record information using various sensors and/or devices associated therewith. This information may be routinely transferred to a central server across a communication network 224 for storage, analysis, and/or other use. When service provider access is limited, the method 5500 can store this information in a local memory for later transmission/transfer. The local memory may include any memory associated with the vehicle and/or any memory of a device that is associated with the vehicle.

In some cases, the information may be transferred upon determining that service provider access is no longer restricted or limited. In one embodiment, the information may be transferred upon detecting that Wi-Fi access is available. Wi-Fi access may include free Wi-Fi, or Wi-Fi that is available to use without requiring the user of the vehicle to pay any additional carrier fees. Additionally or alternatively, the Wi-Fi may include the open vehicle-to-vehicle Wi-Fi that is at least described in conjunction with FIG. 54.

For instance, a first vehicle may have stored information in memory for later transfer. The information may have been stored for later transfer because the first vehicle had limited service provider access, has not had access to a suitable Wi-Fi connection, or some other reason. In any event, a second vehicle, in wireless communication proximity to the first vehicle, may have sufficient Wi-Fi and/or carrier access available. In this example, the first vehicle may establish a communication with the second vehicle and determine capabilities of the second vehicle, including connectivity access (and vice versa). Based on the communication, the first vehicle may transfer the stored information to the second vehicle for transfer to a central server across a network or other entity. In this case, the data may be transmitted from the second vehicle on behalf of the first vehicle. In some cases the information may be transmitted in clusters of data, based on priority of the information. For instance, vehicle information and other agreed to information tracking may take precedence over personal information for transfer by the user.

In some embodiments, the method 5500 may determine that a Wi-Fi connection is available for a specific period of time. For example, a vehicle may park outside of a fast food restaurant having Wi-Fi access and determine that, based on the location, the vehicle can transfer information for the next 30 minutes using the fast food restaurant Wi-Fi. This specific period of time may be determined based on historical data, data associated with a location, data associated with a user (e.g., stored in profile data 252, etc.), data associated with a company, etc., and/or the like. As another example, a user may routinely park his vehicle outside of a location known to have Wi-Fi access overnight. In response to parking his vehicle outside of the location, the vehicle may plan to make use of the Wi-Fi access during the overnight period. In any event, the method 5500 continues at step 5536 by transferring data based at least partially on rules (step 5536). In some embodiments, once the data is transferred, the method 5500 ends at step 5540.

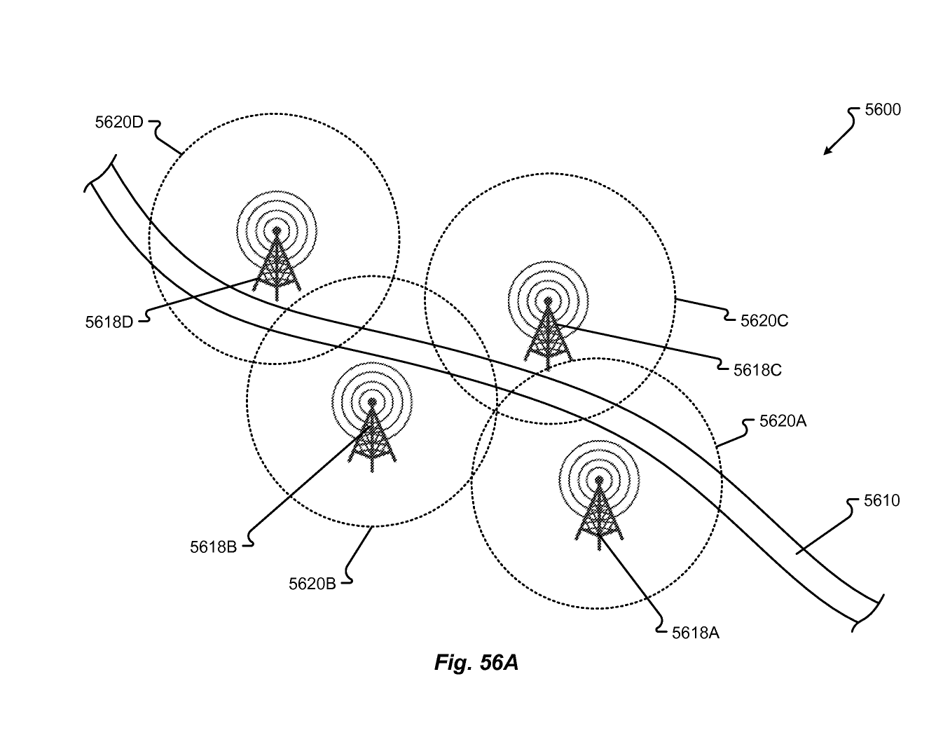

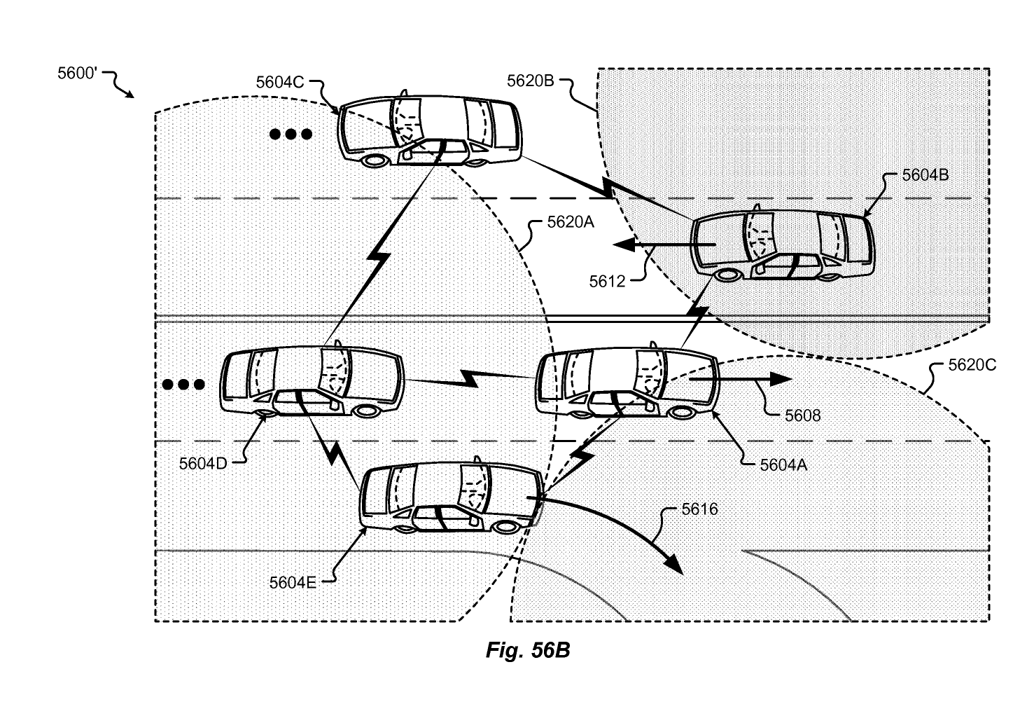

FIG. 56A is a diagram of a communication environment 5600 having a number of access points 5618A-D and coverage areas 5620A-D. As shown, the communication environment 5600 includes a route 5610 running through coverage areas 5620A-D associated with various wireless access points 5618A-D. The route 5610 may include, but is in no way limited to, a road, street, highway, freeway, sidewalk, way, path, causeway, and/or other way leading from one point or place to another. The coverage areas 5620A-D depict a number of connectivity ranges, in which the wireless access points can be detected and/or reached. Although shown as two-dimensional areas, it should be appreciated that the coverage areas may include a third dimension represented as a height from the ground level to a coverage detection point above the ground level. For example, the coverage areas 5620A-D may include volumes of coverage space that surround one or more of the access points 5618A-D. In some embodiments, the coverage areas 5620A-D and the various wireless access points 5618A-D may be associated with different carriers and/or service providers (e.g., Verizon®, AT&T®, Sprint®, T-Mobile®, etc.). For instance, as a vehicle 104 travels along the route 5610 (e.g., from right to left) the vehicle 104 passes through a first coverage area 5620A, a second coverage area 5620B, a third coverage area 5620C, and a fourth coverage area 5620D.

FIG. 56B shows a detail view of the communication environment 5600′ having a number of vehicles 5604A-E travelling along a route 5610. As shown in FIG. 56B, the vehicles 5604A-E are travelling toward and/or away from one or more coverage areas 5620A-C. For example, first vehicle 5604A is travelling in a first direction 5608, while second vehicle 5604B is travelling in a second direction 5612 which is opposite the first direction 5608. In particular, first vehicle 5604A is shown leaving the first coverage area 5620A and entering the third coverage area 5620C. Second vehicle 5604B is shown in the third coverage area 5620C travelling in a direction 5612 toward the first coverage area 5620A.

In one embodiment, wireless communications may be made between the vehicles 5604A-E as discussed in conjunction with FIG. 54, etc. The wireless communications may include one or more of the vehicles 5604A-E accessing an external Wi-Fi access point of at least one of the other vehicles 5604A-E. These communications may be made between two or more vehicles 5604A-E that are in a communication proximity (e.g., a communication range, signal detectable area, etc.) to one another. Additionally or alternatively, the one or more vehicles 5604A-E in communication proximity may form an impromptu network. This network may be used for the exchange of information including, but not limited to, information associated with at least one behavioral entity, update information, diagnostic information, coverage area 5620A-D communications, and/or other information/data.

In some embodiments, a connectivity map may be generated using information collected from the one or more vehicles 5604A-E. For example, the vehicles 5604A-E may become data collectors for signal information. As a vehicle 5604A-E travels along various routes, the vehicle 5604A-E may be configured to collect information corresponding to connectivity signals. Detected signals may be associated with a geographical position or location and/or time of detection of the signal. Additionally or alternatively, undetected signals (or lost signals) may be associated with a geographical position or location and/or a time when the signal was no longer detected or lost. For instance, a vehicle 5604A may detect a first carrier area 5620A and signal information at a first time and location. As the vehicle 5604A moves to another geographical location, the signal information associated with the first carrier area 5620A may change. This information and/or change in information may be stored in a memory. The information may be routinely collected and updated for one or more carrier areas 5620A-D, etc. In some cases, the location information may be based on location information (e.g., GPS data, etc.) of the vehicle, as described above.

The connectivity map may include detailed maps of one or more of wireless networks, provider coverage, carrier coverage areas, access points (e.g., static of fixed access points, dynamic or moving access points—including an average number of vehicles 5604A-E having connectivity at a given time), and/or a signal quality (e.g., available bandwidth, transfer speeds, Quality of Service (QoS), Signal to Noise Ratio (SNR), consistency, etc.), signal strength (e.g., strong, sufficient, below average, weak, and/or ranges therebetween—the signal strength may be classified with a numerical and/or symbolic strength value similar, if not identical, to the signal strength classifications on a mobile phone, etc.), signal traffic (e.g., how many devices are using a connection, available bandwidth based on number of devices and/or utilized bandwidth, historical bandwidth uses, etc., and/or time-based estimations of the same). In one embodiment, the connectivity map and/or detailed signal strength may provide information that a particular carrier area and/or location includes high quality signal but may have high interference. In some cases, a vehicle may switch carriers based on the information and/or connectivity map. This switch may be performed manually and/or automatically. For example, the vehicle may utilize a “roam” feature to access one or more networks having connectivity. Additionally or alternatively, the roam feature may be associated with an additional cost to a user of the vehicle.

Once a vehicle collects connectivity map information, the vehicle may transfer the information to a central server across a network. In some cases, a central server may be maintained by a single entity (e.g., connectivity mapping service company, etc.). In one embodiment, a central server may be associated with one or more entities (e.g., carriers, service providers, etc.). In another embodiment, a central server may be associated with each entity (e.g., carrier, connectivity mapping service company, service provider, etc., and/or other groups). As each entity may control the central server associated with the entity, connectivity map information may be securely stored by the entity and restricted from access by an unauthorized party (e.g., other entity, etc.).

As shown in FIG. 56B, data or information may be handed off from one vehicle 5604A-E to another vehicle 5604A-E in the communication network 5600′. For example, where the first vehicle 5604A is be travelling in first direction 5608 and comes into a communication proximity with second vehicle 5604B, the first vehicle 5604A may receive information (e.g., from second vehicle 5604B, third vehicle 5604C, etc.) regarding connectivity in an area ahead of first direction 5608 (e.g., at least because second vehicle 5604B came from the area ahead of first direction 5608). Similarly, second vehicle 5604B may receive information regarding connectivity in an area ahead of second direction 5612 (e.g., from first vehicle 5604A, third vehicle 5604C, etc.). A vehicle 5604A-E travelling from one coverage area 5620A-D to another may determine to transfer data before leaving a coverage area 5620A-D. For instance, third vehicle 5604C may communicate with fourth vehicle 5604D and provide information that the area in which fourth vehicle is travelling to (e.g., based on destination data, data structure information, traffic control information, travel direction—first direction 5608, etc., and/or combinations thereof) includes second and third coverage areas 5620B, 5620C. In this example, fourth vehicle 5604D may determine that any transfer of data should be made while the vehicle 5604D is still in the first coverage area 5620A (e.g., because fourth vehicle may be configured to prevent paying roaming charges, switching carriers, and/or using other coverage areas 5620, etc.). Alternatively, fourth vehicle 5604D may determine to suspend data transfer until another coverage area associated with a carrier of the first coverage area 5620A becomes available. In some cases, fourth vehicle 5604D may determine to transfer data using second and/or third coverage areas 5620B, 5620C. As can be appreciated, data may be exchanged between a number of vehicles 5604A-E and/or sent on behalf of at least one vehicle 5604A-E.

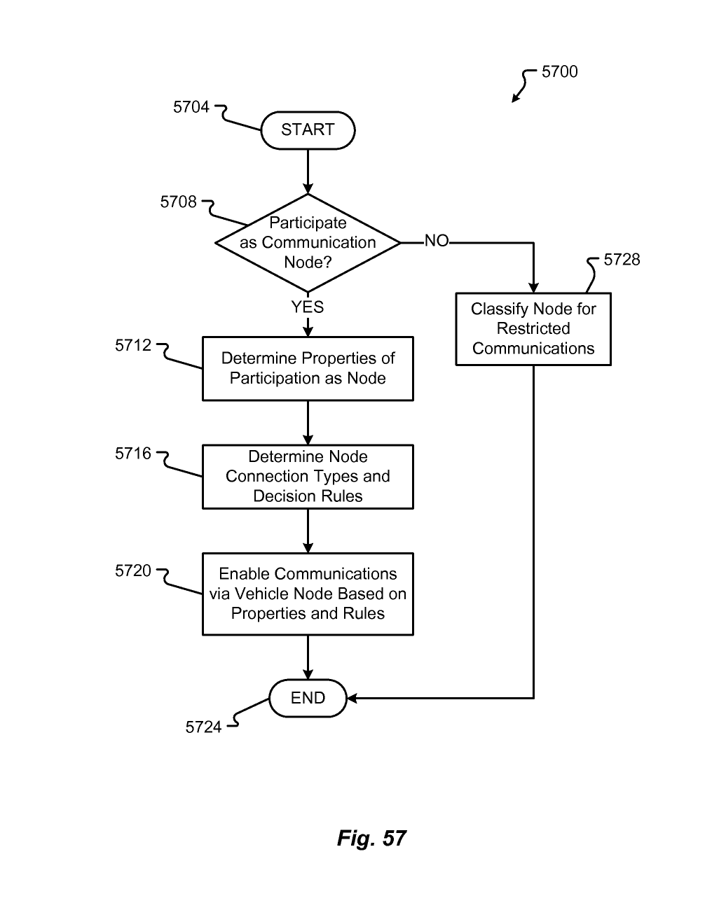

An embodiment of a method 5700 for configuring vehicle communication nodes is shown in FIG. 57. While a general order for the steps of the method 5700 is shown in FIG. 57, the method 5700 can include more or fewer steps or can arrange the order of the steps differently than those shown in FIG. 57. Generally, the method 5700 starts with a start operation 5704 and ends with an end operation 5724. The method 5700 can be executed as a set of computer-executable instructions executed by a computer system and encoded or stored on a computer readable medium. Hereinafter, the method 5700 shall be explained with reference to the systems, components, modules, software, data structures, user interfaces, etc. described in conjunction with FIGS. 1-56B.

In some embodiments, at least one vehicle 104, 5604A-E may be configured to participate as a communication node. As can be appreciated, any vehicle that plays a role in a communication from one point to another may be classified as a communication node. In the examples provided above, where a first vehicle communicates with a second vehicle, both the first and second vehicle are communication nodes. A communication node may include communication endpoints, relays, access points, and/or other points used in a communication path. The configuration of a vehicle as a communication node may be set by a vehicle owner, a vehicle user, an administrator, a manufacturer, a vehicle sales group, and/or some other entity. This configuration can be set manually and/or automatically, based on user profile data, settings, preferences, and/or other information. For instance, a user may prefer to restrict others from utilizing the communication components of the user's vehicle. In one example, the user may be concerned about available bandwidth, costs, traffic data, and/or acting on behalf of another user. In another example, the user may be concerned with privacy and security of information associated with the user's vehicle. In any event, the method 5700 described herein can provide for a number of communication participation node rules and controls.

The method 5700 begins at step 5704 and proceeds by determining whether the vehicle will participate as a communication node (step 5708). In one embodiment, the determination may be made by providing a prompt to at least one device of the vehicle for review and selection by a user associated with the vehicle. For example, the prompt may be presented to a GUI (e.g., in the form of a user-selectable field, etc.) and configured to receive at least one input (e.g., touch, voice, gesture, etc., and/or other input) from a user. In some embodiments, determining whether a vehicle will participate as a communication node may include referring to rules stored in a memory. The rules may correspond to settings and/or preferences, conditional input, and/or the like.

In the event that the vehicle is determined as not participating as a communication node, the method 5700 continues by classifying the node for restricted communications (step 5728). Restricted communications can include preventing the node from being used in any communications. In one embodiment, restricted communications may allow for the vehicle to act as a communication node in emergency communications. Examples of emergency communications may include, but are not limited to, AMBER Alerts™, Emergency Broadcast Messages, distress signals, Mayday calls, Pan-pan calls, safety signals, security calls, police and/or emergency responder signals, and/or other signals designated as emergency. In some cases, certain emergency communications may be configured to breakthrough vehicle nodes classified as restricted. As can be appreciated, these breakthrough communications may configured to reach one or more vehicles in communication network.

In the event that the vehicle 104, 5604A-E is determined as willing to participate as a communication node in a communication network, the method 5700 continues by determining properties associated with the vehicle's participation as a communication node, or node (step 5712). The properties can include, but are not limited to, privacy settings, emergency settings, data transfer rates, data transfer sizes, communication and/or connection times, combinations thereof, and the like. These properties may be configured and/or setup in a similar, if not identical, manner as configuring the vehicle to participate as a communication node described in conjunction with step 5708. For example, the emergency settings may be configured to allow the vehicle to receive and/or transmit all types of emergency signals. In another example, the vehicle may be configured to receive only some emergency signals (e.g., Emergency Broadcast information, police information, etc.) while preventing other emergency signals (e.g., AMBER Alerts™, etc.) from being received and/or transmitted.

As another example, a vehicle may be allowed to act as a communication node and transmit information on behalf of another vehicle during a specified time period and/or based on connectivity information. For example, the vehicle may be configured to transmit data on any network (e.g., carrier, Wi-Fi, etc.) used by the vehicle when bandwidth is available (e.g., within a preferred threshold—under a paid for limit, etc.) and configured to transmit data on select networks (e.g., Wi-Fi, etc.) when bandwidth availability is limited on some other network (e.g., carrier network, etc.). In one example, a user may configure her vehicle to transmit data only during off-peak hours (e.g., overnight, during early morning hours, etc.). In any event, the method 5700 provided herein can allow for total customization of communication node participation.

The method 5700 proceeds by determining node connection types and decision rules (step 5716). One example of determining node connection types may include referring to “blacklist” and/or “whitelist” rules stored in memory. The blacklist rules may include a restricted set of communication nodes which the vehicle may be prevented from using as communication nodes in a communication. Additionally or alternatively, the blacklist rules may include a restricted set of communication nodes which are prevented from using the vehicle as a communication node in a communication. In any event, blacklist communication nodes may be tagged, or included in a set of blacklisted nodes, based on at least one of reliability, security concerns, safety issues, personal preferences, time of day, geographical location, and the like. For instance, an unreliable vehicle may be used as a communication node, but later it may be found that information sent from the unreliable vehicle may be transmitted over a series of days, weeks, or months, and so on. Rather than sending the information in a timely manner (e.g., within seconds, minutes, or hours, etc.) as may have been specified in the transmission of information to the unreliable, the unreliable vehicle may consistently fail to send information according to set times. In response, the unreliable vehicle may be included in a blacklist. As another example, a vehicle may be travelling through an area of Russia that is associated with information thieves. In this example, the vehicle may designate any vehicle from the area of Russia as a blacklisted communication node. The vehicle may determine that some of the vehicles in the area are passing through the area of Russia and may originate from a different region (e.g., by referring to hardware address, and/or identifier of the vehicle stored in memory, etc.). These vehicles may not be tagged as blacklisted. In this case, the vehicle may selectively use non-blacklisted vehicles as communication nodes.

In some embodiments, the whitelist rules may include a set of communication nodes which the vehicle may be encouraged to use as communication nodes in a communication. Additionally or alternatively, the whitelist rules may include a set of communication nodes which are allowed to use the vehicle as a communication node in a communication. In some embodiments, the whitelist rules may be substantially opposite to the blacklist rules. Whitelist communication nodes may be tagged, or included in a set of whitelisted nodes, based on at least one of reliability, security ability, safety, personal preferences, time of day, geographical location, and the like. Typical whitelist communication nodes may include friends, vehicles with high reliability (e.g., average or above data, transfer rate, bandwidth, signal strength, etc.), vehicles with high security (e.g., using secured transmission channels, secure data transfer protocols, etc.), and/or other preferred communication nodes. Similar to the blacklist rules, the whitelist rules may include communication nodes configured by a vehicle user, administrator, communication network controller, company, or other entity. The rules may be set in response to conditions (e.g., based on recorded historical information associated with a vehicle, etc.) and/or manually (e.g., based on user input, etc.).

Next, the method 5700 continues by enabling communications (via the vehicle) based at least partially on the determined properties and rules (step 5720). As described herein, the vehicle may act as a communication endpoint, access point, relay, and/or other communication node in a communication network. The method 5700 ends at step 5724.

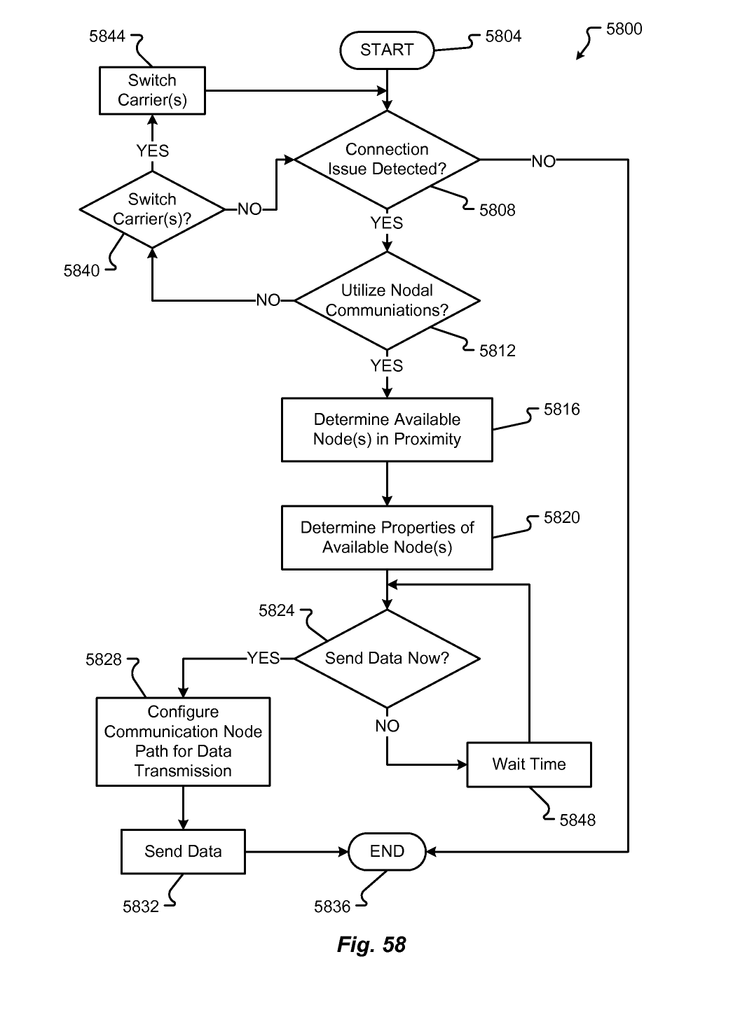

An embodiment of a method 5800 for sending data in a vehicle communication network is shown in FIG. 58. While a general order for the steps of the method 5800 is shown in FIG. 58, the method 5800 can include more or fewer steps or can arrange the order of the steps differently than those shown in FIG. 58. Generally, the method 5800 starts with a start operation 5804 and ends with an end operation 5836. The method 5800 can be executed as a set of computer-executable instructions executed by a computer system and encoded or stored on a computer readable medium. Hereinafter, the method 5800 shall be explained with reference to the systems, components, modules, software, data structures, user interfaces, etc. described in conjunction with FIGS. 1-57.

The method 5800 begins at step 5804 and proceeds by determining whether any connection issue is detected (step 5808). Connection issues may include, but are not limited to, one or more of connectivity service interruption, loss of signal, bandwidth constraints, data transfer limits, poor signal strength, intermittent connectivity, approaching a paid-for communication limit, reaching a paid-for communication limit, and the like. In the event no connection issues are detected, the method 5800 may end at step 5836 or continue to monitor connectivity for any connection issues.

When at least one connection issue is detected, the method 5800 continues by determining whether to utilize nodal communications (step 5812). Among other things, nodal communications may include utilizing at least one other vehicle, or device, as a communication node in a communication. Vehicle communication nodes may be configured at least as described in conjunction with FIGS. 56A-57. Device communication nodes can include communication nodes that are associated with various communication devices, such as wireless access points, routers, modems, and/or other communications equipment. The determination to utilize nodal communications may depend on the type of connection issue detected and/or conditions at the time of detecting the connection issue. For example, a vehicle may determine that a coverage area associated with a particular carrier is limited in a region in which the vehicle is travelling. Continuing this example, the vehicle may be travelling in low traffic area (e.g., rural area, late at night, etc.) where few or no other vehicles are in proximity to the vehicle. In this example, the vehicle may determine not to utilize nodal communications. As another example, nodal communications may be restricted where security of data transmission is of concern to a user. For instance, a user may configure nodal communication settings associated with the vehicle to avoid using nodal communications where sensitive data (e.g., banking data, personal data, governmental intelligence data, and/or other secure transmissions) may be transferred. Alternatively, settings of the vehicle may be configured to utilize nodal communications when a vehicle is restricted from switching carriers or sending information through an alternative service provider. These settings may be configured by a user, carrier, service provider, manufacturer, company, and/or some other entity. In some embodiments, the settings may be stored in user preferences and even associated with a particular user.

Determining whether to utilize nodal communications may include an originating vehicle determining to transmit data along a group of vehicles that are networked (e.g., in a daisy-chain fashion, etc.) when there is an absence of a wireless path (e.g., no direct path, no signal, etc.) to a remote destination from the originating vehicle. Such nodal communications may allow the originating vehicle to transmit data using a series of intermediate communication nodes (e.g., other vehicles, access points, etc.).

In the event that the method 5800 determines not to utilize nodal communications, the method 5800 may continue by determining whether to switch to another (e.g., different) carrier or service provider (step 5840). The determination to switch carriers may depend on one or more factors, such as, communication settings, communication preferences, carrier availability, paid-for carrier services available to a vehicle and/or user, and the like. Where an alternative, or switchable, carrier is unavailable, the vehicle may determine not to switch carriers. A carrier may be unavailable based on a number of factors, such as, a lack of service, poor signal reception, bandwidth limitations, unique hardware requirements (e.g., Subscriber Identity Module (SIM) card, security protocols, communications equipment, antenna frequency and/or configuration, etc.), a number of users accessing resources associated with the carrier, and the like.

When the determination is made to switch carriers, the method 5800 may continue by switching from one carrier to another (step 5844). In some cases, the vehicle may allow the vehicle to continue to use resources of the first carrier while simultaneously using the resource associated with the second carrier. For instance, the first carrier may be used for local calls, while the second carrier may be used for large file and/or data transmissions. In some embodiments, switching carriers can allow the vehicle to send communications using the switched carrier as the communications service provider.

In the event that nodal communications are determined to be utilized in step 5812, the method 5800 may proceed by determining available nodes in proximity to the vehicle (step 5816). Availability may refer to an existence of a detected communication node and/or an accessibility of a detected communication node. In any event, the available nodes include any communication node that may be detected in a physical proximity to the vehicle. One example of a physical proximity can include a signal detection area, range, or distance from the vehicle, or communication module(s) of the vehicle, to at least one communication node. Communication nodes can include at least one of vehicles, Wi-Fi access points, routers, modems, and/or other wireless communication module configured to broadcast and/or receive communication signals. For example, a vehicle travelling along a route in an urban area may determine that a number of communication nodes exist in proximity of the vehicle. These communication nodes may comprise vehicles having wireless communications abilities, home Wi-Fi access points, business Wi-Fi access, and/or free Wi-Fi access spots. In some embodiments, the methods and systems provided herein may send and/or receive communications using one or more of the communication nodes described.

Next, the method 5800 proceeds by determining the properties of the available communication nodes (step 5820). Properties can include signal strength, signal quality, service provider information, ownership information, reliability, and/or more. In some cases, a communication node may be detected as broadcasting in an area, but may include access restrictions (e.g., restricting access to authorized entities only). The access restrictions may include further properties, such as required authorization credentials, verification codes, and the like. In some cases, the properties may include a broadcast identification (e.g., SSID, etc.) associated with the communication node. Additionally or alternatively, the properties may include data transmission rules associated with one or more of the communication nodes. Transmission rules may define data transfer rates and/or times, number of allowed connections, blacklisted entities, whitelisted entities, access times, and/or other communication rules.

The method 5800 proceeds by determining when to send data via at least one of the communication nodes (step 5824). In some embodiments, the determined properties of the available communication nodes may dictate a time for sending data. By way of example, the available communication nodes may only allow for sending data during at least one specified time period. For example, when the determination time (e.g., the time of reaching step 5824) falls outside of the specified time period, the method 5800 may determine to wait until the time is within the specified time before sending data. In this example, the method 5800 proceeds to wait for time (step 5848). In some embodiments, the method 5800 may initiate a timer at step 5848 and upon expiration of a preset time return to determining when to send data (step 5824). In one embodiment, the method 5800 may proceed by waiting for a time period until an input is received (e.g., a change in properties, a manual input, a change in available communication nodes and/or a status associated therewith, an accessibility detection, etc., and/or combinations thereof). When the input is received, or when the time period expires, the method 5800 may return to step 5824.

When a determination is made to send the data in step 5824, the method 5800 may continue by configuring a communication node path for data transmission (step 5828). For instance, data may be sent from the vehicle to one communication node to another and so on (e.g., to transmit data from one point to another). In some embodiments, the path may be configured by one or more components of the vehicle 104 (e.g., vehicle control system 204, communication subsystems 344, external vehicle communications access point 5456, etc.). It should be appreciated, that available communication nodes may periodically change, especially as a vehicle is moving along a route. In some embodiments, the communication nodes may be classified as static (hard-wired, access points, building Wi-Fi, stationary vehicles, etc.) or dynamic (e.g., mobile, moving vehicles, etc.). Whether static or dynamic, the communication nodes may be selected as part of configuring the communication node path based on this classification. By way of example, a vehicle travelling along a highway may determine that surrounding vehicles having communication abilities are travelling in the same direction and/or to a same destination. In this case, the vehicle may configure a communication node path that includes the vehicles having the communication abilities as nodes in the communication node path. Depending on the type of information to be transmitted and/or properties associated with the transmission of data, the communication node path may include selecting communication nodes travelling in a different direction from the vehicle, a similar direction to that of the vehicle, and/or combinations thereof. The method 5800 proceeds by sending the data via the configured communication node path (step 5832). The method ends at step 5836.

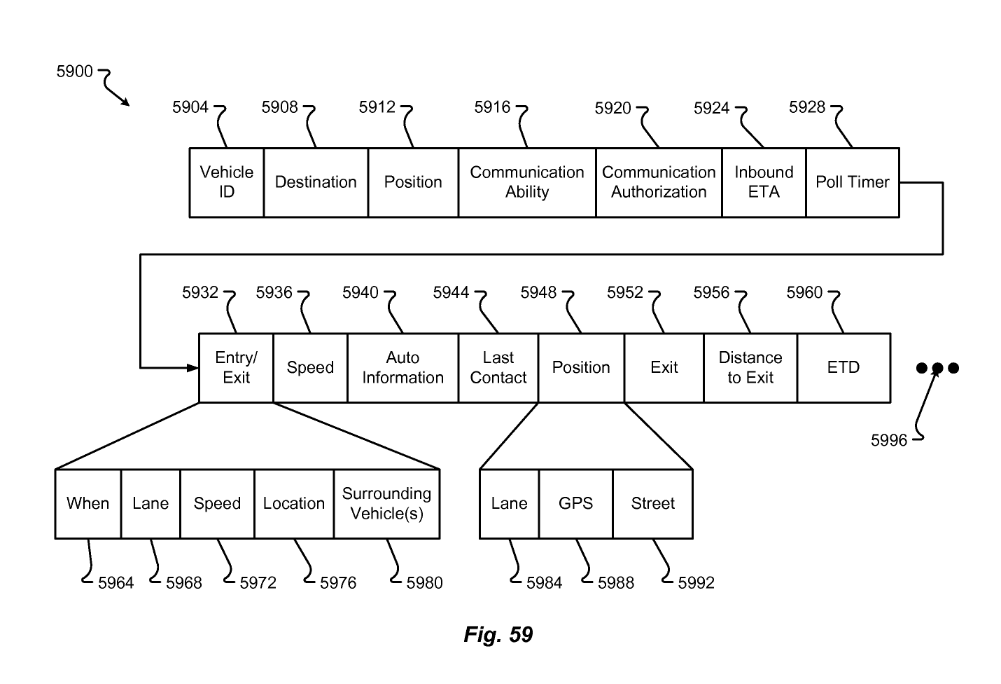

An embodiment of vehicle information that may be stored within a memory of the vehicle or exchanged between vehicles may be as shown FIG. 59. The memory can include one or more fields that may be stored as a flat file database, relational database, object oriented database, etc. These one or more fields may include information that may be used to manage the communication system 5600 or may be used by a vehicle to determine how to communicate with at least one other communication node. The information can include one or more of the fields shown in FIG. 59 but may not be limited to those fields or may have fewer fields than those shown in FIG. 59, as represented by ellipses 5996. Each of the several fields and the information contained therein will be described hereinafter. In some embodiments, the data structure 5900 described in conjunction with FIG. 59 may at least be used to develop a map of connectivity, configure a communication network, configure communication nodes included in a communication path, and/or more.

A vehicle identifier (ID) field or identifier field 5904 can provide a unique identifier for the vehicle. This identifier 5904 may be used to send messages to that vehicle, while in the communication system 5600. The vehicle identifier 5904 may be static such that it is produced one time and stored thereinafter by the vehicle and used, by that vehicle, for any interaction with the communication system 5600. In other situations, that vehicle identifier 5904 is dynamically generated upon any contact with a communication system 5600. The vehicle identifier 5904 can be a numeric, alpha numeric, globally unique identifier (GUID), or any other type of identifier. In some embodiments, the vehicle identifier 5904 may be referred to as a node identifier, a communication node identifier, and/or combinations thereof.

A destination field 5908 may include the destination of the vehicle on the route currently being traveled. The destination 5908 may be provided as a GPS coordinate, a latitude/longitude, a physical address, some other graphical information system data or other type of data. The destination 5908 may be provided by a user entering such information into a location module 896 and/or traffic controller 8112, etc.

The position field 5912 can include the current position of the vehicle at a point in time. The position 5912 may be a GPS coordinate, an address, or some other type of designation of the current physical location of the vehicle. The position 5912 may be updated periodically or continually for interactions with a traffic control system and/or communication system 5600.

The communication ability field 5916 may include information relating to one or more communications abilities of the vehicle. Communications abilities may include communications hardware, communications software, communication applications, revisions and/or versions associated therewith, and the like. For instance, communications abilities may include whether a vehicle includes a particular type of communication device or component, such as a particular antenna, communications module, SIM card, etc.

A communication authorization field 5920 can include an authorization for another entity to use a communication ability of the vehicle provided in the communication ability field 5916. The communication authorization may apply to general rules that allow or deny access to a communications ability of the vehicle. Additionally or alternatively, the communication authorization field 5920 may include information that can be used by another entity (e.g., vehicle, device, etc.) in establishing an authorized use. For example, the communication authorization may include at least one key, hash, code, salt, encryption, and/or other security data configured to selectively allow access to a communication ability of the vehicle.

The inbound estimated time of arrival (ETA) 5924 is a time predicted by the automobile to arrive at an entry point to the roadway. This inbound ETA 5924 can allow a communication server to determine spacing and distribution of communication nodes in a configured communication node path. Further, the communication server may add and/or exclude vehicles from a communication network 5600 based on the inbound ETA 5924.

A poll timer 5928 may provide a time period or amount of minutes or seconds used by the vehicle and/or the communication server to contact the vehicle. The pull timer 5928 may be set such that when the vehicle is inbound to the communication system 5600, the traffic controller 8112 knows to contact and update the communication server with the current position 5912 and/or the inbound ETA 5924. This poll timer 5928 allows the communication server to continually update the desired entry point for the vehicle.

An entry/exit field 5932 includes the information for the vehicle on their positioning to enter or exit the roadway. Thus, this information allows the vehicle to understand which communication network 5600 a vehicle is in at a given point in time. As such, the entry/exit field 5932 can include a when field 5964 which includes a time for when the vehicle should enter the communication network 5600. This timing 5964 may be a set time or number of seconds or minutes until which the car is needed to enter the communication network 5600. The when field 5964 should correlate to an opening within communication network traffic for the vehicle to enter.

A lane field 5968 includes the lane upon which the vehicle is travelling to. In some embodiments, the lane field 5968 may include information used by the various entities and/or components of a communication network 5600 in configuring a communication network 5600 and/or a communication node path.

A speed field 5972 includes the speed that the vehicle is travelling along a route. In some embodiments, vehicles may be included and/or excluded from a communication network 5600 based on the speed the vehicle is travelling. For instance a moving vehicle travelling at a significantly different speed compared to the vehicle creating a communication node path, may determine that the moving vehicle will not be reliable as a communication node. This determination may be made based on the limited amount of time that the moving vehicle is in proximity to the vehicle.

The location field 5976 includes a location within vehicular traffic and the lane upon which the vehicle is travelling. This location 5976 may include a mile marker or be designated by some other geographical information.

A surrounding vehicle field 5980 can include the vehicle ID 5904 for at least one vehicle that is in front, back, or to the sides of the vehicle. As such, the vehicle may be able to ascertain the exact positioning between vehicles in a communication network 5600. As this “position” moves because the vehicles are moving, the surrounding vehicles provide a location for the vehicle in traffic when traveling along a route.

The entry/exit information 5932 may also be changed or be modified as the vehicle enters the communication system 5600 or exits the communication system 5600. As such, this information may be provided periodically to allow the vehicle to enter or leave one or more communication systems 5600, or networks.

The speed field 5936 may include an average speed the vehicle maintains during travel. The information contained in the speed field 5936 may be generated from historical data, user profile data 252, and/or the like.

The auto information field 5940 can include any information about the vehicle that may be sent to a communication server or other entity for determination of how to configure communication nodes in a communication system 5600.

A last contact field 5944 can include information for when this vehicle last entered into a communication system 5600. The field 5944 may also include information upon which the vehicle should contact at least one other entity and/or component of the communication system 5600.

A position field 5948 may include information about the permanent position upon which the vehicle is expected to maintain within the traffic along a route. As such, the position information 5948 can include a lane designation 5984, a GPS coordinate 5988, a street name 5992, a traffic location, etc. This information 5948 may also be used to determine a current origin, such as position 5912.

The exit information 5952 may be the information designated by the vehicle to a traffic control system about when the vehicle wishes to exit to maintain their desired travel route. Further, this information 5952 may also be designated by a control server 2004 and provided to the vehicle to manage that route based on the exit chosen by the traffic control system.

A distance to exit 5956 may include the amount of distance (e.g., miles, feet, etc.) used to measure where the current position 5912 is compared to the exit 5952 upon which the vehicle needs to exit. This distance 5956 may be used by the vehicle to begin to leave a communication system 5600 or network.

The estimated time of departure 5960 can include an amount of time expected to reach the exit 5952. This information may be based on the distance to exit 5956 and the speed 5936 maintained by the vehicle.

Vehicle Theme Library and Presentation:

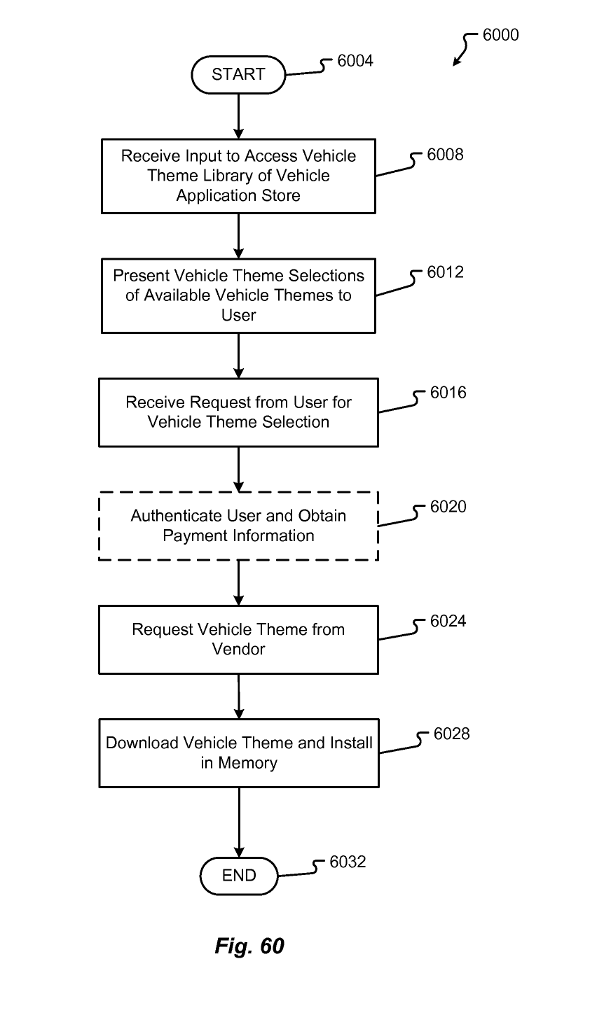

An embodiment of a method 6000 for accessing a vehicle theme library is shown in FIG. 60. While a general order for the steps of the method 6000 is shown in FIG. 60, the method 6000 can include more or fewer steps or can arrange the order of the steps differently than those shown in FIG. 60. Generally, the method 6000 starts with a start operation 6004 and ends with an end operation 6032. The method 6000 can be executed as a set of computer-executable instructions executed by a computer system and encoded or stored on a computer readable medium. Hereinafter, the method 6000 shall be explained with reference to the systems, components, modules, software, data structures, user interfaces, etc. described in conjunction with FIGS. 1-59.

The vehicle theme may be configured to control one or more settings of a vehicle. For instance, the vehicle theme can control a lighting effect, color, intensity, of the interior and/or exterior lighting of the vehicle. In some embodiments, a vehicle theme can include theme-specific sounds, voices, fonts, icons, window tinting and/or transparency (e.g., in vehicles having actively controlled glass), GUI layouts, accessibility, feature and/or control sensitivity, and the like. Additionally or alternatively, the vehicle theme may be associated with one or more users of a vehicle. Vehicle themes may be stored in a profile data 252 memory associated with a user. Vehicle themes may be associated with a rank or control order hierarchy. In this example, when two users are in a particular area 508A-N or zone 512A-E of a vehicle, the vehicle may present the vehicle theme according to the rank or control hierarchy (e.g., the vehicle theme of the user having a higher rank when compared to the vehicle theme of another user will be presented according to this embodiment). In one embodiment, multiple themes may be allowed to coexist, or be presented, in different areas 508A-N and/or zones 512A-N of the vehicle. Where the multiple themes may merge or come together at adjacent areas 508A-N and/or zones 512A-N (e.g., in display devices, consoles, dash displays, etc.), a merged theme may be configured at the merger area to incorporate features from each theme of the multiple themes.

The method 6000 begins at step 6004 and proceeds when input is received to access a vehicle theme library associated with a vehicle application store (step 6008). In one embodiment, a user may provide the input via selecting a theme option presented to a user device associated with the vehicle. For instance, the user may access a central control touchscreen of a vehicle and navigate to a theme page of an application store. In some embodiments, the application store may be configured as a vehicle application store that includes applications executed by at least one processor associated with the vehicle. The vehicle applications may be specifically designed for use with a vehicle and/or include vehicle control functionality. Examples of a vehicle application store are more fully described in U.S. patent application Ser. No. 13/679,412 to Ricci, the entire contents of which are hereby incorporated herein by reference for all that it teaches and for all purposes.

In some embodiments, the input for accessing the vehicle theme library may include may be provided automatically in response to detecting that a user does not have a particular theme in user profile data 252. For example, a vehicle may recognize a user, and based on the recognition, refer to a data structure associated with the user for one or more preferences, settings, and configurations. In the event that the user does not have a particular theme, the control system may automatically direct the user to the theme library of the vehicle application store. In one embodiment, the user may be directed to a theme library associated with the vehicle and having at least one theme.

In any event, upon receiving the input the method 6000 proceeds by presenting a number of vehicle theme selections of available vehicle themes to the user (step 6012). The vehicle theme selections may be presented to a display device associated with the vehicle. Each selection can include one or more of a theme description, identifier, screen shot, cost, download option, sample “try” option, and more. The selections may be arranged as selectable icons, in a list format, in a grid format, or in some other graphical presentation displayed to a display device of the vehicle.

The method 6000 continues when a request is received from a user selecting at least one vehicle theme from the presented vehicle theme selections (step 6016). The selection may allow a user to enter a demonstration of the vehicle theme. In a demonstration mode, the vehicle may be configured to present elements of the vehicle theme. This demonstration can allow a purchaser of a vehicle theme to temporarily configure a vehicle and its components to present a demonstrating theme. The presentation may include changing lighting, displayed elements, control features, and/or other aspects of the vehicle. If the user approves of the theme, the user may proceed to install, apply, and/or download the theme. In one embodiment, the user may determine to “try” different themes before selecting a theme to apply to the vehicle. In some embodiments, the vehicle themes may be associated with a cost. In this case, the request from the user selecting the theme may serve to at least one of install and pay for the vehicle theme.

The method 6000 may continue by authenticating the user and obtaining payment information for a selected vehicle theme associated with a cost (step 6020). Authentication may require a user identification and authorization code (e.g., a username and password, etc.). The payment information may be retrieved from a local and/or remote memory. For instance, the payment information may be maintained in the profile data 252 memory associated with a user.

Next, the method 6000 continues by requesting the selected vehicle theme from a vehicle theme vendor (step 6024). The vehicle theme vendor may be a third party, a company, an entity, the vehicle application store, and/or other supplier of the vehicle theme.

The method 6000 may proceed by downloading the vehicle theme and installing the vehicle theme a memory associated with the vehicle (step 6028). In some embodiments, the vehicle theme may be stored in the profile data 252 and associated with a particular user. As can be appreciated, the user may transport the vehicle theme from one vehicle to another vehicle by providing access to the vehicle theme stored in the profile data 252 memory. In any event, the memory associated with the vehicle may be local (e.g., in at least one device associated with the vehicle, smartphone, etc.), remote (e.g., in a memory across a communication network, in the cloud, etc.), and/or combinations thereof. The method ends at step 6032.

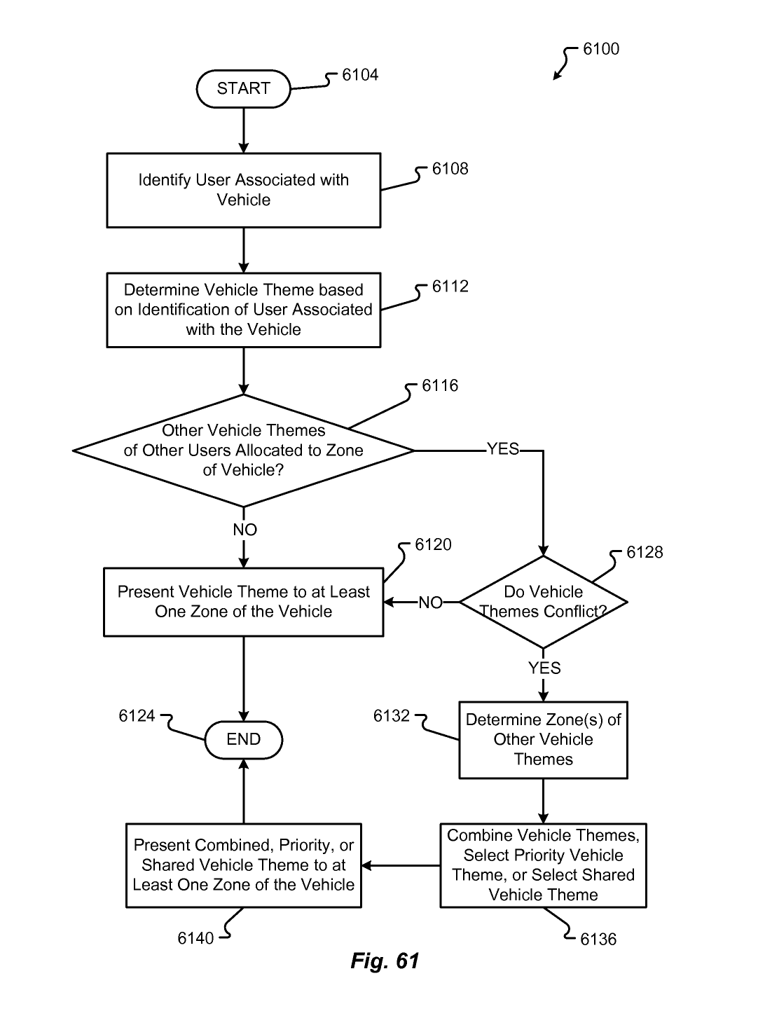

An embodiment of a method 6100 for presenting a vehicle theme in a vehicle is shown in FIG. 61. While a general order for the steps of the method 6100 is shown in FIG. 61, the method 6100 can include more or fewer steps or can arrange the order of the steps differently than those shown in FIG. 61. Generally, the method 6100 starts with a start operation 6104 and ends with an end operation 6124. The method 6100 can be executed as a set of computer-executable instructions executed by a computer system and encoded or stored on a computer readable medium. Hereinafter, the method 6100 shall be explained with reference to the systems, components, modules, software, data structures, user interfaces, etc. described in conjunction with FIGS. 1-60.

The method 6100 begins at step 6104 and proceeds by identifying a user associated with a vehicle (step 6108). Identifying the user may include any of the aforementioned steps described in conjunction with identifying and/or recognizing a user in a vehicle. For example, a user may be identified based on a recognition of facial characteristics of the user. In one embodiment, the identification may include comparing detected features of a user to information about features associated with one or more users stored in a memory. A successful identification may be made of a user when information from the detected features match stored user feature information and associated with a particular user.

The method 6100 proceeds by determining a vehicle theme based on the identification of the user associated with the vehicle (step 6112). This step may include a user identification module 822 referring to a user profile data 252 memory. For example, a user may store one or more vehicle themes in a profile data 252 memory associated with that user. The vehicle theme can be stored in a settings field 1124 or other field of a data structure 1200, etc.

In some embodiments, the method 6100 may continue by determining whether any other vehicle themes associated with other users are allocated to at least one area 508A-N and/or zone 512A-N of the vehicle (step 6116). By way of example, in the event that the user is the only user in the vehicle, the vehicle may not have an allocated theme presented to the at least one area 508A-N and/or zone 512A-N of the vehicle. In this case, the method 6100 would proceed to step 6120 and present the vehicle theme associated with the user to at least one area 508A-N and/or zone 512A-N of the vehicle. As can be appreciated, whether a vehicle theme is presented to one or more area 508A-N and/or zone 512A-N may be stored in settings associated with the user and/or the vehicle theme. These settings may be included in the user profile data 252. The method ends at step 6124.

In the event that at least one other vehicle theme is presented to at least one area 508A-N and/or zone 512A-N of the vehicle, the method 6100 may proceed to determine whether the vehicle themes conflict (step 6128). For instance, a passenger user may enter the front passenger-side of a vehicle having a vehicle theme of a driver user presented therein. In this case, the method 6100 would determine that another vehicle theme is presented, or allocated, to at least one area 508A-N and/or zone 512A-N. If the presented theme is the same as, or substantially similar to, the vehicle theme associated with the identified user, the method 6100 may proceed to allow the vehicle themes to be presented together as provided in step 6120. However, if the vehicle themes are determined to conflict with one another, the method 6100 may proceed to step 6132 and determine the area 508A-N and/or zone 512A-N associated with the other, conflicting, vehicle theme. Conflicting vehicle themes may include contrasting lighting, voices, volumes, sounds, presentations, intensity levels, colors, and/or other aspects associated with the thematic presentation and/or vehicle configuration.

Where the other vehicle themes are determined to be adjacent to the user's vehicle theme, or determined area 508A-N and/or zone 512A-N for the user's vehicle theme, the method 6100 may selectively combine the vehicle themes, choose a priority vehicle theme (e.g., ranked theme), and/or select a shared vehicle theme (step 6136).

Combining the vehicle themes may include merging one theme presentation into another. This vehicle theme presentation merger may be best suited to vehicle themes that conflict in regard to color, font, and/or display aspects. For instance, a vehicle with a driver having a “red” vehicle theme presentation color may identify a passenger having a “blue” vehicle theme presentation color. In this instance, the two vehicle themes may be combined to transition from “red” in color at the driver's side of the vehicle to “blue” in color at the passenger's side of the vehicle. As can be appreciated a color gradient (e.g., “purple” color, etc.) may be presented in a zone 512A-N between the driver and passenger.

Selection of a priority vehicle theme may be based on familial relationships, vehicle owner, age, privilege, authorization, and/or other factor. For instance, where a father and son have entered a vehicle and both are detected as having their own different vehicle themes, the method 6100 may determine to select the father's vehicle theme. This priority, or rank, may be stored in vehicle settings. The vehicle settings may be stored in user profile data 252.

In some embodiments, a vehicle theme may not be combined or selected from a priority vehicle theme. For instance, the vehicle themes may be so different that they cannot be combined. Additionally or alternatively, the vehicle themes may be associated with an identical rank or priority, or may not have any priority classification at all. In any event, a shared vehicle theme may be selected for presentation in the vehicle. The shared vehicle theme may be another vehicle theme that is common to each user. In one embodiment, the shared vehicle theme may correspond to a vehicle theme that each user finds non-offensive. In another embodiment, the shared vehicle theme may be default vehicle theme that is selected for conflict scenarios.

In any event, the method 6100 continues by presenting the combined, priority, or shared vehicle theme to at least one area 508A-N and/or zone 512A-N of the vehicle (step 6140). The presentation of the vehicle theme may be determined by settings stored in a memory as provided herein. The method 6100 ends at step 6124.

Vehicle Plug and Play Communication System:

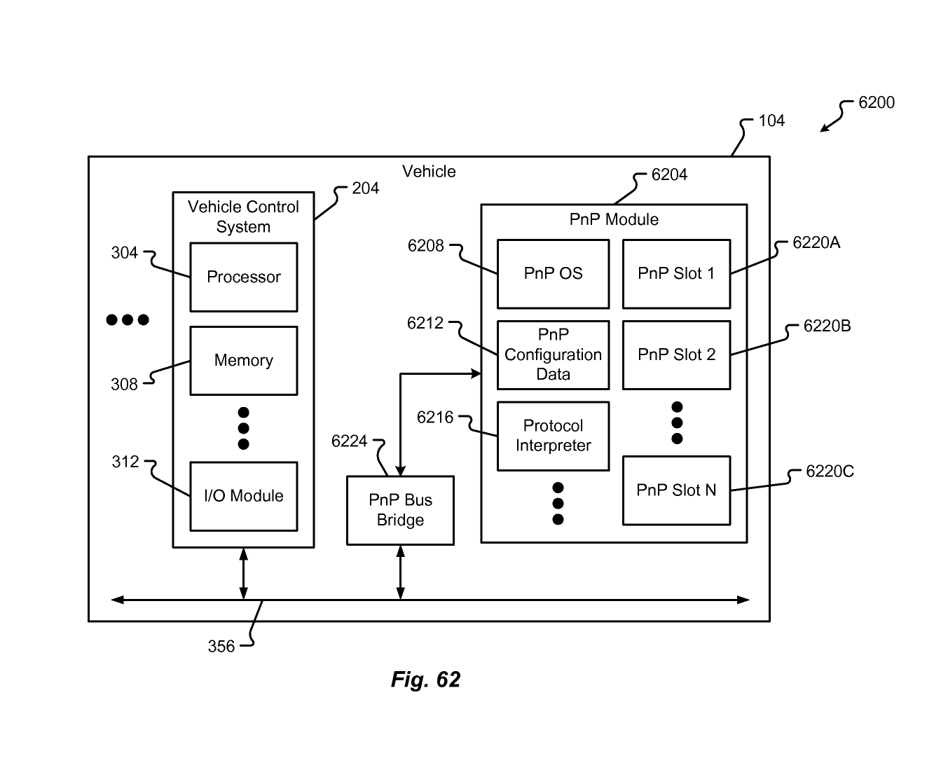

FIG. 62 shows a block diagram of a plug-and-play (PnP) system 6200 for receiving and connecting one or more modular processing units with a vehicle control system 204. The PnP system 6200 may include a PnP module 6204 associated with a vehicle 104 and comprising a PnP OS 6208, PnP configuration data 6212, a protocol interpreter 6216, and one or more PnP slots 6220A-C. In some embodiments, the PnP system 6200 may include a PnP bus bridge 6224 configured to interface with a communication bus 356. In one embodiment, the PnP bus bridge 6224 may be a part of the PnP module 6204.

The PnP system 6200 may be configured to receive a number of vehicle PnP devices. In some embodiments, the PnP system may recognize a PnP device and configure the recognized PnP device to operate with one or more components of the vehicle 104. The operation may include allowing communication to and/or from the PnP device to the one or more components of the vehicle 104. Examples of the one or more components of the vehicle 104, may include, but are in no way limited to, a vehicle control system 204 and/or any of the vehicle systems 300 described above.

The PnP slots 6220A-C may be configured as one or more interconnections disposed on a backplane of a communications unit (e.g., the PnP module 6204, etc.). It is anticipated that each PnP slot 6220A-C may be configured to receive a PnP device. In some embodiments, the interconnections can include at least one of a power, data, and/or other signal connection. Each interconnection may be configured to physically and/or electrically connect with one or more features of a PnP device. In one embodiment, two or more of the PnP slots 6220A-C may receive a single PnP device spanning the two or more of the PnP slots 6220A-C. The single PnP device in this embodiment may physically and/or electrically connect to the two or more PnP slots 6220A-C. In another embodiment, a single PnP device may physically and/or electrically connect to a single PnP slot of the two or more PnP slots 6220A-C while a portion of the single PnP device spans the two or more PnP slots 6220A-C. The PnP slots 6220A-C may be electrically connected to a PnP slot bus.

The PnP OS 6208 may include any operating system configured to support PnP functionality. Additionally or alternatively, the PnP OS 6208 may include a PnP basic input/output system (BIOS) configured to detect a PnP device connected with a PnP slot 6220A-C. The PnP OS 6208 can include executables adapted to automate PnP configuration of a PnP device connected with a PnP slot 6220A-C. In configuring a PnP device, the PnP OS 6208 may refer to PnP configuration data 6212 stored in memory.

PnP configuration data 6212 may include information corresponding to PnP devices stored in a memory. This memory can include one or more fields that may be stored as a flat file database, relational database, object oriented database, etc. These one or more fields may include information that may be used to configure and/or manage PnP devices connected to PnP slots 6220A-C.

In some embodiments, a PnP device may include a communications protocol that is incompatible with at least one of the communications protocols utilized by the various components of the vehicle 104. The protocol interpreter 6216 may include a parser, general protocols, vehicle protocols, universal protocols, proprietary protocols, and/or any other protocols used in communication.

In some embodiments, the PnP bus bridge 6224 may include a processor and memory configured to execute PnP detection, recognition, and/or selectively enable communications between a PnP device and the various components of the vehicle 104. The PnP bus bridge 6224 may be configured as a chipset in some embodiments. In one embodiment, the PnP bus bridge 6224 may be configured to control I/O functions between a PnP device connected to a PnP slot 6220A-C and one or more vehicle systems 300 or other components of a vehicle 104.

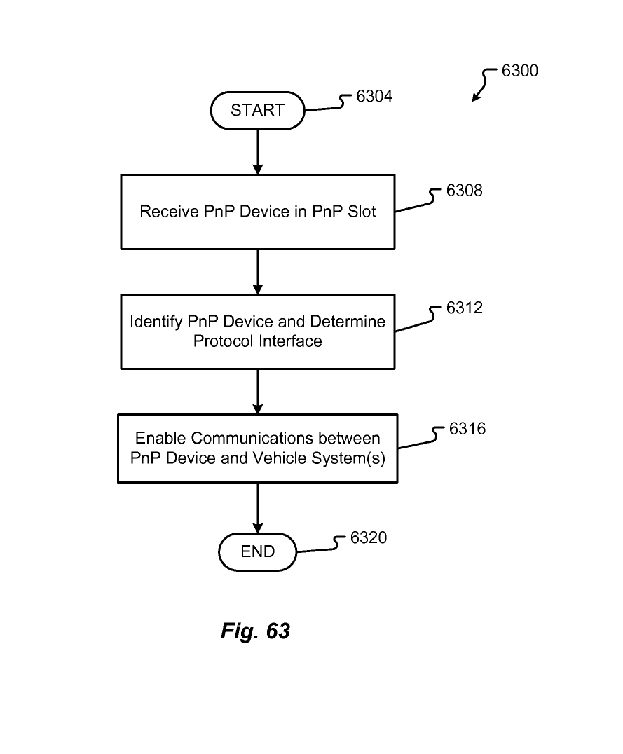

An embodiment of a method 6300 for configuring a vehicle PnP device for communication with components of a vehicle 104 is shown in FIG. 63. While a general order for the steps of the method 6300 is shown in FIG. 63, the method 6300 can include more or fewer steps or can arrange the order of the steps differently than those shown in FIG. 63. Generally, the method 6300 starts with a start operation 6304 and ends with an end operation 6320. The method 6300 can be executed as a set of computer-executable instructions executed by a computer system and encoded or stored on a computer readable medium. Hereinafter, the method 6300 shall be explained with reference to the systems, components, modules, software, data structures, user interfaces, etc. described in conjunction with FIGS. 1-62.

The method 6300 begins at step 6304 and proceeds when a PnP device is received in a PnP slot 6220A-C of the PnP module 6204 (step 6308). Receiving the PnP device may include physically connecting the PnP device with at least one feature of the PnP slot 6220A-C. For example, the PnP device may be electrically connected and physically connected to the PnP module 6204, via at least one of the interconnections of the PnP slots 6220A-C.

Next, the method 6300 continues by identifying a connected PnP device and determining a protocol interface (step 6312). In particular, the PnP OS 6208 scans the PnP slots 6220A-C, via a PnP slot bus, for any connected hardware (e.g., PnP device). In some embodiments, the PnP OS 6208 may send an interrogation signal across the PnP slot bus to determine whether any PnP devices are connected to the PnP module 6204. The interrogation signal may request identification information from any connected PnP devices. In response, a connected PnP device may send identification information to the PnP OS 6208. Identification information may include a device identifier, hardware address, manufacturer information, compatibility information, and/or any other identifying data.

The PnP OS 6208 can then refer to the PnP configuration data 6212 for PnP configuration information. As can be appreciated, installed or previously installed PnP devices may include one or more records stored in the PnP configuration data having configuration information. In the event, the PnP device is newly installed, the PnP OS 6208 may determine to configure the PnP device (e.g., by assigning location identifiers, communication protocols, I/O settings, etc., and/or combinations thereof to the PnP device). The configuration information for the configured PnP device may be stored in memory (e.g., in the PnP configuration data 6212).

Next, the method 6300 continues by enabling communications between the installed PnP device and one or more of the vehicle systems 300 (step 6316). In some embodiments, communications may pass through a PnP bus bridge 6224 configured to handle the I/O functions of the PnP devices and the vehicle 104. The method 6300 ends at step 6320.

Communication and Installation of Vehicle Updates:

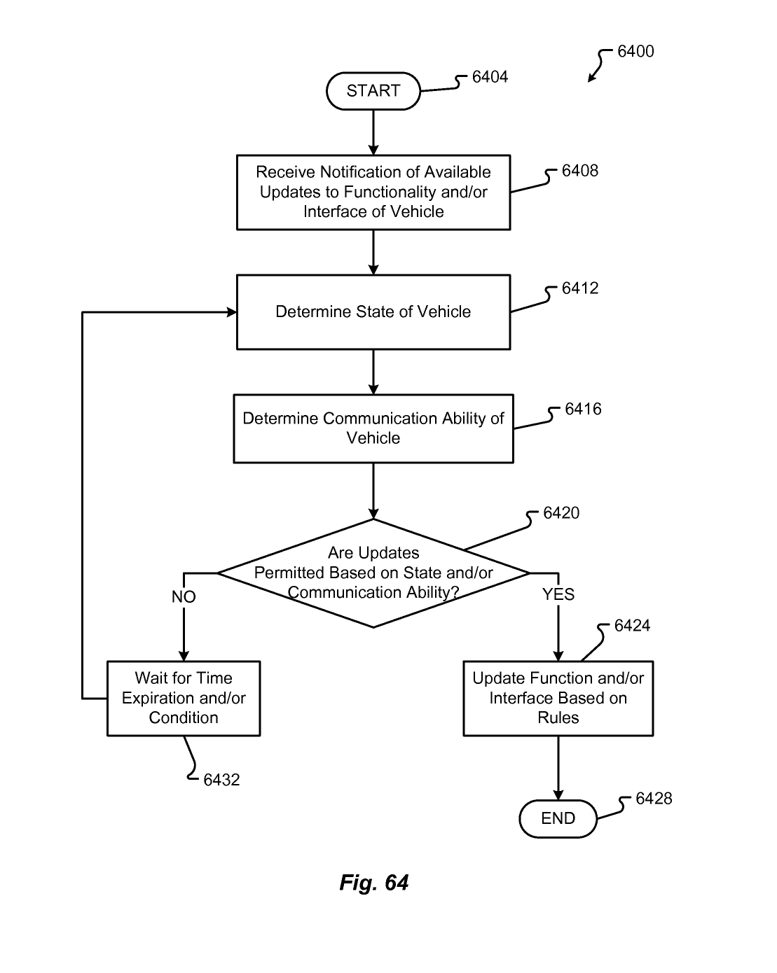

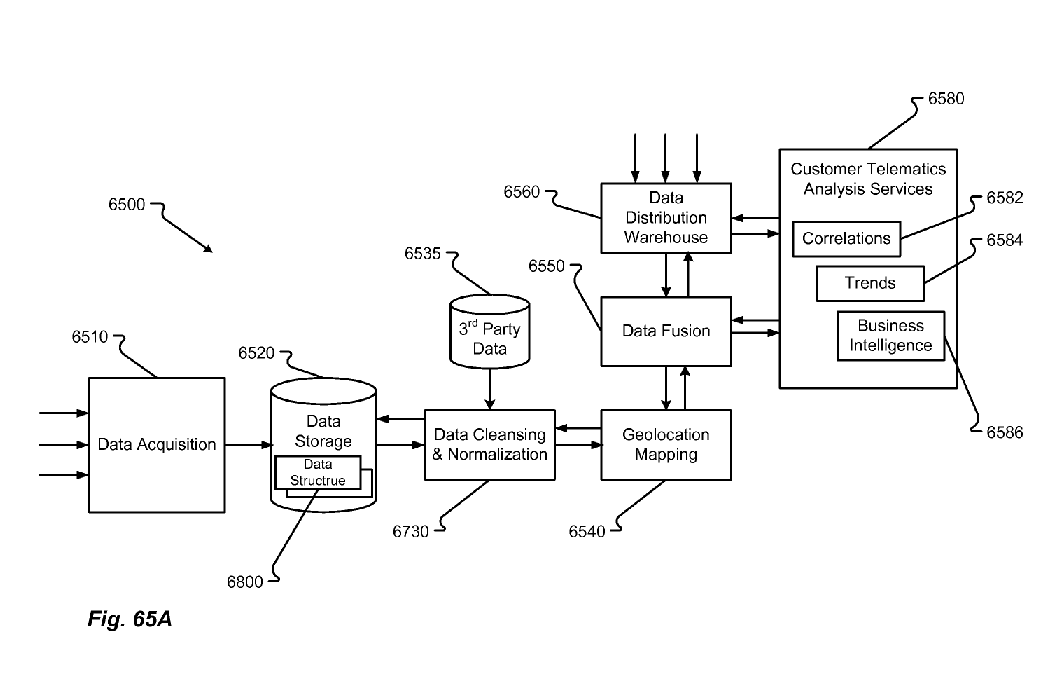

An embodiment of a method 6400 for communicating and installing vehicle updates is shown in FIG. 64. While a general order for the steps of the method 6400 is shown in FIG. 64, the method 6400 can include more or fewer steps or can arrange the order of the steps differently than those shown in FIG. 64. Generally, the method 6400 starts with a start operation 6404 and ends with an end operation 6428. The method 6400 can be executed as a set of computer-executable instructions executed by a computer system and encoded or stored on a computer readable medium. Hereinafter, the method 6400 shall be explained with reference to the systems, components, modules, software, data structures, user interfaces, etc. described in conjunction with FIGS. 1-63.

As can be appreciated, the functionality, presentation, interfaces, and the like associated with the various methods and systems disclosed herein, may benefit from periodic updates. The updates may be made in response to developer improvements (e.g., added functionality, increased security, user interface enhancements, and/or the like), organizational requirements, legislative changes, or some other reason. For example, a user may have installed a vehicle application directed to configurable dash displays from the vehicle application store. The configurable dash display application may provide for a number of customizable dash display options (e.g., including a range of gauge presentations, layouts, limits, etc.). The user may select to only include a speed gauge with an upper speed limit set to 140 mph. Continuing this example, legislation may change after the user has installed the configurable dash display application that requires all upper limits of vehicles be set to a maximum of 85 mph. In response to the legislation, the configurable dash display application may be updated automatically and/or manually. The following method 6400 provides embodiments of communicating and installing updates for vehicle applications and/or systems.

The method 6400 begins at step 6404 and proceeds when a notification of at least one available update is received at the vehicle (step 6408). The update may include a change in functionality, presentation, and/or interface features of one or more applications and/or systems of a vehicle 104. The notification may be received by the device interaction subsystem 352, the communication subsystem 344, the vehicle control system 204, and/or other vehicle system 300. In some embodiments, the notification may be presented to a user of the vehicle, via at least one device (e.g., user interface device 212, 248, 882, speaker 880, etc.) associated with the vehicle 104 and/or user 216. For instance, the notification may be presented as a “pop-up” notification displayed to at least one portion of the vehicle console. An identifier may be included with the notification to indicate whether the update is optional, mandatory, user-configurable, automatically installed, etc., and/or combinations thereof.

Next, the method 6400 may continue by determining the state of the vehicle 104 (step 6412). The state of the vehicle may refer to a condition of the vehicle 104 determined at specific point in time (e.g., a current time, a future time, a past time, etc.). Examples of the state of a vehicle, or vehicle state, may include, but are not limited to, engine status (e.g., engine running, engine off, engine temperature, engine wear, etc.), gear and/or transmission selection (e.g., in a parked position, in drive, in reverse, in neutral, etc.), ignition switch status (e.g., lock, accessories, on, start, etc.), active and/or planned travel data (e.g., GPS information, entered destinations, planned trips, etc.), vehicle speeds, vehicle location, and/or the like.

The method 6400 proceeds by determining the communication ability of the vehicle 104 (step 6416). A communication ability can include communications hardware, communications software, communication applications, revisions and/or versions associated therewith, and the like. For instance, communication abilities may include whether a vehicle includes a particular type of communication device or component, such as a particular antenna, communications module, SIM card, etc. Additionally or alternatively, the communication ability may include one or more of available bandwidth, signal strength, carrier type, service provider type, communication costs, etc., associated with a user and/or vehicle. In any event, the communication ability may be based on historical data and/or associated with specific times of the day, week, month, year, etc. For example, a vehicle may not have any communications ability during the day, but may have communications ability (e.g., Wi-Fi access, wireless connectivity, etc.) overnight. In this example, the communication ability may include a time associated with the communication ability.

The method 6400 continues by determining whether the updates are permitted based on the determined state and/or communication ability of the vehicle 104 (step 6420). As can be appreciated, certain updates may require activating and/or deactivating one or more features associated with the vehicle 104. This activation/deactivation may be distracting, dangerous, and/or disorienting to a user. By way of example, updating a configurable dash display may include adding a gauge, adjusting a gauge, and/or moving a displayed element from the dash display and/or console instrument cluster. In this example, removing a gauge while the vehicle is in motion may be disruptive to a user, if not confusing. As another example, a vehicle may be installing an update to an instrument cluster or dash display while the vehicle is travelling in an area with coverage area gaps and/or no connectivity. In this example, the installation may be paused for a time period while the vehicle attempts to reconnect to complete the installation of the update. During this time period, and until the vehicle regains connectivity, the dash display may not appear to a user.

In step 6420, the installation of certain updates may be controlled by rules stored in a memory. The rules may include installation restrictions for specific applications and/or features. In one embodiment, critical vehicle functions may be restricted from updating while the vehicle is in motion. Critical vehicle functions may include vehicle control applications, vehicle control features, feedback instruments, legally required elements, and/or other elements that are required for safe navigation and driving. In some embodiments, the critical vehicle functions may be restricted from updating while the vehicle is in a poor coverage area. The updating of critical vehicle functions may be allowed when the vehicle state is determined to be in a parked, or nonmoving, condition. In some embodiments, once the updating of critical vehicle functions has begun, the vehicle 104 may be prevented (e.g., via the vehicle control system 204, etc.) from changing vehicle state. For instance, the vehicle may not be allowed to begin moving until the update of critical vehicle functions has completed.

Some aesthetic or hidden vehicle features may be updated where critical vehicle functional updates are prevented. For instance, updating a font, color, or other visual display of elements that are not critical to the operation of the vehicle may be allowed while the vehicle is moving. Additionally or alternatively, hidden vehicle features such as algorithm improvements, code updates, security updates, and/or other nonvisual and noncritical vehicle features may be similarly updated. The rules governing whether updates are permitted or restricted may be set by one or more entity, group, organization, administrator, and/or the like.

In some embodiments, a pre-update image of a display may be saved and presented to the display while the display is updating, and once the update is complete, the pre-update image may be replaced with the updated image. In one embodiment, the update process may include installing an updated version of an application, or application feature, in parallel with the pre-updated version of the application. In other words, two applications may be installed in the vehicle. The pre-updated version of the application may be allowed to run until a switch is made from the pre-updated version of the application to the installed updated version of the application. The switch may be made manually (e.g., via a user, in response to a notification that the update is installed, etc., and/or combinations thereof) or automatically (e.g., via the vehicle control system 204, etc.). In one embodiment, the automatic switching from the pre-updated version to the updated version of the application may be effected when the user is not interacting with the application. For instance, in the case of an updated displayed element, the switch may be activated when one or more cameras and/or other sensors of the vehicle observes that the user is looking away from the displayed element. In any event, once the switch is made, the pre-updated version of the application may be deleted from memory. Among other things, this approach allows for the continuity in a presented application without a major disruption to the overall presentation.

In the event that updates are not permitted, or are restricted, the method 6400 may proceed by waiting for a time period and/or condition (step 6432). In some embodiments, the time period may correspond a specific amount of time that is configured to expire before the method 6400 can continue. The time period may be associated with a type of update, a state of the vehicle, and/or a communication ability of the vehicle. Once the time period expires, the method 6400 may continue by returning to step 6420. Additionally or alternatively, the time period may be associated with a condition. For instance, where a vehicle is restricted from updating the functionality and/or interface of a vehicle while the vehicle is in motion, the method 6400 may continue in step 6432 when the state of the vehicle is determined to be in a parked position. As another example, where a vehicle is not permitted to install updates based on a determined communication ability (e.g., limited wireless connectivity, etc.), the method 6400 may continue when it is determined that the communication ability is restored (e.g., available wireless connectivity, etc.).

In the event that updates are permitted based on the vehicle state and/or communication ability, the method 6400 continues by updating the function and/or interface of the vehicle 104 based at least partially on rules stored in memory. The rules may control the nature of the update, a timing of the update, and/or other aspect of the update method 6400. The method 6400 ends at step 6428.

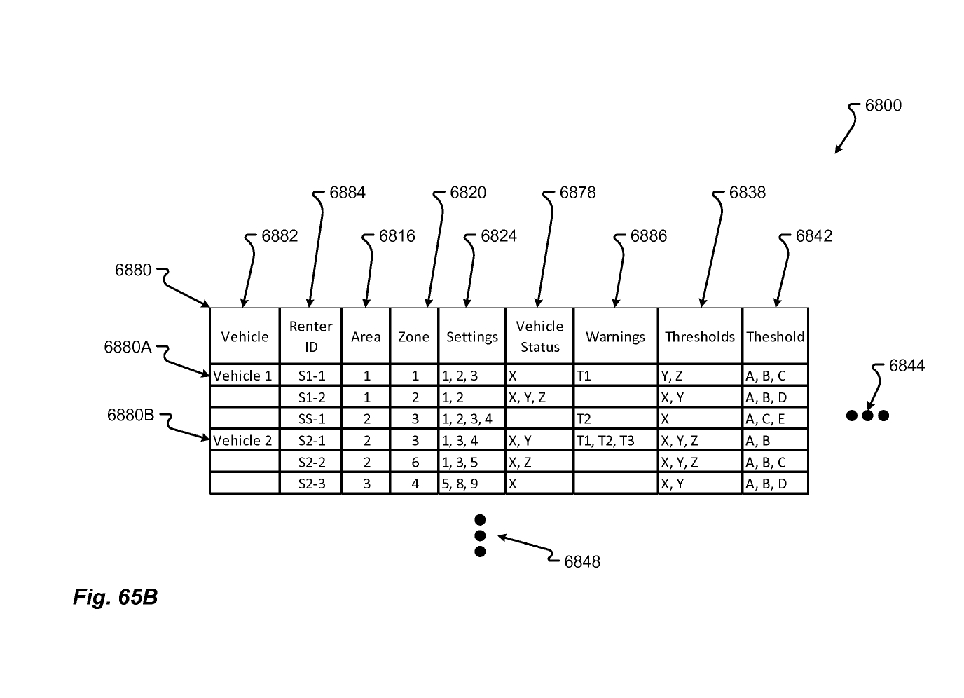

An embodiment of a fleetwide vehicle telematics system 6500 comprising a plurality of vehicle systems 200 is shown in FIG. 65A. The telematics system 6500 will be described with reference to FIGS. 1-64. Generally, the telematics system 6500 receives vehicle state data for a plurality of vehicles (i.e. a “fleet” of vehicles), fuses that data with customer enterprise data and with geolocation data, and performs analysis which may identify fleetwide trends or correlations among the vehicle fleet. The telematics system 6500 may comprise hardware and/or software that conducts various operations for or with the vehicle systems 204. The telematics system 6500 may comprise any type of computing system operable to conduct the operations as described herein. The fleetwide vehicle telematics system 6500 comprises modules of: data acquisition 6510, data storage 6520 comprising data structures 6800, data cleansing and normalization 6730, third-party data 6535, geolocation mapping 6540, data fusion 6550, data distribution warehouse 6560, and customer telematics analysis services 6580 comprising correlations 6582, trends 6584 and business intelligence 6586.

Data acquisition 6510 receives data regarding a plurality of vehicles from one or more sources. The data received comprises vehicle state data comprising latitude/longitude location, speed, acceleration, deceleration, jerk, turn radius, engine parameters such as fluid levels (oil, hydraulic, brake, etc), airbag deployment state (deployed or stowed), video from a vehicle interior camera and video from a vehicle exterior camera, and driver and passenger device use (e.g. smartphone use such as texting). The data may be generated from sources to include vehicle on-board sensors, overhead (eg satellite) monitoring/surveillance, commercial tracking services, and customer enterprise systems (e.g. driver profile data, vehicle features and configuration). Driver profile data, as from a customer enterprise system, may comprise driver name, age, if a rental vehicle then rental information such as terms and conditions of rental, history of rentals, membership in rental clubs or rewards programs, and driver preferences (eg desire for GPS unit). Note that “customer” means the entity with responsibility for the fleet of vehicles, e.g. a Hertz rental car company. “Customer enterprise system” means the computer system which maintains all or part of the business-wide data of the customer. The data acquisition 6510 module outputs the data to data storage 6520 module comprising data structures 6800 (See FIG. 65B and below detailed discussion). Data acquisition 6510 may be a commercial off the shelf system and/or be performed by an outside third party.

Data storage module 6520 may be any known data storage means known to those skilled in the art, to include relational database management systems and any server known to those skilled in the art. Data storage module 6520 may comprise data storage, data aggregate and data security. Data storage module 6520 sends and/or receives data to data cleansing & normalization 6730 module. Data storage module 6520 may be a commercial off the shelf system and/or be performed by an outside third party.

Data cleansing & normalization 6730 module performs any of several functions to data, comprising cleansing, scrubbing and correction, such as removal of “wild point” aka erroneous data from the data. Data cleansing & normalization 6730 module may receive data from 3^{rd} party data 6535 database to, among other things, assist in the aforementioned cleansing, scrubbing and correction. For example, the 3^{rd} party data 6535 may provide threshold values or parameters useful in identifying erroneous data. The data of the data cleansing & normalization 6730 module may be stored in data structures 6800. The data of the data cleansing & normalization 6730 module may be normalized in that it format and/or data structure may be reconfigured for a particular application and/or use. Data cleansing & normalization 6730 may be a commercial off the shelf system and/or be performed by an outside third party.

Data cleansing & normalization 6730 module outputs and/or receives data from geolocation mapping module 6540, which provides geolocation data for one or more of the plurality of vehicles. Geolocation mapping module 6540 may provide, among other things, geocoding, rendering (e.g. rendering an image or representation of the location of one or more vehicles relative to a meaningful location such as an address), and routing. Geolocation mapping module 6540 sends and receives data with Data Fusion 6550 module. Geolocation mapping module 6540 may be a commercial off the shelf system and/or be performed by an outside third party.

Data Fusion 6550 module sends and receives data, such as data of data structure 6800, with modules comprising: geolocation mapping 6540, data distribution warehouse 6560 and customer telematics analysis services 6580. Data Fusion 6550 module may employ any fusion algorithms know to those skilled in the art to combine the data. For example, regarding a speed value of a particular vehicle. Data source one (e.g. from a vehicle-mounted speedometer) providing a first measurement of speed may be combined with data source two (e.g. as measured from data derived from cell phone transmissions) by a state estimation algorithm to yield one combined or fused estimate of the speed (a particular “state” value of the vehicle). State estimation algorithms may comprise Kalman filtering. Data Fusion 6550 module may be a commercial off the shelf system and/or be performed by an outside third party.

Data distribution warehouse 6560 receives data from one or more sources comprising, among other things, fleet-wide and per-vehicle management parameters. Fleet-wide management parameters may comprise, for example, operational thresholds regarding maximum speeds, no drive areas and geofencing parameters, location boundaries, airbag deployment or non-deployment (stowed airbag), acceleration and deceleration. The sources of the data received by the data distribution warehouse 6560 module may comprise, third-party service providers (e.g. cartography providers which may provide timely updates to roadway closures or real-time traffic information), third-party applications (e.g. of real-time routing, guidance and/or navigation) and customer enterprise-wide backend systems. Note that customer enterprise-wide backend systems may batch process some or all data. Data distribution warehouse 6560 module may comprise or enable use of application programming interfaces (APIs) or any software routines, protocols and tools for building software applications on or with or using the data contained in the data distribution warehouse 6560 and/or data fusion 6550 module. For example, data distribution warehouse 6560 module may comprise or enable use of APIs to interact with the customer telematics analysis services 6580 module. As another example, customer, via data distribution warehouse 6560 module, may write and execute an API which allows probing of one or more of the plurality of fleet vehicles to determine one or more states, such as the lat/long location of a specified fleet vehicle. Such a probe might be of importance to determine the disposition of a critical package being delivered by a particular fleet vehicle, or to locate an employee of a customer known to be driving in a particular vehicle. Data distribution warehouse 6560 module may be a commercial off the shelf system and/or be performed by an outside third party.

Customer telematics analysis services 6580 sends and/or receives data from each of data distribution warehouse 6560 module and data fusion 6550 module. Customer telematics analysis services 6580 comprises correlations 6582, trends 6584 and business intelligence 6586. Generally, customer telematics analysis services 6580 analyzes data (as stored in one embodiment as data structure 6800) to identify trends or discover correlations among the set of data obtained from a plurality of vehicles. By way of example, by tracking fleet-wide vehicle state data, systemic maintenance issues may be identified (i.e by searching for trends), such as a fleet-wide decrease in time between low oil warning light indicators. Such a trend would not be identifiable without access to fleet-wide vehicle data and without an ability to cull or search down to oil warning indicator data, as enabled by the system 6500. By way of example, correlations between data among the fleetwide set of vehicles may also be discoverable. Using the above low oil warning light indicator trend, the system 6500 may be able to correlate or relate the trend to a specific location (e.g. the southeast USA), geography (higher altitudes), vehicle type (SUVs more than sedans), car vehicle manufacturer (Ford more than non-Ford or more than Chevy), or environmental conditions (more correlation with winter driving conditions, temperatures below freezing, or humidity above 90%). Such trend and correlation capabilities or features may also be termed business analytics, and may comprise the examining of fleetwide data to uncover hidden patterns and unknown correlations.

Customer telematics analysis services 6580 may also provide customer or industry specific solutions. For example, a rental car company may wonder why the number of vehicles returned by vehicle renters who rate the rental as poor has increased over the past six months. The system 6500 may be utilized to perform business analytics to search for the rationale, e.g. by looking for trends or correlations between vehicle state or operating parameters and those renters who rated their rental as poor. The poor rating may be linked to the type of vehicle, e.g. 60% of those renting a Ford Explorer rate the rental experience as poor, thus suggest, as a solution to the poor rating problem, to increase maintenance on the Ford Explorer fleet, or further probe why the renters trend to be dissatisfied with the Ford Explorer. The poor rating may also be associated with an increase rental rates at a particular airport (e.g. O'Hare airport) which, given the volume of rentals at that location, was enough to trigger an identifiable increase in poor ratings.

Customer telematics analysis services 6580 may also draw from customer enterprise data, as maintained in the data distribution warehouse 6560, as to customer business value or business practices or business algorithms. For example, correlation between pricing of rentals at a particular location and poor or good renter ratings may identify locations to adjust vehicle renter fees. Predictive information may also be identified and assisted by the system 6500 and/or the customer telematics analysis services 6580. For example, by culling and analyzing data of the data fusion 6550 module, predictions of high rentals of certain types of vehicles at certain locations may be more precisely identified. That is, while it is generally known that rental vehicle customers at O'Hare will prefer SUVs in the wintertime, it is not generally know if more moderate climates (e.g. St. Louis) similarly shares the link between SUVs and the winter months and if so to what degree and during what times of year.

Referring now to FIG. 65B, a data structure 6800 is shown optionally. The data file 6800 may include several portions 6816-6886 representing different types of data. Each of these types of data may be associated with a vehicle, as shown in portion 128.

There may be one or more vehicle records 1280 and associated data stored within the data file 6882. As provided herein, the vehicle 104 can be any vehicle or conveyance 104 as provided herein. The vehicle 104 may be identified in portion 6882. Additionally or alternatively, the vehicle 104 may be identified by one or more systems and/or subsystems. The various systems of a vehicle 104 may be identified in portion 6884. For example, various features or characteristics of the vehicle 104 and/or its systems may be stored in portion 6884. Optionally, the vehicle 104 may be identified via a unique code or some other type of data that allows the vehicle 104 to be identified.

Vehicle 6882 portion identifies vehicle type, e.g. Ford Escape (6880A) or Ford Explorer (6880B). Renter ID 6884 identifies the renter name or, more broadly in other embodiments, the user of the vehicle (e.g. the employee the corporate fleet vehicle is assigned or checked-out). Area 6816 identifies area from which the vehicle is hosted aka its home base, e.g. an airport site such as Area “1” of ORD, “2” of SFO, and “3” of IAD. Zone 6820 provides geofencing and/or location perimeter thresholds, e.g. Zone 1 may place a limit on use of the vehicle to within 50 miles of the area 6816 identified, and Zone 2 may indicate a threshold of use of vehicle only within the State of Illinois, and Zone 3 may restrict the vehicle to no use on specific roadways (e.g. the backroad “road to Hana” in Maui) or types of roads (off-road use). Settings 6824 may provide features or capabilities or equipment on the vehicle, e.g. 1 may be GPS device, 2 may be another type of navigation device. Vehicle Status 6878 may comprise if vehicle is available, in maintenance and therefore unavailable and/or limited to a certain weight tonnage. Warnings 6886 may comprise vehicle warnings such as low oil indicator, rental terms such as waiver of supplemental liability. Thresholds 6838 may comprise limitation or thresholds imposed on the associated renter ID 6884 and/or vehicle 6882, e.g. maximum speed threshold and maximum deceleration thresholds. Other 6842 may comprise other data of interest, comprising, for example, free text comments.

Additional and/or alternative data contained in data structure 6800 may comprise health status data of the systems and/or components of a fleet vehicle. The health status may include any type of information related to a state of the systems. For instance, an operational condition, manufacturing date, update status, revision information, time in operation, fault status, state of damage detected, inaccurate data reporting, and other types of component/system health status data. One or more warnings data may be stored in data structure 6800. The warnings data may include warning generated by the vehicle, systems of the vehicle, manufacturer of the vehicle, federal agency, third party, and/or a user associated with the vehicle. For example, several components of the vehicle may provide health status information that, when considered together, may suggest that the vehicle has suffered some type of damage and/or failure. Recognition of this damage and/or failure may be stored in the warnings data portion 6886. The data of 6800 may be communicated to one or more parties (e.g., a manufacturer, maintenance facility, user, etc.). In another example, a manufacturer may issue a recall notification for a specific vehicle, system of a vehicle, and/or a component of a vehicle. It is anticipated that the recall notification may be stored in the warning data field 6886. The data of the data structure 6800 may include different information from that described above; it should be appreciated that the portions of data structure 6800 may be similar, or identical, to those as previously disclosed.

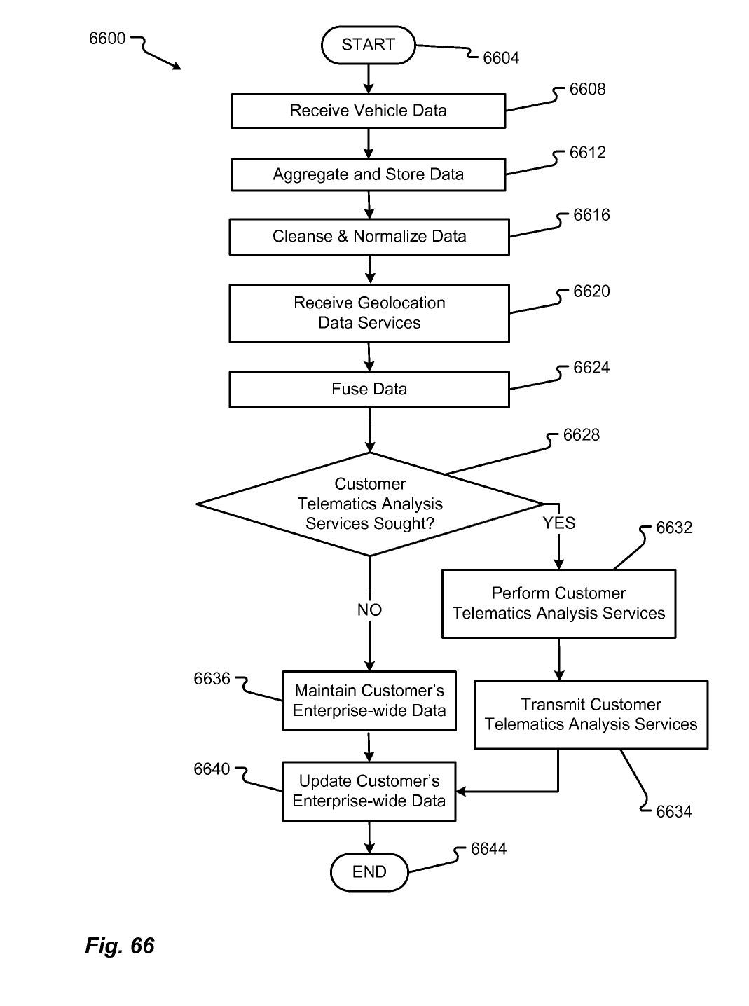

Referring now to FIG. 66, an embodiment of a method 6600 for fleetwide vehicle telematics 6600, as using the fleetwide vehicle telematics system 6500 of FIG. 65A, is provided. While a general order for the steps of the method 6600 is shown in FIG. 66, the method 6600 can include more or fewer steps or can arrange the order of the steps differently than those shown in FIG. 66. Generally, the method 6600 starts with a start operation 6604 and ends with an end operation 6644. The method 6600 can be executed as a set of computer-executable instructions executed by a computer system and encoded or stored on a computer readable medium. Hereinafter, the method 6600 shall be explained with reference to the systems, components, modules, software, data structures, user interfaces, etc. described in conjunction with FIGS. 1-65.

At step 6604, vehicle data is received by data acquisition module 6510. Vehicle data map comprise the vehicle state data described above, e.g. comprising latitude/longitude location, speed, acceleration, deceleration, airbag deployment state, vehicle interior camera video and vehicle exterior camera video. The vehicle data is provided from a plurality of vehicles.

At step 6612, the vehicle data is aggregated and stored, as described above with regards to data storage 6520 module. At step 6616, the vehicle data is cleansed and/or normalized, as described above with regards to data cleansing and normalization module 6730. 3^{rd} party data 6535 data may optionally be received by data cleansing and normalization module 6730 at step 6730. At step 6620, geolocation data service is received, as described above with respect to geolocation mapping 6540 module. Data fusing occurs at step 6550, as described above with regards to data fusion 6550 module.

At step 6628, a query is made as to whether a customer has requested or sought telematics analysis (of the type performed in customer telematics analysis services 6580 module). If the query result is Yes, the method 6600 proceeds to step 6632. If the query result is No, the method 6600 proceeds to step 6636. At step 6632, customer telematics analysis service is performed per the definition or terms specified and received from the customer. The results of the customer telematics analysis service performed in step 6632 is then transmitted or provided to the customer at step 6634. At step 6636, the customer's enterprise data is maintained, that is, the customer enterprise data is provided with any new or additional data received, such as may be provided from data distribution warehouse 6560 module. Optionally, after step 6634 is complete (which is executed in the event that query of step 6628 is positive i.e. Yes), the method 660 proceeds to step 6636.

At step 6640, the customer's enterprise-wide data (as may be contained in one or both of data fusion 6550 module and data distribution warehouse 6560) is updated with, for example, the results of the customer telematics analysis service performed in step 6632. The method 6600 ends at step 6644.

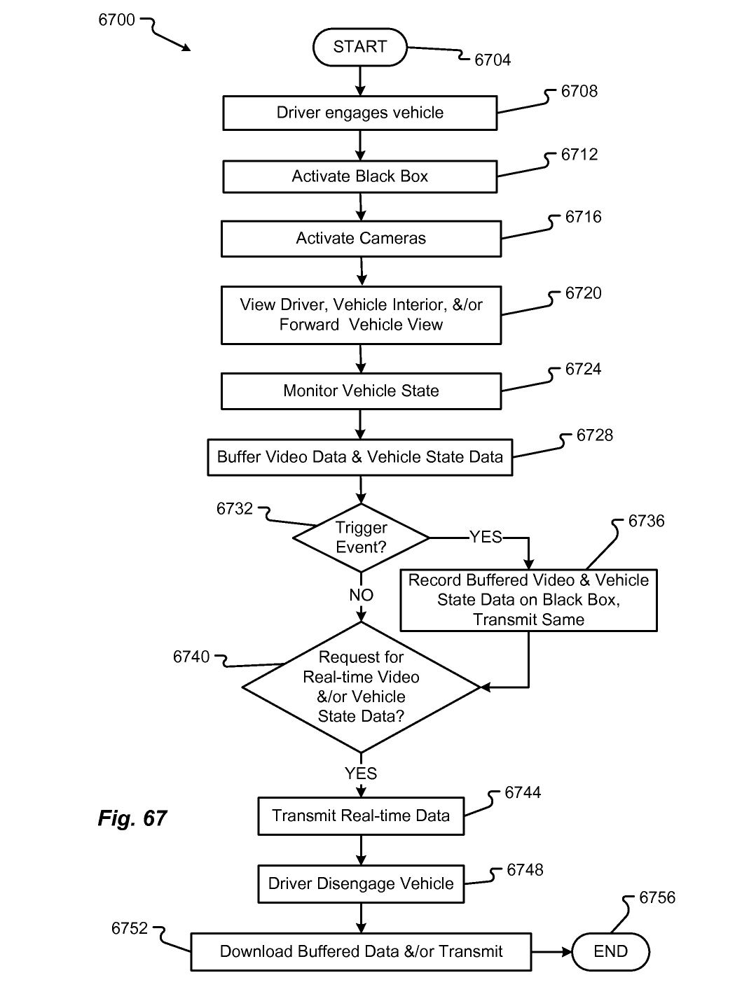

Referring now to FIG. 67, an embodiment of a method 6700 for a single vehicle operating within the context of a fleetwide vehicle telematics system 6600, such as the fleetwide vehicle telematics system 6500 of FIG. 65A, is provided. While a general order for the steps of the method 6700 is shown in FIG. 67, the method 6700 can include more or fewer steps or can arrange the order of the steps differently than those shown in FIG. 67. Generally, the method 6700 starts with a start operation 6704 and ends with an end operation 6756. The method 6700 can be executed as a set of computer-executable instructions executed by a computer system and encoded or stored on a computer readable medium. Hereinafter, the method 6700 shall be explained with reference to the systems, components, modules, software, data structures, user interfaces, etc. described in conjunction with FIGS. 1-66.

At step 6708, a driver engages a vehicle. For example, by crossing a set distance toa vehicle, by inserting a hey into the ignition, touching a door handle, on sitting in a vehicle seat as indicated by, for example, a seat-mounted weight or pressure sensor. At step 6712, a black box, as may be located in the truck of a vehicle or back of a vehicle such as a taxi, is activated (e.g. powered-up). At step 6716, one or more cameras mounted or disposed on or in the vehicle are activated. At step 6720, the one or more cameras view or image one or more of the driver, the occupants, the vehicle interior and external views of the vehicle environment comprising front, rear, and side views.

At step 6724 the vehicle state is monitored. Vehicle state is as described above. At step 6728, the vehicle state data, as monitored at step 6724, and/or the video data as described above at step 6720, are buffered on an on-vehicle system. In another embodiment, these data are transmitted, periodically or continuously, to a receiving site (to include the data acquisition 6510 module).

At step 6732, a query is made as to whether a trigger event has occurred. If the query is positive, i.e. a Yes, the method 6700 proceeds to step 6736. In the query is negative, i.e. a No, the method proceeds to step 6740. A trigger event may be established by the customer, and may comprise the deployment of an airbag, crossing of a threshold value such as speed, deceleration, acceleration and speed. At step 6736, the buffered video and/or vehicle state data of step 6728 is recorded on the black box and/or transmitted to a receiving station. The receiving station may comprise the data acquisition 6510 module.

At step 6740, a query is made as to whether a customer request for real-time video and/or vehicle state data has occurred. If the query is positive, i.e. a Yes, the method 6700 proceeds to step 6744. In the query is negative, i.e. a No, the method proceeds to step 6748. At step 6744 the data requested (i.e. one or both of vehicle state data and video) is transmitted. At step 6748 the driver disengages from the vehicle, such as returning the vehicle to the rental company or to the corporate fleet headquarters. At step 6752, the buffered vehicle state data and buffered video data are downloaded and, optionally, transmitted to, for example, a receiving site (to include the data acquisition 6510 module). The method 6700 ends at step 6756.

In one embodiment, the hardware employed is principally a two-piece design wherein the first piece is a black box located in the trunk of a vehicle, or the back of a cab. The first piece or component has a connection to the CAN bus as well as wireless connectivity, such as 4G, cellular and Wi-Fi, and may also have a wireless video transceiver and a GPS receiver. The second component is a video monitor that mounts on the windshield, e.g. by suction; this piece is a minimalist design having a wireless video transceiver to receive video from the black box. The second component may also have three low-end cameras: one camera points at the driver and captures who is driving (it may be used for record keeping more than facial recognition, but may serve to populate a recognition database). The second of three cameras may face internally, perhaps providing a fisheye lens view of the entire vehicle cabin. A third camera may face externally, providing a rear, front or side view. In one embodiment, a microphone and/or speakers are provided to enable eCalling; sound/audio may also be collected (as a state parameter) and may be buffered as described above. Audio may also provide a trigger altert, e.g. in the event of a vehicle collision. In one embodiment, other than at startup when the first camera may play more of a role, the cameras generally buffer video and do not broadcast or transmit. In one embodiment the buffer may be of selectable duration, e.g. 60 seconds. However, in the event a trigger occurs, such as a fast deceleration or an airbag deployment, the buffer may be sent to the black box and data recording may continue for a selectable amount of time. In one embodiment, a Bluetooth connect could be used to connect to the user's cell phone to enable wireless calling.

In one embodiment, the software required in the system and/or methods of the disclosure, to include those of FIGS. 65-67, is built on a Linux O/S with a single UX design (as opposed to flexible). Furthermore, the hardware device described above may be provided with additional optional add-on features, such as navigation and other apps that are preloaded, i.e. not available via an online store. In one embodiment, all or part of the software is remotely upgradable. In one embodiment, steps of the method 6700 may be implemented via a cell phone application, e.g. to remotely start a vehicle, locate a vehicle, confirm doors are locked and lock/unlock the vehicle, roll up/down the windows, etc.

In one embodiment, an online database is maintained for each vehicle and driver. In one embodiment, at any point in time, the fleet owner (i.e. the customer) may download data on the state of the vehicle, and may receive warnings and potentially video when a trigger occurs. In one embodiment, if communication through an app is required, 4G may be used. In one preferred embodiment, the data discussed above is buffered and transmitted over Wi-Fi, when returned to the shop. If a trigger occurs, the data can be sent via 4G or even cellular.

In one embodiment, customer telematics analysis services comprise geofencing, tracking/retrieving, maintenance, administration (check-in/check-out), operations (fuel, usage, damage), fees (parking, toll, tickets), asset management, asset monitoring, analytics, and GPS and other location data to monitor location, performance, and service needs of a fleet's assets. In one embodiment, the customer comprises any fleet operator, fleet leasing operators, organizations with vehicle fleets, rental fleets providers, taxi and on-demand driving services such as uber and lyft, leasing fleet providers, rental truck companies, government fleets, and corporate fleets.

The system of FIGS. 65-68 may be used in other applications beyond vehicle fleet management. For example, any application where a fleet of similar assets is managed and/or operated. In the transportation sector, additional applications comprise airline fleet management, sea vessel management, railroad, and drones aka unmanned aerial vehicles. Outside of the transportation sector, “fleets” of commercial products may also be addressed through the disclosure. For example, a fleet of smartphones may be monitored so as to enable fleet-wide management and application of analytics—e.g. to investigate trends involving purchase, use, maintenance, and to identify correlations.

The exemplary systems and methods of this disclosure have been described in relation to configurable vehicle systems and associated devices. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, options, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a Personal Computer (PC), laptop, netbook, smart phone, Personal Digital Assistant (PDA), tablet, etc., or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

It should be appreciated that the various processing modules (e.g., processors, vehicle systems, vehicle subsystems, modules, etc.), for example, can perform, monitor, and/or control critical and non-critical tasks, functions, and operations, such as interaction with and/or monitoring and/or control of critical and non-critical on board sensors and vehicle operations (e.g., engine, transmission, throttle, brake power assist/brake lock-up, electronic suspension, traction and stability control, parallel parking assistance, occupant protection systems, power steering assistance, self-diagnostics, event data recorders, steer-by-wire and/or brake-by-wire operations, vehicle-to-vehicle interactions, vehicle-to-infrastructure interactions, partial and/or full automation, telematics, navigation/SPS, multimedia systems, audio systems, rear seat entertainment systems, game consoles, tuners (SDR), heads-up display, night vision, lane departure warning, adaptive cruise control, adaptive headlights, collision warning, blind spot sensors, park/reverse assistance, tire pressure monitoring, traffic signal recognition, vehicle tracking (e.g., LoJack™), dashboard/instrument cluster, lights, seats, climate control, voice recognition, remote keyless entry, security alarm systems, and wiper/window control). Processing modules can be enclosed in an advanced EMI-shielded enclosure containing multiple expansion modules. Processing modules can have a “black box” or flight data recorder technology, containing an event (or driving history) recorder (containing operational information collected from vehicle on board sensors and provided by nearby or roadside signal transmitters), a crash survivable memory unit, an integrated controller and circuitry board, and network interfaces.

Critical system controller(s) can control, monitor, and/or operate critical systems. Critical systems may include one or more of (depending on the particular vehicle) monitoring, controlling, operating the ECU, TCU, door settings, window settings, blind spot monitor, monitoring, controlling, operating the safety equipment (e.g., airbag deployment control unit, collision sensor, nearby object sensing system, seat belt control unit, sensors for setting the seat belt, etc.), monitoring and/or controlling certain critical sensors such as the power source controller and energy output sensor, engine temperature, oil pressure sensing, hydraulic pressure sensors, sensors for headlight and other lights (e.g., emergency light, brake light, parking light, fog light, interior or passenger compartment light, and/or tail light state (on or off)), vehicle control system sensors, wireless network sensor (e.g., Wi-Fi and/or Bluetooth sensors, etc.), cellular data sensor, and/or steering/torque sensor, controlling the operation of the engine (e.g., ignition, etc.), head light control unit, power steering, display panel, switch state control unit, power control unit, and/or brake control unit, and/or issuing alerts to a user and/or remote monitoring entity of potential problems with a vehicle operation.

Non-critical system controller(s) can control, monitor, and/or operate non-critical systems. Non-critical systems may include one or more of (depending on the particular vehicle) monitoring, controlling, operating a non-critical system, emissions control, seating system controller and sensor, infotainment/entertainment system, monitoring certain non-critical sensors such as ambient (outdoor) weather readings (e.g., temperature, precipitation, wind speed, and the like), odometer reading sensor, trip mileage reading sensor, road condition sensors (e.g., wet, icy, etc.), radar transmitter/receiver output, brake wear sensor, oxygen sensor, ambient lighting sensor, vision system sensor, ranging sensor, parking sensor, heating, venting, and air conditioning (HVAC) system and sensor, water sensor, air-fuel ratio meter, hall effect sensor, microphone, radio frequency (RF) sensor, and/or infrared (IR) sensor.

It is an aspect of the present disclosure that one or more of the non-critical components and/or systems provided herein may become critical components and/or systems, and/or vice versa, depending on a context associated with the vehicle.

Optionally, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
receiving vehicle state data from a plurality of vehicles, the vehicle state data comprising a plurality of parameters;
receiving geolocation data associated with the vehicle state data of the plurality of vehicles;
receiving customer enterprise data from a customer, the customer enterprise data associated with the plurality of vehicles;
aggregating the vehicle state data, the geolocation data, and the customer enterprise data associated with the plurality of vehicles to produce aggregate data;
analyzing the aggregate data to provide a customer telematics analysis service to the customer;
determining a trend between two or more vehicles; and
providing an output associated with the trend to the customer.

2. The method of claim 1, wherein the vehicle state data comprises a latitude/longitude location, speed, an acceleration, a deceleration, an airbag deployment, a vehicle interior camera and a vehicle exterior camera.

3. The method of claim 1, wherein the customer enterprise data comprises threshold state values.

4. The method of claim 1, wherein the customer telematics analysis service monitors the threshold state values with respect to the vehicle state data and provides a notice to the customer if at least one threshold state value is exceeded.

5. The method of claim 4, wherein the threshold state values comprise location boundaries, an airbag deployment, an acceleration, and a deceleration.

6. The method of claim 4, wherein the customer telematics analysis service monitors the threshold state values with respect to the vehicle state data and provides a notice to the customer if at least one threshold state value is exceeded, wherein the threshold state value is a location boundary.

7. The method of claim 1, wherein the vehicle state data is buffered for a customer-selected period unless a threshold value is exceeded, wherein the vehicle state data is broadcast to the customer.

8. The method of claim 1, wherein the customer telematics analysis service comprises a probing service that allows a customer to receive vehicle state data for a selected vehicle.

9. The method of claim 1, wherein the customer telematics analysis service comprises a probing service that allows a customer to receive vehicle location state data for a selected vehicle.

10. A tangible and non-transient computer readable medium comprising microprocessor executable instructions that, when executed, perform a method comprising:
receiving vehicle state data from a plurality of vehicles, the vehicle state data comprising a plurality of parameters;
receiving geolocation data associated with the vehicle state data of the plurality of vehicles;
receiving customer enterprise data from a customer, the customer enterprise data associated with the plurality of vehicles;
aggregating the vehicle state data, the geolocation data, and the customer enterprise data associated with the plurality of vehicles to produce aggregate data;
analyzing the aggregate data to provide a customer telematics analysis service to the customer;
determining a trend between two or more vehicles; and
providing an output associated with the trend to the customer.

11. The tangible and non-transient computer readable medium of claim 10, wherein the vehicle state data comprises a latitude/longitude location, speed, an acceleration, a deceleration, an airbag deployment, a vehicle interior camera and a vehicle exterior camera.

12. The tangible and non-transient computer readable medium of claim 10, wherein the customer enterprise data comprises threshold state values.

13. The tangible and non-transient computer readable medium of claim 10, wherein the customer telematics analysis service monitors the threshold state values with respect to the vehicle state data and provides a notice to the customer if at least one threshold state value is exceeded.

14. The tangible and non-transient computer readable medium of claim 13, wherein the threshold state values comprise location boundaries, an airbag deployment, an acceleration, and a deceleration.

15. The tangible and non-transient computer readable medium of claim 13, wherein the customer telematics analysis service monitors the threshold state values with respect to the vehicle state data and provides a notice to the customer if at least one threshold state value is exceeded, wherein the threshold state value is a location boundary.

16. The tangible and non-transient computer readable medium of claim 10, wherein the customer telematics analysis service comprises a probing service that allows a customer to receive vehicle state data for a selected vehicle.

17. The tangible and non-transient computer readable medium of claim 10, wherein the customer telematics analysis service comprises a probing service that allows a customer to receive vehicle location state data for a selected vehicle.

18. A system, comprising:
a communication device, comprising:
a microprocessor; and
a memory comprising microprocessor executable instructions that, when executed by the microprocessor, receives vehicle state data from a plurality of vehicles, the vehicle state data comprising a plurality of parameters; receives geolocation data associated with the vehicle state data of the plurality of vehicles; receives customer enterprise data from a customer, the customer enterprise data associated with the plurality of vehicles; aggregates the vehicle state data, the geolocation data, and the customer enterprise data associated with the plurality of vehicles to produce aggregate data; analyzes the aggregate data to provide a customer telematics analysis service to the customer; determines a trend between two or more vehicles; and provides an output associated with the trend to the customer.

19. The system of claim 18, wherein the vehicle state data comprises a latitude/longitude location, speed, an acceleration, a deceleration, an airbag deployment, a vehicle interior camera and a vehicle exterior camera, and wherein the customer enterprise data comprises threshold state values.

20. The method of claim 19, wherein the customer telematics analysis service monitors the threshold state values with respect to the vehicle state data and provides a notice to the customer if at least one threshold state value is exceeded, wherein the threshold state values comprise location boundaries.
